(19) United States
(12) Patent Application Publication
(10) Pub. No.: US 2026/0214320 A1
(43) Pub. Date: Jul. 23, 2026

(54) CAMERA APPLICATION USER INTERFACES

(71) Applicant: Apple Inc., Cupertino, CA (US)

(72) Inventors: Chanaka G. KARUNAMUNI, San Jose, CA (US); Marcos ALONSO, Oakland, CA (US); Adrian ZUMBRUNNEN, San Francisco, CA (US); Johnnie B. MANZARI, San Francisco, CA (US); Alan C. DYE, San Francisco, CA (US); William A. SORRENTINO, III, Kentfield, CA (US); Stephen O. LEMAY, Palo Alto, CA (US)

(21) Appl. No.: 19/386,020

(22) Filed: Nov. 11, 2025

Related U.S. Application Data
(60) Provisional application No. 63/746,911, filed on Jan. 17, 2025.
(60) Provisional application No. 63/768,810, filed on Mar. 7, 2025.
(60) Provisional application No. 63/808,574, filed on May 19, 2025.
(60) Provisional application No. 63/819,384, filed on Jun. 6, 2025.
(60) Provisional application No. 63/877,973, filed on Sep. 8, 2025.

(51) Int. Cl. H04N 23/63; H04N 23/667

(52) U.S. Cl. CPC H04N 23/632; H04N 23/667

(57) ABSTRACT

The present disclosure generally relates to user interfaces for a camera application and techniques related thereto, including methods for readily switching between camera modes and/or accessing additional mode controls, methods for maintaining certain camera settings when switching between camera modes, methods for changing zoom levels of one or more cameras, based on a change in the number of subjects, methods for capturing media concurrently with two sets of cameras, methods for displaying a camera user interface with a mode switching control that expands, methods for displaying a camera control panel overlaid on camera user interface, methods for displaying a control for adjusting a camera zoom level that shifts positions, and methods for displaying a camera user interface that concurrently includes one or more controls for changing a zoom level and one or more controls for changing a capture orientation.

### CROSS-REFERENCE TO RELATED APPLICATIONS

This application claims priority to U.S. Provisional Patent Application No. 63/877,973, entitled “CAMERA APPLICATION USER INTERFACES,” filed on Sep. 8, 2025, and claims priority to U.S. Provisional Patent Application No. 63/819,384, entitled “CAMERA APPLICATION USER INTERFACES,” filed on Jun. 6, 2025, and claims priority to U.S. Provisional Patent Application No. 63/808,574, entitled “CAMERA APPLICATION USER INTERFACES,” filed on May 19, 2025, and claims priority to U.S. Provisional Patent Application No. 63/768,810, entitled “CAMERA APPLICATION USER INTERFACES,” filed on Mar. 7, 2025, and claims priority to U.S. Provisional Patent Application No. 63/746,911, entitled “CAMERA APPLICATION USER INTERFACES,” filed on Jan. 17, 2025, the content of each of which is incorporated by reference for all purposes.

### FIELD

The present disclosure relates generally to computer user interfaces, and more specifically to user interfaces for a camera application and techniques related thereto.

### BACKGROUND

Computer systems, including portable computer systems such as smartphones, can be equipped with one or more cameras and software applications for use of such cameras to capture images and videos.

### BRIEF SUMMARY

Some techniques for displaying camera user interfaces using electronic devices, however, are generally cumbersome and inefficient. For example, some existing techniques use a complex and time-consuming user interface, which may include multiple key presses or keystrokes. This can be particularly relevant to camera user interfaces, which often provide a wide range of functions, options, and modes. Existing techniques require more time than necessary, wasting user time and device energy. This latter consideration is particularly important in battery-operated devices.

Accordingly, the present technique provides electronic devices with faster, more efficient methods and interfaces for displaying camera user interfaces. Such methods and interfaces optionally complement or replace other methods for displaying camera user interfaces. Such methods and interfaces reduce the cognitive burden on a user and produce a more efficient human-machine interface. For battery-operated computing devices, such methods and interfaces conserve power and increase the time between battery charges.

In some embodiments, a method performed at a computer system that is in communication with one or more input devices, one or more display generation components, and one or more cameras is described. The method includes: displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; while displaying the camera user interface, detecting, via the one or more input devices, a selection input directed to the camera user interface; and in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In accordance with some embodiments, a non-transitory computer-readable storage medium storing one or more programs configured to be executed by one or more processors of a computer system that is in communication with one or more input devices, one or more display generation components, and one or more cameras is described. The one or more programs including instructions for: displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; while displaying the camera user interface, detecting, via the one or more input devices, a selection input directed to the camera user interface; and in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In accordance with some embodiments, a transitory computer-readable storage medium storing one or more programs configured to be executed by one or more processors of a computer system that is in communication with one or more input devices, one or more display generation components, and one or more cameras is described. The one or more programs including instructions for: displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; while displaying the camera user interface, detecting, via the one or more input devices, a selection input directed to the camera user interface; and in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In accordance with some embodiments, a computer system configured to communicate with one or more input devices, one or more display generation components, and one or more cameras is described. The computer system includes one or more processors and memory storing one or more programs configured to be executed by the one or more processors. The one or more programs including instructions for: displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; while displaying the camera user interface, detecting, via the one or more input devices, a selection input directed to the camera user interface; and in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In accordance with some embodiments, a computer system configured to communicate with one or more input devices, one or more display generation components, and one or more cameras is described. The computer system includes: means for displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; means for, while displaying the camera user interface, detecting, via the one or more input devices, a selection input directed to the camera user interface; and means for, in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In accordance with some embodiments, a computer program product, comprising one or more programs configured to be executed by one or more processors of a computer system that is in with one or more input devices, one or more display generation components, and one or more cameras is described. The one or more programs including instructions for: displaying, via the one or more display generation components, a camera user interface that includes concurrently displaying: a live preview of content from the one or more cameras; and a camera mode selection affordance that includes a plurality of options including concurrently displaying: a first set of one or more mode options for switching between photo capture mode and video capture mode; a mode switcher option for selecting additional modes for the camera user interface; while displaying the camera user interface, detecting, via the one or more input devices, a selection input directed to the camera user interface; and in response to detecting the selection input: in accordance with a determination that the selection input is directed to the mode switcher option, displaying a second set of mode options that correspond to different modes; and in accordance with a determination that the selection input is directed to the first set of one or more mode options, switching the camera user interface between the photo mode and the video capture mode.

In some embodiments, a method performed at a computer system that is in communication with one or more input devices, one or more display generation components, and one or more cameras is described. The method includes: while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a non-transitory computer-readable storage medium storing one or more programs configured to be executed by one or more processors of a computer system that is in communication with one or more input devices, one or more display generation components, and one or more cameras is described. The one or more programs including instructions for: while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a transitory computer-readable storage medium storing one or more programs configured to be executed by one or more processors of a computer system that is in communication with one or more input devices, one or more display generation components, and one or more cameras is described. The one or more programs including instructions for: while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a computer system configured to communicate with one or more input devices, one or more display generation components, and one or more cameras is described. The computer system includes one or more processors and memory storing one or more programs configured to be executed by the one or more processors. The one or more programs including instructions for: while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a computer system configured to communicate with one or more input devices, one or more display generation components, and one or more cameras is described. The computer system includes: means for, while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; means for, in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a computer program product, comprising one or more programs configured to be executed by one or more processors of a computer system that is in with one or more input devices, one or more display generation components, and one or more cameras is described. The one or more programs including instructions for: while displaying a camera user interface and while the computer system is configured to capture a first type of media in response to a capture request input using a respective value of a plurality of available values for a first camera setting, detecting, via the one or more input devices, a media-type input corresponding to a request to switch a type of media that will be captured in response to the capture request input; in response to detecting the media-type input: in accordance with a determination that the respective value for the first camera setting is a first value, configuring the computer system to capture a second type of media, different from the first type of media, with the first value for the first camera setting; and in accordance with a determination that the respective value for the first camera setting is a second value, different from the first value for the first camera setting, configuring the computer system to capture the second type of media, with the second value for the first camera.

In accordance with some embodiments, a method performed at a computer system that is in communication with one or more input devices, one or more display generation components, and one or more cameras, is described. The method includes: while displaying, via the one or more display generation components, a camera user interface and before media capture has started based on a user input requesting media capture: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a non-transitory computer-readable storage medium storing one or more programs configured to be executed by one or more processors of a computer system that is in communication with one or more input devices, one or more display generation components, and one or more cameras, is described. The one or more programs including instructions for: while displaying, via the one or more display generation components, a camera user interface and before media capture has started based on a user input requesting media capture: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a transitory computer-readable storage medium storing one or more programs configured to be executed by one or more processors of a computer system that is in communication with one or more input devices, one or more display generation components, and one or more cameras, is described. The one or more programs including instructions for: while displaying, via the one or more display generation components, a camera user interface and before media capture has started based on a user input requesting media capture: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a computer system configured to communicate with one or more input devices, one or more display generation components, and one or more cameras, is described. The computer system includes one or more processors and memory storing one or more programs configured to be executed by the one or more processors. The one or more programs including instructions for: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a computer system configured to communicate with one or more input devices, one or more display generation components, and one or more cameras, is described. The computer system includes: means for, while displaying, via the one or more display generation components, a camera user interface and before media capture has started based on a user input requesting media capture: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a computer program product, comprising one or more programs configured to be executed by one or more processors of a computer system that is in communication with one or more input devices, one or more display generation components, and one or more cameras, is described. The one or more programs including instructions for: detecting a change in a number of subjects that are available to be captured via the one or more cameras; and in response to detecting the change in the number of subjects that are available to be captured via the one or more cameras, changing a zoom level for capturing media with the one or more cameras.

In accordance with some embodiments, a method performed at a computer system that is in communication with one or more input devices, one or more display generation components, and a plurality of cameras that includes a first set of one or more cameras that face a first direction and a second set of one or more cameras that face a second direction, different from the first direction, is described. The method including: while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a non-transitory computer-readable storage medium storing one or more programs configured to be executed by one or more processors of a computer system that is in communication with one or more input devices, one or more display generation components, and a plurality of cameras that includes a first set of one or more cameras that face a first direction and a second set of one or more cameras that face a second direction, different from the first direction, is described. The one or more programs including instructions for: while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a transitory computer-readable storage medium storing one or more programs configured to be executed by one or more processors of a computer system that is in communication with one or more input devices, one or more display generation components, and a plurality of cameras that includes a first set of one or more cameras that face a first direction and a second set of one or more cameras that face a second direction, different from the first direction, is described. The one or more programs including instructions for: while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a computer system configured to communicate with one or more input devices, one or more display generation components, and a plurality of cameras that includes a first set of one or more cameras that face a first direction and a second set of one or more cameras that face a second direction, different from the first direction, is described. The one or more programs including instructions for: while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a computer system configured to communicate with one or more input devices, one or more display generation components, and a plurality of cameras that includes a first set of one or more cameras that face a first direction and a second set of one or more cameras that face a second direction, different from the first direction, is described. The computer system including: means for, while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a computer program product, comprising one or more programs configured to be executed by one or more processors of a computer system that is in communication with one or more input devices, one or more display generation components, and a plurality of cameras that includes a first set of one or more cameras that face a first direction and a second set of one or more cameras that face a second direction, different from the first direction, is described. The one or more programs including instructions for: while displaying, via the one or more display generation components, a camera user interface: detecting, via the one or more input devices, a sequence of one or more inputs that correspond to a request to capture media with both the first set of one or more cameras and the second set of one or more cameras; and in response to detecting the request to capture media with both the first set of one or more cameras and the second set of one or more cameras, capturing media concurrently with the first set of one or more cameras and the second set of one or more cameras, wherein: a first tracking mode is used for capturing media with the first set of one or more cameras, wherein the first tracking mode includes a first set of one or more rules for changing a current framing of the first set of one or more cameras based on a first set of one or more detected events; and a second tracking mode, different from the first tracking mode, is used for capturing media with the second set of one or more cameras, wherein: the second tracking mode includes a second set of one or more rules for changing a current framing of the second set of one or more cameras based on a second set of one or more detected events; and the second set of one or more rules is different from the first set of one or more rules.

In accordance with some embodiments, a method performed at a computer system that is in communication with one or more input devices, one or more display generation components, and one or more cameras, is described. The method includes: displaying, via the one or more display generation components, a camera user interface that includes a camera mode selection user interface object, wherein the camera mode selection user interface object includes an indication of a currently selected capture mode for the one or more cameras; detecting, via the one or more input devices, a set of one or more inputs directed to the camera mode selection user interface object; and in response to detecting the set of one or more inputs directed to the camera mode selection user interface object, expanding the camera mode selection user interface object from a first size to a second size, larger than the first size.

In accordance with some embodiments, a non-transitory computer-readable storage medium storing one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a camera mode selection user interface object, wherein the camera mode selection user interface object includes an indication of a currently selected capture mode for the one or more cameras; detecting, via the one or more input devices, a set of one or more inputs directed to the camera mode selection user interface object; and in response to detecting the set of one or more inputs directed to the camera mode selection user interface object, expanding the camera mode selection user interface object from a first size to a second size, larger than the first size.

In accordance with some embodiments, a transitory computer-readable storage medium storing one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a camera mode selection user interface object, wherein the camera mode selection user interface object includes an indication of a currently selected capture mode for the one or more cameras; detecting, via the one or more input devices, a set of one or more inputs directed to the camera mode selection user interface object; and in response to detecting the set of one or more inputs directed to the camera mode selection user interface object, expanding the camera mode selection user interface object from a first size to a second size, larger than the first size.

In accordance with some embodiments, a computer system configured to communicate with one or more input devices, one or more display generation components, and one or more cameras, is described. The computer system includes one or more processors and memory storing one or more programs configured to be executed by the one or more processors. The one or more programs including instructions for: displaying, via the one or more display generation components, a camera user interface that includes a camera mode selection user interface object, wherein the camera mode selection user interface object includes an indication of a currently selected capture mode for the one or more cameras; detecting, via the one or more input devices, a set of one or more inputs directed to the camera mode selection user interface object; and in response to detecting the set of one or more inputs directed to the camera mode selection user interface object, expanding the camera mode selection user interface object from a first size to a second size, larger than the first size.

In accordance with some embodiments, a computer system configured to communicate with one or more input devices, one or more display generation components, and one or more cameras, is described. The computer system includes: means for displaying, via the one or more display generation components, a camera user interface that includes a camera mode selection user interface object, wherein the camera mode selection user interface object includes an indication of a currently selected capture mode for the one or more cameras; means for detecting, via the one or more input devices, a set of one or more inputs directed to the camera mode selection user interface object; and means for, in response to detecting the set of one or more inputs directed to the camera mode selection user interface object, expanding the camera mode selection user interface object from a first size to a second size, larger than the first size.

In accordance with some embodiments, a computer program product, comprising one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a camera mode selection user interface object, wherein the camera mode selection user interface object includes an indication of a currently selected capture mode for the one or more cameras; detecting, via the one or more input devices, a set of one or more inputs directed to the camera mode selection user interface object; and in response to detecting the set of one or more inputs directed to the camera mode selection user interface object, expanding the camera mode selection user interface object from a first size to a second size, larger than the first size.

In accordance with some embodiments, a method performed at a computer system that is in communication with one or more input devices, one or more display generation components, and one or more cameras, is described. The method includes: displaying, via the one or more display generation components, a camera user interface that includes a first plurality of camera controls, wherein the first plurality of camera controls includes a respective platter that corresponds to one or more of the camera controls of the first plurality of camera controls; detecting, via the one or more user input devices, a set of one or more inputs corresponding to a request to display additional camera controls; in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a non-transitory computer-readable storage medium storing one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a first plurality of camera controls, wherein the first plurality of camera controls includes a respective platter that corresponds to one or more of the camera controls of the first plurality of camera controls; detecting, via the one or more user input devices, a set of one or more inputs corresponding to a request to display additional camera controls; in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a transitory computer-readable storage medium storing one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a first plurality of camera controls, wherein the first plurality of camera controls includes a respective platter that corresponds to one or more of the camera controls of the first plurality of camera controls; detecting, via the one or more user input devices, a set of one or more inputs corresponding to a request to display additional camera controls; in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a computer system configured to communicate with one or more input devices, one or more display generation components, and one or more cameras, is described. The computer system includes one or more processors and memory storing one or more programs configured to be executed by the one or more processors. The one or more programs including instructions for: displaying, via the one or more display generation components, a camera user interface that includes a first plurality of camera controls, wherein the first plurality of camera controls includes a respective platter that corresponds to one or more of the camera controls of the first plurality of camera controls; detecting, via the one or more user input devices, a set of one or more inputs corresponding to a request to display additional camera controls; in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a computer system configured to communicate with one or more input devices, one or more display generation components, and one or more cameras, is described. The computer system includes: means for displaying, via the one or more display generation components, a camera user interface that includes a first plurality of camera controls, wherein the first plurality of camera controls includes a respective platter that corresponds to one or more of the camera controls of the first plurality of camera controls; means for detecting, via the one or more user input devices, a set of one or more inputs corresponding to a request to display additional camera controls; means for, in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a computer program product, comprising one or more programs configured to be executed by one or more processors of a computer system that is in communication with one or more input devices, one or more display generation components, and one or more cameras, is described. The one or more programs including instructions for: displaying, via the one or more display generation components, a camera user interface that includes a first plurality of camera controls, wherein the first plurality of camera controls includes a respective platter that corresponds to one or more of the camera controls of the first plurality of camera controls; detecting, via the one or more user input devices, a set of one or more inputs corresponding to a request to display additional camera controls; in response to detecting the set of one or more inputs corresponding to the request to display additional camera controls: expanding the respective platter from a first size to a second size, larger than the first size; displaying, via the one or more generation components, a second plurality of camera controls, different from the first plurality of camera controls, wherein, the respective platter, when displayed at the second size, occupies a first portion of the camera user interface that was previously occupied by one or more of the first plurality of camera controls; and ceasing to display one or more of the first plurality of camera controls.

In accordance with some embodiments, a method performed at a computer system that is in communication with one or more input devices, one or more display generation components, and one or more cameras, is described. The method includes: detecting, via the one or more user input devices, a set of one or more inputs corresponding to a request to display a camera user interface for capturing media using the one or more cameras at a respective zoom level; in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a non-transitory computer-readable storage medium storing one or more programs configured to be executed by one or more processors of a computer system that is in communication with one or more input devices, one or more display generation components, and one or more cameras, is described. The one or more programs including instructions for: detecting, via the one or more user input devices, a set of one or more inputs corresponding to a request to display a camera user interface for capturing media using the one or more cameras at a respective zoom level; in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a transitory computer-readable storage medium storing one or more programs configured to be executed by one or more processors of a computer system that is in communication with one or more input devices, one or more display generation components, and one or more cameras, is described. The one or more programs including instructions for: detecting, via the one or more user input devices, a set of one or more inputs corresponding to a request to display a camera user interface for capturing media using the one or more cameras at a respective zoom level; in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a computer system configured to communicate with one or more input devices, one or more display generation components, and one or more cameras, is described. The computer system includes one or more processors and memory storing one or more programs configured to be executed by the one or more processors. The one or more programs including instructions for: detecting, via the one or more user input devices, a set of one or more inputs corresponding to a request to display a camera user interface for capturing media using the one or more cameras at a respective zoom level; in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a computer system configured to communicate with one or more input devices, one or more display generation components, and one or more cameras, is described. The computer system includes: means for detecting, via the one or more user input devices, a set of one or more inputs corresponding to a request to display a camera user interface for capturing media using the one or more cameras at a respective zoom level; means for, in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a computer program product, comprising one or more programs configured to be executed by one or more processors of a computer system that is in communication with one or more input devices, one or more display generation components, and one or more cameras, is described. The one or more programs including instructions for: detecting, via the one or more user input devices, a set of one or more inputs corresponding to a request to display a camera user interface for capturing media using the one or more cameras at a respective zoom level; in response to detecting the set of one or more inputs corresponding to the request to display the camera user interface for capturing media using the one or more cameras at the respective zoom level, displaying, via the one or more display generation components, the camera user interface, including: in accordance with a determination that the respective zoom level is a first zoom level, displaying a zoom control user interface object for adjusting a zoom level of the one or more cameras at a first location in the camera user interface; and in accordance with a determination that the respective zoom level is a second zoom level, different from the first zoom level, displaying the zoom control user interface object for adjusting a zoom level of the one or more cameras at a second location in the camera user interface, different from the first location.

In accordance with some embodiments, a method performed at a computer system that is in communication with one or more input, one or more display generation components, and one or more cameras, is described. The method includes: detecting an event associated with displaying a camera user interface; in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; detecting, via the one or more input devices, a selection input; and in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface.

In accordance with some embodiments, a non-transitory computer-readable storage medium storing one or more programs configured to be executed by one or more processors of a computer system that is in communication with one or more input, one or more display generation components, and one or more cameras, is described. The one or more programs including instructions for: detecting an event associated with displaying a camera user interface; in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; detecting, via the one or more input devices, a selection input; and in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface.

In accordance with some embodiments, a transitory computer-readable storage medium storing one or more programs configured to be executed by one or more processors of a computer system that is in communication with one or more input, one or more display generation components, and one or more cameras, is described. The one or more programs including instructions for: detecting an event associated with displaying a camera user interface; in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; detecting, via the one or more input devices, a selection input; and in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface.

In accordance with some embodiments, a computer system configured to communicate with one or more input, one or more display generation components, and one or more cameras, is described. The computer system includes one or more processors and memory storing one or more programs configured to be executed by the one or more processors. The one or more programs including instructions for: detecting an event associated with displaying a camera user interface; in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; detecting, via the one or more input devices, a selection input; and in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface.

In accordance with some embodiments, a computer system configured to communicate with one or more input, one or more display generation components, and one or more cameras, is described. The computer system includes: means for detecting an event associated with displaying a camera user interface; means for, in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; means for detecting, via the one or more input devices, a selection input; and means for, in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface.

In accordance with some embodiments, a computer program product, comprising one or more programs configured to be executed by one or more processors of a computer system configured to communicate with one or more input, one or more display generation components, and one or more cameras, is described. The one or more programs including instructions for: detecting an event associated with displaying a camera user interface; in response to detecting the event associated with displaying the camera user interface, displaying, via the one or more display generation components, the camera user interface, including displaying concurrently within the camera user interface: a live preview of content from the one or more cameras; and a plurality of selectable options including a first selectable option and a second selectable option that is different from the first selectable option; detecting, via the one or more input devices, a selection input; and in response to detecting the selection input: in accordance with a determination that the selection input is directed to the first selectable option of the plurality of selectable options, changing a zoom level of the live preview of content from the one or more cameras; and in accordance with a determination that the selection input is directed to the second selectable option of the plurality of selectable options, different from the first selectable option, changing a capture orientation of media captured by the one or more cameras via the camera user interface

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for displaying camera user interfaces, thereby increasing the effectiveness, efficiency, and user satisfaction with such devices. Such methods and interfaces may complement or replace other methods for displaying camera user interfaces.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6S illustrate camera user interfaces, in some embodiments.

FIG. 7 is a flow diagram illustrating methods for readily switching between camera modes and/or accessing additional mode controls, in some embodiments.

FIG. 8 is a flow diagram illustrating methods for maintaining certain camera settings when switching between camera modes, in some embodiments.

FIGS. 9A-9J illustrate user interfaces for a camera application that changes zoom levels of one or more cameras, based on a change in the number of subjects, in some embodiments.

FIG. 10 is a flow diagram illustrating methods for changing zoom levels of one or more cameras, based on a change in the number of subjects, in some embodiments.

FIGS. 11A-110 illustrate user interfaces for capturing media concurrently with two sets of cameras, in some embodiments.

FIG. 12 is a flow diagram illustrating methods for capturing media concurrently with two sets of cameras, in some embodiments.

FIGS. 13A-13W illustrate interfaces for a camera application that includes a mode switching control that expands, a camera control panel overlaid on camera user interface, and displaying a control for adjusting a camera zoom level that shifts positions, in some embodiments.

FIG. 14 is a flow diagram illustrating methods for displaying a camera user interface with a mode switching control that expands, in some embodiments.

FIG. 15 is a flow diagram illustrating methods for displaying a camera control panel overlaid on camera user interface, in some embodiments.

FIG. 16 is a flow diagram illustrating methods for displaying a control for adjusting a camera zoom level that shifts positions, in some embodiments.

FIGS. 17A-17K illustrate interfaces for displaying a camera user interface that concurrently includes one or more controls for changing a zoom level and one or more controls for changing a capture orientation, in some embodiments.

FIG. 18 is a flow diagram illustrating methods for displaying a camera user interface that concurrently includes one or more controls for changing a zoom level and one or more controls for changing a capture orientation, in some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for camera applications. For example, there is a need for methods and user interfaces for readily switching between camera modes and/or accessing additional mode controls. Additionally, there is a need for methods and user interfaces for maintaining certain camera settings when switching between camera modes. Such techniques can reduce the cognitive burden on a user who accesses a camera user interface, thereby enhancing productivity. Further, such techniques can reduce processor and battery power otherwise wasted on redundant user inputs.

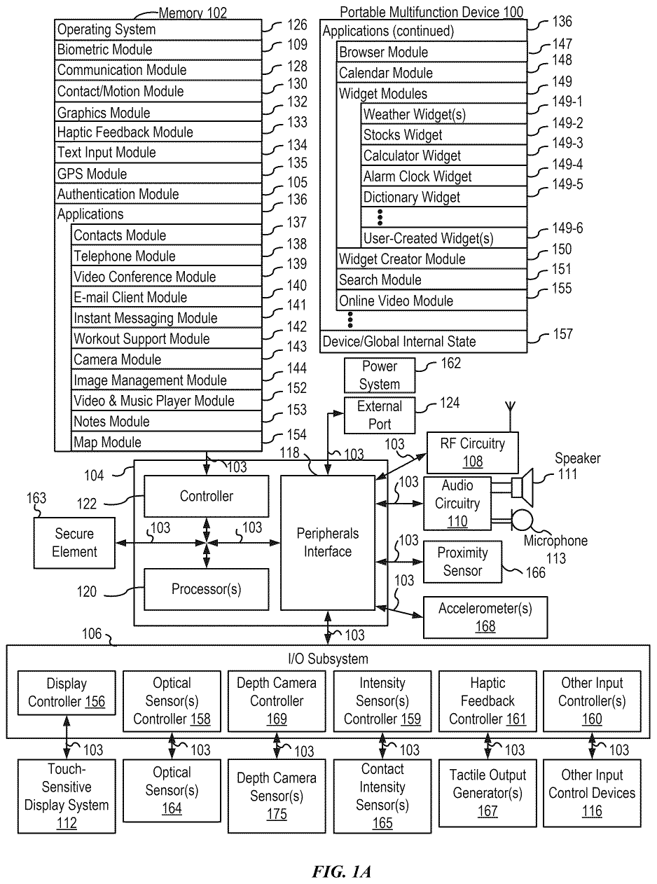

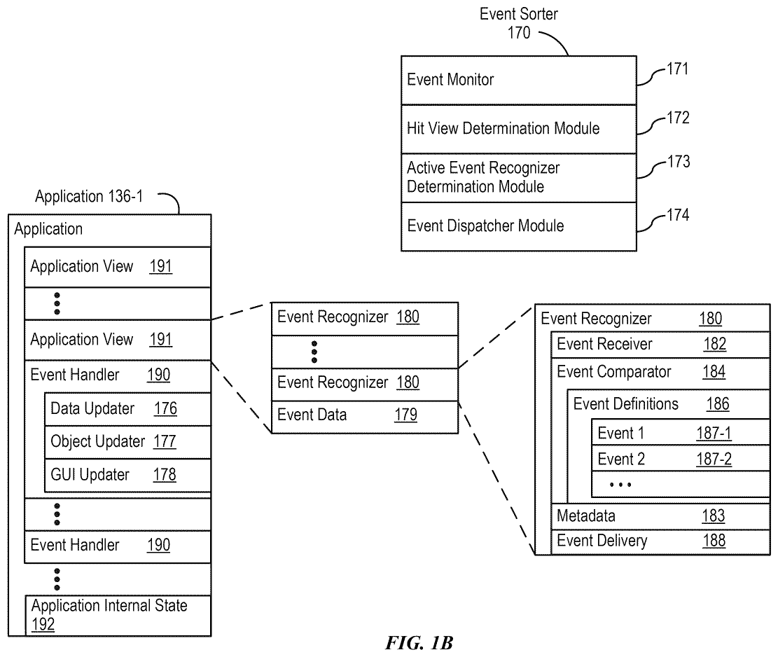

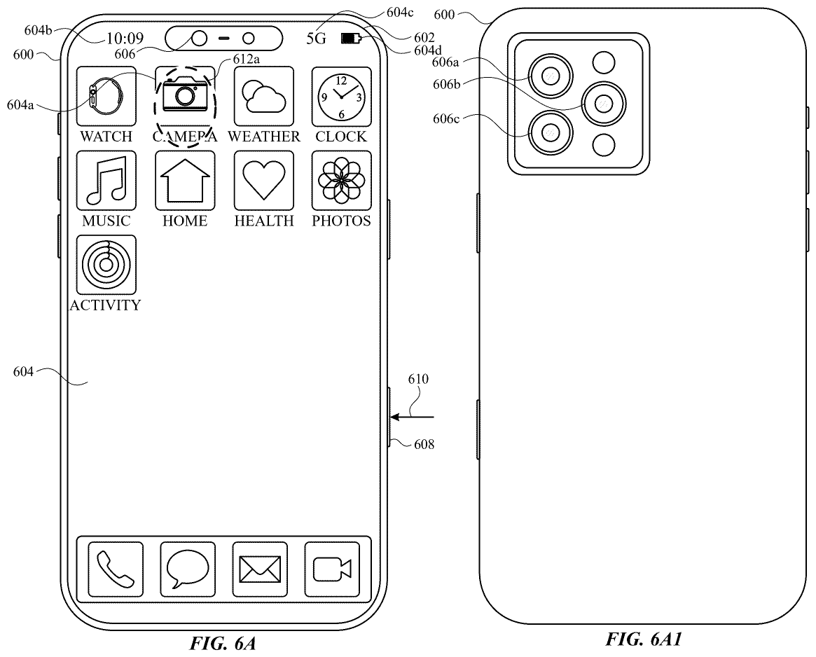

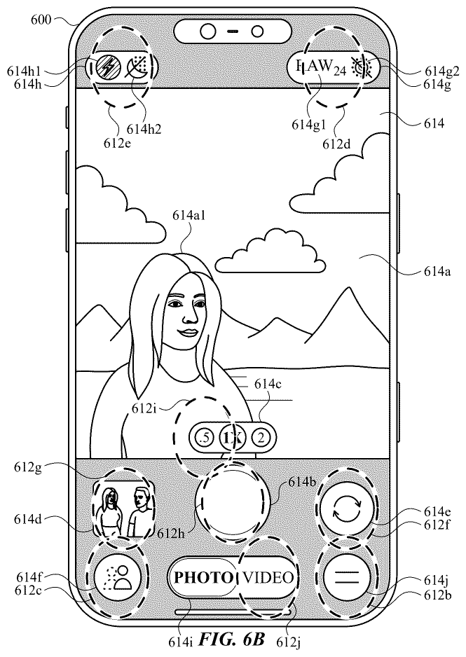

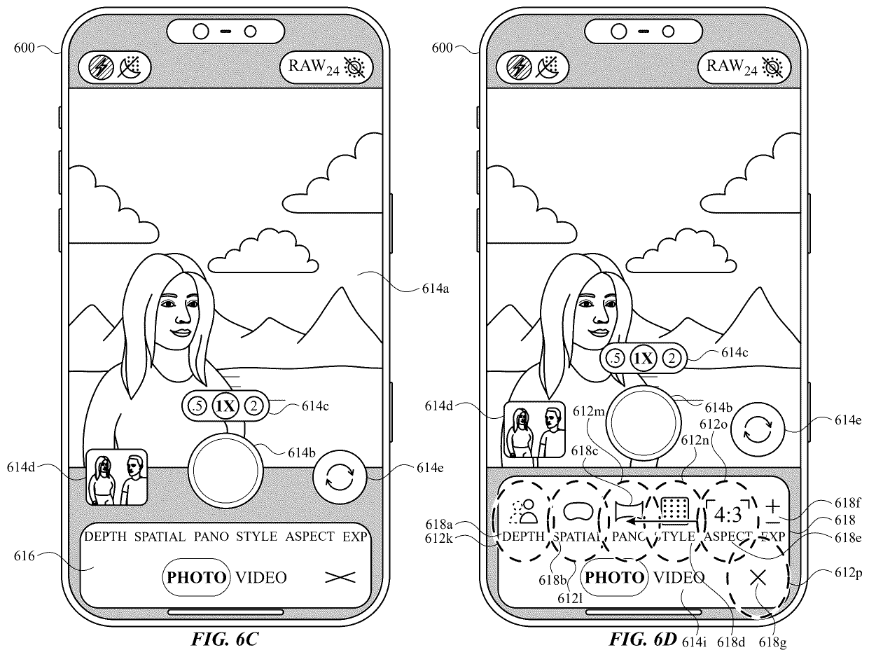

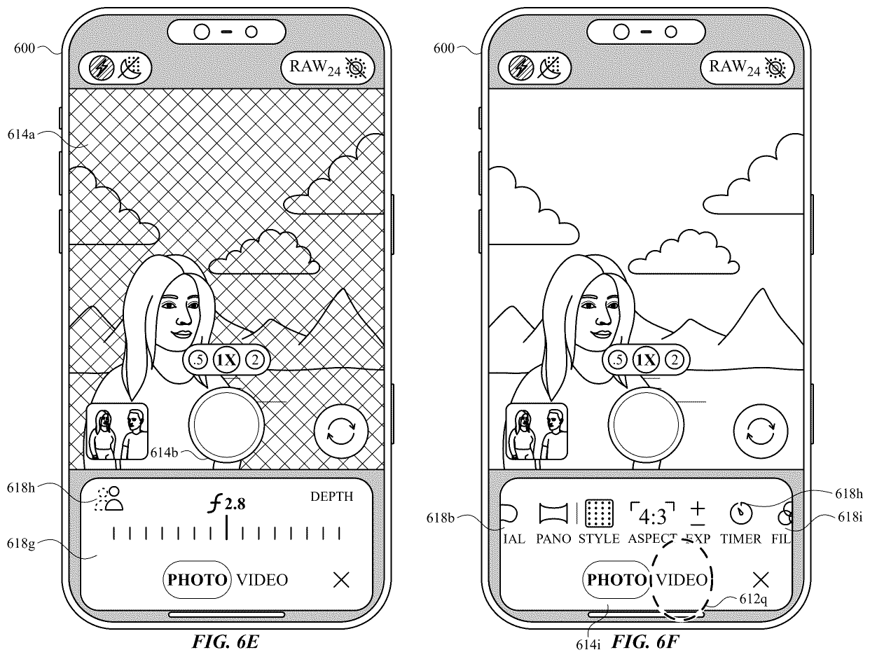

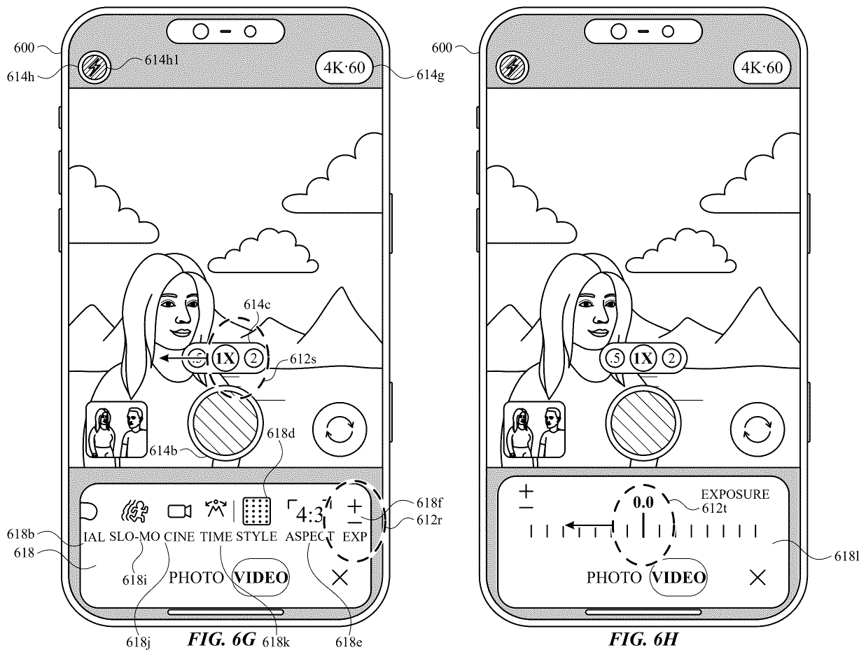

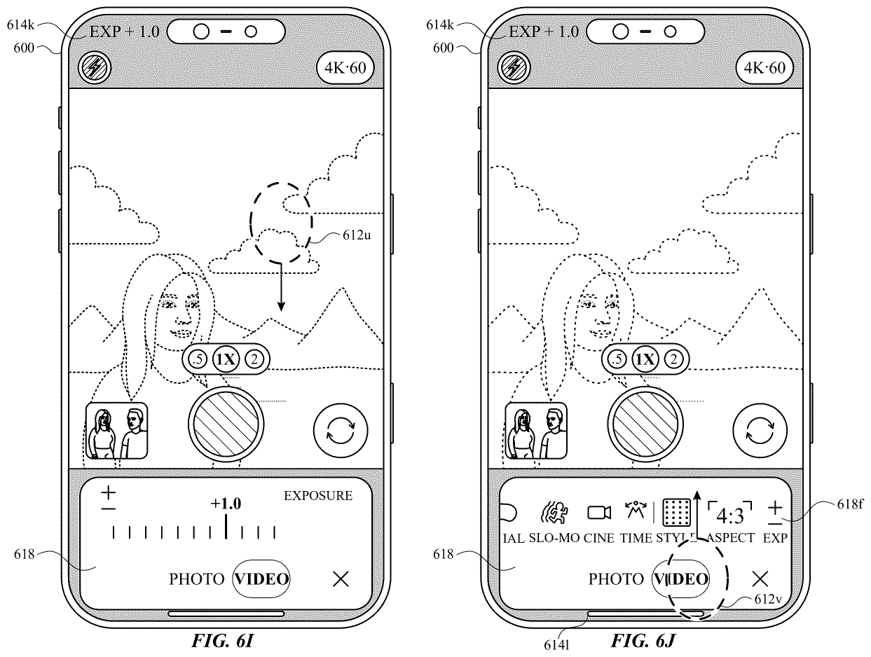

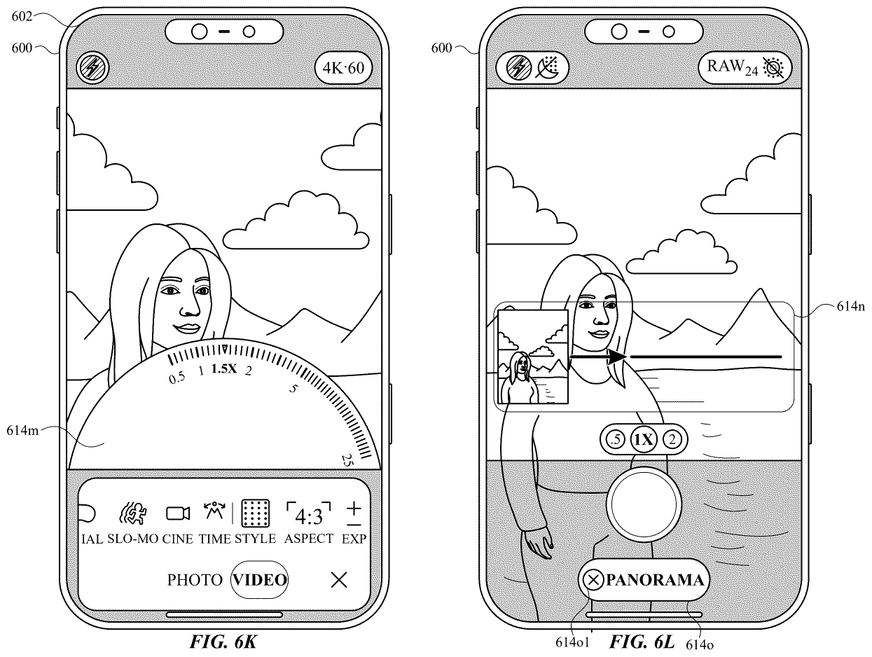

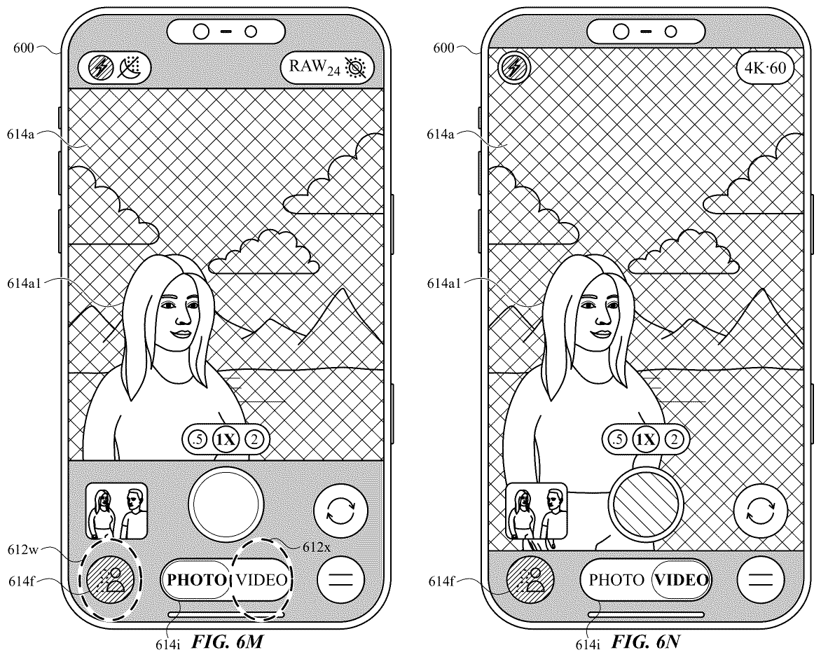

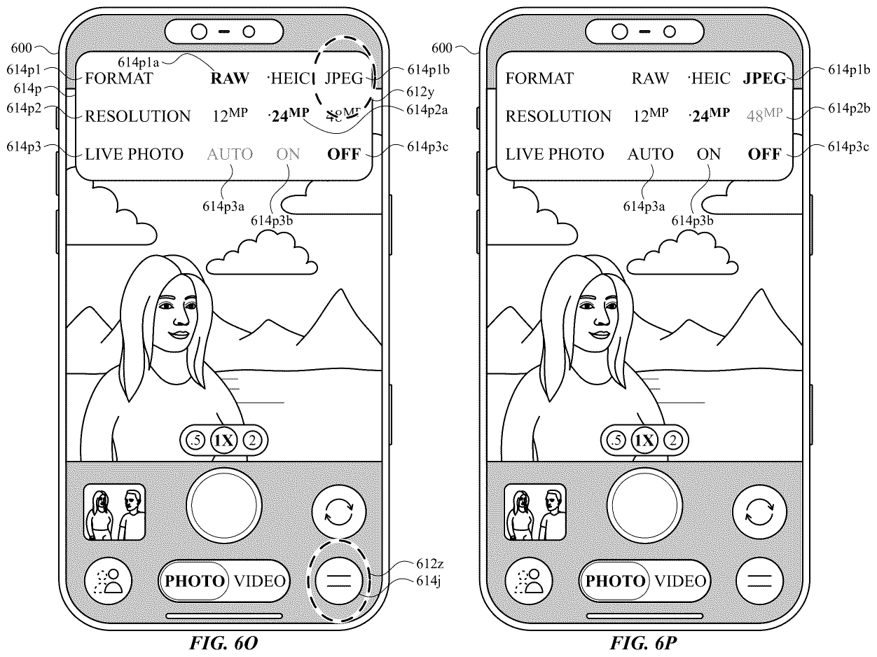

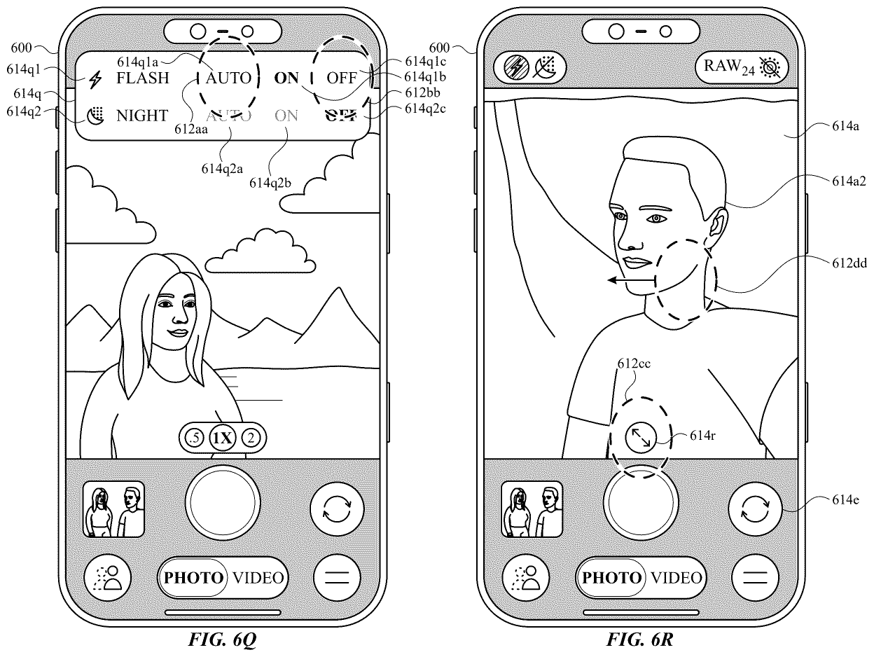

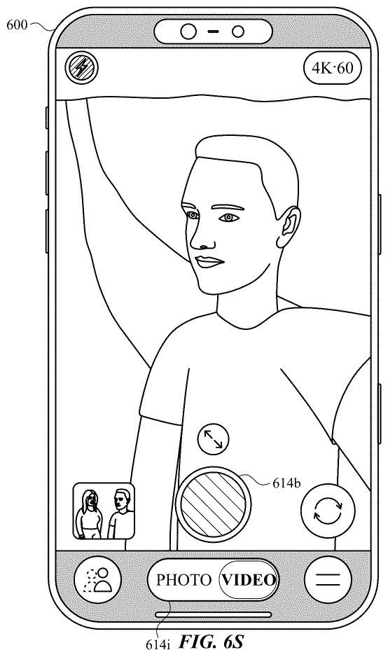

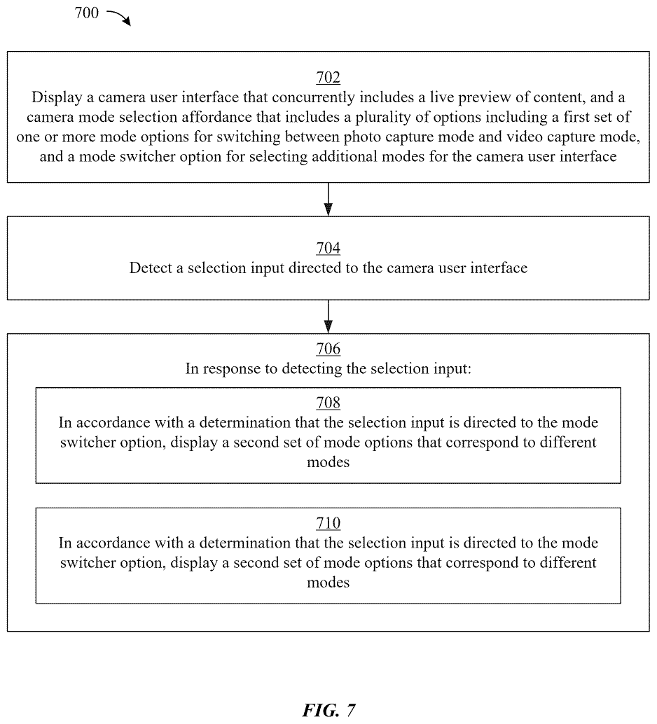

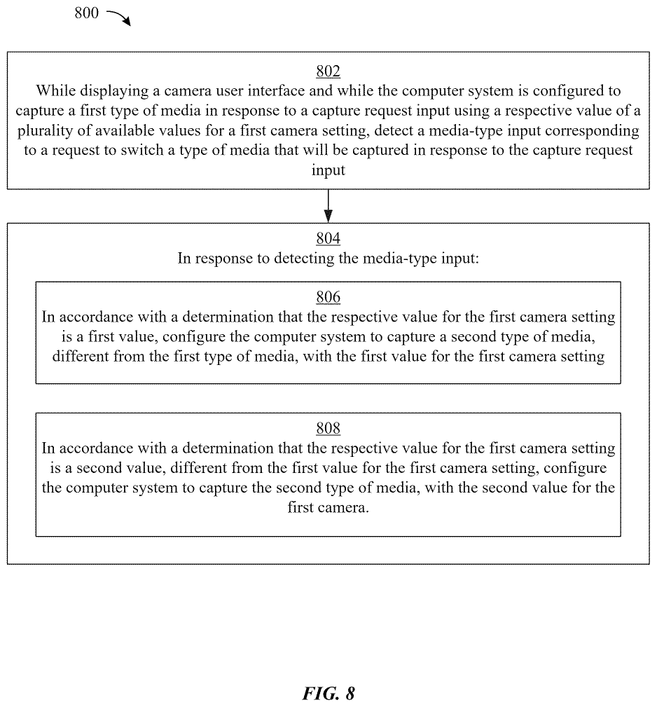

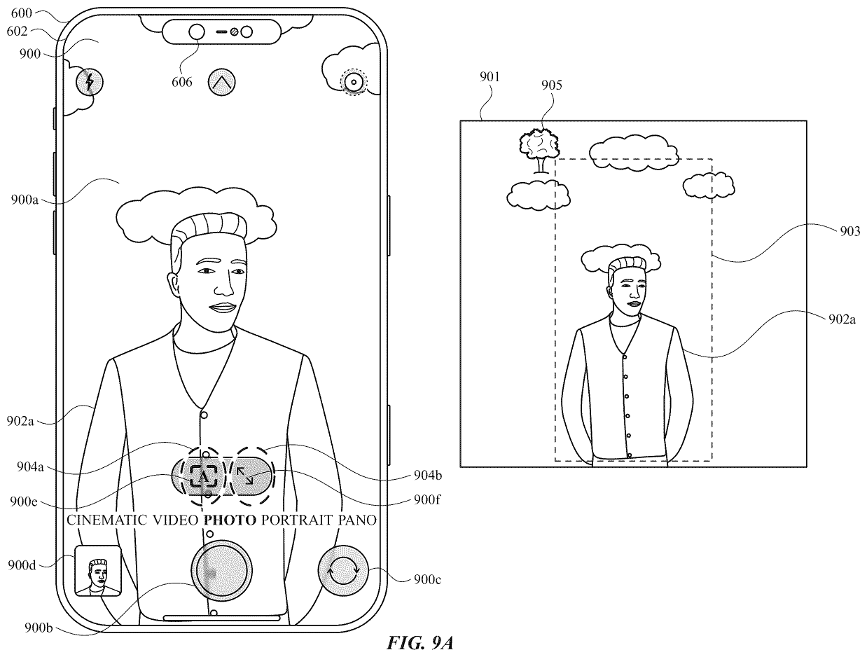

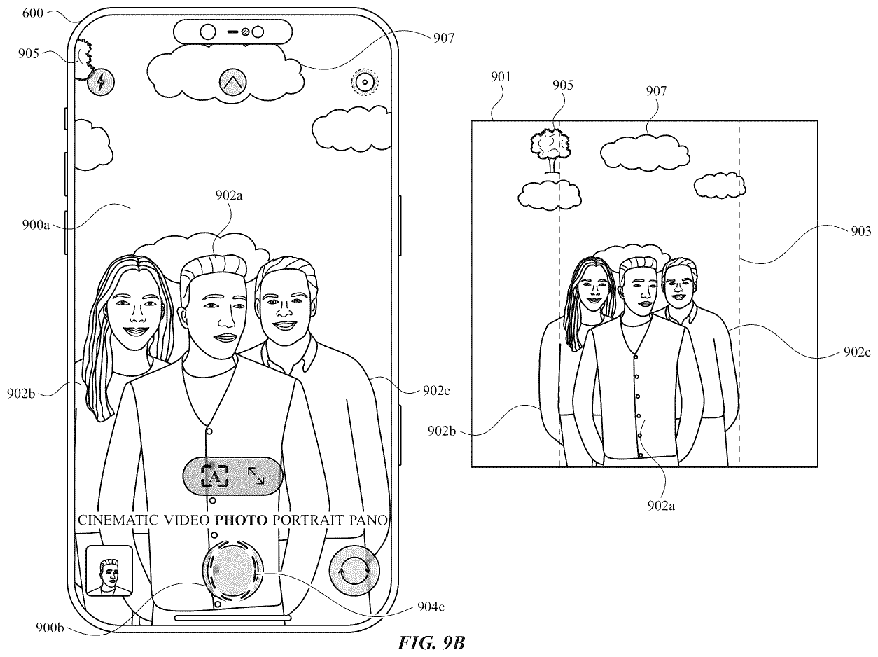

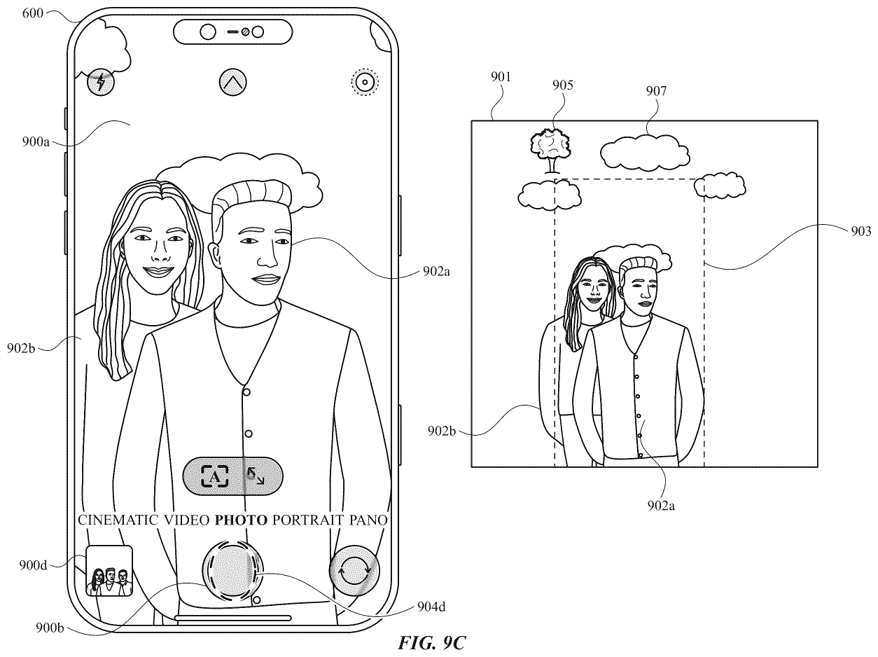

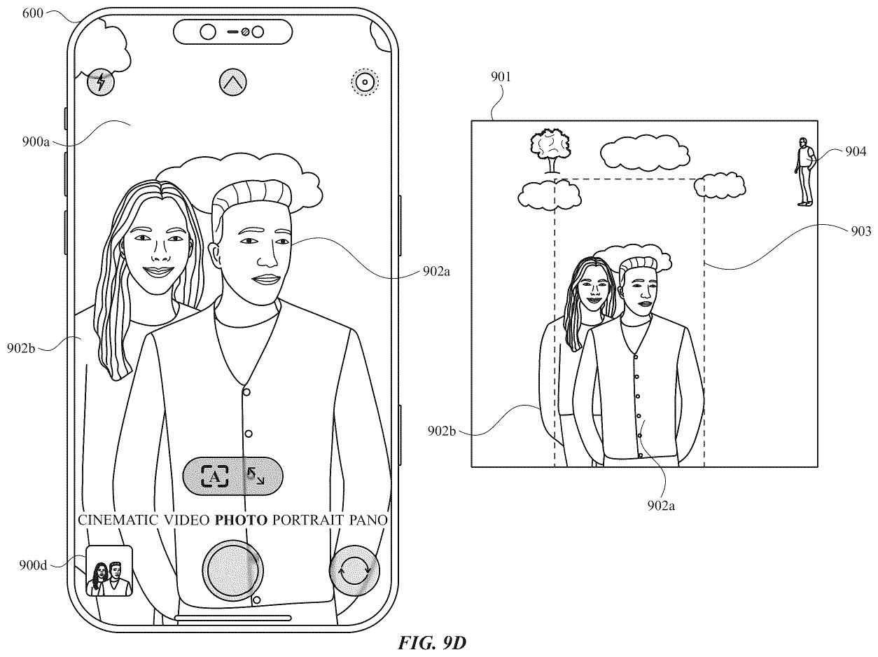

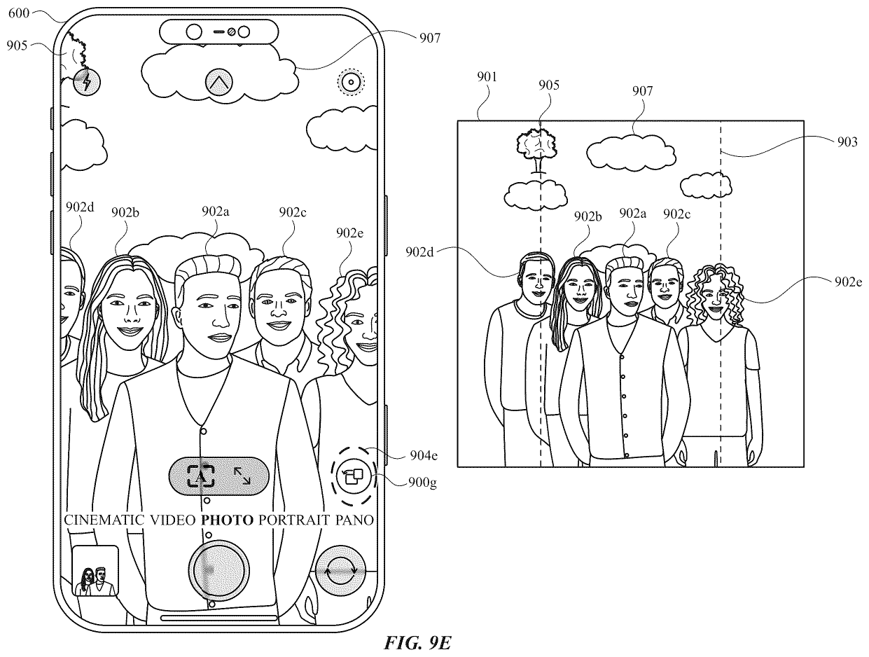

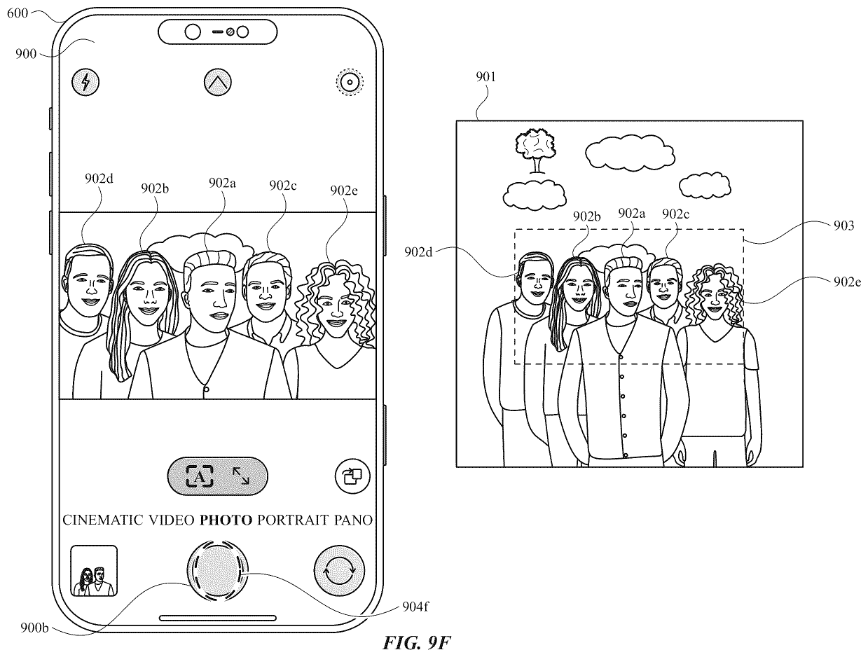

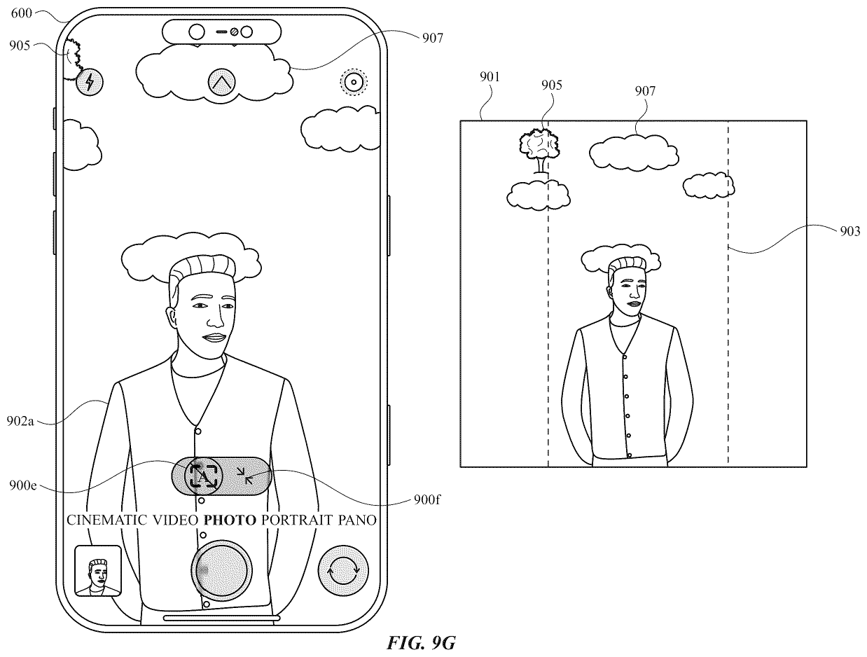

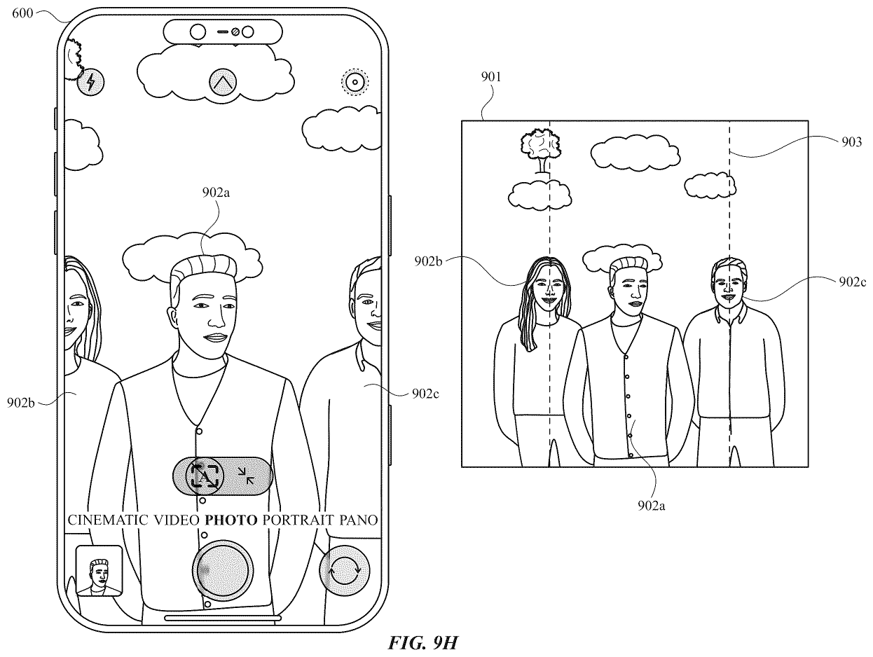

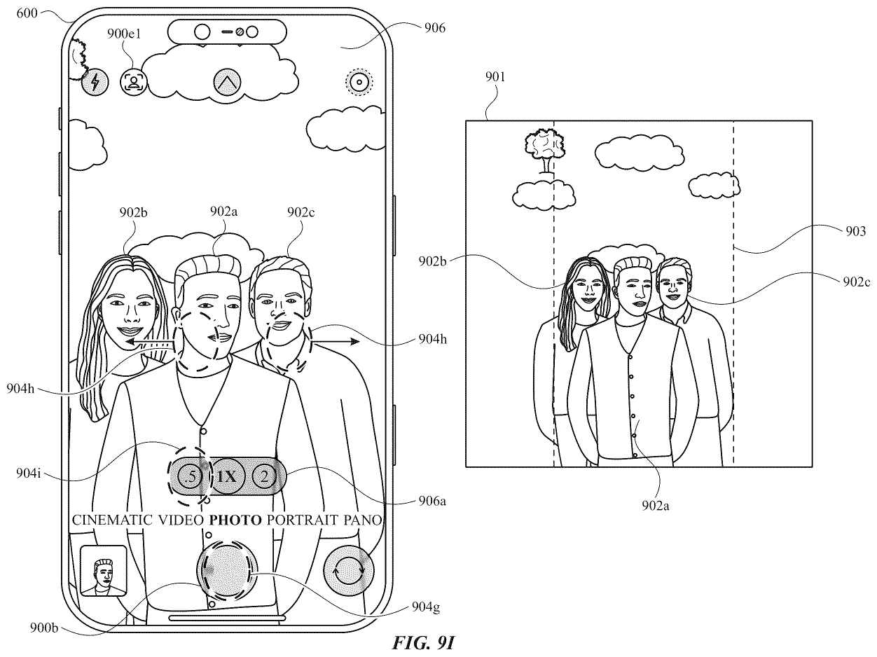

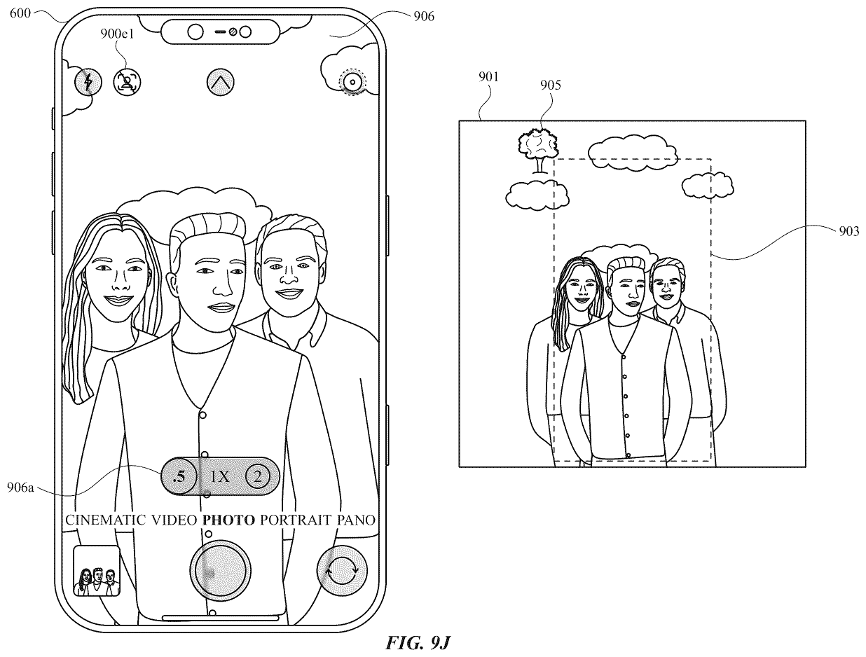

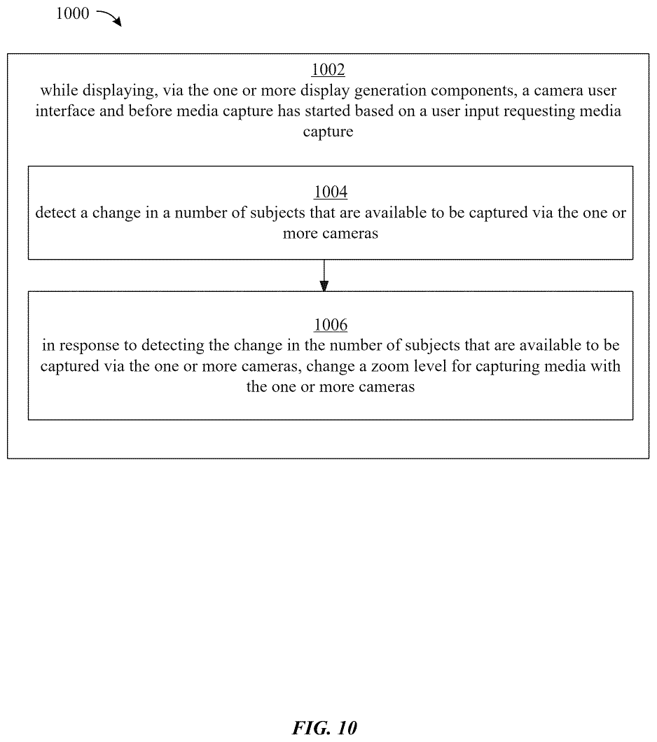

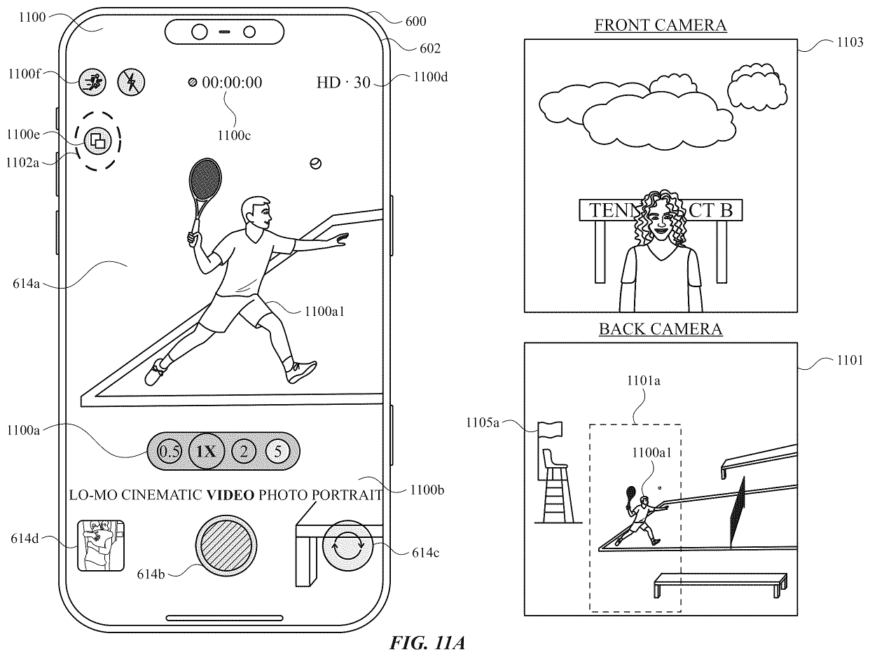

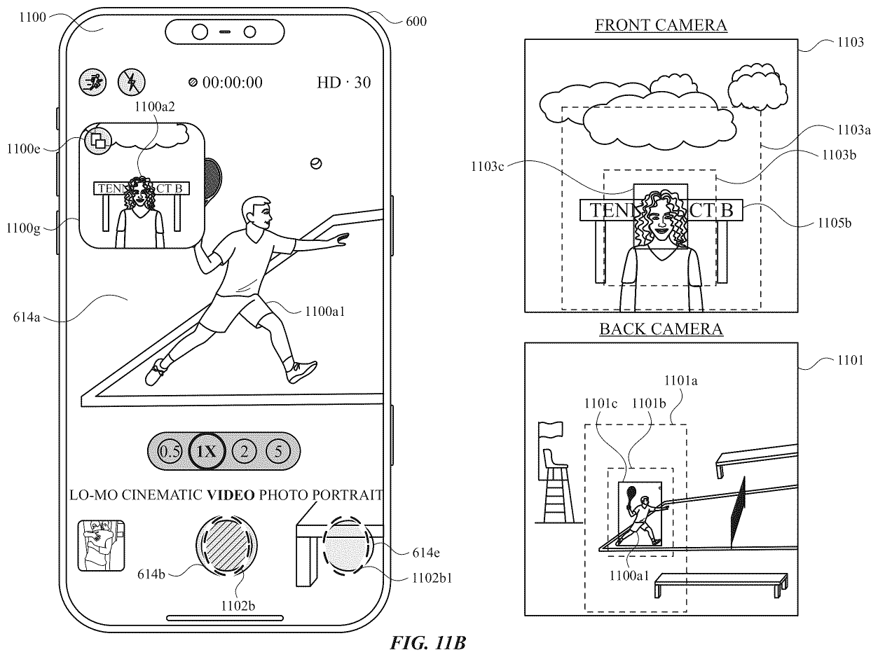

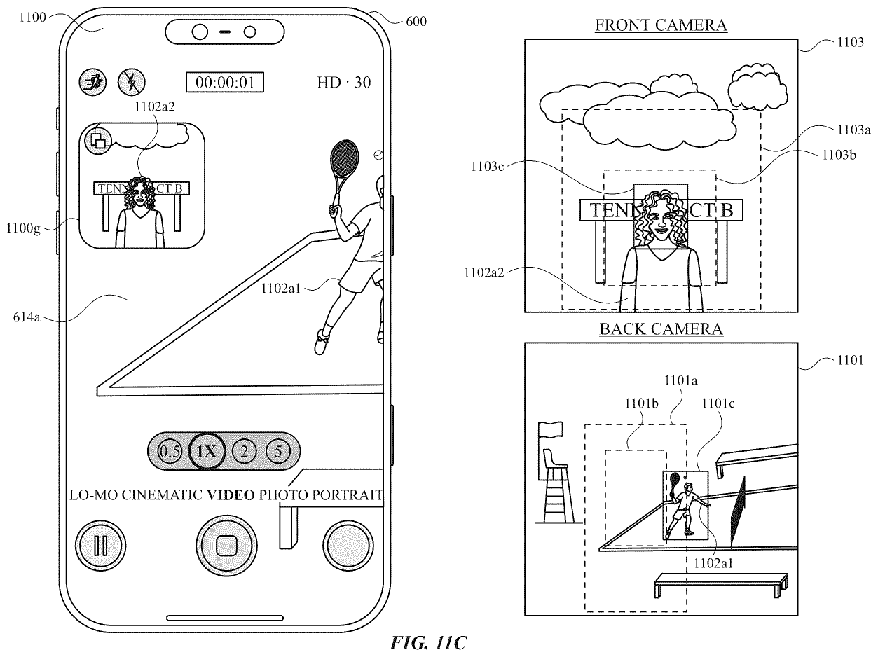

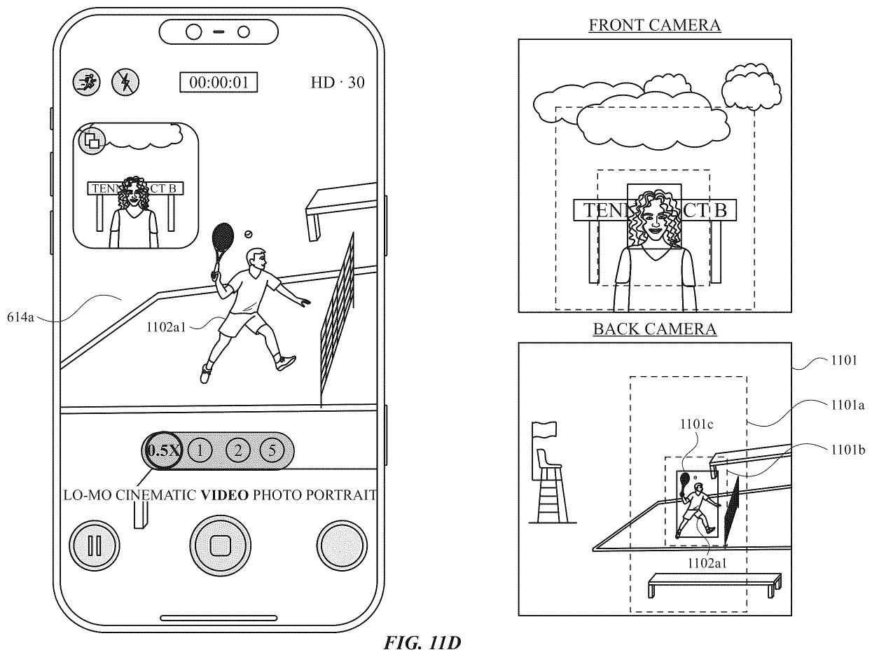

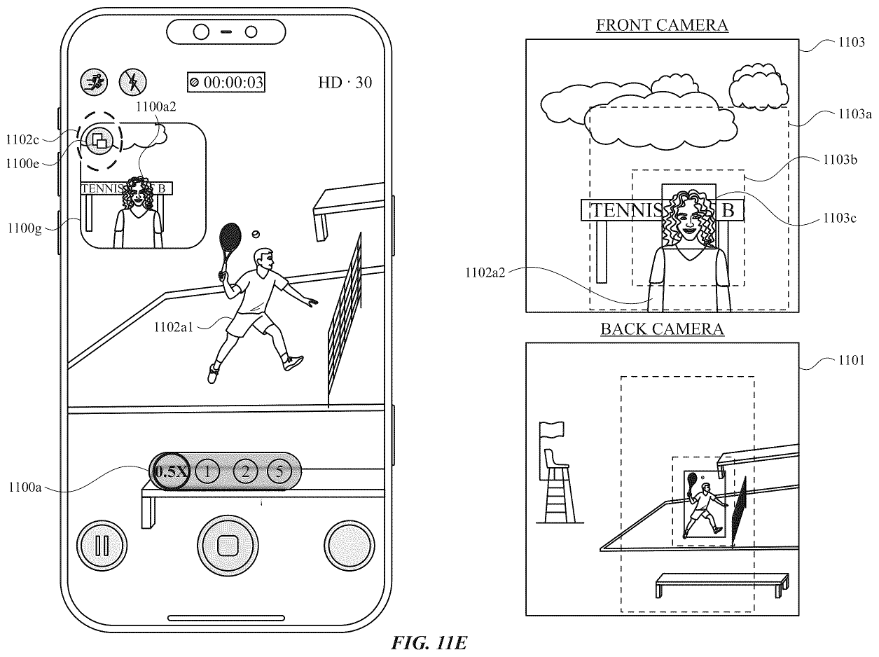

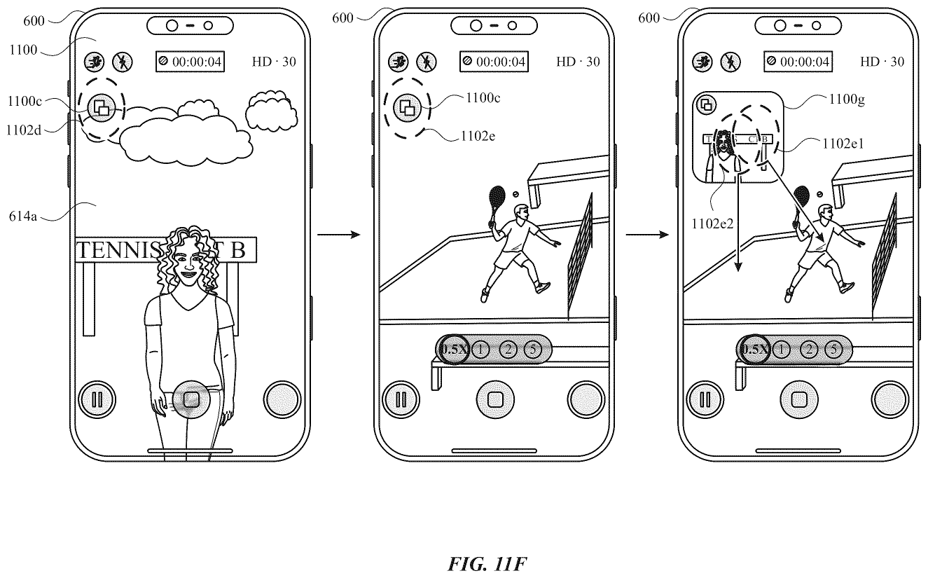

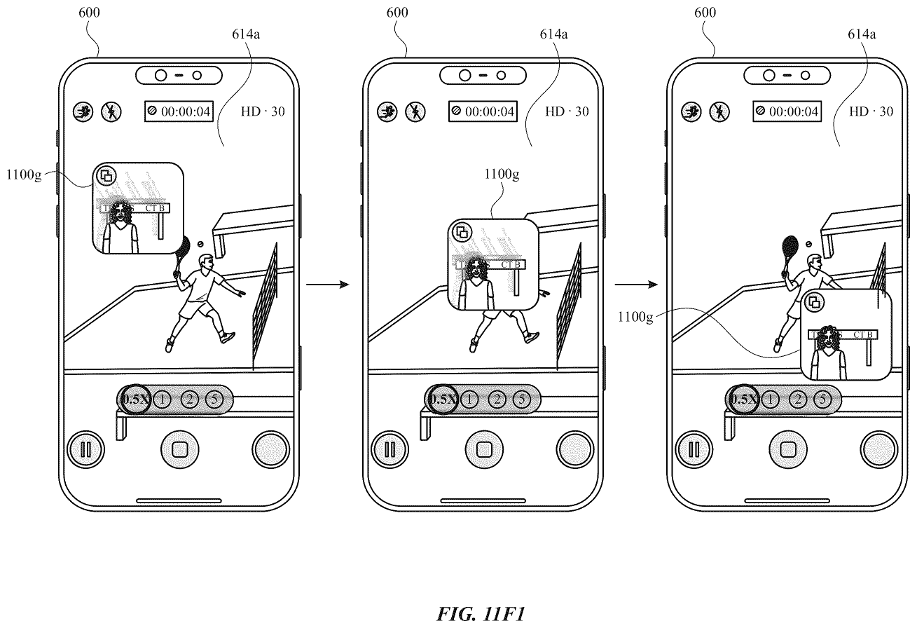

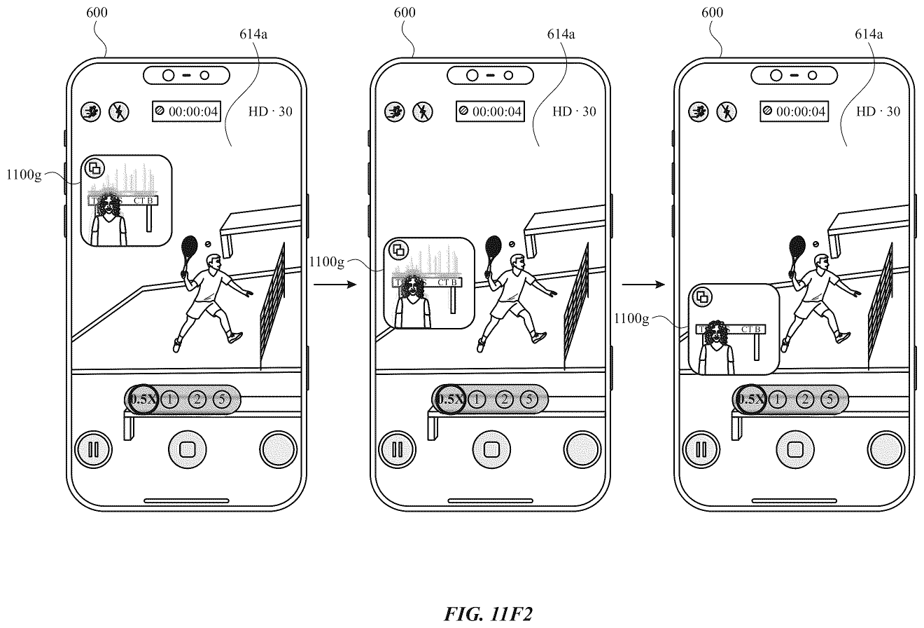

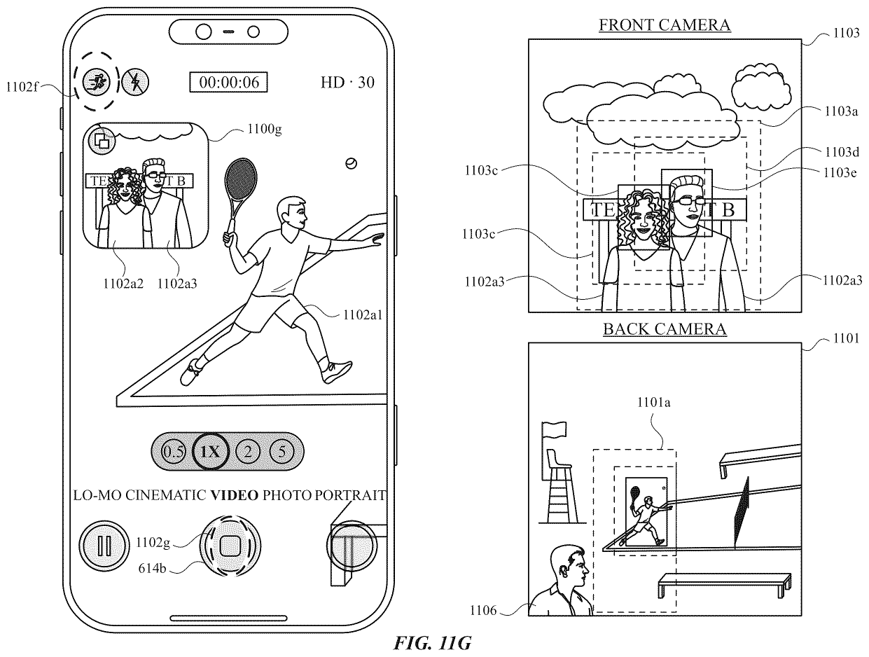

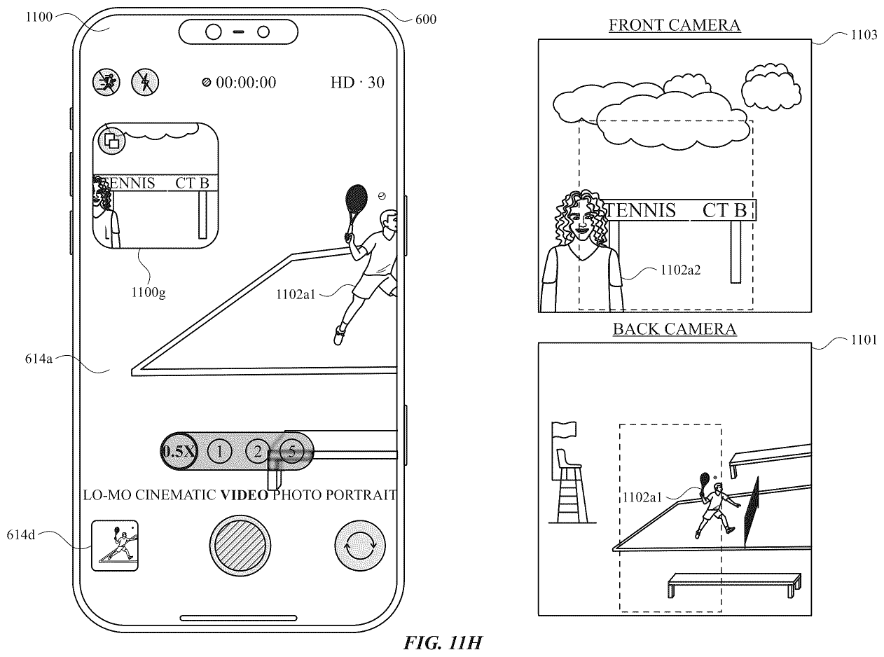

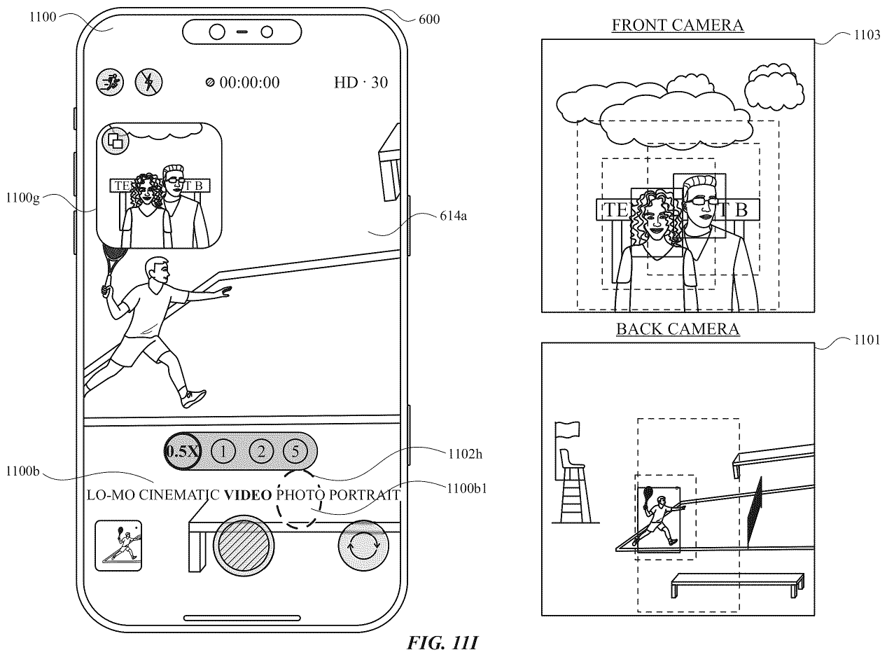

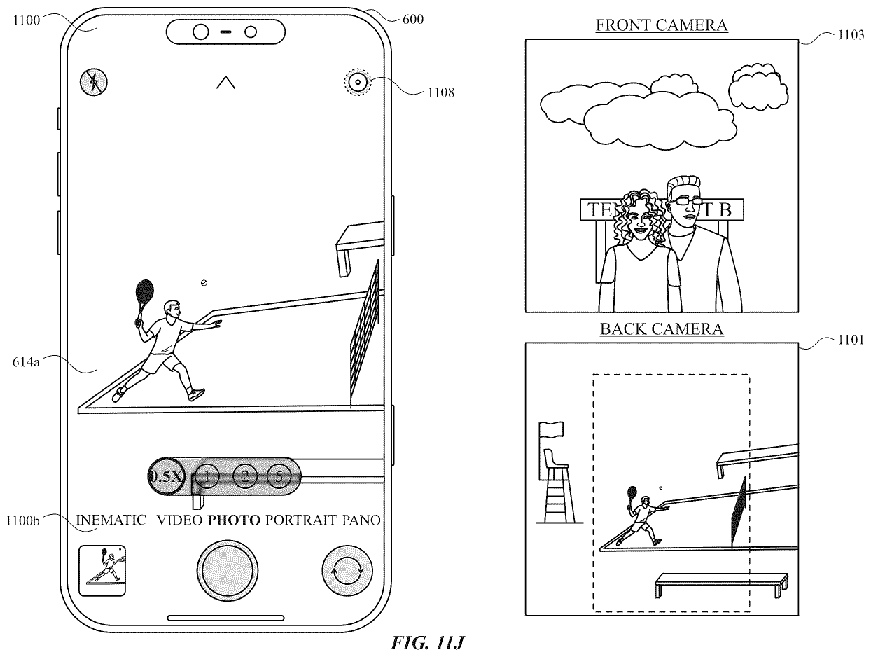

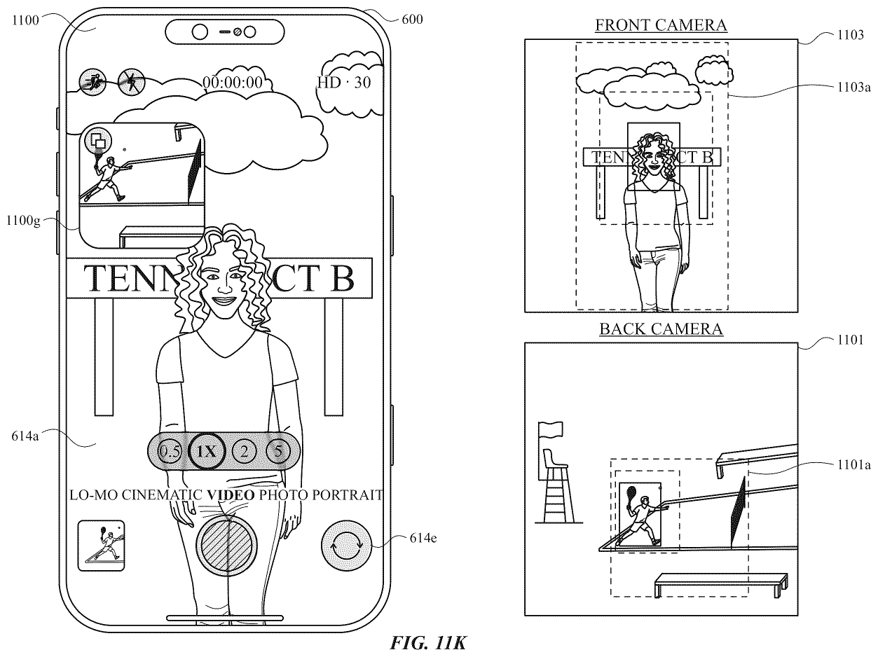

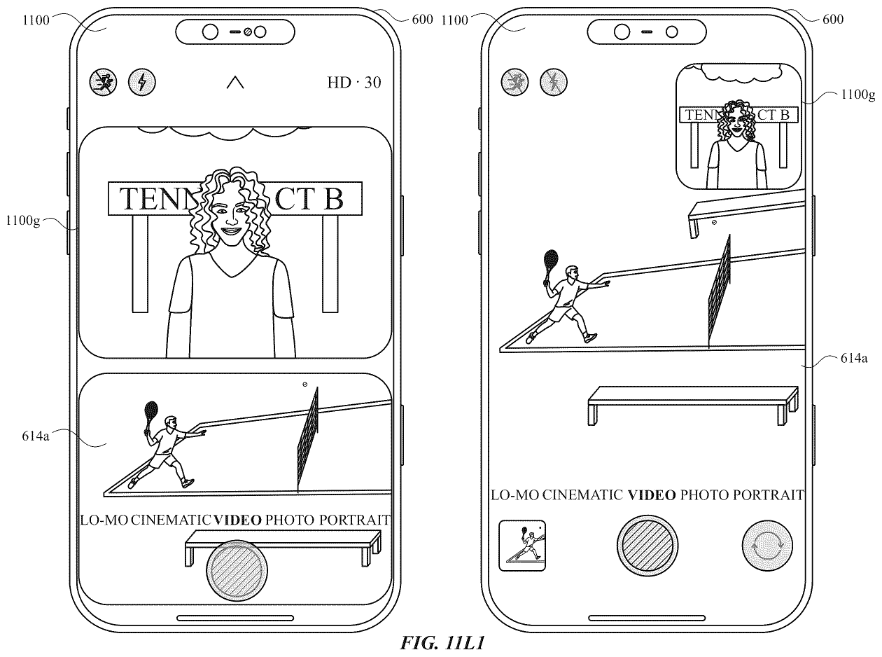

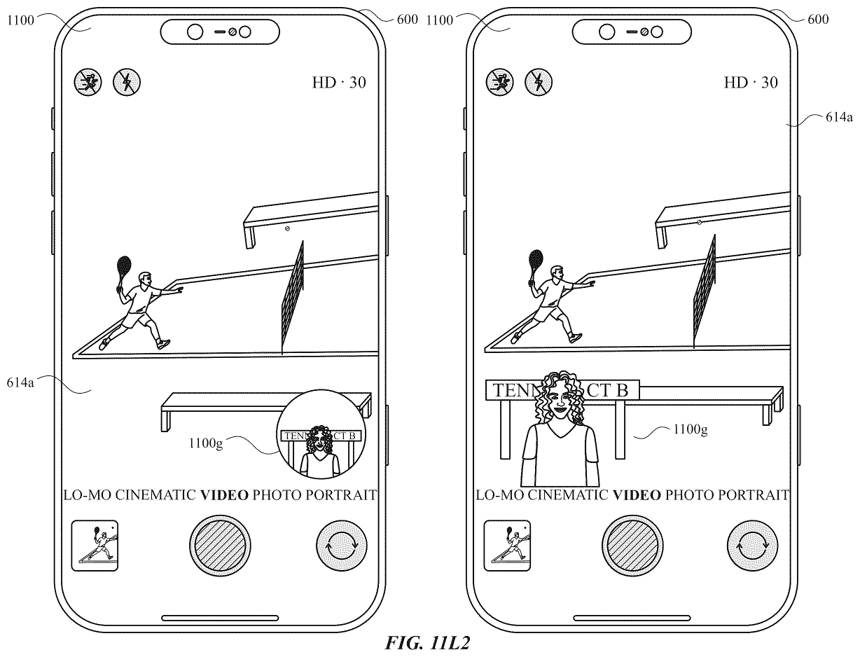

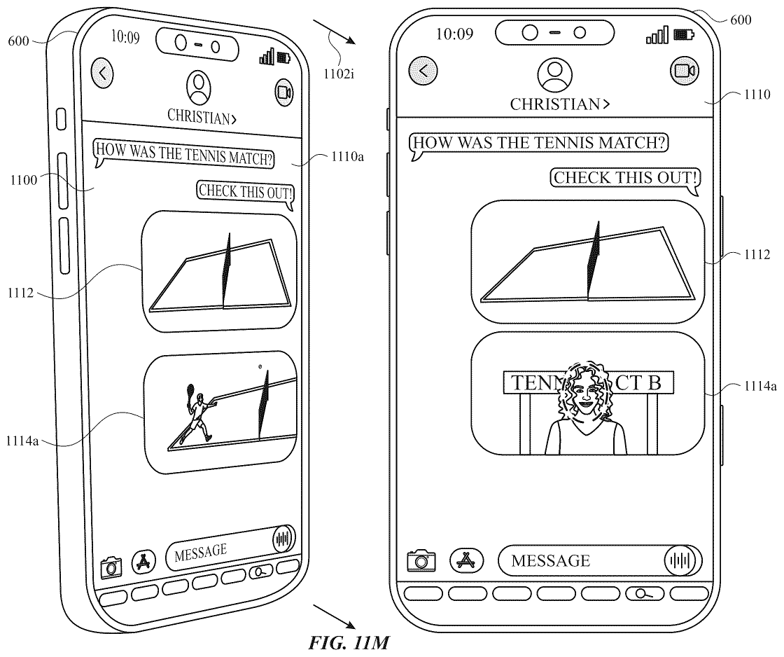

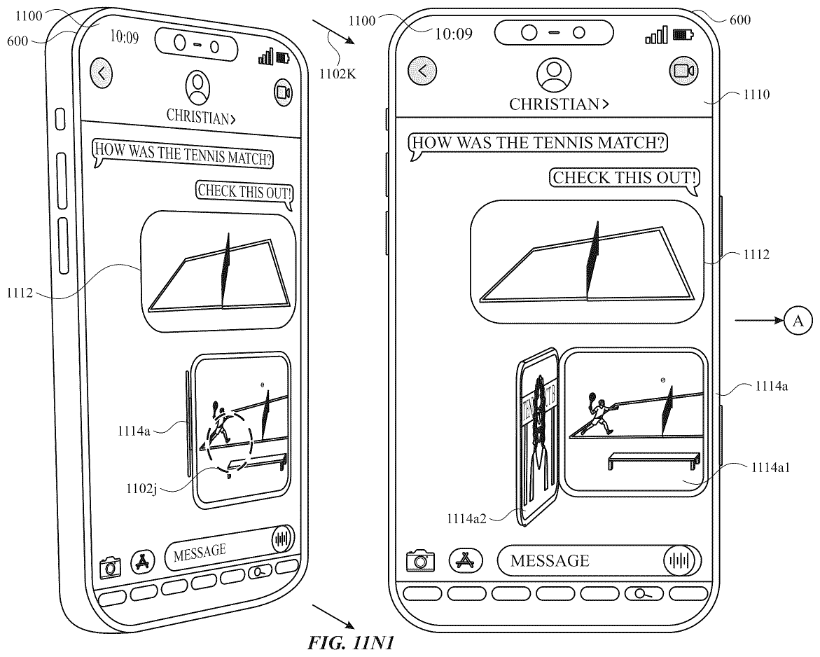

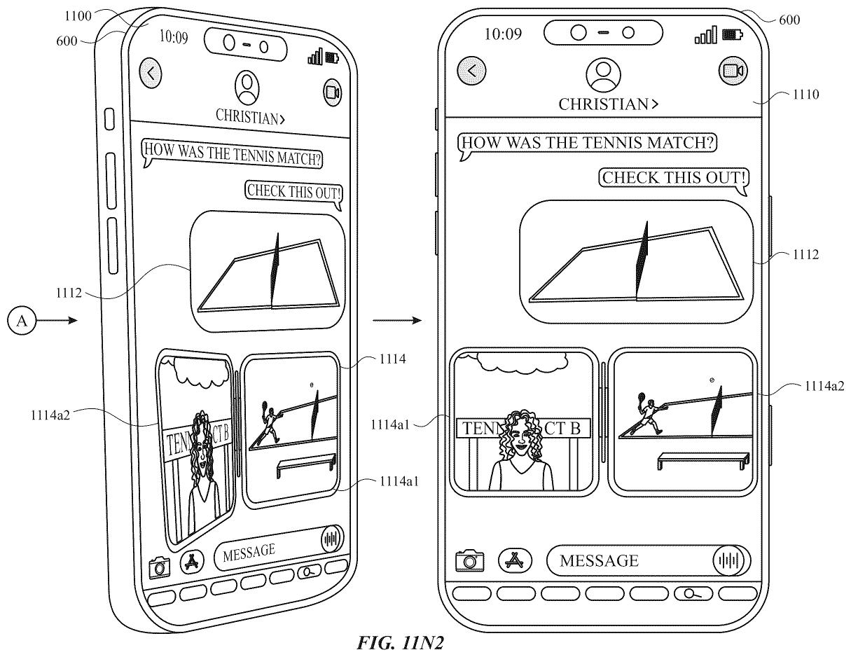

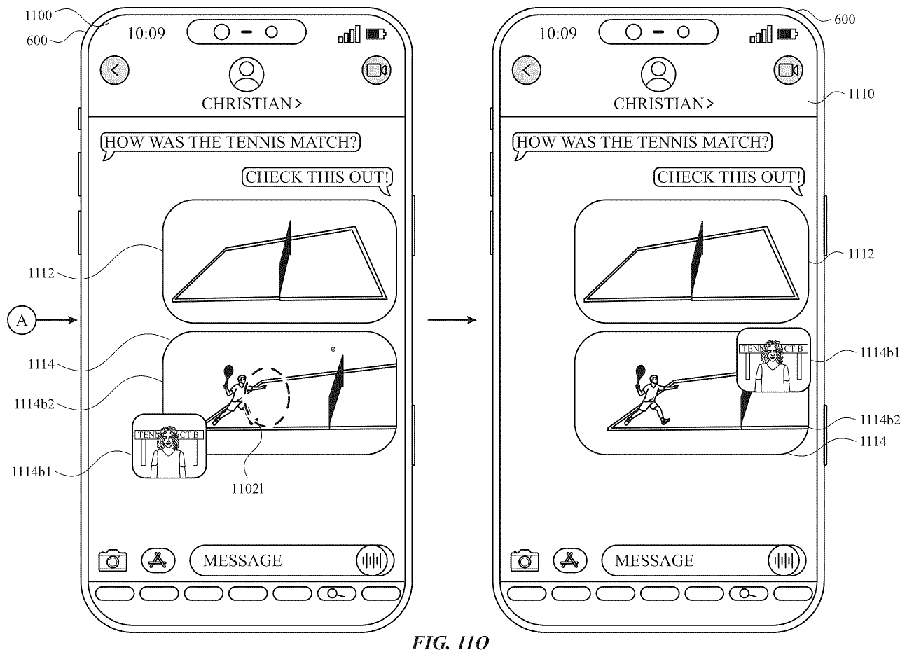

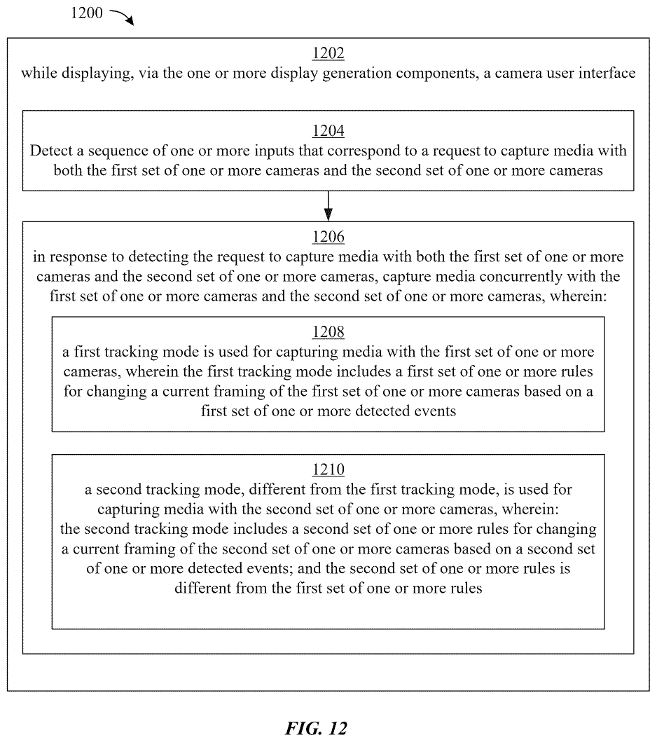

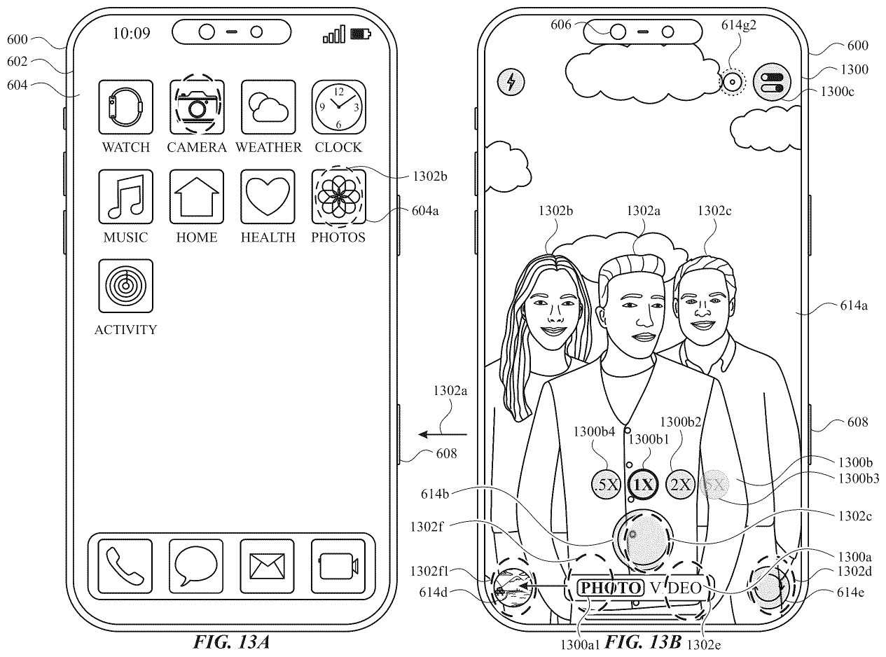

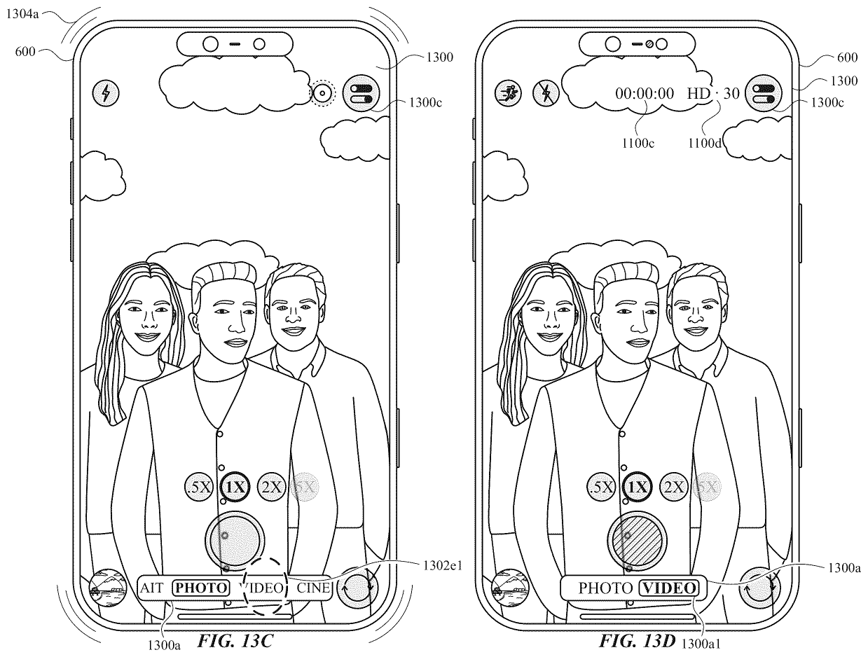

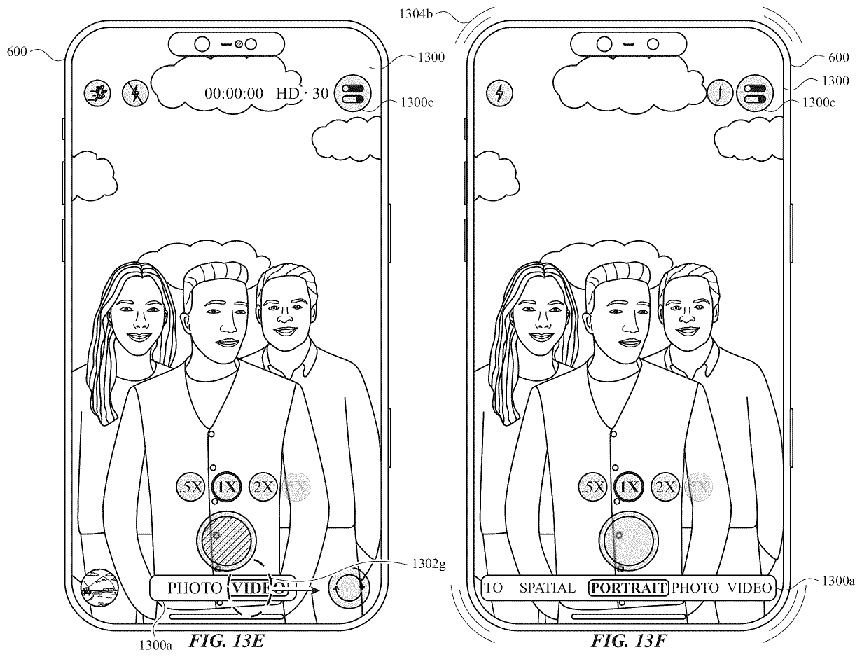

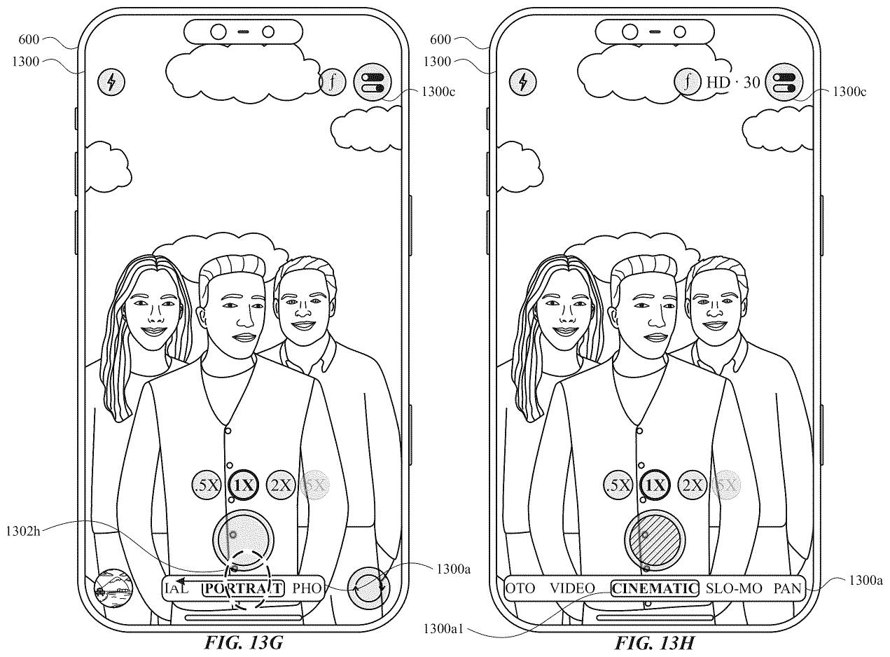

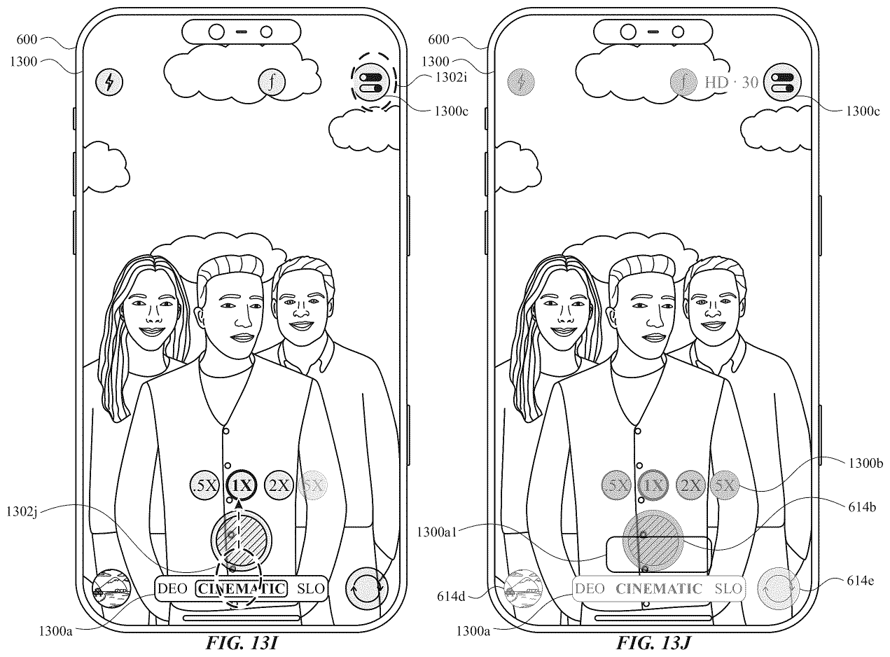

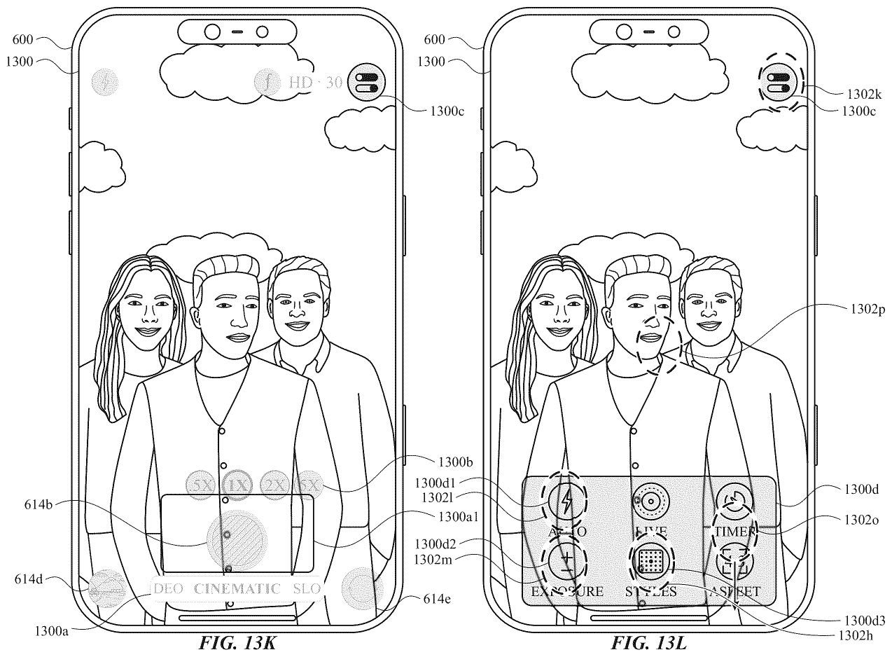

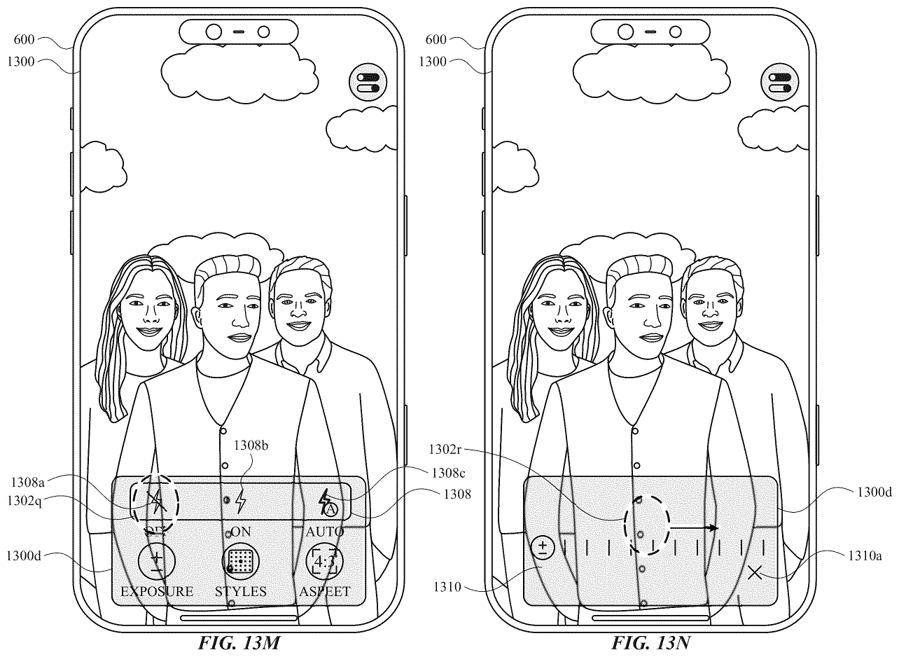

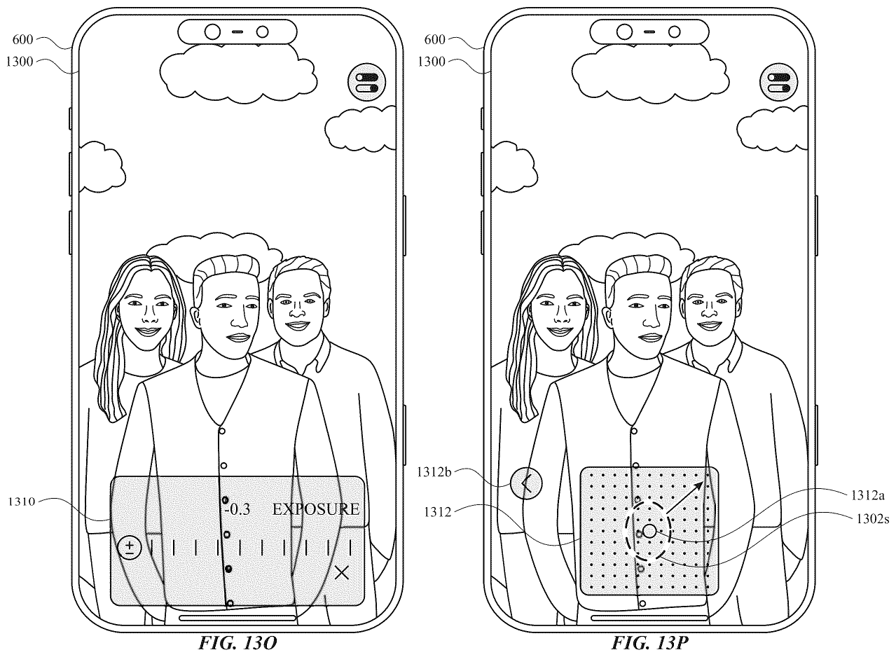

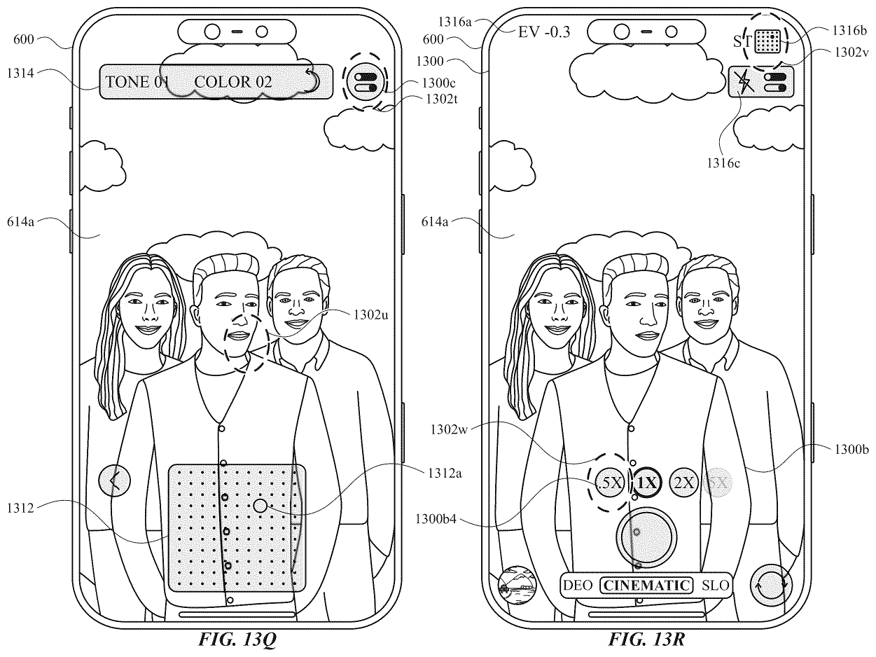

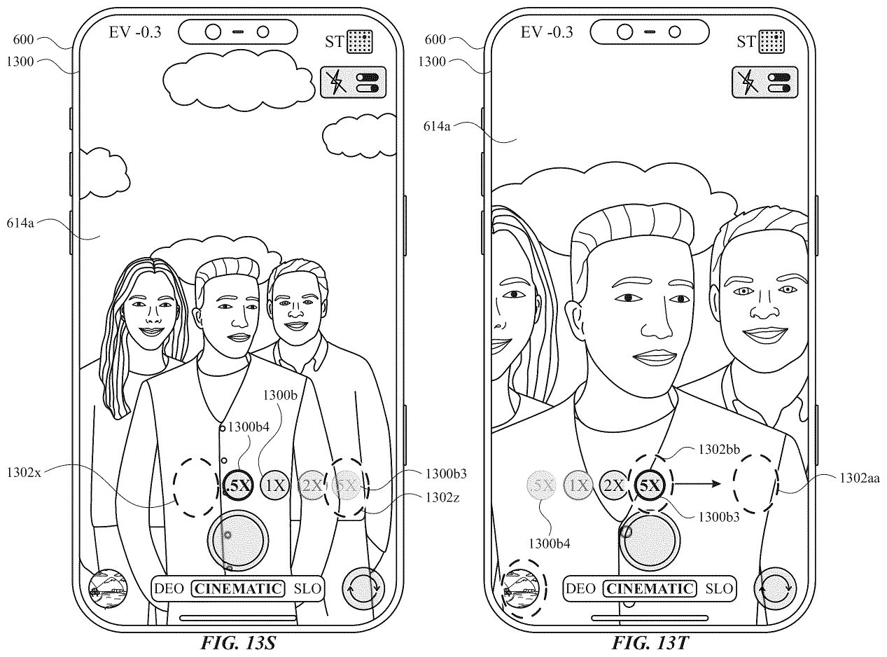

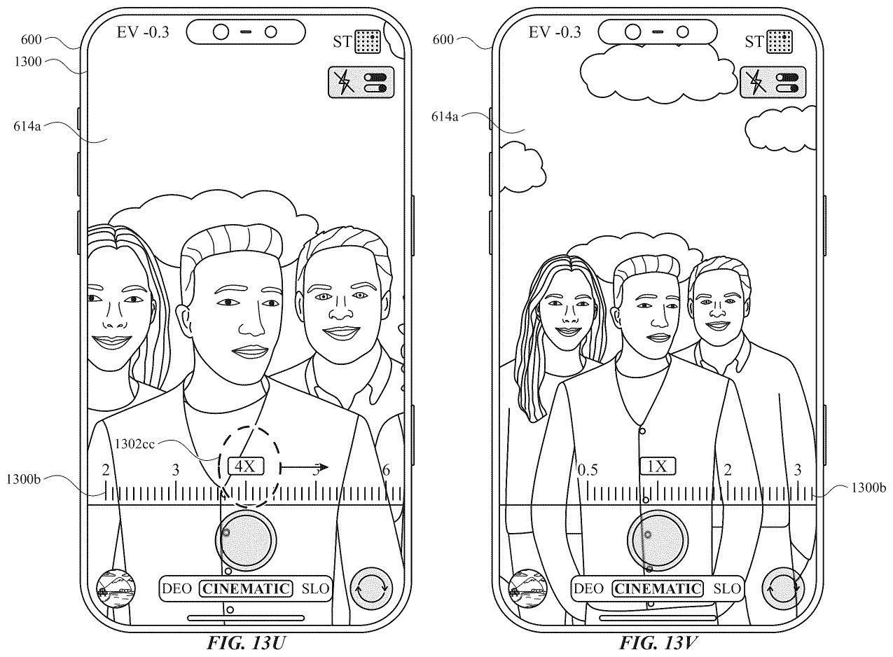

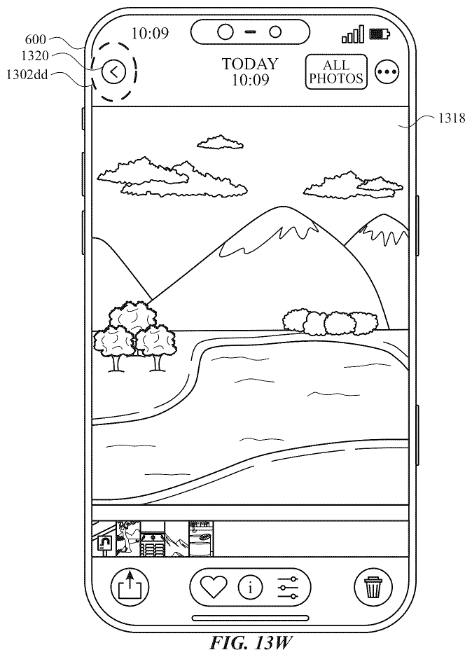

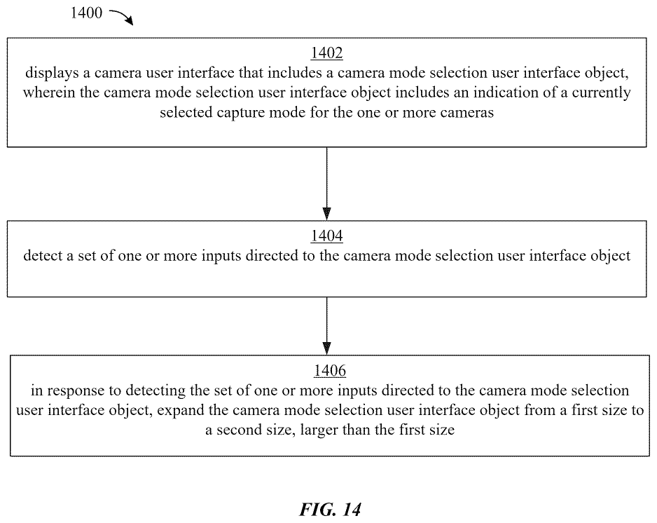

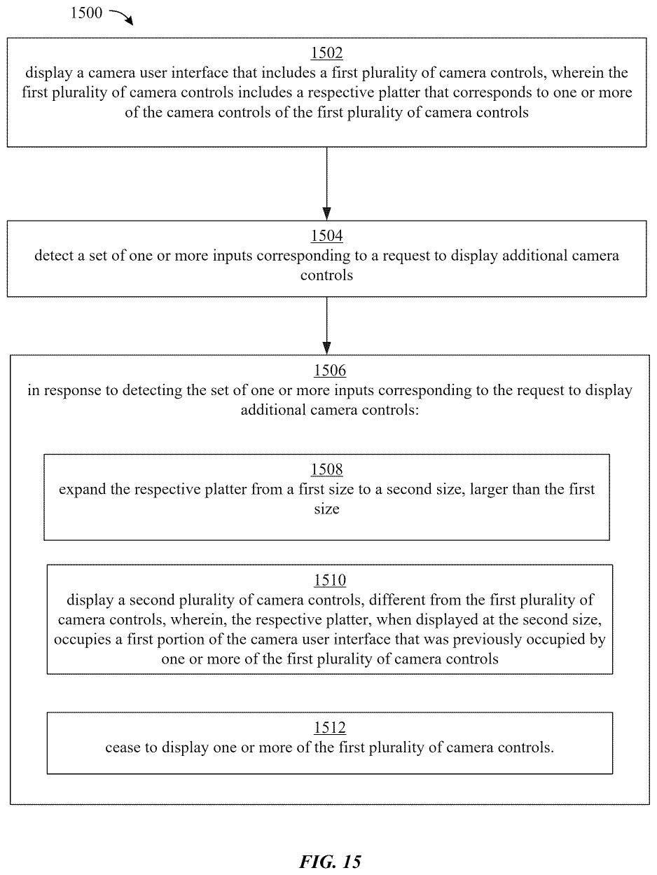

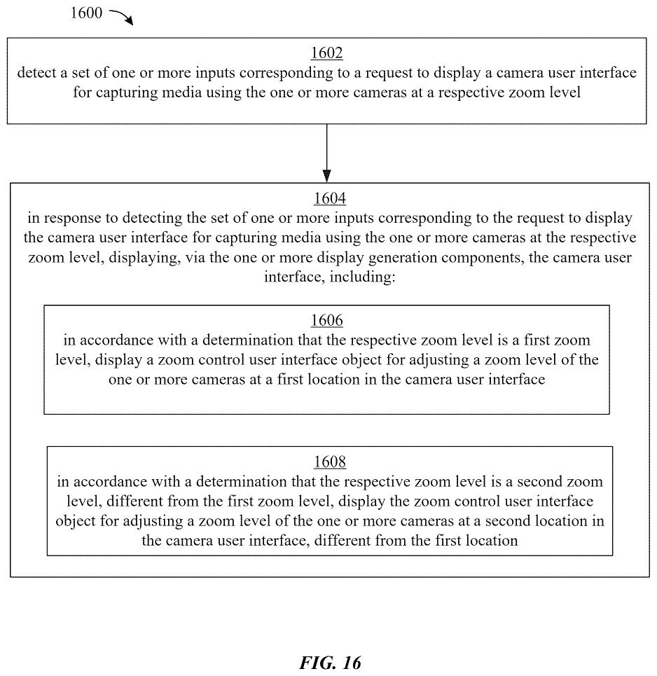

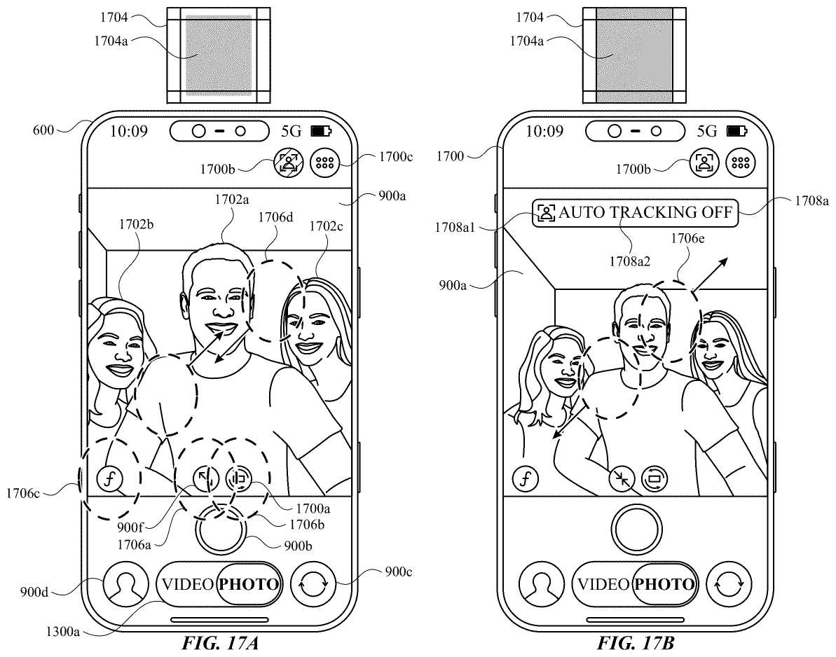

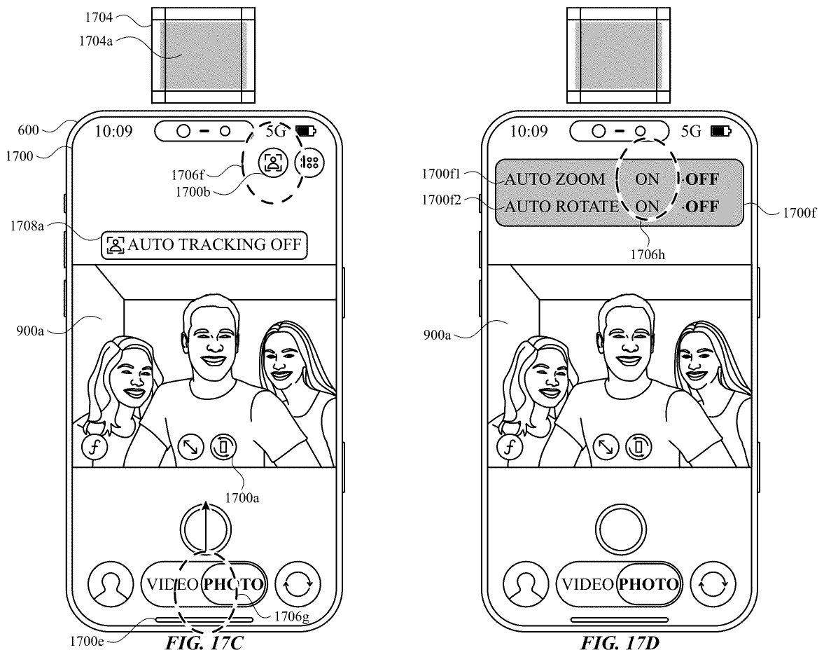

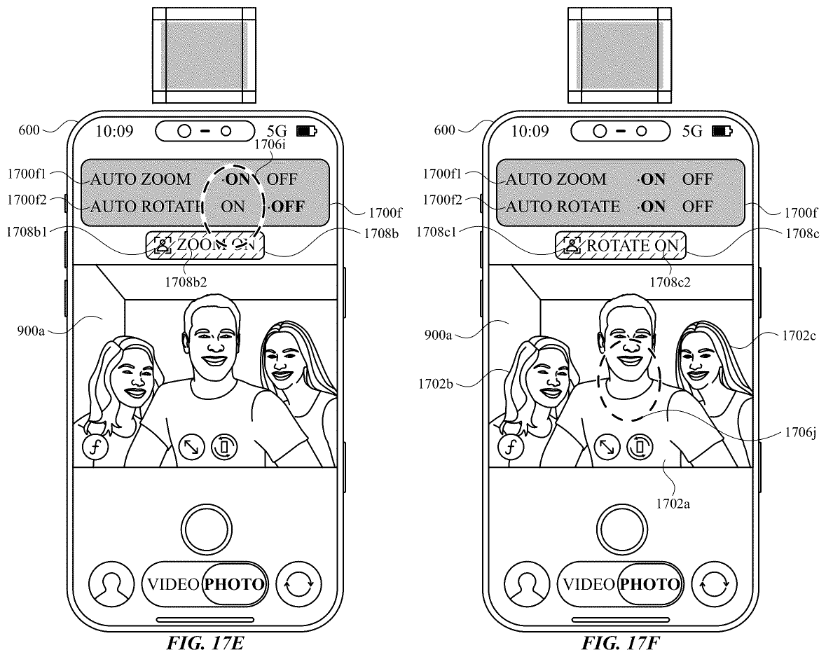

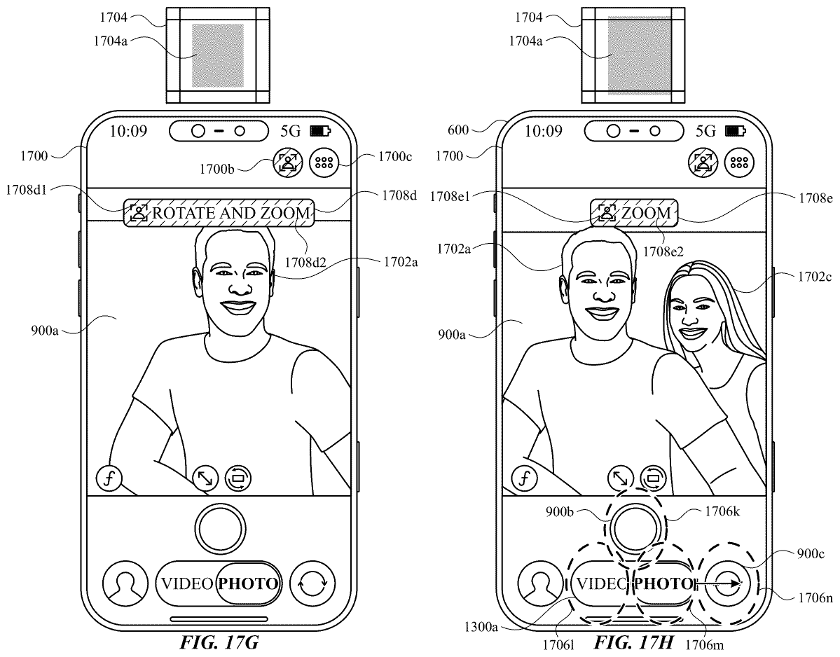

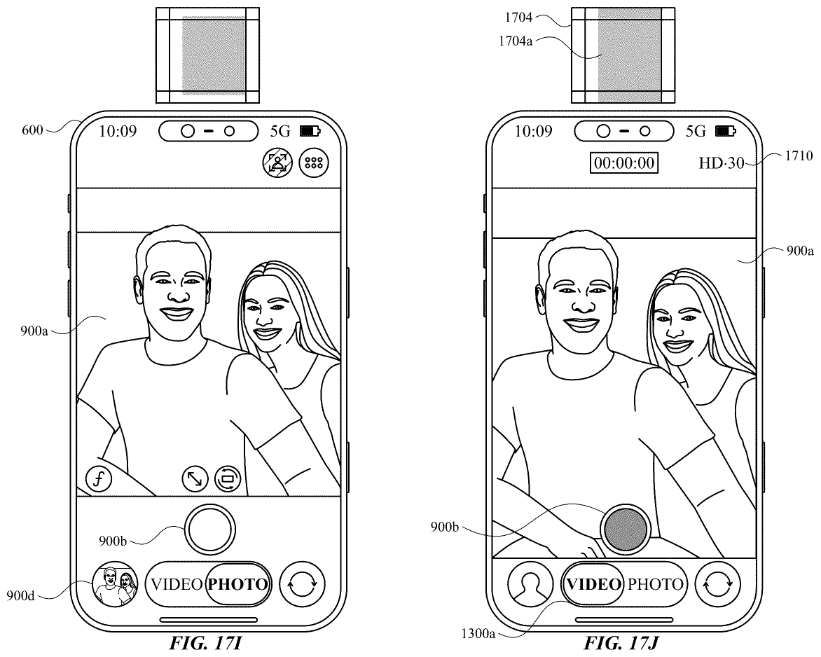

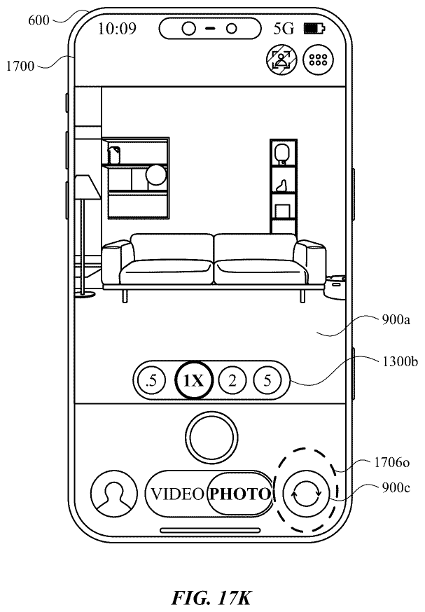

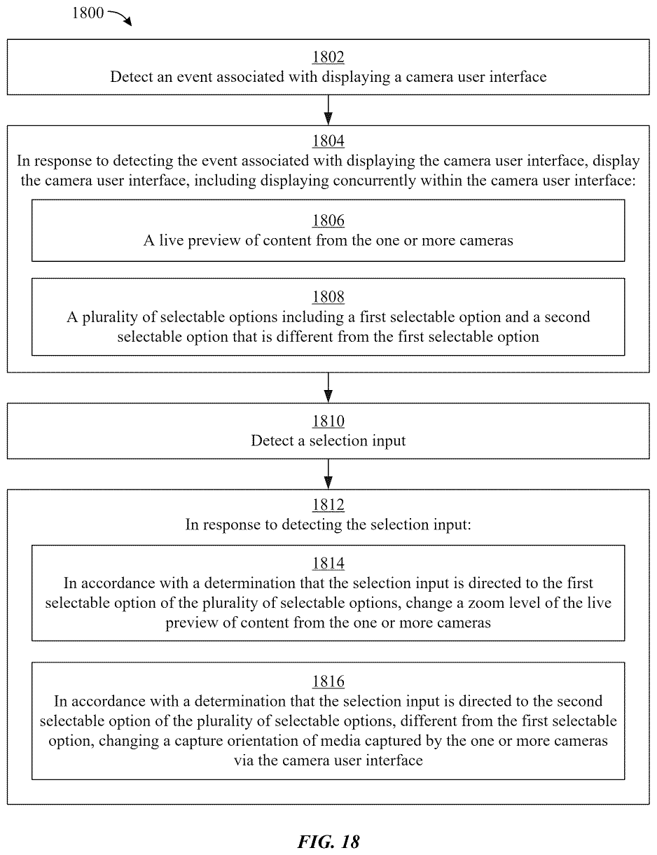

Below, FIGS. 1A-1B, 2, 3A-3G, 4A-4B, and 5A-5B provide a description of exemplary devices for performing the techniques for managing event notifications. FIGS. 6A-6S illustrate exemplary user interfaces for camera applications. FIG. 7 is a flow diagram illustrating methods for readily switching between camera modes and/or accessing additional mode controls in accordance with some embodiments. FIG. 8 is a flow diagram illustrating methods for maintaining certain camera settings when switching between camera modes in accordance with some embodiments. The user interfaces in FIGS. 6A-6S are used to illustrate the processes described below, including the processes in FIGS. 7 and 8. FIGS. 9A-9J illustrate exemplary user interfaces for a camera application that changes zoom levels of one or more cameras. FIG. 10 is a flow diagram illustrating methods for changing zoom levels of one or more cameras, based on a change in the number of subjects, in some embodiments. The user interfaces in FIGS. 9A-9J are used to illustrate the processes described below, including the processes in FIG. 10. FIGS. 11A-110 illustrate exemplary user interfaces for capturing media concurrently with two sets of cameras. FIG. 12 is a flow diagram illustrating methods for capturing media concurrently with two sets of cameras, in some embodiments. The user interfaces in FIGS. 11A-110 are used to illustrate the processes described below, including the processes in FIG. 12. FIGS. 13A-13W illustrate interfaces for a camera application that includes a mode switching control that expands, a camera control panel overlaid on camera user interface, and displaying a control for adjusting a camera zoom level that shifts positions, in some embodiments. FIG. 14 is a flow diagram illustrating methods for displaying a camera user interface with a mode switching control that expands, in some embodiments. FIG. 15 is a flow diagram illustrating methods for displaying a camera control panel overlaid on camera user interface, in some embodiments. FIG. 16 is a flow diagram illustrating methods for displaying a control for adjusting a camera zoom level that shifts positions, in some embodiments. The user interfaces in FIGS. 13A-13W are used to illustrate the processes described below, including the processes in FIGS. 14, 15, and 16. FIGS. 17A-17K illustrate interfaces for displaying a camera user interface that concurrently includes one or more controls for changing a zoom level and one or more controls for changing a capture orientation, in some embodiments. FIG. 18 is a flow diagram illustrating methods for displaying a camera user interface that concurrently includes one or more controls for changing a zoom level and one or more controls for changing a capture orientation, in some embodiments. The user interfaces in FIGS. 17A-17K are used to illustrate the process described below, including the process in FIG. 18.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

As used herein, the phrase “one or more of A and/or B” is construed to include all combinations of A and B, including, but not limited to: A individually without B; B individually without A; as well as a combination of A and B. The phrase “one or more of A, B, and/or C” is construed to include all combinations of A, B, and C, including, but not limited to: A individually without B and C; B individually without A and C; C individually without A and B; as well as any combinations of A, B, and/or C (e.g., A and B without C; A and C without B; B and C without A; and/or A, B, and C). Additionally, as used herein, the phrase “selected from the group consisting of A, B, C, and a combination thereof” and the phrase “at least one of A, B, and C” shall be construed to have the same meaning as the phrase “one or more of A, B, and/or C” as defined above. As used herein, the phrase “at least one of A, B, or C” and “one or more of A, B, or C” shall be construed to have the same meaning as the phrase “one or more of A, B, and/or C” as defined above. As used herein, the phrase “a combination including all of A, B, and C” is construed to include a combination of all the elements listed (e.g., a combination of A, B, and C).

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage media), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

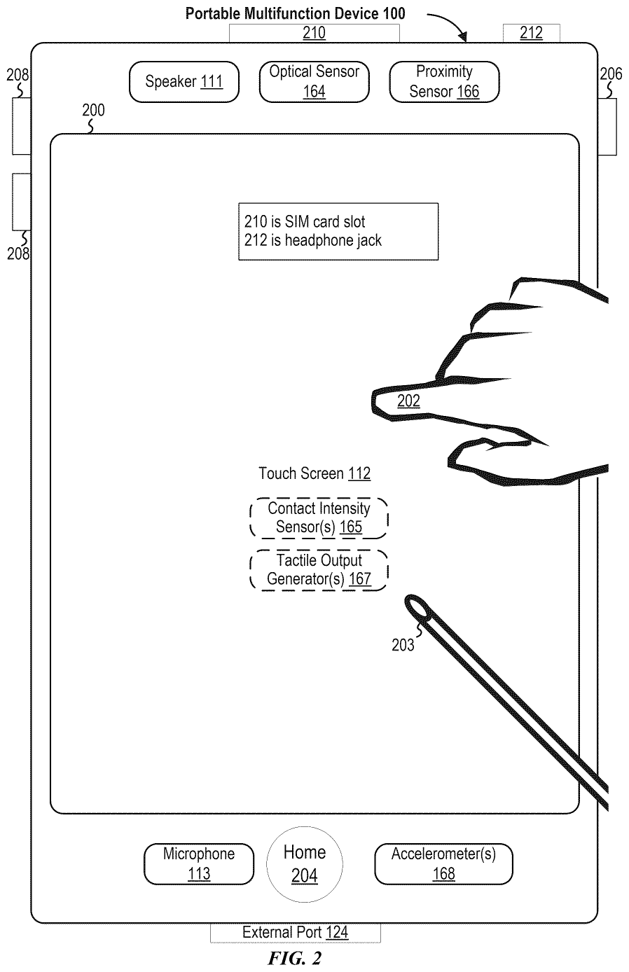

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “O” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

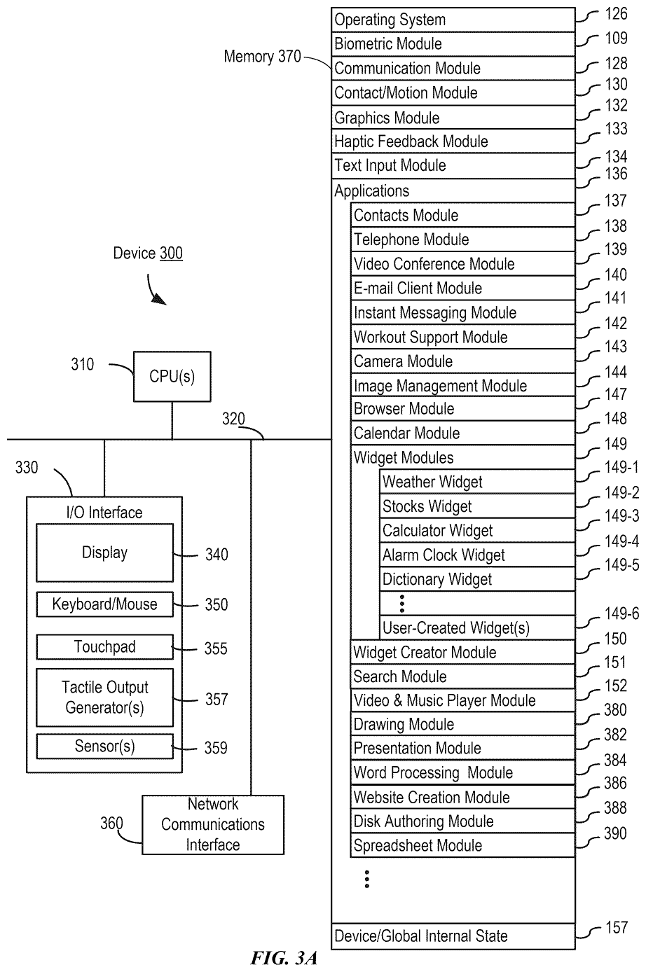

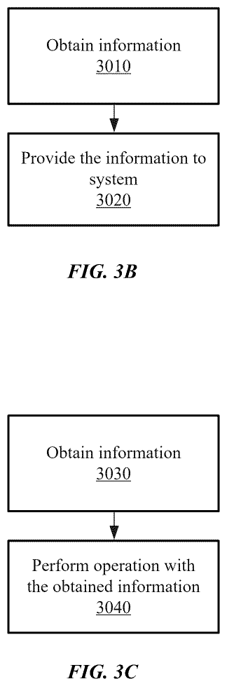

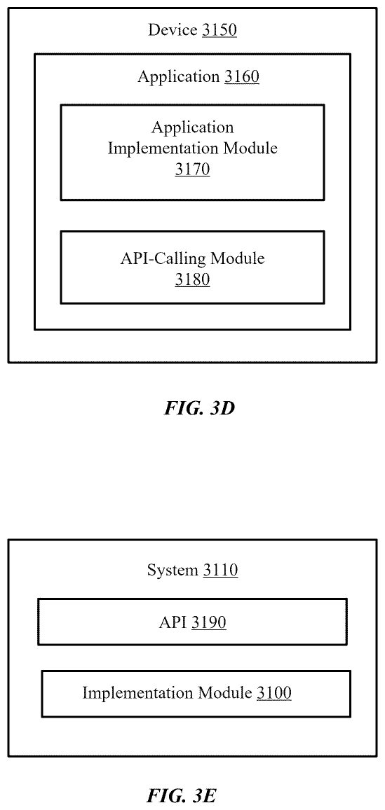

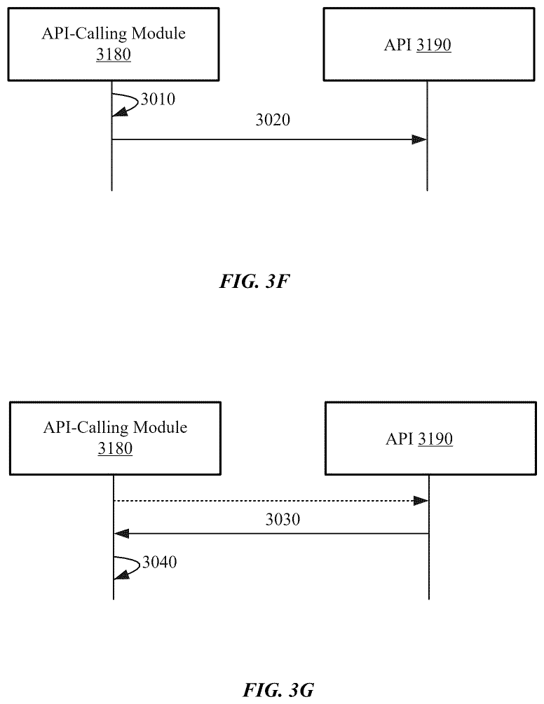

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE®, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7), 800 (FIG. 8), 1000 (FIG. 10), 1200 (FIG. 12), 1400 (FIG. 14), 1500 (FIG. 15), 1600 (FIG. 16), and/or 1800 (FIG. 18) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

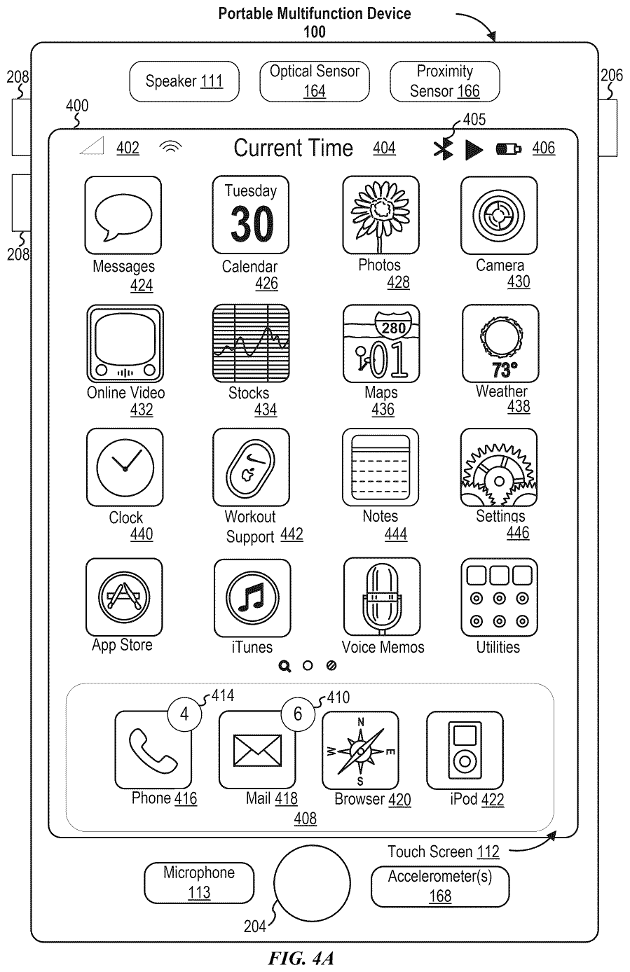

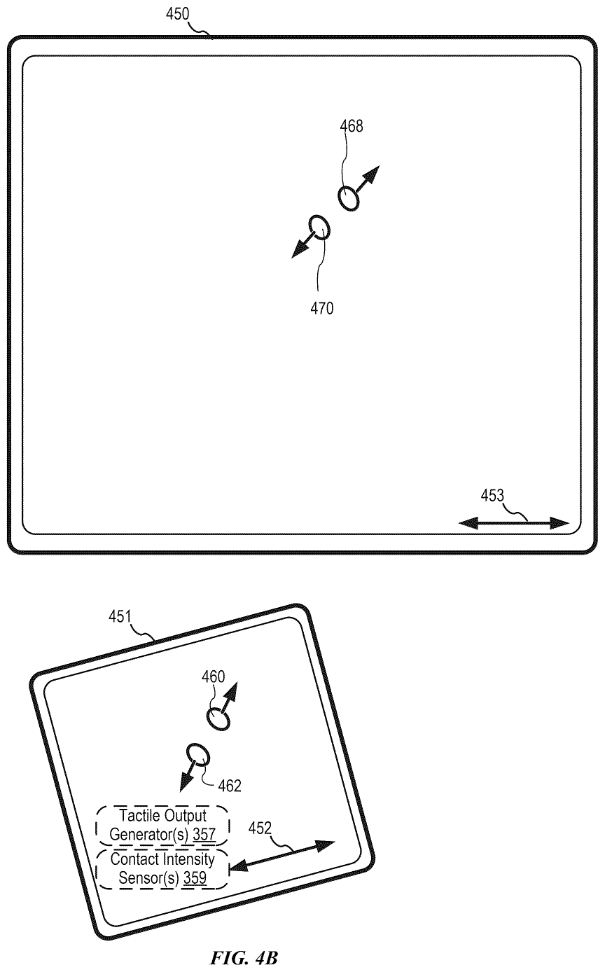

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contact 460 and contact 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

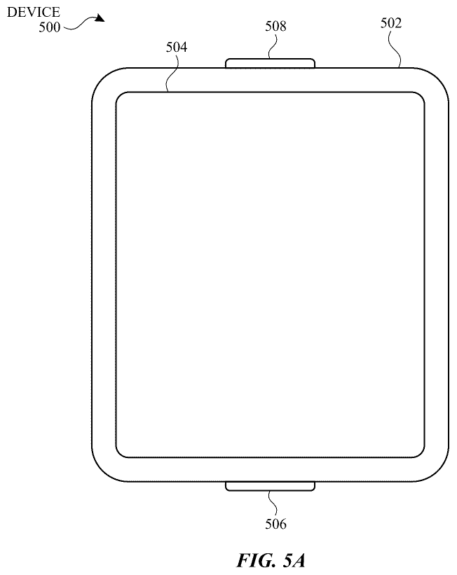

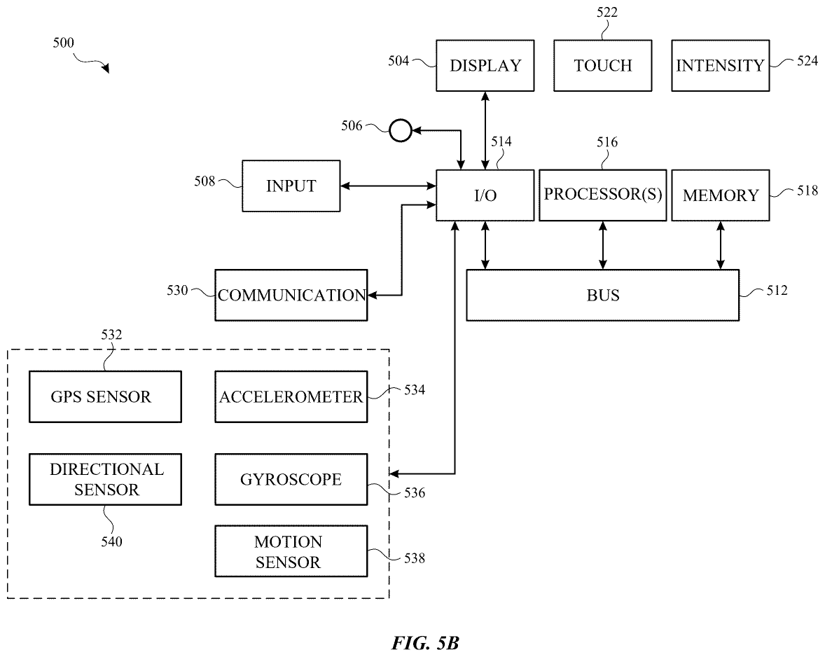

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 800, 1000, 1200, 1400, 1500, 1600, and 1800 (FIGS. 7, 8, 10, 12, 14, 15, 16, and 18). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes, such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseudo-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6S illustrate exemplary user interfaces for a camera application that provide users with options for readily switching between camera modes and/or accessing additional mode controls and exemplary user interfaces that maintain certain camera settings when switching between camera modes, in accordance with some embodiments. The user interfaces in these figures are used to illustrate the processes described below, including the processes in FIGS. 7 and 8.

FIG. 6A illustrates a front view of device 600 displaying home screen 604 on display 602 (e.g., a touch-sensitive display). FIG. 6A1 illustrates a back view of device 600. Device 600 includes a set of cameras, including front facing camera 606 (FIG. 6A) and rear facing cameras 606A, 606B, and 606C (FIG. 6A1). In some embodiments, the set of cameras include different numbers of cameras, different arrangements of cameras, and/or different types of cameras. For example, the different types of cameras optionally include one or more wide-angle lenses, one or more telephoto lenses, and/or one or more macro lenses. For example, the different types of cameras optionally vary in geometry (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), resolution (e.g., 8 MP, 12 MP, 24 MP, 48 MP, and/or 72 MP), pixel size (e.g., 100 nm, 0.5 μm, 1.0 μm, 2.44 μm, 5 μm), and/or presence of other hardware features (e.g., dual or quad pixels, dual pixel autofocus capabilities, and/or optical image stabilization capabilities). Device 600 further includes a plurality of buttons, including camera button 608 that can be used to access a camera application and/or perform one or more camera-related operations. In FIGS. 6A-6S, device 600 is a smartphone (e.g., a portable computer system with phone calling capabilities) that includes a plurality of cameras that can be used to capture visual media, including photos and videos. In some embodiments, the cameras of device 600 have one or more different types of lenses (e.g., wide-angle, ultra wide-angle, telephoto, and/or macro lenses), different lens geometries (e.g., physical or equivalent focal lengths, such as 5 mm, 13 mm, 22 mm, 24 mm, 28 mm, 50 mm, 77 mm, 100 mm, and/or 300 mm, or f-stops of f/1.2, f/1.78, f/2.2, f/2.8, f/3.4, and/or f/8.4), different sensor resolutions (e.g., 8 MP, 12 MP, 24 MP, 48 MP, and/or 72 MP), different sensor pixel sizes (e.g., 100 nm, 0.5 μm, 1.0 μm, 2.44 μm, 5 μm), and/or other varying camera hardware features (e.g., dual or quad pixels, dual pixel autofocus capabilities, and/or optical image stabilization capabilities). In some embodiments, device 600 includes and/or is in communication with different numbers of cameras, different arrangements of cameras, and/or different types of cameras than illustrated in FIG. 6A. For example, computer system 600 is in communication with one or more external cameras (e.g., cameras housed separately from the housing that includes display 602). In some embodiments, device 600 is a tablet computer, a laptop computer, a head-mounted device, or other computer system with one or more cameras and one or more displays. In some embodiments, device 600 includes one or more features of device 100, 300, and/or 500.

At FIG. 6A, home screen 604 includes a plurality of affordances (e.g., selectable user interface objects) that can be used to access various applications or functions of device 600, such as camera application affordance 604a that can be selected to launch a camera application. In some embodiments, home screen 604 is displayed when an application user interface is closed (e.g., when a currently active application is closed or inactivated). Home screen 604 also includes a plurality of status icons/indicators located along an upper edge of display 602 (e.g., in a status bar or status region), including time indicator 604b that indicates a current time of day, connection indicator 604c that indicates wireless connection status (e.g., cellular or WiFi connection status), and battery indicator 604d that indicates remaining battery power graphically and/or textually. In some embodiments, one or more of the status icons/indicators are managed and/or generated by an operating system of device 600. In some embodiments, one or more of the status icons/indicators continue to be displayed when an application is launched and an application user interface is displayed. At FIG. 6A, device 600 detects input 610 on camera button 608 and detects input 612a corresponding to camera application affordance 604a. In some embodiments, camera button 608 is a mechanical button that can be pressed/depressed. In some embodiments, camera button 608 is a touch-sensitive and/or intensity-sensitive button that can detect contact (e.g., finger contact) and/or detect the intensity of contact pressing on camera button 608. In some embodiments, input 612a and/or one or more of inputs 612b-612dd, discussed below, is a touch gesture (e.g., a tap, a swipe, or touch-and-hold), an air gesture (e.g., an air tap or air pinch), or a selection input (e.g., via a hardware input mechanism such as a button) that is detected while a respective user interface element (e.g., camera application affordance 604a) is selected and/or is in focus.

At FIG. 6B, in response to detecting input 610 on camera button 608 and/or input 612a corresponding to camera application affordance 604a, device 600 displays camera user interface 614. Camera user interface 614 includes various selectable user interface objects and indicators for configuring media capture functions and features, capturing media, and reviewing and/or editing captured media. Camera user interface 614 includes camera preview 614a, which includes a representation of a field-of-view of the environment captured by one or more of the cameras of computer system 600 that is framed (e.g., cropped) as it would currently be framed in media captured via camera user interface 614 (e.g., camera preview 614a is a live or near-live viewfinder). At FIG. 6B, camera preview 614a is a representation of the environment (e.g., a mountain landscape with subject 614al in the foreground) as captured by one or more of the rear facing cameras (e.g., rear facing cameras 606A, 606B, and/or 606C). Shutter affordance 614b is a software button that can be selected to initiate the capture of media in a currently selected capture mode using one or more current settings. Zoom affordance 614c is a control for changing the capture magnification and/or switching between cameras/lenses with different magnification; at FIG. 6B, zoom affordance 614c indicates that the current zoom level is 1× (e.g., the 1× indicator is enlarged relative to the 0.5× and 2× indicators where 1× indicates a respective zoom level, 0.5× indicates a zoom level that is ½ of the respective zoom level, and 2× indicates a zoom level that is twice the respective zoom level). Captured media affordance 614d is a selectable thumbnail icon that previews captured media and can be selected to view and/or edit captured media (e.g., in a media viewing or media library user interface). Camera selection affordance 614e is a software button for switching between capture using one or more rear cameras (e.g., environment-facing cameras, such as rear facing cameras 606A, 606B, and/or 606C) and using a front camera (e.g., user-facing camera, such as camera 606). Depth affordance 614f is a control for enabling and/or modifying a simulated (e.g., synthetic) depth-of-field effect that can be applied to captured media to create an appearance of depth (e.g., by blurring visual elements that are at different depths-of-field in the environment via a digital bokeh effect). Media format control affordance 614g includes indications of one or more settings/values relating to the format of captured media, such as file format and/or image resolution, and can be selected to modify one or more of those settings/values. At FIG. 6B, media format control affordance 614g includes unified format indicator 614g1 that indicates, in a single composite indicator, that the camera application is currently configured to store captured images in a RAW file format (a camera file format with minimal data/image processing and compression) and to capture those images at a 24 megapixel resolution. Media format control affordance 614g also includes “live” effect indicator 614g2 that indicates that the camera application is currently configured to capture single frame photos and not configured to capture photo media with a limited duration (e.g., 1, 3, and/or 5 seconds), for example, including content from before and/or after a capture input is detected that can be displayed in sequence (e.g., in response to a user input such as a selection input or a movement input) for a “live” effect. Capture settings control affordance 614h includes indications of one or more settings for modifying media capture, such as settings for flash and/or low-light capture (e.g., a mode in which multiple images are captured and composited to improve image exposure/brightness in low light environments), and can be selected to modify one or more of those settings/values. At FIG. 6B, capture setting control affordance 614h includes flash indicator 614h1 that is bolded to indicate that flash is currently set to an “on” mode (e.g., forced flash mode) and also includes low-light indicator 614h2 that indicates that low-light capture is currently disabled. Mode option affordance 614i can be used to quickly (e.g., via a single input) switch between a photo capture mode and a video capture mode. At FIG. 6B, the camera application is currently configured to capture photo media, as indicated by the bolding in mode option affordance 614i. In some embodiments, mode option affordance 614i operates as a toggle switch to toggle between different modes. In some embodiments, mode option affordance 614i includes more than two modes and a given mode can be selected by providing an input directed at a respective portion of mode option affordance 614i that corresponds to a given mode. Mode switcher option affordance 614j can be selected to display additional mode options and/or settings, as discussed in more detail, below.

In some embodiments, one or more of the user interface objects in camera user interface 614 are displayed with a simulated glass appearance, such that the object(s) appear to be made of, or include, a simulated glass material that is translucent or transparent. In such embodiments, the appearance of the object(s) changes as content below the object(s) changes. For example, zoom affordance 614c, which is overlaid on camera preview 614a, can have a simulated glass appearance that would result in the appearance of zoom affordance 614c changing as the representation of the environment under zoom affordance 614c changes (e.g., due to movement of device 600 or movement of elements within the environment, such as movement of subject 614a1). In some embodiments, one or more of the user interface objects in camera user interface 614 are translucent in a manner similar to that discussed with reference to certain user interface objects (e.g., shutter affordance 900b) of FIG. 9A.

At FIG. 6B, device 600 detects a number of inputs. In some embodiments, when device 600 is depicted detecting a plurality of inputs, as in FIG. 6B for example, the inputs are detected at different times; in some embodiments, two or more of the inputs are detected at the same time. Device 600 detects input 612b corresponding to mode switcher option affordance 614j; the results of which are discussed in detail with reference to FIGS. 6C and 6D. Device 600 detects input 612c corresponding to depth affordance 614f, the results of which are discussed in detail with reference to FIG. 6M. Device 600 detects input 612d corresponding to media format control affordance 614g; the results of which are discussed in detail with reference to FIG. 6O. Device 600 detects input 612e corresponding to capture settings control affordance 614h; the results of which are discussed in detail with reference to FIG. 6Q. Device 600 detects input 612f corresponding to camera selection affordance 614e; the results of which are discussed in detail with reference to FIG. 6R. Device 600 also detects input 612g corresponding to captured media affordance 614d; in response to detecting input 612g, device 600 displays a user interface for viewing and/or editing captured media (e.g., a media viewing or media library user interface). Device 600 also detects input 612h corresponding to shutter affordance 614b; in response to detecting input 612h, device 600 captures media according to the currently set mode (e.g., a photo mode) and one or more currently selected settings and formats (e.g., capturing using flash at 24 megapixels and storing the captured photo in a RAW file format). Once device 600 captures a photo in response to detecting input 612h, device 600 updates captured media affordance 614d to show a thumbnail representation of the newly captured photo. Device 600 also detects input 612i corresponding to zoom affordance 614c; in response to detecting input 612i, device 600 changes a current zoom level and/or displays a zoom level selection wheel affordance (e.g., similar to the result discussed with reference to FIG. 6K). Device 600 also detects input 612j corresponding to mode option affordance 614i; in response to detecting input 612j, device 600 switches from the current photo capture mode to video capture mode, similar to the transition discussed with reference to FIGS. 6M and 6N.

At FIG. 6C, in response to detecting input 612b (e.g., in FIG. 6B) corresponding to mode switcher option affordance 614j, device 600 initiates a process to display additional mode options and/or settings. The process includes displaying an animation of mode switcher option affordance 614j expanding to merge with mode option affordance 614i and an animation of one or more other user interface objects shifting position to accommodate additional controls. In some embodiments, the animation further includes ceasing to display one or more user interface objects and/or showing one or more other user interface objects merging with one or more user interface objects, such as depth affordance 614f ceasing to be displayed or merging with mode option affordance 614i. FIG. 6C illustrates that process in an intermediate state, with mode switcher option affordance 614j and mode option affordance 614i merged to form intermediate mode switcher options platter 616. The intermediate state also shows shutter affordance 614b, zoom affordance 614c, captured media affordance 614d, and camera selection affordance 614e shifting upwards from the positions shown in FIG. 6B.

At FIG. 6D, the process to display additional mode options and/or settings, initiated by device 600 detecting input 612b (e.g., in FIG. 6B), has been completed. Device 600 displays shutter affordance 614b, zoom affordance 614c, captured media affordance 614d, and camera selection affordance 614e shifted further up from the intermediate positions at which they were displayed in FIG. 6C. Device 600 displays mode switcher options platter 618. Mode switcher options platter 618 includes a plurality of affordances for selecting different modes and for modifying settings of a currently selected mode. Depth option affordance 618a is a control for enabling and/or modifying a simulated (e.g., synthetic) depth-of-field effect, in a manner similar to that described for depth affordance 614f. Spatial capture affordance 618b is a control for enabling a spatial capture mode (e.g., a mode for capturing media that can later be displayed with stereoscopic depth). Panoramic mode affordance 618c is a control for enabling a panoramic capture mode (e.g., as discussed with reference to FIG. 6L). Styles affordance 618d is a control for selecting from a plurality of sets of capture settings (e.g., styles) that modify values such as tone, warmth, contrast, and/or exposure. Aspect ratio affordance 618e is a control for modifying the aspect ratio (e.g., a 4:3 ratio, 1:1 ratio, or 16:9 ratio) of captured media. Exposure affordance 618f is a control for selecting an exposure value (e.g., as discussed with reference to FIGS. 6H-6J). Close affordance 618g is a control for closing mode switcher options platter 618. Mode option affordance 614i is now integrated into the bottom portion of mode switcher options platter 618.

At FIG. 6D, device 600 detects a number of inputs on affordances in mode switcher options platter 618. Device 600 detects input 612k corresponding to depth option affordance 618a; the results of which are discussed in detail with reference to FIG. 6E. Device 600 detects input 612l corresponding to spatial capture affordance 618b; in response to detecting input 612l, device 600 configures the camera application to capture spatial photos (e.g., because the photo mode is currently enabled). In some embodiments, if spatial capture affordance 618b is selected while the camera application is in a video mode, the camera application would be configured to capture spatial videos. Device 600 detects input 612m corresponding to depth option affordance 618a; the results of which are discussed in detail with reference to FIG. 6L. Device 600 detects input 612m corresponding to styles affordance 618d; in response to detecting input 612m, device 600 enables a photographic style, modifies a currently selected photographic style, and/or displays one or more additional controls for selecting from a set of available styles. Device 600 detects input 612n corresponding to aspect ratio affordance 618e; in response to detecting input 612n, device 600 modifies a current aspect ratio (e.g., by cycling through available aspect ratios), and/or displays one or more additional controls for selecting from a set of available aspect ratios. Device 600 detects input 6120, which is leftwards swipe input corresponding to mode switcher options platter 618; the results of which are discussed in detail with reference to FIG. 6F. Device 600 detects input 612p corresponding to close affordance 618g; in response to detecting input 612p, device 600 closes mode switcher options platter 618, returning camera user interface 614 to the state shown in FIG. 6B. In some embodiments, closing mode switcher options platter 618 includes displaying an animation of mode switcher option affordance 614j and mode option affordance 614i unmerging (e.g., displays an animation that is the reverse of the animation discussed with reference to FIG. 6C).

At FIG. 6E, in response to detecting input 612k (e.g., in FIG. 6D) corresponding to depth option affordance 618a and while remaining in a photo capture mode, device 600 configures the camera application to capture photo media with a simulated depth-of-field effect. Device 600 also updates camera preview 614a to provide a preview of the simulated depth-of-field effect that shows the background (e.g., the mountains and the clouds) with a blurring effect while subject 614al in the foreground remains in focus. Device 600 also updates mode switcher options platter 618 to include depth effect control affordance 618g that is a slider for selecting a magnitude of the simulated depth-of-field effect. At FIG. 6E, the simulated depth-of-field effect has a magnitude equivalent to an f-stop value of 2.8. One or more inputs (e.g., swipe inputs) can be directed to depth effect control affordance 618g to increase or decrease the magnitude of the simulated depth-of-field effect. In some embodiments, mode switcher options platter 618 can be returned to the state shown in FIG. 6D, while maintaining the simulated depth-of-field effect at the selected value, by providing an input directed to depth effect indicator 618h or by providing a swipe input on camera preview 614a (e.g., in a manner similar to that discussed with reference to FIGS. 6I and 6J).

At FIG. 6F, in response to leftward swipe input 6120 (e.g., in FIG. 6D) corresponding to mode switcher options platter 618 and while remaining in a photo capture mode, device 600 scrolls the controls displayed in mode switcher options platter 618 to display one or more additional controls. At FIG. 6F, mode switcher options platter 618 now includes timer affordance 618h and a portion of filter affordance 618i; depth option affordance 618a is no longer included in mode switcher options platter 618 while a portion of spatial capture affordance 618b remains. Timer affordance 618h, when selected via an input, enables a capture delay timer (e.g., a 3-second, 5-second, or 10-second timer), cycles through available timer options, and/or causes the display of additional timer options for selection. Filter affordance 618i, when selected via an input, enables a filter (e.g., vivid, sepia, or black-and-white), cycles through available filter options, and/or causes the display of additional filter options for selection. At FIG. 6F, device 600 detects input 612q corresponding to mode option affordance 614i.

At FIG. 6G, in response to detecting input 612q (e.g., in FIG. 6F) corresponding to mode option affordance 614i, device 600 configures the camera application of camera user interface 614 to capture video media (e.g., captured in response to detecting input at shutter affordance 614b), as indicated by the updated appearance of mode option affordance 614i and shutter affordance 614b. Device 600 maintains certain settings in the same state that they were in when the camera application was configured to capture photo media (e.g., the same state as shown in FIGS. 6B and 6F). For example, depth mode remains disabled and flash remains set to “on,” as indicated by flash indicator 614h1 in capture settings control affordance 614h. Device 600 also changes or updates certain other settings (e.g., settings that are not compatible with a video mode). For example, the low-light capture mode is not compatible with video media, and therefore control affordance 614h no longer includes low-light indicator 614h2. Similarly, media format control affordance 614g has been updated to indicate that video is being captured at a resolution of 4K (e.g., ~4000 horizontal pixels) and a frame rate of 60 frames per second. Device 600 also, in response to detecting input 612q, updates the options included in mode switcher options platter 618. As shown in FIG. 6G, certain options that were previously displayed (e.g., as seen in 6D) that are applicable to the video capture mode remain (e.g., spatial capture affordance 618b, aspect ratio affordance 618e, and exposure affordance 618f) while other options (e.g., panoramic mode affordance 618c and styles affordance 618d) are no longer included in mode switcher options platter 618. Additional options that are compatible with the video capture mode and that are not, in some embodiments, compatible with the photo capture mode are now included in mode switcher options platter 618. Slow-motion affordance 618i is a control for enabling a slow-motion capture mode in which videos are captured with a higher frame rate to allow for slow motion playback. Cinematic affordance 618j is a control for enabling a video capture mode with a simulated depth effect (e.g., that simulates capture using a shallow depth of field) that can track subjects within the field-of-view of one or more cameras being used for capture. Time-lapse affordance 618k is a control for enabling video at selected intervals.

At FIG. 6G, device 600 detects input 612r corresponding to exposure affordance 618f; the results of which are discussed with reference to FIG. 6H. Device 600 also detects input 612s (e.g., a leftward swipe) corresponding to zoom affordance 614c; the results of which are discussed with reference to FIG. 6K.

At FIG. 6H, in response to detecting input 612r (e.g., in FIG. 6G) corresponding to exposure affordance 618f, device 600, while remaining the video capture mode, updates mode switcher options platter 618 to include exposure control affordance 618l that is a slider for selecting an exposure value (e.g., a value that controls the overall brightness or darkness of captured media). At FIG. 6H, exposure control affordance 618l indicates the current exposure setting is 0.0 (e.g., no exposure correction). Device 600 detects input 612t (e.g., a leftward swipe) corresponding to exposure control affordance 618l.

At FIG. 6I, in response to detecting input 612t (e.g., in FIG. 6H) corresponding to exposure control affordance 618l, device 600 changes the exposure value with which media will be captured (e.g., captured in response to detecting input at shutter affordance 614b) from 0.0 to +1.0. Device 600 also updates camera preview 614a to reflect the new exposure value with the represented environment appearing brighter. Device also displays indication 614k that indicates that the exposure value has been adjusted away from a default value (e.g., from 0.0 to +1.0). In some embodiments, one or more indicators are displayed when selected settings (e.g., exposure, timer, or capture duration) are modified from their default value. In some embodiments, such as that of FIG. 6I, the indicator(s) are displayed in a status region or bar of the user interface. For example, indication 614k is displayed at the same region that time indicator 604b was displayed in FIG. 6B when home screen 604 was being displayed. In some embodiments, the indication is displayed at the location connection indicator 604c was displayed or the location battery indicator 604d was displayed. In some embodiments, the indicator(s) are textual and/or graphical indicator(s) (e.g., a graph or histogram). At FIG. 6I, device 600 detects input 612u (e.g., a downward swipe) corresponding to camera preview 614a.

At FIG. 6J, in response to detecting input 612u (e.g., in FIG. 6I) corresponding to camera preview 614a, device 600 ceases to display to exposure control affordance 618l and returns mode switcher options platter 618 to the state shown in FIG. 6G (e.g., the state prior to input 612r corresponding to exposure affordance 618f). Device 600 continues to be configured to capture video media with an exposure correction value of +1.0, even though exposure control affordance 618l is no longer displayed, and continues to display indication 614k showing that the exposure value has been adjusted to +1.0. At FIG. 6J, device 600 detects input 612v (e.g., an upwards swipe) corresponding to home affordance 614l (e.g., a control for existing a currently active application and returning to home screen 604). In response to detecting input 612v, device 600 ceases to display camera user interface 614 and redisplays home screen 604, which includes ceasing to display indication 614k in the location of the status bar and redisplaying time indicator 604b at the same location. In some embodiments, upon redisplaying camera user interface 614 (e.g., in response to an input directed at camera application affordance 604a), indication 614k is redisplayed and the camera application of camera user interface 614 continues to be configured to capture video media with a +1.0 exposure correction.

At FIG. 6K, in response to detecting input leftward swipe input 612s (e.g., in FIG. 6G) corresponding to zoom affordance 614c, device 600 displays zoom control dial 614m, which indicates that the zoom level has been adjusted to 1.5× (e.g., based on a magnitude of the movement of input 612s). In some embodiments, after adjusting the zoom to 1.5×, device 600 ceases to display zoom control dial 614m and redisplays zoom affordance 614c, with an indication that the zoom value is now 1.5×. In some embodiments, an indicator of the updated zoom value is not displayed at the upper edge of display 602 even though the zoom value has been adjusted away from a default value, as zoom affordance 614c is available to indicate the changed zoom value, even after zoom control dial 614m is no longer displayed.

At FIG. 6L, in response to detecting input 612l (e.g., in FIG. 6D) corresponding to panoramic mode affordance 618c, device 600 configures the camera application of camera user interface 614 to capture panoramic photos (e.g., captured in response to detecting input at shutter affordance 614b). Device 600 updates camera user interface 614 to include panoramic guidance indication 614n, which assists the user with properly handling and/or moving device 600 in order to capture a panoramic photo. Device 600 also ceases to display mode option affordance 614i, as the panoramic mode is incompatible with video media capture, and replaces mode option affordance 614i with panorama indication 6140 that indicates that device 600 is currently configured to panoramic mode. Panorama indication 6140 includes panoramic exit affordance 61401 that can be selected to exit the panoramic mode and return to photo mode. In some embodiments, device 600 displays camera user interface 614 in the state shown in FIG. 6D upon exiting the panoramic mode. In some embodiments, device 600 displays camera user interface 614 in the state shown in FIG. 6B upon exiting the panoramic mode (e.g., without mode switcher options platter 618).

At FIG. 6M, in response to detecting input 612c (e.g., in FIG. 6B) corresponding to depth affordance 614f and while remaining in a photo capture mode, device 600 configures the camera application to capture photo media with a simulated depth-of-field effect. Device 600 also updates camera preview 614a with a preview of the simulated depth-of-field effect that shows the background (e.g., the mountains and the clouds) with a blurring effect while subject 614al in the foreground remains in focus. Device 600 also updates the appearance of depth affordance 614f to indicate that the simulated depth-of-field effect is active. In some embodiments, a respective type of input (e.g., a touch-and-hold input) that corresponds to depth affordance 614f causes display of depth effect control affordance 618g (or a similar affordance for control the magnitude of a depth effect). At FIG. 6M, device 600 detects input 612w corresponding to depth affordance 614f and, in response, device 600 configures the camera application to capture photo media without the simulated depth-of-field effect (e.g., as shown in FIG. 6B). At FIG. 6M, device 600 detects input 612x corresponding to mode option affordance 614i.

At FIG. 6N, in response to detecting input 612x (e.g., in FIG. 6M) corresponding to mode option affordance 614i, device 600 configures the camera application of camera user interface 614 to capture video media (e.g., captured in response to detecting input at shutter affordance 614b), as indicated by the updated appearance of mode option affordance 614i and shutter affordance 614b. Device 600 continues to be configured to capture media (now video media) with the simulated depth-of-field effect, as shown by camera preview 614a and the appearance of depth affordance 614f. In some embodiments, a setting and/or mode that is compatible with both photo and video mode remains in a respective state when transitioning from photo mode to video mode or vice versa. In some embodiments, a setting and/or mode that is incompatible with both photo and video mode is disabled, modified, and/or replaced when transitioning from photo mode to video mode or vice versa, as described with reference to FIG. 6G.

At FIG. 6O, in response to detecting input 612d (e.g., in FIG. 6B) corresponding to media format control affordance 614g, device displays media format control platter 614p. In some embodiments, device 600 displays an animation of media format control affordance 614g expanding to become media format control platter 614p. Media format control platter 614p includes indicators and affordances relating to various media format options and settings. In top row 614p1, media format control platter 614p includes indicators and affordances for file format. Because device 600 is currently configured to a photo capture mode, the file format options (e.g., RAW, HEIC, and JPEG) are photo file formats. At FIG. 6O, device 600 is currently configured to store captured media using the RAW format, as indicated by the appearance of RAW affordance 614p1a. In middle row 614p2, media format control platter 614p includes indicators and affordances for resolution. Because device 600 is currently configured to a photo capture mode, the resolution options (e.g., 12 megapixel, 24 megapixel, and 24 megapixel) are photo resolutions. At FIG. 6O, device 600 is currently configured to capture photo media at a 24 megapixel resolution, as indicated by the appearance of 24 MP affordance 614p2a. In bottom row 614p3, media format control platter 614p includes indicators and affordances for configuring capture of photo media with a limited duration (e.g., 1, 3, and/or 5 seconds, as discussed with reference to “live” effect indicator 614g2). Device 600 is currently configured to not capture photo media with the “live” effect, as indicated by the appearance of “live” effect off affordance 614p3c. At FIG. 6O, “live” effect auto affordance 614p3a and “live” effect on affordance 614p3b are greyed out, indicating that the “auto” and “on” options are not available, because they are incompatible with the RAW format. At FIG. 6O, device 600 detects input 612y corresponding to JPEG affordance 614p1b. At FIG. 6O, device 600 detects input 612z corresponding to mode switcher option affordance 614j. In response to detecting input 612z, device 600 ceases to display media format control platter 614p and displays mode switcher options platter 618, as shown in FIG. 6D. In some embodiments, device 600 ceases to display and/or collapses a currently displayed/opened platter when another platter is invoked (e.g., via an input), doing so in order to conserve screen real estate.

At FIG. 6P, in response to detecting input 612y (e.g., in FIG. 6O) corresponding to JPEG affordance 614p1b, device 600 configures the camera application of camera user interface 614 to store captured photos in JPEG format and updates media format control platter 614p (e.g., updates the appearance of JPEG affordance 614p1b). Because the JPEG file format is not compatible with 48 megapixel resolution photos, 48 MP affordance 614p2b is greyed out. While the “live” effect option remains “off” at FIG. 6P, because the JPEG file format is compatible with the “live” effect, “live” effect auto affordance 614p3a and “live” effect on affordance 614p3b are no longer greyed out, indicating that they are available for selection.

At FIG. 6Q, in response to detecting input 612e (e.g., in FIG. 6B) corresponding to capture settings control affordance 614h, device displays capture settings control platter 614q. In some embodiments, device 600 displays an animation of capture settings control affordance 614h expanding to become capture settings control platter 614q. Capture settings control platter 614q includes indicators and affordances relating to various capture options and settings. In top row 614q1, capture settings control platter 614q includes indicators and affordances relating to flash settings and options, including “auto” affordance 614q1a, “on” affordance 614q1b (bolded to indicate that flash is current set to “on”), and “off” affordance 64q1c. In bottom row 614q2, capture settings control platter 614q includes indicators and affordances relating to low-light capture mode, including “auto” affordance 614q2a, “on” affordance 614q2b, and “off” affordance 64q2c (bolded to indicate that low-light capture mode is “off”). “Auto” affordance 614q2a and “on” affordance 614q2b are greyed out, indicating that the “auto” and “on” options for low-light capture mode are not available because they are incompatible with flash being “on” (e.g., being forced “on”). At FIG. 6Q, device 600 detects input 612aa corresponding to “auto” affordance 614q1a for the flash setting and, in response, configures the flash to an auto setting (e.g., a setting in which device 600 determines if a flash should be used during photo capture based on flash criteria (e.g., based on ambient light and/or one or more other photo settings, such as exposure)). Device 600 also, in response to detecting input 612aa, enables “auto” affordance 614q2a for low-light capture mode as the low-light capture mode, when set to “auto,” is compatible with the flash “auto” setting (e.g., while flash and low-light capture are mutually exclusive for a given photo capture event, device 600 can determine whether to use flash or low-light capture, depending on conditions at the time of capture). Device 600 does not, however, enable “on” affordance 614q2b for low light capture, as doing so would require flash to be disabled under all circumstances, which is inconsistent with the “auto” setting for flash. At FIG. 6Q, device 600 detects input 612bb corresponding to “off” affordance 614q1c for the flash setting and, in response, configures the flash to an off mode and enables both “auto” affordance 614q2a and “on” affordance 614q2b for low light capture, as both of those modes are compatible with the flash being “off.”

At FIG. 6R, in response to detecting input 612f (e.g., in FIG. 6B) corresponding to camera selection affordance 614e, device 600 configures the camera application of camera user interface 614 to capture media (e.g., captured in response to detecting input at shutter affordance 614b) using front facing camera 606, as indicated by the update to camera preview 614a, which now shows user 614a2. While configured to use front facing camera 606, device 600 also displays front camera zoom affordance 614r, which is used to adjust a zoom level. At FIG. 6R, device 600 detects input 612cc corresponding to front camera zoom affordance 614r. In response to detecting input 612cc, device 600 zooms in (e.g., causing user 614a2 to appear larger in camera preview 614a) and updates the appearance of front camera zoom affordance 614r to reflect the new zoom level. At FIG. 6R, device 600 detects input 612dd (e.g., a leftward swipe) corresponding to camera preview 614a.

At FIG. 6S, in response to detecting input 612dd (e.g., in FIG. 6R) corresponding to camera preview 614a, device 600 configures the camera application of camera user interface 614 to capture video media (e.g., captured in response to detecting input at shutter affordance 614b), as indicated by the updated appearances of mode option affordance 614i and shutter affordance 614b. Device 600 continues to show camera preview 614a using front camera 606, as front camera 606 is compatible with both photo and video media capture.

FIG. 7 is a flow diagram illustrating a method for readily switching between camera modes and/or accessing additional mode controls using a computer system in accordance with some embodiments. Method 700 is performed at a computer system (e.g., 100, 300, 500, and/or 600) that is in communication with one or more display generation components (e.g., 602) (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 700 are, optionally, combined, the orders of some operations are, optionally, changed, and some operations are, optionally, omitted.

As described below, method 700 provides an intuitive way for readily switching between camera modes and/or accessing additional mode controls. The method reduces the cognitive burden on a user for readily switching between camera modes and/or accessing additional mode controls, thereby creating a more efficient human-machine interface. For battery-operated computing devices, enabling a user to readily between camera modes and/or access additional mode controls faster and more efficiently conserves power and increases the time between battery charges.

The computer system (e.g., 600) displays (702), via the one or more display generation components (e.g., 602), a camera user interface (e.g., 614) that includes concurrently displaying: a live preview of content (e.g., 614b) from the one or more cameras (e.g., a preview based on a portion or all of a field-of-view(s) of one or more cameras); and a camera mode selection affordance (e.g., 614i in combination with 614j) (e.g., a user-selectable graphical element or a set of user-selectable graphical elements) that includes a plurality of options including concurrently displaying: a first set of one or more mode options (e.g., 614i) for switching between photo capture mode and video capture mode (in some embodiments, the first set of one or more mode operations operates as a toggle, such that input causes the mode to switch between photo capture mode and video capture mode and vice versa); a mode switcher option (e.g., 614j) for selecting additional modes for the camera user interface.

While displaying the camera user interface, the computer system detects (704), via the one or more input devices (e.g., 602 and/or 608), a selection input (e.g., 612f or 612j) (e.g., a touch input, an air gesture, and/or a button press) directed to the camera user interface.

In response to detecting the selection input (706) and in accordance with a determination that the selection input is directed to the mode switcher option (e.g., as shown in FIGS. 6B-6D), the computer system displays (708) a second set of mode options (e.g., 618a-618f) that correspond to different modes (e.g., modes other than photo mode and video capture mode, such as a panoramic mode or a time lapse mode). In some embodiments, displaying the second set of mode options includes remaining in a currently selected capture mode (e.g., the photo capture mode or video capture mode). In response to detecting the selection input and in accordance with a determination that the selection input is directed to the first set of one or more mode options (e.g., as shown in FIGS. 6F-6G or FIGS. 6M-6N), the computer system switches (710) the camera user interface between the photo mode and the video capture mode. Concurrently displaying a first set of one or more mode options for switching between photo capture mode and video capture mode and a mode switcher option provides the first set of options for switching between photo and video while also providing additional control options that are available upon request/input, without cluttering the UI with additional displayed controls when those controls are not required. Doing so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently. Doing so also provides improved visual feedback to the user that the additional second set of mode options are available for display.

In some embodiments, the camera user interface includes a capture affordance (e.g., 614b) (e.g., a selectable shutter button user interface object) that is concurrently displayed with the first set of one or more options and the mode switcher option. In such embodiments, in response to detecting the selection input, in accordance with a determination that the selection input is directed to the capture affordance, the computer system initiates capture of media with the one or more cameras in accordance with one or more selected camera modes (e.g., a mode indicated by 614i) (e.g., capturing a photo if the photo mode is selected and capturing a video if the video capture mode is selected). Concurrently displaying a capture affordance, the first set of one or more mode options for switching between photo capture mode and video capture mode, and the mode switcher option provides a control to capture media in a current mode, while also providing the first set of options for switching between photo and video and also providing additional control options that are available upon request/input, without cluttering the UI with additional displayed controls when those controls are not required.

In some embodiments, the camera user interface includes one or more action affordances (e.g., 614b, 614d, 614e, and/or 614f) (e.g., one or more affordances that, when selected, perform an action function, such as capturing media, changing a depth capture mode, switching a currently selected camera) that are concurrently displayed with the first set of one or more options and the mode switcher option. In such embodiments, in response to detecting the selection input, in accordance with a determination that the selection input is directed to the mode switcher option, shifting (e.g., shifting up) the one or more action affordances in the camera user interface (e.g., translating the displayed position of an action affordance from a first location to a different second location). Shifting one or more action affordances when the second set of mode options are displayed optimizes screen real estate by allowing the one or more action affordances to be displayed at a location at which the second set of mode options will be displayed (when invoked) while also continuing to display the one or more action affordances when the second set of mode options are displayed. Doing so also optimizes the display of the live preview of content by increasing and/or maximizing the size of the live preview of content, when the second set of mode options are not displayed. Optimizing the use of screen real estate and/or optimizing the display of the live preview enhances the operability of the system and makes the user-system interface more efficient (e.g., by optimizing the usage of display real estate) which, additionally, reduces power usage and improves battery life of the system by enabling the user to use the system more quickly and efficiently.

In some embodiments, the one or more action affordances include one or more of: an affordance (e.g., 614d) that, when selected based on an input detected by the one or more input devices, causes the computer system to display a camera roll (e.g., a user interface for displaying previously captured media); an affordance (e.g., 614b) that, when selected based on an input detected by the one or more input devices, causes the computer system to capture media with the one or more cameras (e.g., a shutter button); an affordance (e.g., 614e) that, when selected based on an input detected by the one or more input devices, causes the computer system to switch which camera is being used to capture media (e.g., switching between different cameras on a same side of a housing of the computer system and or switching between different cameras on different sides of a housing of the computer system); and an affordance (e.g., 614c) that, when selected based on an input detected by the one or more input devices, causes the computer system to change a zoom level that is used to capture media with the one or more cameras. In some embodiments, a plurality of zoom affordances, including a zoom affordance for changing to a first zoom value (e.g., 1× or 2×) and a zoom affordance for changing to a second zoom value (e.g., 3× or 5×).

In some embodiments, in response to detecting the selection input, in accordance with a determination that the selection input is directed to the mode switcher option, the computer system displays the second set of mode options (e.g., 618a-618f) (e.g., that correspond to different camera modes in a region of the camera user interface (e.g., the region occupied by 618 in FIG. 6D) that was previously occupied by the one or more action affordances (e.g., by at least one of the one or more action affordances). In some embodiments, at least one action affordance was displayed at a first location before shifting to a second location, different from the first location, and at least a portion of the second set of mode options is displayed at the first location. Displaying the second set of mode options that correspond to different camera modes in a region of the camera user interface that was previously occupied by the one or more action affordances optimizes the use of screen real estate, without cluttering the UI with additional displayed controls when those controls are not required.

In some embodiments, in response to detecting the selection input, in accordance with a determination that the selection input is directed to the mode switcher option (e.g., as shown in FIG. 6F-6G), the computer system maintains display of the first set of one or more mode options (e.g., 618b, 618d, and/or 618f) (in some embodiments, maintaining display at the same location, without shifting the first set of one or more mode options). Maintaining display of the first set of one or more mode options provides improved visual feedback that mode switching remains available, while the second set of mode options are displayed.

In some embodiments, maintaining display of the first set of one or more mode options includes displaying a second set of one or more mode options (e.g., options shown in 618 at FIG. 6G) that includes one or more mode options that are not included in the first set of one or more mode options. In some embodiments, when the photo mode is selected the mode options (e.g., for the photo mode) include one or more of: a portrait mode, spatial capture mode, panorama mode, aspect ratio control, exposure compensation control, and media capture style control without including one or more mode options that are specific to the video mode (e.g., time lapse capture option and/or a slow motion video capture option). In some embodiments, when the photo mode is selected the mode options (e.g., for the photo mode) include one or more of: a slow motion capture option, a time lapse capture option, a cinematic (e.g., portrait mode) video capture option, a spatial video capture option, an aspect ratio control, an exposure compensation control, and media capture style control without including one or more mode options that are specific to the photo mode (e.g., panorama capture option, and/or an exposure compensation option). In some embodiments, options that are similar between different modes are represented by a consistent user interface element (e.g., portrait mode and cinematic video mode are represented by the same user interface element and spatial photo capture and spatial video capture are represented by the same user interface element).

In some embodiments, in response to detecting the selection input, in accordance with a determination that the selection input is directed to the first set of one or more mode options, the computer system maintains display of the mode switcher option (e.g., 614i as seen in FIG. 6G). In some embodiments, maintaining display of one or more action affordances that were concurrently displayed with the first set of one or more options and the mode switcher option at the time the selection input was detected (in some embodiments, while display of the one or more action affordances are maintained, their position(s) are shifted). Maintaining display of the mode switcher option while switching the camera user interface between the photo mode and the video capture mode provides improved visual feedback that mode option remains available in both the photo and video capture modes.

In some embodiments, the second set of one or more mode options includes a mode option selected from the set consisting of: photographic styles (e.g., 618e) (e.g., an option for adjusting/selecting customizations as to how media is captured), filters (e.g., 618i) (e.g., an option for applying a visual filter to captured media), aspect ratio (618d), exposure (e.g., 618f), spatial capture (e.g., 618b) (e.g., an option for enabling capturing media for display with stereoscopic depth), timer (e.g., 618h), and panorama (e.g., 618c) (e.g., an option for enabling a panoramic photo capture mode). Including certain mode options in the second set of mode options provides users with access to those options when requested, without cluttering the UI with additional displayed options when those options are not required.

In some embodiments, the second set of one or more mode options includes one or more (e.g., one or a plurality of) mode options that are compatible with both photo capture and video capture (e.g., 618d, 618e, and/or 618a) (e.g., the mode option(s) is supplemental/additive to the photo capture mode and to the video capture mode and can operate with either mode). In some embodiments, the mode option that is compatible with both photo capture and video capture is a depth capture mode (e.g., a mode that captures media with depth information such that the media, when viewed, includes depth effects such as bokeh/blurring) or a spatial capture mode (e.g., an option for enabling capturing media for display with stereoscopic depth). In some embodiments, capturing media (e.g., photo or video media) in the depth capture mode includes adding a simulated depth effect in which at least a portion of the background is blurred and a portion of the foreground is not blurred to simulate taking a photo or video with a shallow depth of field wherein the portion of the foreground is in the plane of focus. In some embodiments, capturing media (e.g., photo or video media) in the spatial capture mode includes capturing one or more images for a right eye and one or more images for a left eye that when viewed concurrently create an illusion of a spatial representation of a field-of-view of the one or more cameras. Including mode options that are compatible with both the photo and video capture modes provides users with access to those options when requested, without cluttering the UI with additional displayed options when those options are not required.

In some embodiments, the camera user interface includes a camera switching affordance (e.g., 614c or 614e) that is concurrently displayed with the first set of one or more options and the mode switcher option. In response to detecting the selection input (e.g., 612f), in accordance with a determination that the selection input is directed to the camera switching affordance, the computer system switches which camera is being used to capture media for the camera user interface (e.g., switching between two cameras on different sides of a housing of the computer system or switching between two cameras on the same side of a housing of the computer system).

In some embodiments, the camera user interface includes a zoom affordance (614c) that is concurrently displayed with the first set of one or more options and the mode switcher option. In response to detecting the selection input, in accordance with a determination that the selection input is directed to the zoom affordance (e.g., 612i), the computer system changes a zoom level for capturing media with the one or more cameras. In some embodiments, the camera user interface includes a plurality of zoom affordances, for switching to a plurality of different zoom levels (e.g., 1×, 2×, and 3×). In some embodiments, changing a zoom level for capturing media with the one or more cameras includes changing the zoom level of the live preview of content of the one or more cameras. In some embodiments, changing the zoom level includes digitally changing the zoom level, optically changing the zoom level, or doing both. In some embodiments, optically changing the zoom level includes changing the focal length of a zoom lens (e.g., an optical zoom lens). In some embodiments, optically changing the zoom level includes switching from using a first camera (e.g., a camera with a prime lens) having a first focal length to a second camera having a second focal length, different than the first focal length.

In some embodiments, the computer system detects, via the one or more input devices, a gesture (e.g., a touch or air gesture, such as a swipe) that includes movement directed to the zoom affordance (e.g., 612s). In response to detecting the gesture, the computer system changes a zoom level for capturing media with the one or more cameras in a direction that is based on a direction of the movement (e.g., FIGS. 6G and 6K) (e.g., zooming out if the movement is in a first direction and zooming in if it is in a different second direction).

In some embodiments, the computer system detects, via the one or more input devices, a gesture (e.g., a touch or air gesture, such as a swipe) that includes movement directed to the zoom affordance (e.g., 612s). In response to detecting the gesture, the computer system changes a zoom level for capturing media with the one or more cameras by an amount that is based on a magnitude (e.g., FIGS. 6G and 6K) (e.g., speed and/or distance) of the movement.

In some embodiments, while displaying the second set of one or more mode options, the computer system detects, via the one or more input devices, an input (6120) (e.g., a movement input or a swipe input) directed to the second set of one or more options. In response to detecting the input directed to the second set of one or more options, the computer system navigates (e.g., scrolling) through the second set of one or more options (e.g., as shown in FIGS. 6D and 6F) (e.g., ceasing to display one or more of the second set of one or more options and displaying an additional option in the second set of one or more options that was not previously displayed). Including additional options in the second set of one or more mode options are that accessible via a navigation input provides users with access to those options when requested, without cluttering the UI with additional displayed options when those options are not required.

In some embodiments, while displaying the second set of one or more mode options, the computer system detects, via the one or more input devices, a second input (e.g., 612k-612n) directed to the second set of one or more options; and In some embodiments, the second input (e.g., a tap, an air gesture, or a button press while a respective option is selected/highlighted) is directed to an exposure control and causes additional exposure-related options to be displayed (e.g., as seen in FIG. 6H). In some embodiments, the second input (e.g., a tap, an air gesture, or a button press) is directed to panoramic mode control and causes the camera user interface and computer system to be configured to capture media in a panoramic mode (e.g., as seen in FIG. 6L). In response to detecting the second input directed to the second set of one or more options, the computer system performs an operation corresponding to a respective option (e.g., selected option) of the second set of one or more options. In some embodiments, the operation is an operation not available to be selected in the camera user interface prior to displaying the second set of one or more mode options.

In some embodiments, performing the operation corresponding to a respective option of the second set of one or more options includes: in accordance with a determination that the input is directed to a first option (e.g., 618a) (e.g., a filter option) in the second set of one or more options, performing a first operation (e.g., the operation shown in FIG. 6E) corresponding to the first option (e.g., displaying a set of selectable filters); and in accordance with a determination that the input is directed to a second option (e.g., 612m) (e.g., a spatial capture mode option) in the second set of one or more options, performing a second operation (e.g., the operation shown in FIG. 6L) (e.g., enabling a spatial capture mode) corresponding to the second option, wherein the second operation is different from the first operation.

In some embodiments, performing the operation corresponding to a respective option of the second set of one or more options includes displaying a set of one or more adjustment options (e.g., 618g) associated with the respective option (e.g., as seen in FIG. 6E) (e.g., displaying one or more different selectable options such as a slider for setting a style, displaying one or more different selectable options for setting a low light capture mode, displaying one or more different selectable options for setting an exposure value, displaying one or more different selectable options for setting a timer duration that indicates how long after a capture affordance is selected the camera waits before capturing media, or displaying one or more different selectable options for selecting an aspect ratio). In some embodiments, displaying one or more selectable options includes displaying a slider or other adjustable control that can be adjusted between a plurality of different values (e.g., based on one or more inputs detected via the one or more input devices that are directed to the slider or other adjustable control) to change a behavior of the camera application when capturing media. In some embodiments, the displaying one or more selectable options includes displaying a plurality of options that can be individually selected (e.g., based on one or more inputs detected via the one or more input devices that are directed to the selectable options) to change a behavior of the camera application when capturing media. Displaying a set of one or more adjustment options associated with the respective option when the respective option is selected provides users with access to the adjustment options when requested, without cluttering the UI with additional displayed options when those options are not required.

In some embodiments, performing the operation corresponding to a respective option (e.g., 618b or 618c) of the second set of one or more options includes enabling and/or changing a capture mode for the one or more cameras (e.g., enabling or disabling a spatial capture mode, enabling or disabling a panorama capture mode, and/or enabling or disabling a simulated depth of field capture mode).

In some embodiments, the second set of one or more mode options includes options (e.g., 618b or 618c) (e.g., a spatial capture mode option) that change a camera capture mode; and the second set of one or more mode options includes options (e.g., a filter option) that display a set of one or more adjustment options associated with the respective option (e.g., 618g or 618l). Including both an option to change a camera mode and an option to display a set of one or more adjustment options associated with the respective option in the second set of mode options provides users with access to those options when requested, without cluttering the UI with additional displayed options when those options are not required.

In some embodiments, the computer system displays, via the one or more display generation components, in the camera user interface, a media format control (e.g., 614g) (e.g., concurrently with the first set of one or more mode options, the capture affordance, the live preview, and/or the mode switcher option). While displaying the media format control, the computer system detects via the one or more input devices, an input (e.g., 612d) (e.g., a tap, an air gesture, or a button press while a respective option is selected/highlighted) directed to the media format control. In response to detecting the input directed to the media format control, the computer system displays, via the one or more display generation components, in the camera user interface (e.g., concurrently with the first set of one or more mode options, the capture affordance, the live preview, and/or the mode switcher option), a plurality of media format options (e.g., the options in 614p), including multiple options for changing captured media resolution (e.g., 12 megapixel, 24 megapixel, and/or 48 megapixel) and multiple options for changing file format (e.g., JPEG, HEIC, and/or RAW). Displaying a plurality of media format options in response to an input directed to a media format control provides users with access to options that include multiple resolution and file format options when requested, without cluttering the UI with additional displayed options when those options are not required.

In some embodiments, the plurality of media format options include multiple options for switching photo capture between still photo capture and capture of a photo with additional frames before and/or after the capture input that can be replayed in sequence (e.g., options in 614p3) (sometimes referred to as a “live photo”) (e.g., a live photo option with selectable affordances for switching between “automatic” where the device automatically decides whether or not to capture a live photo, “on” where the device automatically enabled to capture a live photo, and “off” where the device is disabled from capturing a live photo).

In some embodiments, the plurality of media format options are displayed in a platter (e.g., 614p) that overlays at least a portion of the live preview. Displaying the plurality of media format options in a platter that overlays the live preview optimizes the display of the live preview of content by increasing and/or maximizing the size of the live preview of content, when the plurality of media format options are not displayed.

In some embodiments, while displaying the plurality of media format options: the computer system detects, via the one or more input devices, an input (e.g., 612y) (e.g., a tap, an air gesture, or a button press while a respective option is selected/highlighted) directed to a media format option (e.g., a file format (e.g., RAW or JPG) or a resolution (e.g., 12 megapixel or 24 megapixel) of the stored media) of the plurality of media format options; and in response to detecting the input directed to the media format option of the plurality of media format options, the computer system changes a capture format for capturing media with the one or more cameras based on the selected media format option (e.g., as shown in FIGS. 60 and 6P) (e.g., selecting a first media format if the input is directed to a first media format option affordance and selecting a second media format that is different from the first media format if the input is directed to a second media format option affordance that is different from the first media format option affordance). In some embodiments, some of the media format options are mutually exclusive (e.g., 12 megapixel, 24 megapixel, and/or 48 megapixel). In some embodiments, some of the media format options can be selected concurrently with other media format options (e.g., the user can select one resolution, one file format and one status for live photo concurrently).

In some embodiments, in conjunction with displaying the plurality of media format options, the computer system ceases to display one or more other controls (e.g., 614h) (e.g., a flash mode control for adjusting a flash setting of the camera such as a control for selecting between an automatic flash mode, a flash enabled mode and a flash disabled mode). Ceasing to display one or more other controls when displaying the plurality of media format options optimizes the use of screen real estate and reduces clutter in the user interface, which so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, while displaying the plurality of media format options with a first media format option (e.g., 614p1a) (e.g., 48 megapixel resolution option) of the plurality of media format options enabled for selection, detecting, via the one or more input devices, an input (e.g., 612y) (e.g., a tap, an air gesture, or a button press while a respective option is selected/highlighted) directed to a second media format option (e.g., 614p1b) (e.g., a JPEG format option) of the plurality of media format options. In response to detecting the input directed to the second media format option: the computer system changes a second capture format for capturing media with the one or more cameras based on the second media format option (e.g., enabling storage of captured photos in JPEG format), and disables the first media format option for selection (e.g., disables 614p2b) (e.g., making the first media format option non-selectable, such as disabling the ability to select the 48 MP resolution option such that selection of the option (e.g., tapping on the option) would not cause the corresponding operation to be performed). In some embodiments, the appearance of the first media format option is modified (e.g., greyed out, darkened, and/or blurred) to indicate that the first media format option is not available for selection. In some embodiments, the first media format option is disabled because it is incompatible with the selected second media format option (e.g., 48 MP photos are not compatible with JPEG format). Disabling a media format option for selection when changing a capture format prevents an incompatible option from being selected, which enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently. Doing so also provides improved visual feedback as to which options are compatible with the selected capture format.

In some embodiments, the media format control includes a single media format indicator (e.g., 614g1) that visually indicates the status (in some embodiments, a configuration) of a first media format parameter (e.g., captured media resolution) and the status of a second media format parameter (e.g., file format for captured media), different from the first media format parameter, the single media format indicator including: a first visual sub-element (e.g., “RAW” in 614g1) that indicates the status of the first media format parameter; and a second visual sub-element (e.g., “24” in 614g1) that indicates the status of the second media format parameter. In some embodiments, when the status of first media format parameter changes with the status of the second media format parameter changing, the appearance of the first visual sub-element changes while the appearance of the second visual sub-elements remains the same, and vice versa. Displaying a single media format indicator that indicates the status of the first media format parameter and the second media format parameter optimizes the use of screen real estate and reduces clutter in the user interface.

In some embodiments, one or more of the platters and/or affordances (e.g., 614c, 618, and/or 614p) are displayed with a simulated glass material that has an appearance that is based on the live preview (e.g., the content currently in the live preview) and changes as content in the live preview changes, wherein the simulated glass material distorts an appearance of the content in the live preview that is seen through the simulated glass using a simulated optical effect (e.g., simulated blurring, simulated refraction, and/or simulated reflection).

In some embodiments, the computer system displays, via the one or more display generation components, in the camera user interface, a capture settings control (e.g., 614h) (e.g., concurrently with the first set of one or more mode options, the capture affordance, the live preview, and/or the mode switcher option) (in some embodiments, concurrently with, and separate from, the media format control). While displaying the capture settings control, the computer system detects, via the one or more input devices, an input (e.g., 612e) (e.g., a tap, an air gesture, or a button press while a respective control is selected/highlighted) directed to the capture settings control. In response to detecting the input directed to the capture settings control, the computer system displays, via the one or more display generation components, in the camera user interface (e.g., concurrently with the first set of one or more mode options, the capture affordance, the live preview, and/or the mode switcher option), a plurality of capture settings options (e.g., the options in 614q). In some embodiments, the plurality of capture settings options include a plurality of flash setting options, a plurality of low-light setting options, and/or a plurality of exposure control options (e.g., one or more of shutter speed, aperture, and ISO settings). Displaying a plurality of capture settings options in response to an input directed to a capture settings control provides users with access to options that include multiple resolution and file format options when requested, without cluttering the UI with additional displayed options when those options are not required.

In some embodiments, the plurality of capture settings options are displayed in a second platter that overlays at least a portion of the live preview. Displaying the plurality of capture settings options in a platter that overlays the live preview optimizes the display of the live preview of content by increasing and/or maximizing the size of the live preview of content, when the plurality of media format options are not displayed.

In some embodiments, prior to detecting the input (e.g., 612e) directed to the capture settings control (e.g., 614h), the capture settings control is concurrently displayed with a respective media format control (e.g., 614g) that indicates the status of one or more selectable media format parameters, the method including: in response to detecting the input directed to the capture settings control, ceasing to display the respective media format control. In some embodiments, at least a portion of the plurality of capture settings options are displayed at a location at which the respective media format control was displayed. In some embodiments, while displaying the respect media format control, detecting via the one or more input devices, an input (e.g., a tap) directed to the respective media format control; and in response to detecting the input directed to the respective media format control, displaying, via the one or more display generation components, in the camera user interface (e.g., concurrently with the first set of one or more mode options, the capture affordance, the live preview, and/or the mode switcher option), a plurality of media format options, including multiple options for changing captured media resolution (e.g., 12 megapixel, 24 megapixel, and/or 48 megapixel) and multiple options for changing file format (e.g., JPEG, HEIC, and/or RAW). Ceasing to display the respective media format control when displaying the plurality of capture settings options optimizes the use of screen real estate and reduces clutter in the user interface, which so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, while displaying the plurality of capture settings options with a first capture setting option (e.g., low light mode option) of the plurality of capture settings options enabled for selection (e.g., 614q2a), the computer system detects, via the one or more input devices, an input (e.g., a tap, an air gesture, or a button press while a respective option is selected/highlighted) directed to a second capture setting option (e.g., 614q1b) (e.g., a flash on option) of the plurality of capture settings options. In response to detecting the input directed to the second capture setting option: the computer system changes a capture setting option for capturing media with the one or more cameras based on the second capture setting option (e.g., configuring the flash on during media capture); and the computer system disables the first capture setting option for selection (e.g., making the first capture setting option non-selectable, such as disabling the ability to select the low light mode option or such that selection of the option (e.g., tapping on the option) would not cause the corresponding operation to be performed). In some embodiments, the appearance of the first capture setting option is modified (e.g., greyed out, darkened, and/or blurred) to indicate that the first capture setting option is not available for selection. In some embodiments, the first capture setting option is disabled because it is incompatible with the selected second capture setting option (e.g., low light mode is incompatible with flash). Disabling a first media capture setting option for selection when changing a capture setting prevents an incompatible option from being selected, which enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently. Doing so also provides improved visual feedback as to which options are compatible with the selected setting option.

In some embodiments, the first set of one or more mode options for switching between photo capture mode and video capture mode are displayed in a first platter (e.g., 614i); and displaying the second set of mode options includes displaying the mode switcher option merging with the first platter to form a second platter that includes the second set of mode options (e.g., as shown in FIGS. 6C and 6D). In some embodiments, the second platter is larger than the first platter and occupies at least a portion of the space occupied by the first platter. In some embodiments, the computer system displays an animation of the mode switcher option progressively merging into the first platter. Displaying the mode switcher option merging with the first platter to form a second platter that includes the second set of mode options provides improved visual feedback that the second set of mode options include options that are compatible with the photo capture mode and video capture mode.

In some embodiments, the camera user interface includes a first expandable control (e.g., a mode switcher option (e.g., 614j), a media format control (e.g., 614g), or a capture settings control (e.g., 614h)) that has expanded and unexpanded states and a second expandable control option that has expanded and unexpanded states. In such embodiments, while the first expandable control (e.g., 618) is in the unexpanded state, detecting, via the one or more input devices, an input (e.g., 614z) (e.g., a tap, an air gesture, or a button press while control is selected/highlighted) corresponding to a request to expand the first expandable control. In response to detecting the input corresponding to the request to expand the first expandable control: expanding the first expandable control to the expanded state (e.g., 618); and in accordance with a determination that the second expandable control is in the expanded state, collapsing the second expandable control (614p) to the unexpanded state. In some embodiments, response to the input and in accordance with a determination that the second expandable control is in the unexpanded state, maintaining the second expandable control in its unexpanded state. Collapsing another expanded control when expanding a different expandable control optimizes the use of screen real estate and reduces clutter in the user interface.

Note that details of the processes described above with respect to method 700 (e.g., FIG. 7) are also applicable in an analogous manner to the methods described below/above. For example, method 700 optionally includes one or more of the characteristics of the various methods described above with reference to methods 800, 1000, 1200, 1400, 1500, 1600 and/or 1800. For example, the first set of one or more mode options of method 700 can be used to switch the type of media captured in response to a capture request, while maintaining a respective value of a camera setting, in accordance with method 800. For brevity, these details are not repeated below.

FIG. 8 is a flow diagram illustrating a method for maintaining certain camera settings when switching between camera modes using a computer system in accordance with some embodiments. Method 800 is performed at a computer system (e.g., 100, 300, 500, and/or 600) that is in communication with one or more display generation components (e.g., 602) (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 800 are, optionally, combined, the orders of some operations are, optionally, changed, and some operations are, optionally, omitted.

As described below, method 800 provides an intuitive way for maintaining certain camera settings when switching between camera modes. The method reduces the cognitive burden on a user for maintaining certain camera settings when switching between camera modes, thereby creating a more efficient human-machine interface. For battery-operated computing devices, enabling a user to maintain certain camera settings when switching between camera modes faster and more efficiently conserves power and increases the time between battery charges.

While displaying a camera user interface (e.g., 614) and while the computer system (e.g., 600) is configured to capture a first type of media (e.g., photo media and/or video media) in response to a capture request input (e.g., 612h) (e.g., a tap on a shutter button, an predetermined air gesture, an input on a button) using a respective value of a plurality of available values for a first camera setting (e.g., the setting corresponding to 614f or 618f), the computer system detects (802), via the one or more input devices, a media-type input (e.g., 612j or 612v) corresponding to a request to switch a type of media that will be captured in response to the capture request input. In some embodiments, the media-type input is an input corresponding to a camera mode selection affordance (e.g., 612j). In some embodiments, the available values are from a limited set of discrete values (e.g., on or off) or a continuous range of values, such as a range of zoom values ranging from 1× to 20×).

In response to detecting the media-type input (804): in accordance with a determination that the respective value for the first camera setting (e.g., a depth mode setting, that when selected, causes media to be captured with depth information that is later used to modify how the media is displayed (e.g., with simulated depth effects)) is a first value (e.g., exposure of +1.0 as shown in FIG. 6I) (e.g., enabled for the first type of media), configuring (e.g., 806) the computer system to capture a second type of media (e.g., configuring to capture video when a photo media was previously selected or vice versa), different from the first type of media, with the first value for the first camera setting (e.g., the first camera setting is a persistent setting that is applicable to both the first and second types of media); and in accordance with a determination that the respective value for the first camera setting is a second value, different from the first value for the first camera setting, configuring (e.g., 808) the computer system to capture the second type of media, with the second value for the first camera. Maintaining a respective value for a first camera setting that was used to capture a first type of media when configuring the computer system to capture a second type of media reduces the number of inputs needed to enable use of the respective value for the first camera setting with the second type of media. Doing so also automatically configures the second type of media to be captured using the respective value for the first camera setting, which performs an operation when the computer system is re-configured, without requiring further input.

In some embodiments, the media-type input is detected while the computer system is configured to capture the first type of in response to a capture request input (e.g., a tap on a shutter button, an predetermined air gesture, an input on a button) using a respective value of a plurality of available values for a second camera setting (e.g., a zoom setting corresponding to 614c) (a spatial media capture setting, a zoom level setting, a camera selection setting), different from the first camera setting. In some embodiments, the first camera setting and the second camera setting are independently selected and mutually compatible such that the computer system can be configured to capture media with both settings at any respective value. In response to detecting the media-type input: in accordance with a determination that the respective value for the second camera setting is a first value (e.g., a zoom of 1.5×) (e.g., enabled for the first type of media) for the second camera setting, configuring the computer system to capture the second type of media (e.g., configuring to capture video when a photo media was previously selected or vice versa), different from the first type of media, with the first value for the second camera setting (e.g., the second camera setting is a persistent setting that is applicable to both the first and second types of media); and in accordance with a determination that the respective value for the first camera setting is a second value (e.g., a zoom of 2.0×) for the second camera setting, different from the first value for the second camera setting, configuring the computer system to capture the second type of media, with the second value for the second camera. In some embodiments, the first and second camera settings are compatible and can both be simultaneously enabled. In some embodiments, the first and second camera settings are mutually exclusive settings. In some embodiments, the computer system is configured to capture the first type of media in response to a capture request input using respective values for a plurality of different, independently selectable/settable camera settings that are compatible with both the first and second types of media and the respective values for these plurality of independently selectable/settable camera settings are persistent across the two types of media. In such embodiments, switching between the media types does not affect the currently selected setting for the plurality of independently selectable/settable camera settings. Maintaining a respective value for a second camera setting that was used to capture a first type of media when configuring the computer system to capture a second type of media reduces the number of inputs needed to enable use of the respective value for the second camera setting with the second type of media. Doing so also automatically configures the second type of media to be captured using the respective value for the second camera setting, which performs an operation when the computer system is re-configured, without requiring further input.

In some embodiments, the camera user interface includes a first set of one or more mode options (e.g., 614i) for switching between a mode for capturing the first type of media (e.g., a photo capture mode or a video capture mode) and a mode for capturing the second type of media. In some embodiments, the first set of one or more mode operations operates as a toggle, such that input causes the mode to switch between photo capture mode and video capture mode and vice versa. In some embodiments, the first set of one or more mode options includes an indication of the type of media that will be captured in response to the capture request. In such embodiments, the media-type input (e.g., 612j) is directed to the first set of one or more mode options (e.g., to a first option of the first set of one or more options).

In some embodiments, the camera user interface includes a live preview of content (e.g., 614a) from the one or more cameras (e.g., a preview based on a portion or all of a field-of-view(s) of one or more cameras); and the media-type input (e.g., 612dd) is directed to a portion of the live preview of content. In some embodiments, the media-type input includes movement. In some embodiments, the media-type input is a swipe gesture (e.g., on a touch-sensitive surface or as an air gesture).

In some embodiments, the first type of media is photo media or video media (e.g., as indicated by 614i). In some embodiments, the first type of media is photo media and the second type of media is video media. In some embodiments, capturing photo media includes capturing media with a limited duration (e.g., 1, 3, and/or 5 seconds), for example, including content from before and/or after a capture input is detected that can be displayed in sequence (e.g., in response to a user input such as a selection input or a movement input) for a “live” effect. In some embodiments, capturing video media includes capturing time lapse or slow-motion video. Maintaining a respective value for a second camera setting that was used to capture a first type of media when configuring the computer system to capture a video media (from a previous photo media mode) reduces the number of inputs needed to enable use of the respective value for the second camera setting with video media. Doing so also automatically configures the video media to be captured using the respective value for the second camera setting, which performs an operation when the computer system is re-configured, without requiring further input.

In some embodiments, the first camera setting is a depth capture mode setting (e.g., 614f or 618a). In some embodiments, capturing media (e.g., photo or video media) in the depth capture mode includes adding a simulated depth effect in which at least a portion of the background is blurred and a portion of the foreground is not blurred to simulate taking a photo or video with a shallow depth of field wherein the portion of the foreground is in the plane of focus. In some embodiments, the depth capture mode setting is a binary setting (e.g., depth capture on or off). In some embodiments, the depth capture setting includes a selected simulated f-stop value from a plurality of possible f-stop values. Maintaining a respective value for a depth capture setting that was used to capture a first type of media when configuring the computer system to capture a second type of media reduces the number of inputs needed to enable use of the respective value for the depth capture setting with the second type of media. Doing so also automatically configures the second type of media to be captured using the respective value for the depth capture setting, which performs an operation when the computer system is re-configured, without requiring further input.

In some embodiments, the first camera setting is a zoom level setting (e.g., 614c or 614m). In some embodiments, changing a zoom level for capturing media with the one or more cameras includes changing the zoom level of the live preview of content of the one or more cameras. In some embodiments, changing the zoom level includes digitally changing the zoom level, optically changing the zoom level, or doing both. In some embodiments, optically changing the zoom level includes changing the focal length of a zoom lens (e.g., an optical zoom lens). In some embodiments, optically changing the zoom level includes switching from using a first camera (e.g., a camera with a prime lens) having a first focal length to a second camera having a second focal length, different than the first focal length. Maintaining a respective value for a zoom setting that was used to capture a first type of media when configuring the computer system to capture a second type of media reduces the number of inputs needed to enable use of the respective value for the zoom setting with the second type of media. Doing so also automatically configures the second type of media to be captured using the respective value for the zoom setting, which performs an operation when the computer system is re-configured, without requiring further input.

In some embodiments, the first camera setting is an exposure compensation setting (e.g., 618f or 618l). In some embodiments, the exposure compensation setting is a value from a plurality of selectable values. Maintaining a respective value for an exposure compensation setting that was used to capture a first type of media when configuring the computer system to capture a second type of media reduces the number of inputs needed to enable use of the respective value for the exposure compensation setting with the second type of media. Doing so also automatically configures the second type of media to be captured using the respective value for the exposure compensation setting, which performs an operation when the computer system is re-configured, without requiring further input.

In some embodiments, the first camera setting is a flash setting (e.g., a setting in 614q1). In some embodiments, the flash setting is a binary setting (e.g., flash on or off). In some embodiments, the flash setting is a selected value (e.g., on, off, strobe, and/or automatic mode that switches between on and off based on current lighting conditions in the field of view of the one or more cameras) from a plurality of possible values. Maintaining a respective value for a flash setting that was used to capture a first type of media when configuring the computer system to capture a second type of media reduces the number of inputs needed to enable use of the respective value for the flash setting with the second type of media. Doing so also automatically configures the second type of media to be captured using the respective value for the flash setting, which performs an operation when the computer system is re-configured, without requiring further input.

In some embodiments, the camera user interface includes a mode switcher option (e.g., 614j) (e.g., an affordance or selectable user interface object) for selecting additional modes. The computer system detects a first user input (e.g., 612b) (e.g., a tap, an air gesture, or a button press while the mode switched option is selected/highlighted) directed to the mode switcher option. In response to detecting the first user input, the computer system displays a first set of mode options (e.g., options in 618) that correspond to different modes (e.g., modes other than a photo mode and a video capture mode, such as a panoramic mode or a time lapse mode) and that includes at least a first adjustment option for adjusting a third camera setting (e.g., 618a, 618d, and/or 618f) (in some embodiments, the third camera setting is the first camera setting or the second camera setting or is a setting different from the first and second camera settings). In some embodiments, the first adjustment option is a slider. In some embodiments, the first set of mode options includes a plurality of adjustment options for adjusting a plurality of camera settings, such as exposure compensation, depth effect, filters, and/or aspect ratios. In some embodiments, the mode switcher option is the mode switcher option of method 700. Displaying the first set of mode options that correspond to different camera modes in response to an input directed to the mode switch option optimizes the use of screen real estate, without cluttering the UI with additional displayed controls when those controls are not required.

In some embodiments, while displaying the first set of one or more mode options, the computer system detects, via the one or more input devices, a second input (e.g., 612k or 612l) (e.g., a tap input, a movement input, or a swipe input). In response to detecting the second input: in accordance with a determination that the second user input corresponds to a respective option (e.g., 618a or 618b) of the first set of one or more options, adjusting a respective value of a respective camera setting that corresponds to the respective option; and in accordance with a determination that the second user input corresponds to a first portion of the camera user interface (e.g., 618g) (e.g., a portion that is outside of the portion in which the first set of one or more mode options is displayed (e.g., outside a platter where the set of one or more mode options are displayed)) ceasing to display the first set of one or more mode options.

In some embodiments, while displaying the second set of one or more mode options, the computer system detects, via the one or more input devices, an input (e.g., 6120) (e.g., a movement input or a swipe input) directed at the first set of one or more options. In response to detecting the input directed to the first set of one or more options, the computer system navigates (e.g., scrolling) through the first set of one or more options (e.g., as shown in FIGS. 6D and 6F) (e.g., ceasing to display one or more options of the first set of one or more options and displaying an additional option in the first set of one or more options that was not previously displayed). Including additional options in the first set of one or more mode options that are accessible via a navigation input provides users with access to those options when requested, without cluttering the UI with additional displayed options when those options are not required.

In some embodiments, displaying the camera user interface includes concurrently displaying: a control (e.g., 618g or 618l) (e.g., an affordance or selectable user interface object) for changing the first camera setting; and a second set of one or more mode options (e.g., 614i) for switching between a mode for capturing the first type of media (e.g., a photo capture mode or a video capture mode) and a mode for capturing the second type of media. In some embodiments, the second set of one or more mode operations operates as a toggle, such that input causes the mode to switch between photo capture mode and video capture mode and vice versa. In some embodiments, the second set of one or more mode options includes an indication of the type of media that will be captured in response to the capture request. In such embodiments, the computer system detects a respective user input (e.g., a tap, an air gesture, or a button press while a respective option is selected/highlighted). In response to detecting the respective input: in accordance with a determination that the respective input (e.g., 612t) is directed to the control for changing the first camera setting, changing the respective value for the first camera setting; and in accordance with a determination that the respective input (e.g., 612j) is directed to the second set of one or more mode options, switching the camera user interface between being configured to capture the first type of media and being configured to capture second type of media in response to a capture request input. Concurrently displaying a control for changing the first camera setting with a second set of one or more mode options provides users with an efficient user interface that optimizes and/or reduces the number of inputs required to configure the first camera setting while in a mode for capture the first type of media, while also having access to an option to change to a mode for capture of the second type of media. Providing an efficient user interface so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the control for changing the first camera setting (e.g., 614d) is displayed in the camera user interface prior to displaying a third set of mode options (e.g., options in 618) that correspond to different modes (e.g., modes other than a photo mode and a video capture mode, such as a panoramic mode or a time lapse mode) in the camera user interface. In some embodiments, the third set of mode options are displayed in an expanded control region (e.g., a platter) that is in an unexpanded state when the control for changing the first camera setting is initially displayed in the camera user interface.

In some embodiments, the camera user interface includes a second mode switcher option (e.g., 614j) (e.g., an affordance or selectable user interface object) for selecting additional modes; and the control (e.g., 618f) for changing the first camera setting is displayed in response to an input directed to the second mode switcher option. In some embodiments, the control for changing the first camera setting is part of a set of mode options that correspond to different modes that are displayed in an expanded control region. Displaying the control for changing the first camera setting in response to an input directed to a second mode switcher option makes the control for changing the first camera setting available upon request, without cluttering the UI with additional displayed controls when those controls are not required.

In some embodiments, while displaying the camera user interface and while the computer system is configured to capture the first type of media or the second type of media in response to a capture request input, detecting, via the one or more input devices, an input corresponding to a request to switch to a first camera mode (e.g., panoramic mode corresponding to 618c) (e.g., a tap, an air gesture, or a button press while a respective option is selected/highlighted). In some embodiments, the input is directed to a first set of one or more mode options for switching between a mode for capturing the first type of media. In some embodiments, the first camera mode is mode in which media capture is performed in a manner that is incompatible with a mode for capturing the first type of media or a mode for capturing the second type of media. In some embodiments, the first camera mode is a panoramic camera mode (e.g., a mode that is not compatible with at least video media capture), a slow-motion camera mode (a mode that is not compatible with at least photo media capture), or a time lapse camera mode (a mode that is not compatible with at least photo media capture). In response to detecting the input corresponding to the request to switch to the first camera mode: switching to the first camera mode (e.g., as shown in FIG. 6L) (e.g., configuring the computer system to capture media based on the first mode in response to a capture request input); and updating the camera user interface to indicate that the first camera mode is not compatible with at least one of the first type of media and the second type of media (e.g., as shown in FIG. 6L where 614i is replaced by 6140) (e.g., is incompatible with a mode for capturing the first type of media or incompatible with a mode for capturing the second type of media). In some embodiments, updating the camera user interface includes displaying a visual indication of the first camera mode. Updating the camera user interface to indicate that the first camera mode is not compatible with at least one of the first type of media and the second type of media reduces the risk that a user will provide an erroneous input and/or select incompatible settings, which enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently. Doing so also provides improved visual feedback as to the compatibility of certain options.

In some embodiments, updating the camera user interface to indicate that the first camera mode is not compatible with at least one of the first type of media and the second type of media includes (e.g., as seen in FIG. 6L) ceasing to display, in the camera user interface, a second set of one or more mode options (e.g., 614i) for switching between a mode for capturing the first type of media (e.g., a photo capture mode or a video capture mode) and a mode for capturing the second type of media. Ceasing to display mode options for switching between a mode for capturing the first type of media and a mode for capturing the second type of media when the computer system is switched to a first mode that is not compatible with at least one of the first type of media and the second type of media reduces the risk that a user will provide an erroneous input and/or select incompatible settings/modes.

In some embodiments, switching to the first camera mode includes displaying a control (e.g., 614o1) (e.g., an affordance or selectable user interface object) that, when selected, causes the computer system to exit the first camera mode. In some embodiments, exiting the first camera mode includes returning to a previously selected mode (e.g., a mode for capturing photo media or a mode for capturing video media).

In some embodiments, the first camera mode is a mode for capturing panoramic media (e.g., wide format photography) in response to a capture request input (e.g., as shown in FIG. 6L). In some embodiments, the panoramic media capture mode is incompatible with a mode for capturing the first type of media (e.g., a mode for video media capture). Ceasing to display mode options for switching between a mode for capturing the first type of media and a mode for capturing the second type of media when the computer system is switched to a panoramic mode that is not compatible with at least one of the first type of media and the second type of media reduces the risk that a user will provide an erroneous input and/or select incompatible settings/modes.

In some embodiments, while the respective value of the plurality of available values for the first camera setting is a default value, detecting, via the one or more input devices, a first set of one or more inputs (e.g., 612t) (one or more gestures on a touch-sensitive surface and/or one or more air gestures) corresponding to a request to change the first camera setting to a non-default value. In some embodiments, the first set of one more inputs includes an input directed at a control affordance for changing the first camera setting. In response to detecting the first set of one or more inputs: changing the first camera setting to the requested non-default value; and displaying, via the one or more display generation components, in a first region (e.g., the upper left of display 602) (e.g., a status region of the camera user interface that is separate from a region at which a control for adjusting the first camera setting is displayed), first information (e.g., 614k) (e.g., graphical (e.g., a histogram), textual, and/or numeric information) (in some embodiments, the information provides an indication of the current (e.g., non-default) value of the first camera setting) corresponding to the first camera setting. In some embodiments, the first region is a region at an edge and/or a corner of the user interface. In some embodiments, the first camera setting is an ISO setting, an exposure setting, a storage format setting, and/or an image resolution setting. Displaying, in a first region, first information corresponding to the first camera setting when the first camera setting is changed to a non-default value performs an operation when a set of conditions has been met without requiring further user input. Doing so also provides improved visual feedback.

In some embodiments, while a respective value of a plurality of available values for a respective camera setting (e.g., an exposure control setting, a capture delay timer setting, or an f-stop setting), different from the first camera setting, is a default value, detecting, via the one or more input devices, a second set of one or more inputs (e.g., 612t) (one or more gestures on a touch-sensitive surface and/or one or more air gestures) corresponding to a request to change the respective camera setting to a non-default value. In some embodiments, the respective set of one more inputs includes an input directed at a control affordance for changing the respective camera setting. In response to detecting the second set of one or more inputs: changing the respective camera setting to the requested non-default value; and displaying, via the one or more display generation components, in the first region, second information (e.g., 614k) (e.g., graphical, textual, and/or numeric information) (in some embodiments, the information provides an indication of the current (e.g., non-default) value of the respective camera setting) corresponding to the respective camera setting. Displaying, in a first region, first information corresponding to the second camera setting when the second camera setting is changed to a non-default value performs an operation when a set of conditions has been met without requiring further user input. Doing so also provides improved visual feedback.

In some embodiments, in accordance with a determination that a first plurality of camera settings that includes the first camera setting (e.g., exposure value corresponding to 618l) are at their respective default values (e.g., that no camera setting of the first plurality of camera settings has been adjusted to a non-default value), the camera user interface is displayed without information in the first region that indicates a respective value of a camera setting (e.g., of any camera setting) of the first plurality of camera settings (e.g., as shown in FIG. 6H when exposure is at the default value of 0.0). In some embodiments, the first region includes information relating to camera settings only when a camera setting of the first plurality of camera settings is adjusted to a non-default value. Displaying the camera user interface without information in the first region that indicates a respective value of a camera setting when the first plurality of camera settings that includes the first camera setting are at their respective default values are at their default values provides improved visual feedback.

In some embodiments, while the camera user interface is not displayed (e.g., as seen in FIG. 6A) (in some embodiments, while a camera application that generates and/or manages the camera user interface is not active, is a suspended application, and/or is a background application), the computer system displays, via the one or more display generation components, in the first region, system status information (e.g., 604b) (e.g., date, time, wireless connectivity, and/or battery life). In some embodiments, the first region does not include information about camera settings when the camera user interface is not displayed, even if one or more camera settings have been adjusted to a non-default value. Displaying, in the first region, system status information when the camera user interface is not displayed performs an operation when a set of conditions has been met without requiring further user input. Doing so also provides improved visual feedback that the camera user interface is not currently active.

Note that details of the processes described above with respect to method 800 (e.g., FIG. 800) are also applicable in an analogous manner to the methods described above/below. For example, method 800 optionally includes one or more of the characteristics of the various methods described herein with reference to methods 700, 1000, 1200, 1400, 1500, 1600 and/or 1800. For example, the media-type input of method 800 can be detected while displaying a user interface in accordance with methods 700, 1000, 1200, 1400, 1500, 1600 and/or 1800. For brevity, these details are not repeated below.

FIGS. 9A-9J illustrate exemplary user interfaces for a camera application that changes zoom levels of one or more cameras, based on a change in the number of subjects, in accordance with some embodiments. The user interfaces in these figures are used to illustrate the processes described below, including the process in FIG. 10.

FIG. 9A illustrates, on the left, device 600 displaying camera user interface 900. Camera user interface 900 includes various selectable user interface objects and indicators for configuring media capture functions and features, capturing media, and reviewing and/or editing captured media. Camera user interface 900 includes camera preview 900a, which includes a representation of a field-of-view of the environment captured by one or more front facing cameras of computer system 600 that is framed (e.g., cropped) as it would currently be framed in media captured via camera user interface 900 (e.g., camera preview 900a is a live or near-live viewfinder). At FIG. 9A, camera preview 900a is a representation of the environment (e.g., an outdoor environment with subject 902a standing in the foreground) as captured by one or more of the front facing cameras of device 600, such as front facing camera 606. As seen in FIG. 9A, camera preview 900a spans the surface of display 602, showing content at each of the four edges of the display. In some embodiments, while camera preview 900a includes a representation of the environment from the top edge of display 602 to the bottom edge of display 602, portions (e.g., at the top and bottom of the display) are presented with a different visual appearance (e.g., a gray mask) to indicate that those portions will not be included in captured media or at least will not be initially included in captured media when it is viewed. In some embodiments, the size and/or dimensions of the portions that are presented with the different visual appearance are based on a currently selected aspect ratio (e.g., a 4:3 aspect ratio would have larger portions at the top and bottom excluded from captured media than if a 16:9 aspect ratio were selected). Shutter affordance 900b is a software button that can be selected to initiate the capture of media in a currently selected capture mode using one or more current settings. Camera selection affordance 900c is a software button for switching between capture using one or more front facing cameras (e.g., front facing camera 606) and using one or more rear facing cameras (e.g., rear facing cameras 606A, 606B, and/or 606C). Captured media affordance 900d is a selectable thumbnail icon that previews captured media and can be selected to view and/or edit captured media (e.g., in a media viewing or media library user interface).

At FIG. 9A, camera user interface 900 also includes tracking mode affordance 900e that indicates a current status (e.g., enabled as indicated in FIG. 9A) of an automatic subject tracking mode and is also selectable to modify the status of that mode. The automatic subject tracking mode, when enabled, causes device 600 to modify a zoom level and/or modify the content (e.g., by panning) that is displayed in camera preview 900a and captured in media (e.g., based on selection of shutter affordance 900b). In some embodiments, mode option affordance 614i operates as a toggle switch to toggle between the automatic subject tracking mode being enabled and disabled. The operation of the automatic subject tracking mode is described in more detail, below. At FIG. 9A, camera user interface 900 also includes zoom affordance 900f that can be selected to toggle the current level of zoom of the currently selected camera(s), which also modifies the zoom level of the content displayed in camera preview 900a.

In some embodiments, one or more of the user interface objects in camera user interface 900a are displayed with a simulated glass appearance, such that the object(s) appear to be made of, or include, a simulated glass material that is translucent or transparent and exhibits simulated refraction and/or reflection of content within the user interface such as content under the simulated glass material, content near the simulated glass material, and/or content within the simulated glass material. In such embodiments, the appearance of the object(s) changes as content below the object(s) changes. For example, tracking mode affordance 900e, which is overlaid on camera preview 900a, can have a simulated glass appearance that would result in the appearance of tracking mode affordance 900e changing as the representation of the environment under tracking mode affordance 900e changes (e.g., due to movement of device 600 or movement of elements within the environment, such as movement of subject 902a). FIG. 9A, for example, depicts certain shapes and/or details of subject 902a being partially visible through user interface objects of camera user interface 900a. For example, note that details (e.g., buttons) of the sweater worn by subject 902a are visible through translucent shutter affordance 900b, tracking mode affordance 900e, and camera selection affordance 900c in FIG. 9A.

FIG. 9A, on the right, includes schematic 901 which depicts a portion of the physical environment that is within the field-of-view of one or more front facing cameras of device 600. Selected portion 903 (e.g., the portion within the dashed line) is the portion of the physical environment that is currently represented by camera preview 900a and that will be captured as media (e.g., captured based on selection of shutter affordance 900b). At FIG. 9A, selected portion 903 does not include portions of the physical environment (e.g., tree 905) that are in the field-of-view of one or more front facing cameras of device 600, as device 600 is currently configured (e.g., framed) to capture media that does not include those portions of the physical environment.

At FIG. 9A, device 600 detects input 904a (e.g., a tap gesture) directed to tracking mode affordance 900e and input 904b (e.g., a tap gesture) directed to zoom affordance 900f. In some embodiments, input 904a, input 904b, and/or one or more of the inputs discussed with reference to the embodiment of FIGS. 9A-9J, discussed below, is a touch gesture (e.g., a tap, a swipe, or touch-and-hold), an air gesture (e.g., an air tap or air pinch), or a selection input (e.g., via a hardware input mechanism such as a button) that is detected while a respective user interface element (e.g., tracking mode affordance 900e) is selected and/or is in focus. The response of device 600 to detecting inputs 904a and 904b are discussed, below, with reference to FIG. 9G.

FIG. 9B depicts device 600 after subject 902b and subject 902c have entered the field-of-view of the one or more front facing cameras of device 600. In response to having detected a change (e.g., an increase) in the number of subjects that are available to be captured via the one or more front facing cameras of device 600, device 600 has automatically (e.g., without user input) changed a zoom level for capturing media, which is reflected in the updated state of camera preview 900a. As seen in FIG. 9B, camera preview 900a is now zoomed out relative to FIG. 9A and now includes a portion of tree 905 and all of cloud 907, which was only partially visible in camera preview 900a of FIG. 9A. The change in zoom level is also represented by the updated state of selected portion 903 on the right of FIG. 9B. At FIG. 9B, device 600 detects input 904c (e.g., a tap gesture) directed at shutter affordance 900b. In response to input 904c, device 600 captures media (e.g., a photo) that includes the content shown in preview 900a and selected portion 903 of FIG. 9B.

FIG. 9C depicts device 600 after subject 902c has left the field-of-view of the one or more front facing cameras of device 600. In response to having detected a change (e.g., a decrease) in the number of subjects that are available to be captured via the one or more front facing cameras of device 600, device 600 has automatically (e.g., without user input) changed a zoom level for capturing media and also panned over to adjust the content that will be captured in media, which is reflected in the updated state of camera preview 900a. As seen in FIG. 9C, camera preview 900a is now zoomed in relative to FIG. 9B, such that neither tree 905 nor cloud 907 are visible within preview 900a or included in selected portion 903. As a result of the panning operation, subject 902a is now less centered within preview 900a. At FIG. 9C, captured media affordance 900d now includes a preview of the photo captured in response to input 904c of FIG. 9B. At FIG. 9C, device 600 detects input 904d (e.g., a tap gesture) directed to shutter affordance 900b. In response to input 904d, device 600 captures media (e.g., a photo) that includes the content shown in preview 900a and selected portion 903 of FIG. 9C.

FIG. 9D depicts device 600 after individual 904 has entered the field-of-view of the one or more front facing cameras of device 600. In some embodiments, while device 600 detects (e.g., identifies) individual 904 and, via image processing techniques, and recognizes individual 904 as a person, device 600 does not identify individual 904 as a potential subject for the purpose of modifying a zoom level in accordance with the automatic subject tracking mode. In some embodiments, device 600 does not identify individual 904 as a subject for the purposes of the automatic subject tracking mode because individual 904 is not facing the one or more front facing cameras of device 600, because individual 904 is determined to be more than a predetermined distance from device 600, and/or because individual 904 is more than a predetermined distance from one or more existing subjects (e.g., subject 902a and/or 902b). As a result of individual 904 not being identified as a subject for the purposes of the automatic subject tracking mode, device 600 does not modify the existing zoom level and/or pan the content within preview 900a and selected portion 903 to include individual 904. At FIG. 9D, captured media affordance 900d now includes a preview of the photo captured in response to input 904d of FIG. 9C.

FIG. 9E depicts device 600 after subjects 902c, 902d, and 902e have entered the field-of-view of the one or more front facing cameras of device 600. In response to having detected a change (e.g., an increase) in the number of subjects that are available to be captured via the one or more front facing cameras of device 600, device 600 has automatically (e.g., without user input) changed a zoom level for capturing media, which is reflected in the updated state of camera preview 900a. As seen in FIG. 9E, camera preview 900a is now zoomed out relative to FIG. 9D, such that a portion of tree 905 and all of cloud 907 are visible within preview 900a or included in selected portion 903. However, because device 600 is currently configured to capture images with a portrait orientation (e.g., height greater than width), the width of selected portion 903 is insufficient to accommodate the entirety of subjects 902d and 902e. In response to detecting that the currently selected capture orientation and/or aspect ratio for media capture is insufficient to accommodate one or more detected subjects, device 600 has displayed capture orientation affordance 900g. At FIG. 9E, device 600 detects input 904e (e.g., a tap gesture) directed to capture orientation affordance 900g.

At FIG. 9F, in response to detecting input 904e, device 600 switches from capturing media with a portrait orientation to capturing media with a landscape orientation (e.g., width greater than height), while the physical orientation of device 600 remains unchanged. With the portrait orientation, all five subjects 902a, 902b, 902c, 902d, and 902e are now visible in preview 900a and selected portion 903. In some embodiments, device 600 is configured to automatically select an appropriate capture orientation and/or capture aspect ratio, based on a change in detected subjects. In some embodiments, capture orientation affordance 900g operates as a toggle to enable or disable an automatic capture orientation mode, with device 600 being configured to automatically select an appropriate capture orientation and/or capture aspect ratio, based on a change in detected subjects, when the mode is enabled. At FIG. 9F, device 600 detects input 904f (e.g., a tap gesture) directed at shutter affordance 900b. In response to input 904f, device 600 captures media (e.g., a photo) that includes the content shown in preview 900a and selected portion 903 of FIG. 9F.

As noted above, FIG. 9G depicts the responses of device 600 to input 904a and input 904b of FIG. 9A. In response to detecting input 904a directed to tracking mode affordance 900e, device 600 disables the automatic subject tracking mode and updates the appearance of tracking mode affordance 900e to indicate that the mode is disabled. In response to detecting input 904b directed to zoom affordance 900f, device 600 zooms out to a predetermined zoom level, as reflected in preview 900a and selected portion 903, which now include a portion of tree 905 and all of cloud 907. Device 600 also updates the appearance zoom affordance 900f to indicate that the next input directed to zoom affordance 900f will result in zooming in (e.g., to the predetermined zoom level of FIG. 9A).

FIG. 9H depicts device 600 after subject 902b and subject 902c have entered the field-of-view of the one or more front facing cameras of device 600, while the automatic subject tracking mode is disabled (e.g., as indicated by the appearance of tracking mode affordance 900e). Device 600 has not modified the zoom level with which media is captured, as shown by the states of preview 900a and selected portion 903, which both remain at the same level as shown in FIG. 9G, because the automatic subject tracking mode is disabled.

FIG. 9I illustrates, on the left, device 600 displaying camera user interface 906. In some embodiments, camera user interface 906 is an alternative of camera user interface 900 and camera user interface 906 includes one or more features of camera user interface 900, described above. Camera user interface 906 includes tracking mode affordance 900e1, which is an alternative of tracking mode affordance 900e and includes the features described above with respect to tracking mode affordance 900e. Tracking mode affordance 900e1 is displayed in an upper left hand corner of camera user interface 906. At FIG. 9I, the automatic subject tracking mode that corresponds to tracking mode affordance 900e1 is enabled, as indicated by the visual appearance of tracking mode affordance 900e1. Camera user interface 906 includes zoom affordance 906a that indicates that the current zoom level is 1× (e.g., the 1× indicator is enlarged relative to the 0.5× and 2× indicators where 1× indicates a respective zoom level, 0.5× indicates a zoom level that is ½ of the respective zoom level, and 2× indicates a zoom level that is twice the respective zoom level). Subjects 902a, 902b, and 902c are present in the field of view of the one or more front facing cameras of device 600 and are also visible in preview 900a and selected portion 903.

At FIG. 9I, device 600 detects input 904g (e.g., a tap gesture) directed at shutter affordance 900b. In response to input 904g, device 600 captures media (e.g., a photo) that includes the content shown in preview 900a and selected portion 903 of FIG. 9I. Device 600 also detects input 904h (e.g., a de-pinch gesture made by moving two contacts apart) and detects input 904i (e.g., a tap gesture) directed to the 0.5× indicator of zoom affordance 906a.

At FIG. 9J, in response to input 904h and/or in response to input 904i, device 600 modifies the zoom level by zooming out (e.g., as indicated by a greater amount of tree 905 being visible in preview 900a and selected portion 903) and disables the automatic subject tracking mode that corresponds to tracking mode affordance 900e1, as indicated by the updated appearance of tracking mode affordance 900e1. In some embodiments, device 600 disables the automatic subject tracking mode when a user provides one or more manual inputs to modify a zoom level, which indicates that user wishes to have manual control over the level of zoom. At FIG. 9J, captured media affordance 900d now includes a preview of the photo captured in response to input 904g of FIG. 9I.

FIG. 10 is a flow diagram illustrating a method for changing zoom levels of one or more cameras, based on a change in the number of subjects, in accordance with some embodiments. Method 1000 is performed at a computer system (e.g., 100, 300, 500, and/or 600) that is in communication with one or more input devices (e.g., 602) (e.g., touch-sensitive surfaces, hardware input devices (e.g., hardware buttons or rotatable input mechanisms), microphones, gesture input devices, air gesture input devices, and/or gaze input devices), one or more display generation components (e.g., 602) (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 1000 are, optionally, combined, the orders of some operations are, optionally, changed, and some operations are, optionally, omitted.

As described below, method 1000 provides an intuitive way for changing zoom levels of one or more cameras, based on a change in the number of subjects. The method reduces the cognitive burden on a user for changing zoom levels of one or more cameras, based on a change in the number of subjects, thereby creating a more efficient human-machine interface. For battery-operated computing devices, enabling a user to change zoom levels of one or more cameras, based on a change in the number of subjects faster and more efficiently conserves power and increases the time between battery charges.

Method 1000 occurs while the computer system (e.g., 600) is displaying (1002), via the one or more display generation components (e.g., 602), a camera user interface (e.g., 900 or 906) (e.g., an interface of a camera application) and before media capture has started (e.g., visual media capture using the one or more cameras, such as photo or video capture) based on a user input (e.g., such as an input directed to shutter affordance 900e) (e.g., made via the one or more input devices) requesting media capture (e.g., an input directed to a software shutter button and/or to a hardware button that operates as a shutter button): In some embodiments, computer system and/or a camera application of the camera user interface performs automatic media capture. Such automatically captured media can be, for example, used for a photo media mode where a sequence of limited duration is played back (e.g., in response to a user input such as a selection input or a movement input on a representation of the captured media) for a “live” effect, with the sequence including content from before and/or after a capture input is detected. Automatically captured media could also be used, for example, in later media editing and/or to perform corrective actions like image stabilization. For the purposes of the embodiments in FIGS. 9A-9J and method 1000, automatic media capture is not media capture based on a user input requesting media capture. In some embodiments, media capture refers to the capture of media for storage (e.g., locally at the computer system or remotely) and later viewing and/or playback, in contrast to data captured via the one or more cameras for other purposes such as auto-focusing, subject detection, ambient light detection, and/or the like.

The computer system detects (1004) (e.g., automatically, without user input, detecting based on one or more sensors such as via data from the one or more cameras) a change (e.g., an increase or decrease) in a number of subjects (e.g., as described with reference to FIGS. 9B, 9C, and 9E) (e.g., one or more persons, animals, and/or identified objects of interest) that are available to be captured via the one or more cameras (e.g., captured for inclusion in captured media); and In some embodiments, the change is a change in a number of subjects within a field-of-view of a currently active camera. In some embodiments, the change includes detecting a change based on data detected outside of a field-of-view that is currently being displayed in a live preview of content from the one or more cameras that is currently being displayed in the camera user interface. For example, while the live preview of content is displaying content equal to a 75° field-of-view of a selected camera, a change in the number of subjects is detected based on data corresponding to an area that is between 75° and 95° of the field-of-view of the selected camera or based on data from a second camera that has a wider field-of-view than the camera being used to present the live preview of content. In other words, the detected change in a number of subjects is based, at least in part, on changes occurring outside of the visual area shown in the live preview of content of the user camera interface.

In response to (e.g., automatically in response to) detecting the change in the number of subjects that are available to be captured via the one or more cameras, the computer system changes (1006) (e.g., increasing or decreasing) a zoom level for capturing media with the one or more cameras (e.g., as reflected in changes to 900a and/or 903 as described with reference to FIGS. 9B, 9C, and 9E) (e.g., a currently selected camera and/or a camera being used to generate at least a portion of field-of-view of a live preview of content). In some embodiments, changing a zoom level of at least the first camera includes changing a zoom level of a live preview of content of the camera user interface. In some embodiments, changing a zoom level of at least the first camera includes changing a zoom level at which media capture will occur in response to a user input made via the one or more input devices requesting media capture. In some embodiments, changing the zoom level includes digitally changing the zoom level (e.g., by including a subset of data captured by a respective camera of the one or more cameras in the live preview and/or in captured media). For example, digitally changing the zoom can include showing a 75° field-of-view from a camera that captures data from a 95° field-of-view. In some embodiments, changing the zoom level includes optically changing the zoom level. In some embodiments, optical zoom includes changing between different available prime cameras (e.g., prime lenses). In some embodiments, optical zoom includes changing the focal length of a zoom lens. In some embodiments, the first camera is a front-facing camera (e.g., a camera on the same side of a computer system as a display of the computer system). In some embodiments, the first camera is referred to as a selfie-camera as it typically faces the user of the computer system during normal operation of the computer system (e.g., when the user is holding the computer system in a position that allows for viewing of content on the display). Changing a zoom level for capturing media with the one or more cameras based on detecting a change in the number of subjects that are available to be captured via the one or more cameras performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to improper zooming that could exclude one or more subjects for media capture. Reducing the risk that a transient media capture opportunity is missed enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the camera user interface (e.g., 900 or 906) concurrently includes (in some embodiments, concurrently includes at the time the change in the number of subjects is detected) an automatic zoom mode user interface object (e.g., 900e) that, when enabled, causes the computer system to automatically switch between different zoom levels for capturing media with the one or more cameras when corresponding conditions are met (e.g., an automatic zoom mode affordance); and a manual zoom mode user interface object (e.g., 900f or 906a) that, when selected, changes between different zoom levels for capturing media with the one or more cameras based on user input (e.g., a manual zoom mode affordance).

In some embodiments, while automatic zoom mode is enabled for capturing media with the one or more cameras, the computer system detects, via the one or more input devices, a sequence of one or more inputs (e.g., 904b or 904i) directed to the manual zoom mode user interface object. In some embodiments, detecting via one or more input devices, such as touch-sensitive surfaces, hardware input devices (e.g., hardware buttons or rotatable input mechanisms), microphones, gesture input devices, air gesture input devices, and/or gaze input devices. In response to detecting the sequence of one or more inputs directed to the manual zoom mode user interface object: the computer system disables an automatic zoom mode (e.g., as discussed with reference to FIG. 9J) for capturing media with the one or more cameras, wherein the computer system, when in the automatic zoom mode, automatically changes the zoom level for capturing media with the one or more cameras of the computer system when a change in in a number of subjects that are available to be captured via the one or more cameras is detected; and the computer system changes (e.g., increasing or decreasing) a zoom level of for capturing media with the one or more of the cameras of the computer system (e.g., a currently selected camera and/or a camera being used to generate at least a portion of field-of-view of a live preview of content). In some embodiments, the second camera and the first camera are the same camera. In some embodiments, the input corresponding to the manual zoom mode user interface object is detected while the automatic zoom mode is enabled. Disabling an automatic zoom mode while also changing a zoom level for capturing media with the one or more cameras based on selection of a manual zoom mode user interface object reduces the number of inputs needed to perform a set of operations.

In some embodiments, the computer system detects, via the one or more input devices, a sequence of one or more inputs (e.g., 904a) directed to the automatic zoom mode user interface object; and In some embodiments, detecting via one or more input devices, such as touch-sensitive surfaces, hardware input devices (e.g., hardware buttons or rotatable input mechanisms), microphones, gesture input devices, air gesture input devices, and/or gaze input devices. In response to detecting the sequence of one or more inputs directed to the automatic zoom mode user interface object, the computer system disables (e.g., as described with reference to FIG. 9G) an automatic zoom mode without changing a zoom level for capturing media with the one or more cameras (e.g., the first camera, the second camera, and/or any camera) of the computer system (in some embodiments, without changing the zoom level of any camera of the one or more cameras), wherein the computer system, when in the automatic zoom mode, automatically changes the zoom level for capturing media with the one or more cameras when a change in in a number of subjects that are available to be captured via the one or more cameras is detected. Disabling an automatic zoom mode without changing a zoom level of a respective camera of the one or more cameras based on an input corresponding to the automatic zoom mode user interface object reduces the risk that the system will change (e.g., automatically) to a zoom level other than that intended by a user, as indicated by the user's selection of the automatic zoom mode user interface object. Doing so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, in accordance with a determination that an automatic zoom mode is enabled, the automatic zoom mode user interface object (e.g., 900e) is displayed with a first visual appearance (e.g., as seen in FIG. 9A) (e.g., with a first color, a first pattern, a first level of emphasis (e.g., bolding or highlighting), and/or at a first size), wherein the computer system, when in the automatic zoom mode, automatically changes the zoom level for capturing media with the one or more cameras when a change in in a number of subjects that are available to be captured via the one or more cameras is detected; and in accordance with a determination that the automatic zoom mode is not enabled, the automatic zoom mode user interface object is displayed with a second visual appearance (e.g., as seen in FIG. 9G), different from the first visual appearance. In some embodiments, when the automatic zoom mode user interface object is displayed with the first appearance, the manual zoom mode user interface object is not displayed with the first visual appearance (e.g., is displayed with the second visual appearance). In some embodiments, when the automatic zoom mode user interface object is displayed with the second appearance, the manual zoom mode user interface object is not displayed with the second visual appearance (e.g., is displayed with the first visual appearance).

In some embodiments, changing the zoom level for capturing media with the one or more cameras includes: in accordance with a determination that the change in the number of subjects that are available to be captured via the one or more cameras includes a first type of change in the number of subjects, changing the zoom level for capturing media with the one or more cameras to a first zoom level (e.g., zooming out as discussed with reference to FIG. 9B); and (in some embodiments, the first type of change includes an increase in the number of subjects, a decrease in the number of subjects, a change in which the subjects remaining available to be captured having a first spacing, and/or a change in which the subjects remaining available to be captured having a second spacing, different from the first spacing) in accordance with a determination that the change in the number of subjects that are available to be captured via the one or more cameras includes a second type of change in the number of subjects, changing the zoom level for capturing media with the one or more cameras to a second zoom level (e.g., zooming in as discussed with reference to FIG. 9C), that is different from the first zoom level. Changing the zoom level to different levels of zoom based on the type of change in the number of subjects performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to improper zooming that could exclude one or more subjects for media capture.

In some embodiments, the change in the number of subjects that are available to be captured via the one or more cameras is an increase in the number of subjects that are available to be captured via the one or more cameras; and changing the zoom level for capturing media with the one or more cameras includes decreasing the zoom level (e.g., zooming out as discussed with reference to FIG. 9B) (e.g., zooming out so as to increase the field-of-view used for media capture). In some embodiments, the zoom level is decreased to increase the available field-of-view so as to bring the increased number of subjects into frame for media capture. Decreasing the zoom (e.g., zooming out) when there is an increase in the number of subjects performs an operation when a set of conditions has been met without requiring further user input. Doing so also assists a user in properly composing media capture to accommodate a larger number of subjects, reducing the number of inputs needed to properly compose media capture. Doing so also reduces the risk that a transient media capture opportunity is missed due to improper zooming that could exclude one or more subjects for media capture.

In some embodiments, the change in the number of subjects that are available to be captured via the one or more cameras is a decrease in the number of subjects that are available to be captured via the one or more cameras; and changing the zoom level for capturing media with the one or more cameras includes increasing the zoom level (e.g., zooming in as discussed with reference to FIG. 9C) (e.g., zooming in so as to decrease the field-of-view used for media capture, thereby enlarging objects (e.g., subjects) within the field-of-view). In some embodiments, the zoom level is increased to increase the size of subjects in the captured media. Increasing the zoom (e.g., zooming in) when there is a decrease in the number of subjects performs an operation when a set of conditions has been met without requiring further user input. Doing so also assists a user in properly composing media capture to accommodate a smaller number of subjects, reducing the number of inputs needed to properly compose media capture. Doing so also reduces the risk that a transient media capture opportunity is missed due to improper zooming.

In some embodiments, while an automatic zoom mode is enabled, wherein the computer system, when in the automatic zoom mode, automatically changes the zoom level for capturing media with the one or more cameras when a change in in a number of subjects that are available to be captured via the one or more cameras is detected, the computer system detects, via the one or more input devices, a sequence of one or more inputs (e.g., 904a) that corresponds to a request to disable the automatic zoom mode; and In some embodiments, the request is detected via one or more input devices, such as touch-sensitive surfaces, hardware input devices (e.g., hardware buttons or rotatable input mechanisms), microphones, gesture input devices, air gesture input devices, and/or gaze input devices. In response to detecting the sequence of one or more inputs that corresponds to the request to disable the automatic zoom mode, the computer system disables the automatic zoom mode; while the automatic zoom mode is disabled, detecting a second change (e.g., an increase or decrease) in a number of subjects that are available to be captured via the one or more cameras. In response detecting the second change in the number of subjects that are available to be captured via the one or more cameras, the computer system maintains the current zoom level (e.g., as discussed with reference to FIG. 9H) for capturing media with the one or more cameras (e.g., forgoing changing the zoom level of the first camera). In some embodiments, maintaining the zoom level of all cameras of the one or more cameras. Maintaining a zoom level when a change in the in the number of subjects that are available to be captured via the one or more cameras when an automatic zoom mode is disabled through express user input provides users with greater control over features of the computer system. Doing so reduces the risk that the system will change (e.g., automatically) to a zoom level other than that intended by a user. Doing so also enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the camera user interface includes a respective manual zoom mode user interface object (e.g., 900f or 906a). The computer system detects, via the one or more input devices, a sequence of one or more inputs (e.g., 904b or 904i) directed to the respective manual zoom mode user interface object; and In some embodiments, detecting via one or more input devices, such as touch-sensitive surfaces, hardware input devices (e.g., hardware buttons or rotatable input mechanisms), microphones, gesture input devices, air gesture input devices, and/or gaze input devices. In response to detecting the sequence of one or more inputs directed to the respective manual zoom mode user interface object, the computer system changes (e.g., increasing or decreasing) a zoom level for capturing media with the one or more cameras (e.g., a currently selected camera and/or a camera being used to generate at least a portion of field-of-view of a live preview of content). In some embodiments, the third camera is the same as the first camera and/or the second camera. In some embodiments, the respective manual zoom mode user interface object is a zoom toggle that causes the zoom level to cycle between a predetermined set of zoom levels (e.g., between two predetermined zoom levels).

In some embodiments, changing the zoom level for capturing media with the one or more cameras includes displaying, via the one or more display generation components, an indication of a current zoom level (e.g., indications within 906a) (e.g., the zoom level to which the first camera is being changed). In some embodiments, A current zoom level is not displayed prior to changing the current zoom level and displaying the indication of the current zoom level includes initially displaying the indication. In some embodiments, displaying the indication of the current zoom level includes updating an existing indication of a zoom level from a first value (e.g., a value prior to detecting the change in the number of subjects) to a second value that indicates the changed value. Displaying an indication of a current zoom level provides improved feedback as to change in zoom level and the current zoom level.

In some embodiments, the indication of the current zoom level is a user-selectable interface object (e.g., indication within 906a). The computer system detects, via the one or more input devices, a sequence one or more user inputs that includes an input directed to the indication of the current zoom level; and In some embodiments, the first set of one or more user inputs is detected via one or more input devices, such as touch-sensitive surfaces, hardware input devices (e.g., hardware buttons or rotatable input mechanisms), microphones, gesture input devices, air gesture input devices, and/or gaze input devices. In some embodiments, the first set of one or more user inputs includes a tap, a swipe, and/or a sustained input that includes movement. In response to detecting the sequence of one or more user inputs that includes the input directed to the indication of the current zoom level, the computer system further changes the zoom level for capturing media with the one or more cameras. In some embodiments, further changing the zoom level includes a change that is the same as or different from changing the zoom level (e.g., the initial change is zooming in and the further change is zooming out).

In some embodiments, the subjects that are available to be captured via the one or more cameras does not include one or more detected individuals (e.g., 904) that meet non-subject criteria. In some embodiments, a detected individual meets non-subject criteria when the individual is facing in a specific direction (e.g., away from the camera), is only partially within the field-of-view, is at a certain distance (e.g., further than specific distance from the camera or further than a specific distance from one or more subjects (e.g., greater than 10 feet from the closest subject), and/or are in certain portions (e.g., an edge) of the field-of-view of the one or more cameras). While an automatic zoom mode is enabled and while a respective zoom level is set for capturing media with the one or more cameras, wherein the computer system, when in the automatic zoom mode, automatically changes the zoom level for capturing media with the one or more cameras when a change in in a number of subjects that are available to be captured via the one or more cameras is detected, the computer system detects a change in the number of detected individuals that meet non-subject criteria (in some embodiments, while not detecting a change in the number of subjects that are available to be captured via the one or more cameras). In response to detecting the change in the number of individuals that meet non-subject criteria, the computer system maintains the respective zoom level for capturing media with the one or more cameras (e.g., as discussed with reference to FIG. 9D). In some embodiments, individuals that are not subjects (e.g., individuals that meet non-subject criteria) do not affect zoom level when the computer system is in the automatic zoom mode, as such individuals (in contrast to subjects) are ignored for the purposes of automatically changing zoom. Maintaining the respective zoom level of the first camera when a change is detected in the number of individuals that meet non-subject criteria reduces the risk that the system will change (e.g., automatically) to a zoom level other than that intended by a user. Doing so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, while the one or more cameras (e.g., a first camera of the one or more cameras) is configured to capture media with a first aspect ratio and while the computer system is in a first orientation (e.g., being held in a portrait or a landscape orientation) (in some embodiments, and while displaying a live preview of content from the one or more cameras with the first aspect ratio), the computer system detects a third change in a number of subjects (e.g., as described with reference to FIG. 9E) that are available to be captured via the one or more cameras while the computer system remains in the first orientation (e.g., without detecting a change in the orientation of the computer system). In response to (e.g., automatically in response to) detecting the third change in the number of subjects that are available to be captured via the one or more cameras, the computer system changes (e.g., as described with reference to FIGS. 9E and 9F) the aspect ratio with which the one or more cameras are configured to capture media from the first aspect ratio to a second aspect ratio (e.g., portrait at 3:4 (width to height) or 16:9 to landscape at 4:3 or 9:16), different from the first aspect ratio. In some embodiments, further in response to detecting the third change in the number of subjects that are available to be captured via the one or more cameras, changing a zoom level for capturing media with the one or more cameras. In some embodiments, also changing an aspect ratio with which a live preview of content from the one or more cameras is displayed. Changing the aspect ratio with which the first camera is configured to capture media from the first aspect ratio to a second aspect ratio based on detecting a third change in the number of subjects that are available to be captured via the one or more cameras performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to an improper aspect ratio that could exclude one or more subjects for media capture.

In some embodiments, the camera user interface includes an aspect ratio user interface object (e.g., 900g) (e.g., an affordance for changing an aspect ratio). While the computer system is in a first orientation (e.g., being held in a portrait or a landscape orientation), the computer system detects an input (e.g., 904e) corresponding to the aspect ratio user interface object. In some embodiments, without detecting a change in the orientation of the computer system. In some embodiments, detecting via one or more input devices, such as touch-sensitive surfaces, hardware input devices (e.g., hardware buttons or rotatable input mechanisms), microphones, gesture input devices, air gesture input devices, and/or gaze input devices. In response to detecting the input corresponding to the aspect ratio user interface object, the computer system changes an aspect ratio with which the one or more cameras (e.g., the first camera of the one or more cameras) are configured to capture media (e.g., changing from a first aspect ratio to a second aspect ratio (e.g., portrait at 3:4 (width to height) or 16:9 to landscape at 4:3 or 9:16), different from the first aspect ratio). In some embodiments, also changing an aspect ratio with which a live preview of content from the one or more cameras is displayed. Changing an aspect ratio with which the first camera is configured to capture media while the system remains in a first orientation provides users with greater control over features of the computer system by allowing an aspect ratio change without having to reorient the system.

In some embodiments, the camera user interface includes a live preview of content (e.g., 900a) from the one or more cameras. In response to detecting the input corresponding to the aspect ratio user interface object, the computer system updates the live preview of content (e.g., changing an aspect ratio of the live preview of content in a manner that matches the change in aspect ratio with which the first camera is configured to capture media), wherein the updated live preview of content includes a preview of content that is not within the field-of-view of the one or more cameras (e.g., outside of the field of view of the first camera of the one or more cameras). For example, the live preview includes a at least portion of content from a field-of-view of a second camera of the one or more cameras that has a field-of-view that includes at least a portion that is outside the field-of-view of the one or more cameras. For example, the first camera is a wide angle camera and the second camera is an ultra-wide angle camera. In some embodiments, the live preview content includes a first portion of content that corresponds to the field-of-view of the first camera and a second portion of content that corresponds to the field-of-view of the second camera and that is outside the field-of-view of the first camera. In some embodiments, the first portion of content and the second portion of content are visually distinguishable from each other. Displaying an updated live preview of content includes a preview of content that is not within the field-of-view of the first camera provides improved feedback as to the change in aspect ratio and also assists users with composing media capture by providing additional visual context of a scene, outside of a the field-of-view of the first camera. Assisting users with composing media enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the aspect ratio user interface object (e.g., 900g), when selected via one or more successive inputs, causes the aspect ratio with which the one or more cameras (e.g., the first camera of the one or more cameras) capture media to cycle between a predetermined set of aspect ratios (e.g., to toggle between aspect ratios (e.g., between 2, 3, or 4 predetermined aspect ratios)).

In some embodiments, changing an aspect ratio with which the one or more cameras (e.g., the first camera of the one or more cameras) are configured to capture media includes: in accordance with a determination that a number of subjects that are available to be captured via the one or more cameras (e.g., at the time when the input corresponding to the aspect ratio user interface object is detected) is a first number of subjects (in some embodiments, and/or in accordance with the positions of subjects that are available to be captured via the one or more cameras), changing the an aspect ratio with which the one or more cameras (e.g., the first camera of the one or more cameras) are configured to capture media to a first changed aspect ratio (e.g., as discussed with reference to FIGS. 9E and 9F); and in accordance with a determination that a number of subjects that are available to be captured via the one or more cameras is a second number of subjects, changing the aspect ratio with which the one or more cameras (e.g., the first camera of the one or more cameras) are configured to capture media to a second changed aspect ratio, different from the first changed aspect ratio. In some embodiments, a wider aspect ratio is selected when there are a great number of subjects (e.g., the changed aspect ratio is 4:3 when there are two subjects and 16:9 when there are 3 subjects). In some embodiments, the changed aspect ratio is selected so as to include more and/or all available subjects within the captured media. Changing the aspect ratio with which the first camera is configured to capture media to a second changed aspect ratio based on a number of subjects that are available to be captured via the one or more cameras performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to an improper aspect ratio that could exclude one or more subjects for media capture.

In some embodiments, while displaying the camera user interface without the aspect ratio user interface object (e.g., 900g), detecting that a set of aspect-ratio-user-interface-object-display criteria are met. In response to detecting that the set of aspect-ratio-user-interface-object-display criteria are met, displaying (e.g., automatically without express user input requesting display), in the camera user interface, the aspect ratio user interface object (e.g., as discussed with reference to FIG. 9E), wherein the set of aspect-ratio-user-interface-object display criteria are met based at least on data from the one or more cameras (e.g., based on data indicating a change in a scene captured by the one or more cameras, such as changes in the number and/or position of subjects that are available to be captured via the one or more cameras). Displaying (e.g., automatically without express user input requesting display), in the camera user interface, the aspect ratio user interface object in response to detecting that the set of aspect-ratio-user-interface-object display criteria are met performs an operation when a set of conditions has been met without requiring further user input. Doing so also provides improved feedback as the criteria being met.

In some embodiments, in response to detecting the change in the number of subjects that are available to be captured via the one or more cameras, the computer system changes a framing with which the one or more cameras (e.g., the first camera of the one or more cameras) capture media (e.g., as discussed with reference to FIG. 9C) (e.g., panning (e.g., left or right) the framing of the first camera so as to include different portions of the environment within captured media). In some embodiments, the change in framing is a digital framing/panning effect. For example, the first camera could be initially framed using a first subportion of the field-of-view of the first camera and changing the framing includes using a second subportion that does not overlap the first subportion, at least in part. In some embodiments, the change in framing is selected so as to bring one or more subjects into the frame of the first camera so as to include the one or more subjects in captured media. Changing a framing with which the first camera captures media in response to detecting the change in the number of subjects that are available to be captured via the one or more cameras performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to an improper framing that could exclude one or more subjects for media capture.

In some embodiments, changing the zoom level for capturing media with the one or more cameras occurs prior to detecting a request (e.g., any request) to capture media (e.g., prior to detecting 904c or 904d) that is based on a user input requesting media capture while the camera user interface is displayed (e.g., after initially displaying the camera user interface). In some embodiments, the change occurs before any user input (e.g., express user input such as selection of an affordance or a button) is received after the camera user interface is first displayed/invoked.

In some embodiments, detecting the change in the number of subjects that are available to be captured via the one or more cameras is based, at least in part, on data (e.g., camera data and/or scene data) that is detected outside of a field-of-view that is currently being displayed in a respective live preview of content from the one or more cameras that is currently being displayed in the camera user interface (e.g., as discussed with reference to FIGS. 9D and 9E). In some embodiments, while the live preview of content is displaying content equal to a 75° field-of-view of a selected camera, a change in the number of subjects is detected based on data corresponding to an area that is between 75° and 95° of the field-of-view of the selected camera or based on data from a second camera that has a wider field-of-view than the camera being used to present the live preview of content. In other words, the detected change in a number of subjects is based, at least in part, on changes occurring outside of the visual area shown in the live preview of content of the user camera interface. Changing a zoom level for capturing media with the one or more cameras based on detecting a change in the number of subjects that are available to be captured via the one or more cameras based, at least in part, on data (e.g., camera data and/or scene data) that is detected outside of a field-of-view that is currently being displayed in a respective live preview of content from the one or more cameras that is currently being displayed in the camera user interface performs an operation when a set of conditions has been met without requiring further user input. Doing so also assists a user in properly composing media capture to accommodate a varying number of subjects, reducing the number of inputs needed to properly compose media capture. Doing so also reduces the risk that a transient media capture opportunity is missed due to improper zooming that could exclude one or more subjects for media capture.

Note that details of the processes described above with respect to method 1000 (e.g., FIG. 10) are also applicable in an analogous manner to the methods described above/below. For example, method 1000 optionally includes one or more of the characteristics of the various methods described herein with reference to methods 700, 800, 1200, 1400, 1500, 1600 and/or 1800. For example, the detected change in subject can occur while displaying a user interface in accordance with methods 700, 800, 1200, 1400, 1500, 1600 and/or 1800. For brevity, these details are not repeated below.

FIGS. 11A-110 illustrate exemplary user interfaces for capturing media concurrently with two sets of cameras, in accordance with some embodiments. The user interfaces in these figures are used to illustrate the processes described below, including the process in FIG. 12.

FIG. 11A illustrates, on the left, device 600 displaying camera user interface 1100. Camera user interface 1100 includes various selectable user interface objects and indicators for configuring media capture functions and features, capturing media, and reviewing and/or editing captured media. In some embodiments, camera user interface 1100 includes one or more features and/or user interface objects, described with respect to camera user interface 614 and/or camera user interface 900. For example, in the embodiment of FIGS. 11A-110, camera user interface 1100 includes camera preview 614a that is a representation of the environment (e.g., a tennis court with subject 1100a1 in the foreground) as captured by one or more of the rear facing cameras of device 600 (e.g., rear facing cameras 606A, 606B, and/or 606C). As seen in FIG. 11A, camera preview 614a spans the surface of display 602, showing content at each of the four edges of the display. In some embodiments, while camera preview 900a includes a representation of the environment from the top edge of display 602 to the bottom edge of display 602, portions (e.g., at the top and bottom of the display) are presented with a different visual appearance (e.g., a gray mask) to indicate that those portions will not be included in captured media. In some embodiments, the size and/or dimensions of the portions that are presented with the different visual appearance are based on a currently selected aspect ratio (e.g., a 4:3 aspect ratio would have larger portions at the top and bottom excluded from captured media than if a 16:9 aspect ratio were selected). Camera user interface 1100 also includes shutter affordance 614b that is a software button that can be selected to initiate the capture of media in a currently selected capture mode using one or more current settings. Camera user interface 1100 also includes zoom affordance 1100a that is a control for changing the capture magnification and/or switching between cameras/lenses with different magnifications; at FIG. 11A, zoom affordance 1100a indicates that the current zoom level is 1× (e.g., the 1× indicator is enlarged relative to the 0.5×, 2×, and 5× indicators where 1× indicates a respective zoom level, 0.5× indicates a zoom level that is ½ of the respective zoom level, 2× indicates a zoom level that is twice the respective zoom level, and 5× indicates a zoom level that is five times the respective zoom level). Captured media affordance 614d is a selectable thumbnail icon that previews captured media and can be selected to view and/or edit captured media (e.g., in a media viewing or media library user interface). Camera selection affordance 614e is a software button for switching between primarily capturing using one or more rear (e.g., environment-facing, such as rear facing cameras 606A, 606B, and/or 606C) cameras and using a front (e.g., user-facing) camera (e.g., camera 606). Camera user interface 1100 also includes capture mode selector 1100b that indicates a current capture mode (video in FIG. 11A) and that can be used to change a capture mode. In some embodiments, camera user interface 1100 includes mode option affordance 614i (e.g., as seen in FIG. 6B) or mode option affordance 1300a (e.g., as seen in FIG. 13B). At FIG. 11A, because device 600 is currently configured to capture video media, camera user interface 1100 includes one or more video-related user interface objects, such as recording time indicator 1100c (currently showing zero recording time, as capture has yet to be initiated) and capture resolution and frame rate indicator 1100d (currently indicating high definition resolution at 30 frames per second).

In some embodiments, one or more of the user interface objects in camera user interface 1100 are displayed with a simulated glass appearance, such that the object(s) appear to be made of, or include, a simulated glass material that is translucent or transparent. In such embodiments, the appearance of the object(s) changes as content below the object(s) changes. For example, zoom affordance 1100a, which is overlaid on camera preview 614a, can have a simulated glass appearance that would result in the appearance of zoom affordance 1100a changing as the representation of the environment under zoom affordance 1100a changes (e.g., due to movement of device 600 or movement of elements within the environment, such as movement of subject 1100a1). In some embodiments, one or more of the user interface objects in camera user interface 1100 are translucent in a manner similar to that discussed with reference to certain user interface objects (e.g., shutter affordance 900b) of FIG. 9A.

At FIG. 11A, camera user interface 1100 includes multi-camera affordance 1100e that can be selected to configure device 600 and user interface 1100 to capture media using multiple cameras (e.g., cameras that face in different directions) at once. Camera user interface 1100 also includes tracking mode affordance 1100f that indicates a current status (e.g., enabled as indicated in FIG. 9A) of an automatic subject tracking mode and is also selectable to modify the status of that mode. The automatic subject tracking mode, when enabled, causes device 600 to modify a zoom level and/or modify the content (e.g., by panning) that is displayed in camera preview 614a and captured in media (e.g., based on selection of shutter affordance 614b). While capturing media with multiple cameras, the automatic subject tracking mode that is controlled via tracking mode affordance 1100f can utilize different criteria (e.g., different logic) for tracking management for different cameras. For example, when device 600 is configured to capture media with at least one back facing camera and at least one front facing camera (e.g., camera 606), the automatic subject tracking mode includes a first tracking mode that is used for capturing media with the back facing camera, that first tracking mode having a first set of one or more rules for changing a current framing (e.g., zoom level and/or portion of available camera field-of-view that is captured) of the back facing camera. Similarly, the automatic subject tracking mode includes a second tracking mode that is used for capturing media with the front facing camera, that second tracking mode having a second set of one or more rules for changing a current framing of the front facing camera. In some embodiments, the automatic subject tracking mode that is controlled via tracking mode affordance 1100f includes one or more features of the automatic tracking mode that is controlled by tracking mode affordance 900e (e.g., FIG. 9A).

FIG. 11A, on the right at the bottom, includes back facing environment schematic 1101 which depicts a portion of the physical environment that is within the field-of-view of one or more back facing cameras of device 600. Selected portion 1101a (e.g., the portion within the dashed line) is the portion of the physical environment that is currently represented by camera preview 614a and that will be captured as media (e.g., captured based on selection of shutter affordance 614b). At FIG. 11A, selected portion 1101a does not include certain portions of the physical environment (e.g., umpire chair 1105a) that are in the field-of-view of one or more back facing cameras of device 600, as device 600 is currently configured to capture media that does not include those portions of the physical environment. At FIG. 11A, selected portion 1101a does include subject 1100a1, who is also visible in preview 614a.

FIG. 11A, on the right at the top, includes front facing environment schematic 1103 which depicts a portion of the physical environment that is within the field-of-view of one or more front facing cameras of device 600. Because device 600 is not currently configured to capture media using one or more front facing cameras of device 600a, front facing environment schematic 1103 does not include a selected portion, at FIG. 11A.

At FIG. 11A, device 600 detects input 1102a (e.g., a tap gesture) directed to multi-camera affordance 1100e. In some embodiments, input 1102a and/or one or more of the inputs discussed with reference to the embodiment of FIGS. 11A-110, discussed below, is a touch gesture (e.g., a tap, a swipe, or touch-and-hold), an air gesture (e.g., an air tap or air pinch), or a selection input (e.g., via a hardware input mechanism such as a button) that is detected while a respective user interface element (e.g., multi-camera affordance 1100e) is selected and/or is in focus.

At FIG. 11B, device 600, in response to detecting input 1102a, displays inset preview 1100g in camera user interface 1100. Inset preview 1100g is a representation of the environment (e.g., an outdoor environment with subject 1100a2 standing in front of sign 1105b that reads “TENNIS CT B”) as captured by one or more of the front facing cameras of device 600, such as front facing camera 606. In the embodiment of FIG. 11A-110, inset preview 1100g provides a preview of content that will be included in media that will be captured via one or more front facing cameras of device 600 simultaneously with content that will be included and that is captured via one or more back facing cameras of device 600, as previewed in preview 614b.

At FIG. 11B, back facing environment schematic 1101 includes tracking bounds indicator 1101b and tracked content indicator 1101c. Tracked content 1101c indicates a subject and/or object that device 600 is currently tracking (e.g., tracking via one or more image processing algorithms) in order to implement the first set of one or more rules for changing the current framing of the back facing camera. In the embodiment of FIGS. 11A-110, device 600 will change the current framing of the back facing camera when tracked content 1101c shifts outside of the bounds of tracking bounds indicator 1101b (e.g., when a portion of tracked content 1101c shifts outside of tracking bounds indicator 1101b or when the entirety of tracked content 1101c shifts outside of tracking bounds indicator 1101b). Similarly, front facing environment schematic 1103 includes tracking bounds indicator 1103b and tracked content indicator 1103c. Tracked content 1103c indicates a subject and/or object that device 600 is currently tracking (e.g., tracking via one or more image processing algorithms) in order to implement the second set of one or more rules for changing the current framing of the front facing camera. In the embodiment of FIGS. 11A-110, device 600 will change the current framing of the back facing camera when tracked content 1103c shifts outside of the bounds of tracking bounds indicator 1103b (e.g., when a portion of tracked content 1103c shifts outside of tracking bounds indicator 1103b or when the entirety of tracked content 1103c shifts outside of tracking bounds indicator 1103b). As depicted in FIG. 11B, the first set of rules for the back facing camera uses different tracking logic than the second set of rules for the front facing camera. For example, the front facing camera is biased towards tracking faces (e.g., because front facing cameras are often used for taking “selfies” of a user of device 600) while the back facing camera is tracking the entirety of the body of subject 1100a1 (e.g., because the back facing cameras are often used for capturing action, such as a tennis match). Additionally, as shown in FIG. 11B, tracking bounds indicator 1101b is closer in size to tracked content indicator 1101c in comparison to the relative sizes of tracking bounds indicator 1103b and tracked content indicator 1103c. Accordingly, a greater degree of movement of the content tracked by the front facing camera is required before device 600 adjust current framing of the back facing camera, as compared to the degree of movement of the content tracked by the back facing camera that will result in device 600 adjusting the framing of the back facing camera. In some embodiments, device 600 displays representations corresponding to one or more of tracking bounds indicator 1101b, tracking bounds indicator 1103b, tracked content indicator 1101c, and tracked content indicator 1103c in camera user interface 1100.

At FIG. 11B, device 600 detects input 1102b (e.g., a tap gesture) directed to shutter affordance 614b. In response to input 1102b, device 600 begins capturing media (e.g., a video) that includes the content shown in preview 614a from the back facing camera and includes the content shown in preview 1100g from the front facing camera. In some embodiments, the captured media is stored as two separate video streams and/or files, one from the back facing camera content and one for the front facing camera content. In some embodiments, a single video stream and/or file is stored, with content from one camera (e.g., the front facing camera) embedded (e.g., as an overlay) along with the content of the other camera (e.g., the back facing camera). Device 600 also detects input 1102b1 (e.g., a tap gesture) directed to camera selection affordance 614e, the result of which is discussed with reference to FIG. 11K.

At FIG. 11C, subject 1102a1 has moved forwards while video media capture continues. As shown in back facing environment schematic 1101. As result, a majority of tracked content indicator 1101c is now outside of tracking bounds indicator 1101b. On the left side of FIG. 11C, the forward movement of subject 1102a1 has caused the subject to partially outside of the content shown in preview 614a, which is also shown by selected portion 1101a. The position of user 1102a2 remains unchanged, as shown by preview 1100g and selected portion 1103a.

At FIG. 11D, in response to tracked content indicator 1101c moving outside of tracking bounds indicator 1101b, device 600 changes the current framing of back facing camera by both zooming out (e.g., as indicated by the updated status of zoom indicator 1100a) and panning to the right. As a result, subject 1100a1 is brought back towards the center of preview 614. Device 600 also sets an updated position for tracking bounds indicator 1101b, based on the updated position of the content within tracking bounds indicator 1101b. In some embodiments, device 600 employs one or more algorithms to predict or extrapolate the movement of tracked content and adjusts the current framing of a camera prior to the content (e.g., subject 1100a1) moving outside of preview 614a and selected portion 1101a. As shown in FIG. 11D, device 1100 has not adjusted the current framing of the front facing camera, as subject 1100a2 has not moved.

At FIG. 11E, device 600 has adjusted the current framing of the front facing camera, as subject 1100a2 has moved such that content indicator 1103c moved outside of tracking bounds indicator 1103b, as tracking bounds indicator 1103b was shown in FIG. 11C (e.g., subject 1102a2 moved a first amount to the subject's left and then moved a second amount back to their right). Specifically, device 600 has panned to the right, as shown by the updated states of preview 1100g and selected portion 1103a. As a result, subject 1102a2 remains substantially in the center of preview 1100g and selected portion 1103a. As shown in FIG. 11E, device 1100 has not adjusted the current framing of the back facing camera, as subject 1100a1 has not moved. Thus, as illustrated in FIGS. 11C-11E, device 600 can adjust the framing of the front facing camera independently from adjusting the framing of the back facing camera and can also do so based on different sets of rules for adjusting framing. Device 600 detects input 1102c (e.g., a tap gesture) directed at multi-camera affordance 1100e.

At FIG. 11F, on the left, in response to detecting input 1102c, device 600 updates preview 614a to display content from the front facing camera of device 600, removes preview 1100g, and configures camera user interface 1100 to capture media using the front facing camera of device 600, without capturing media using the one or more back cameras of device 600. At FIG. 11F, on the left, device 600 detects input 1102d (e.g., a tap gesture) directed to multi-camera affordance 1100e. At FIG. 11F, in the middle, in response to detecting input 1102d, device 600 updates preview 614a to display content from the back facing camera of device 600, without displaying preview 1100g (e.g., camera user interface 1100 is returned to the layout shown in FIG. 11A), and configures camera user interface 1100 to capture media using the back facing camera of device 600, without capturing media using the one or more front cameras of device 600. At FIG. 11F, in the middle, device 600 detects input 1102e (e.g., a tap gesture) directed at multi-camera affordance 1100e. At FIG. 11F, on the right, in response to detecting input 1102e, device 600 re-displays preview 1100g, with content from the front facing camera of device 600; preview 614a continues to display content from the back facing camera (e.g., camera user interface 1100 is returned to the layout shown in FIG. 11B). Further in response to input 1102e, device 600 configures camera user interface 1100 to capture media using both the front and back facing camera. Thus, as shown in FIG. 11F, multi-camera affordance 1100e can be used to cycle through a set of capture and preview options for the one or more front cameras, one or more back cameras, or both. In some embodiments, the sequence is in a different order than that shown in FIG. 11F and/or include more or less options (e.g., the sequence can include an option where preview 614a is based on the one or more front cameras and preview 1100g is based on the one or more back cameras). At FIG. 11F, on the right, device 600 detects input 1102e1 (e.g., a diagonal swipe) directed at preview 1100g and input 1102e2 (e.g., a downward swipe) directed at preview 1100g.

At FIG. 11F1, on the left, in response to input 1102e1, device 600 moves preview 1100g based on a direction of input 1102e1 (e.g., diagonally down and to the right), while maintaining display of preview 614a. While moving preview 1100g, device 600 applies a visual effect, specifically a motion blur effect in the embodiment of FIG. 11F1, to preview 1100g while preview 1100g is in motion; the visual effect reduces the fidelity of the content in preview 1100g while preview 1100g is in motion and optionally introduces visual distortion of the content that is direction-dependent (e.g., motion blur streaks that extend along the direction of motion of the preview). As shown in FIG. 11F1, one or more visual characteristics of the visual effect is based on a characteristic (e.g., direction, speed, and/or acceleration) of the movement and/or the input. For example, a streaking visual component of the motion blur is based on the direction and speed of the movement (e.g., the image appears to leave a trail opposite from the direction of movement). At FIG. 11F1, on the right, device 600 ceases to move preview 1100g and also ceases to apply the visual effect (e.g., motion blur effect) to preview 1100g.

FIG. 11F2, on the left, in response to input 1102e2, device 600 moves preview 1100g based on a direction of input 1102e2 (e.g., down), while maintaining display of preview 614a. While moving preview 1100g in response to input 1102e, device 600 applies a visual effect, specifically a motion blur effect in the embodiment of FIG. 11F2, to preview 1100g while preview 1100g is in motion; the visual effect reduces the fidelity of the content in preview 1100g while preview 1100g is in motion and optionally introduces visual distortion of the content that is direction-dependent (e.g., motion blur streaks that extend along the direction of motion of the preview). As shown in FIG. 11F2, one or more visual characteristics of the visual effect is based on a characteristic (e.g., direction, speed, and/or acceleration) of the movement and/or the input. For example, a streaking visual component of the motion blur is based on the direction and speed of the movement (e.g., the image appears to leave a trail opposite from the direction of movement). At FIG. 11F2, in contrast to FIG. 11F1, the streaking visual component is opposite the downwards direction, rather than opposite the down and to the right diagonal direction, as is the case in FIG. 11F1. At FIG. 11F2, on the right, device 600 ceases to move preview 1100g and also ceases to apply the visual effect (e.g., motion blur effect) to preview 1100g.

FIG. 11G illustrates camera user interface 1100 with the same interface layout as shown in FIG. 11B (e.g., with preview 1100g showing content from the one or more front cameras of device 600). In FIG. 11G, subject 1102a3 has entered the field-of-view of one or more front facing cameras of device 600, as reflected in preview 1100g and selected portion 1103a of front facing environment schematic 1103. Device 600 tracks each subject as different content, as indicated by the addition of tracked content indicator 1103e that corresponds to subject 1102a3 and tracking bounds indicator 1103d. In some embodiments, device 600 tracks subject 1102a3 separately, but generates and monitors a single common tracking bounds indicator based on the locations of both tracked content indicator 1103c (e.g., for subject 1102a2) and tracked content indicator 1103e (e.g., for subject 1102a3). In such embodiments, device 600, adjust the current framing of the one or more back cameras of device 600 if either tracked content indicator 1103c or tracked content indicator 1103e moves outside of the common tracking bounds indicator.

At FIG. 11G, individual 1106 has entered the field-of-view of the one or more back facing cameras of device 600. In some embodiments, while device 600 detects (e.g., identifies) individual 1106 and, via image processing techniques, and recognizes individual 1106 as a person, device 600 does not identify individual 1106 as a potential subject for the purpose of potentially adjusting the framing of the one or more back facing cameras of device 600. In some embodiments, device 600 does not identify individual 1106 as a subject for the purposes of the automatic subject tracking mode because individual 1106 is not facing the one or more back cameras of device 600 and/or because individual 1106 is determined to be less than a predetermined distance from device 600 (e.g., because device 600 is currently tracking content in a mid-ground region rather than a foreground region), and/or because individual 1106 is more than a predetermined distance from one or more existing subjects (e.g., for subject 1102a1). As a result of individual 1106 not being identified as a subject for the purposes of the automatic subject tracking mode, device 600 does not adjust the current framing of the one or more back cameras, even though individual 1106 is currently not in frame, as shown by preview 614a and selected portion 1101a.

At FIG. 11G, device 600 detects input 1102f (e.g., a tap gesture) directed at tracking mode affordance 1100f and input 1102g (e.g., a tap gesture) directed to shutter affordance 614b. In response to detecting input 1102f, device 600 disables the automatic subject tracking mode associated with tracking mode affordance 1100f. In response to detecting input 1102g, device 600 stops recording the video initiated by input 1102b (e.g., in FIG. 11B).

At FIG. 11H, device 600 displays camera user interface 1100 with the automatic subject tracking mode associated with tracking mode affordance 1100f disabled. Captured media affordance 614d has been updated with a representation of the video that was captured in response to input 1102b (e.g., in FIG. 11B). Accordingly, device 600 is not adjusting the current framing of either the one or more front cameras or one or more back cameras of device 600 based on the tracked positions of subjects. Accordingly, back facing environment schematic 1101 and front facing environment schematic 1103 do not include tracked content indicators or tracking bounds indicators. In some embodiments, device 600 continues to identify and track subjects, but device 600 does not adjust camera framings automatically based on that tracking, while the automatic subject tracking mode associated with tracking mode affordance 1100f is disabled. For example, at FIG. 11H, subject 1102a1 moved partially outside of preview 614a and selected portion 1101a, but device 600 does not reframe the one or more back facing cameras. Similarly, subject 1102a2 has moved partially outside of preview 1100g and selected portion 1103a, but device 600 does not reframe the one or more front facing cameras.

FIG. 11I illustrates camera user interface 1100 with the same interface layout as shown in FIG. 11B (e.g., with preview 1100g showing content from the one or more front cameras of device 600). The automatic subject tracking mode associated with tracking mode affordance 1100f has been re-enabled, as indicated by the state of tracking mode affordance 1100f. Device 600 detects input 1102h (e.g., a tap gesture) at photo indicator 1100b1 of capture mode selector 1100b.

At FIG. 11J, device 600, in response to detecting input 1102h, configures camera user interface 1100 to capture media in a photo mode, as indicated by the updated state of capture mode selector 1100b, including ceasing to display one or more video-related user interface objects (e.g., recording time indicator 1100c) and displays one or more photo-related user interface objects (e.g., “live” effect indicator 614g2 that is discussed in more detail with reference to FIG. 6B). Further in response to detecting input 1102h, device 600 ceases to display multi-camera affordance 1100e and tracking mode affordance 1100f. Device 600 ceases to display multi-camera affordance 1100e because, in the embodiment of FIGS. 11A-110, a photo capture mode is not configured to capture media from both the one or more front cameras and the one or more back cameras of device 600, simultaneously. In some embodiments, device 600 is capable of capturing media from both the one or more front cameras and the one or more back cameras of device 600, while in a photo mode. Similarly, ceases to display multi-camera affordance 1100e because, in the embodiment of FIGS. 11A-110, the subject tracking mode associated with tracking mode affordance 1100f is not available in a photo capture mode. In some embodiments, the subject tracking mode associated with tracking mode affordance 1100f is available in a photo capture mode.

At FIG. 11K, device 600, in response to detecting input 1102b1 (e.g., in FIG. 11B), updates camera user interface 1100 to use content from the one or more front cameras in preview 614a and content from the one or more back cameras in preview 1100g and updates camera user interface 1100 to capture media, accordingly. Back facing environment schematic 1101 and front facing environment schematic 1103 and selected portion 1101a and selected portion 1103a reflect the updated configuration of camera user interface 1100.

FIGS. 11L1 and 11L2 depict alternative layouts for camera user interface 1100, while displaying preview 1100g (e.g., alternatives to the layout of FIG. 11B). At FIG. 11L1 on the left, preview 614a and preview 1100g are displayed at the same size. At FIG. 11L1 on the right, preview 1100g is displayed in the upper right hand corner of camera user interface 1100, rather than in the upper left hand corner, as seen in FIG. 11B. At FIG. 11L2 on the left, preview 1100g is displayed in camera user interface 1100 as a bordered circle near the lower right corner. At FIG. 11L2 on the right, preview 1100g is borderless and some of the content captured by the one or more front cameras of device 600 is displayed as overlaying the content of preview 614a. In some embodiments, a user can select a desired layout (e.g., from the layouts of FIG. 11B, 11L1, or 11L2) via one or more settings interfaces. In some embodiments, device 600 cycles through the layouts of FIG. 11B, 11L1, or 11L2 based on a selection of an affordance (e.g., selection of multi-camera affordance 1100e).

FIG. 11M illustrates one example of how representations of media (e.g., video media) that is captured using camera user interface 1100 can be displayed (e.g., in a media viewer application or media gallery application or in a messaging application). FIG. 11M on the left, illustrates device 600 displaying text messaging user interface 1110. The user of device 600 is having an ongoing text conversation with contactable user “Christian”, with a message from Christian (“How was the tennis match?”) displayed on the left hand side of message transcript 1110a. In response to Christian's inquiry, the user of device 600 has sent the text reply, “Check this out!”, as seen on the right hand side of message transcript 1110a. The user of device 600 has also attached two pieces of media, a standard photo 1112 (e.g., a photo captured using just the one or more back facing cameras of device 600) and the video captured using camera user interface 1100 in response to input 1102b (e.g., in FIG. 11B), which is represented by video representation 1114a. At FIG. 11M on the left, video representation 1114a includes a thumbnail based on content from the one or more back facing cameras of device 600 (e.g., a thumbnail of content similar to what is seen in preview 614a of FIG. 11B). While displaying text messaging user interface 1110, device 600 detects input 1102i (e.g., a tilt gesture where the orientation of device 600 is rotated around its long axis). At FIG. 11M on the right, device 600, in response to detecting input 1102i, updates video representation 1114a to include a thumbnail based on content from the one or more front facing cameras of device 600 (e.g., a thumbnail of content similar to what is seen in preview 1100g of FIG. 11B). As illustrated in FIG. 11M, a user of device 600 can alternate between viewing video representation 1114a with the back- or front-facing thumbnails by rotating or tilting device 600. In some embodiments, device 600 provides a haptic and/or audio output when alternating between the two thumbnails.

FIGS. 11N1 and 11N2 illustrate another embodiment of how the video captured using camera user interface 1100 in response to input 1102b (e.g., in FIG. 11B) can be represented (e.g., represented in a media viewer application or media gallery application or in a messaging application). At FIG. 11N1, on the left, device 600 displays video representation 1114a with the appearance of a stylized locket in a closed state having a thumbnail based on content from the one or more back facing cameras of device 600 (e.g., a thumbnail of content similar to what is seen in preview 614a of FIG. 11B) on the front. In some embodiments, video representation 1114a includes no thumbnail (e.g., has a plain, locket cover) or has a thumbnail based on content from the one or more front facing cameras of device 600 (e.g., a thumbnail of content similar to what is seen in preview 1100g of FIG. 11B). At FIG. 11N1 on the left, while video representation 1114a appears as a closed locket, device 600 detects input 1102j (e.g., a tap) directed to video representation 1114a and input 1102k (e.g., a tilt gesture where the orientation of device 600 is rotated around its long axis). At FIG. 11N1 on the right, device 600, in response to detecting input 1102j and/or input 1102k, updates the appearance of video representation 1114a to show an animation of the locket opening. The animation includes showing video representation 1114 having thumbnail 1114a2 based on content from the one or more front facing cameras of device 600 (e.g., a thumbnail of content similar to what is seen in preview 1100g of FIG. 11B) on the inside of the cover of the locket and thumbnail 1114a1 based on content from the one or more back facing cameras of device 600 (e.g., a thumbnail of content similar to what is seen in preview 614a of FIG. 11B) inside the body of the locket. FIG. 11N2 on the left shows the animation continuing with the cover of the locket continuing to open further, revealing a more face-on view of thumbnail 1114a2 on the inside cover of the locket. FIG. 11N2 on the right, shows video representation 1114 after the animation has completed and the locket has fully opened to show full views of thumbnail 1114a1 and thumbnail 1114a2. In some embodiments, device 600 provides a haptic and/or audio output while displaying the animation of the locket opening.

FIG. 11O illustrates another embodiment of how the video captured using camera user interface 1100 in response to input 1102b (e.g., in FIG. 11B) can be represented (e.g., represented in a media viewer application or media gallery application or in a messaging application). At FIG. 11O, on the left, device 600 displays video representation 1114 with a sub-representation 1114b1 that includes content from the one or more front facing cameras of device 600 overlaid on the lower left corner of sub-representation 1114b2 that includes content from the one or more back facing cameras of device 600. At FIG. 11O on the left, device 600 detects input 11021 (e.g., a tap input) directed to video representation 1114. At FIG. 11O on the right, device 600, in response to detecting input 1102l, updates the appearance of video representation 1114 so that sub-representation 1114b1 is now overlaid on the upper right corner of sub-representation 1114b2. In some embodiments, device 600 provides a haptic and/or audio output in response to detecting input 11021 (e.g., and based on movement of sub-representation 1114b1 to the upper right corner of sub-representation 1114b2).

FIG. 12 is a flow diagram illustrating a method for capturing media concurrently with two sets of cameras, in accordance with some embodiments. Method 1200 is performed at a computer system (e.g., 100, 300, 500, and/or 600) that is in communication with one or more input devices (e.g., 602) (e.g., touch-sensitive surfaces, hardware input devices (e.g., hardware buttons or rotatable input mechanisms)), microphones, gesture input devices, air gesture input devices, and/or gaze input devices), one or more display generation components (e.g., 602) (e.g., a display controller; a touch-sensitive display system; a display (e.g., integrated and/or connected), a 3D display, a transparent display, a projector, and/or a heads-up display), and a plurality of cameras (e.g., one or more front (user-facing) cameras, rear (environment-facing) cameras, and/or externally-connected cameras, and/or a plurality of cameras with different lenses (e.g., different fixed focal lengths), such as a standard camera, a telephoto camera, a wide-angle camera, and/or a macro camera) that includes a first set of one or more cameras (e.g., rear facing cameras 606A, 606B, and/or 606C) that face a first direction and a second set of one or more cameras (e.g., 606) that face a second direction, different from the first direction. In some embodiments, the first direction is opposite the second direction. In some embodiments, one or more cameras of the first set of one or more cameras is referred to as a back-facing or rear-facing camera (e.g., because it is positioned on a side opposite a display of the computer system and/or because it faces away from a user of the computer system while the computer system is being operated in a typical manner. In some embodiments, one or more cameras of the second set of one or more cameras is referred to as a front-facing camera and/or a selfie-camera as it typically faces the user of the computer system during normal operation of the computer system (e.g., when the user is holding the computer system in a position that allows for viewing of content on the display). Some operations in method 800 are, optionally, combined, the orders of some operations are, optionally, changed, and some operations are, optionally, omitted.

As described below, method 1200 provides an intuitive way for capturing media concurrently with two sets of cameras. The method reduces the cognitive burden on a user for capturing media concurrently with two sets of cameras, thereby creating a more efficient human-machine interface. For battery-operated computing devices, enabling a user to capture media concurrently with two sets of cameras faster and more efficiently conserves power and increases the time between battery charges.

The computer system (e.g., 600), while displaying (1202), via the one or more display generation components, a camera user interface (e.g., 1100), detects (1204), via the one or more input devices (e.g., 602), a sequence of one or more inputs that correspond to a request (e.g., an input directed to a software shutter button and/or to a hardware button that operates as a shutter button) to capture (e.g., record) media (e.g., photo and/or video media) with both the first set of one or more cameras (e.g., one or more back facing cameras of device 600) and the second set of one or more cameras (e.g., 606) (e.g., via single capture request input that causes capture to occur using both the first set of one or more cameras and the second set of one or more cameras concurrently). In some embodiments, the camera user interface includes a first live preview of content from at least one camera of the first set of one or more cameras. In some embodiments, the camera user interface concurrently includes the first live preview of content and a second live preview of content from at least one camera of the second set of one or more cameras.

In response to detecting the request to capture media (e.g., concurrently capture media) with both the first set of one or more cameras and the second set of one or more cameras, the computer system captures (1206) media concurrently with the first set of one or more cameras (e.g., one or more back facing cameras of device 600) and the second set of one or more cameras (e.g., 606).

A first tracking mode is used for capturing media with the first set of one or more cameras (1208). The first tracking mode includes a first set of one or more rules (e.g., discussed with reference to FIG. 11B) for changing a current framing of the first set of one or more cameras (e.g., by digitally and/or optically zooming and/or panning the field of view of the first set of one or more cameras) based on a first set of one or more detected events (e.g., movements of subject 1100a1) (e.g., based on detected movement of the device, detected movement of the first set of one of more cameras, and/or detected changes in content in the field of view of the first set of one or more cameras).

A second tracking mode, different from the first tracking mode, is used for capturing media with the second set of one or more cameras (1210). The second tracking mode includes a second set of one or more rules (e.g., discussed with reference to FIG. 11B) for changing a current framing of the second set of one or more cameras (e.g., by digitally and/or optically zooming and/or panning the field of view of the second set of one or more cameras) based on a second set of one or more detected events (e.g., movements of subject 1100a2) (e.g., based on detected movement of the device, detected movement of the second set of one of more cameras, and/or detected changes in content in the field of view of the second set of one or more cameras). In some embodiments, the first set of one or more detected events is different from the first set of one or more detected events.

The second set of one or more rules is different from the first set of one or more rules (e.g., as discussed with reference to FIG. 11B). In some embodiments, the first and/or the second tracking mode is a subject (one or more persons, animals, and/or identified objects of interest) tracking mode that automatically controls framing adjustment (e.g., what content is centered in the captured media and/or a live preview of content), a zoom level, and/or a focal depth (e.g., in order to track changes in position of one or more subjects). In some embodiments, the first set of one or more cameras tracks at least a first subject without tracking a second subject and the second set of one or more cameras tracks at least the second subject, without tracking the first subject. In some embodiments, a current framing of a respective set of one or more cameras determines which portions of the field of view of the respective set of one or more cameras is captured in response to a capture request while the current framing is set (e.g., if a first framing is the current framing, the respective set of one or more cameras captures a first portion of the field of view of the respective set of one or more cameras and if a second framing is the current framing, the respective set of one or more cameras captures a second portion of the field of view of the respective set of one or more cameras, where the second portion of the field of view of the respective set of one or more cameras is different from the first portion of the field of view of the respective set of one or more cameras). Capturing media concurrently with the first set of one or more cameras and the second set of one or more cameras while using a first tracking mode for capturing media with the first set of one or more cameras and a second tracking mode for capturing media with the second set of one or more cameras performs different framing operations when a set of conditions has been met without requiring further user input. Doing so also reduces the number of inputs needed to perform framing operations. Doing so also reduces the risk that one or more transient media capture opportunities are missed due to improper framing (e.g., that could exclude one or more subjects for media capture). Reducing the risk that a transient media capture opportunity is missed enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the computer system detects, via the one or more input devices (in some embodiments, via the first set of one or more cameras and/or the second set of one or more cameras), a first amount of movement of a first face of a first subject (e.g., 1100a2) (e.g., that is within the field-of-view of the first set of one or more cameras and/or the field-of-view of the second set of one or more cameras). In response to detecting the first amount of movement (e.g., movement of a certain distance) of the first face of the first subject: in accordance with a determination that the first face of the first subject is within a field-of-view of the second set of one or more cameras, the computer system changes a current framing of the second set of one or more cameras (e.g., 606); and in accordance with a determination that the first face of the first subject is within a field-of-view of the first set of one or more cameras (e.g., one or more back facing cameras of device 600), the computer system forgoes changing a current framing of the first set of one or more cameras. In some embodiments, the second set of rules is more sensitive to facial movements than the first set of rules. In some embodiments, a second amount of movement of the first face of the first subject that is greater than the first amount of movement would cause changes in framing of both the first and second set of cameras to change a current framing. In some embodiments, a third amount of movement of the first face of the first subject that is less than first amount of movement would not cause changes in framing of either the first or the second set of cameras. In some embodiments, the first set of one or more detected events include detected movements of one or more faces of subjects; the second set of one or more detected events include detected movements of one or more faces of subjects; and the second set of one or more rules is more weighted towards (e.g., biased towards) changing a current framing based on detected movements of one or more faces of subjects than the first set of one or more rules. In some embodiments, the second set of rules causes changes in framing to be more weighted based on detected movement of faces relative to other detected events (e.g., such as changes in lighting or movement of objects other than faces). In contrast, the first set of rules causes changes in framing that are less weighted based on detected movement of faces relative to other detected events, as compared to the second set of rules (e.g., the first set of rules could be more weighted towards non-face object tracking). Weighing the second set of one or more rules more towards changing a current framing based on detected movements of one or more faces of subjects than the first set of one or more rules improves face tracking via the second set of one or more cameras, which are typically facing a user of the computer system. Doing so performs more face-tracking-weighted framing operations when a set of conditions has been met without requiring further user input. Doing so also reduces the number of inputs needed to perform framing operations that are more weighted to tracking faces. Doing so also reduces the risk that one or more transient media capture opportunities are missed due to improper framing (e.g., that could exclude one or more faces for media capture).

In some embodiments, the second set of rules includes at least one rule for changing the current framing so as to maintain one or more detected faces of subjects (e.g., discussed with reference to FIG. 11B for the face of subject 1100a2) within the current framing (in some embodiments, within a predetermined portion of the current framing, such as the center) of the second set of one or more cameras. In some embodiments, the second set of rules includes rule(s) for changing framing so that detected face(s) remain within the frame, even if the detected face(s) move. Changing the current framing so as to maintain one or more detected faces of subjects within the current framing performs more face-weighted framing operations when a set of conditions has been met without requiring further user input. Doing so also reduces the number of inputs needed to perform framing operations that are more weighted to tracking faces. Doing so also reduces the risk that one or more transient media capture opportunities are missed due to improper framing (e.g., that could exclude one or more faces for media capture).

In some embodiments, the second set of rules includes at least one rule for changing the current framing so as to maintain one or more detected faces of subjects within a predetermined portion of the current framing (e.g., a portion indicated by 1103b) (e.g., within a center portion of the current framing) of the second set of one or more cameras. In some embodiments, the second set of rules includes rule(s) for changing framing so that detected face(s) remain centered within the frame, even if the detected face(s) move. Changing the current framing so as to maintain one or more detected faces of subjects within a predetermined portion of the current framing performs framing operations when a set of conditions has been met without requiring further user input. Doing so also reduces the number of inputs needed to perform framing operations. Doing so also reduces the risk that one or more transient media capture opportunities are missed due to improper framing (e.g., that could exclude one or more faces from a center portion of captured media).

In some embodiments, the camera user interface includes a tracking mode disable user interface object (e.g., 1100f) (e.g., an affordance for disabling tracking mode). The computer detects, via the one or more user input devices, a user input (e.g., 1102f) (e.g., a tap, a swipe, and/or an air gesture) directed to the tracking mode disable user interface object. In response to detecting the user input directed to the tracking mode disable user interface object, the computer system disables the first tracking mode and/or disabling the second tracking mode (e.g., as discussed with reference to FIG. 11H). In some embodiments, while the first tracking mode is disabled, framing of the first set of one or more cameras does not change based on detected events. In some embodiments, while the second tracking mode is disabled, framing of the second set of one or more cameras does not change based on detected events.

In some embodiments, the first set of one or more rules cause a current framing of the first set of one or more cameras to change independently of the second set of one or more rules (e.g., as described with reference to FIG. 11C). The second set of one or more rules cause a current framing of the second set of one or more cameras to change independently of the first set of one or more rules. In some embodiments, automatic framing of the first set of one or more cameras, operating via the first tracking mode, occurs independently of automatic framing of the second set of one or more cameras, operating via the second tracking mode. Having a first set of one or more rules that cause a current framing of the first set of one or more cameras to change independently of the second set of one or more rules performs independent framing operations when a set of conditions has been met without requiring further user input. Doing so also reduces the number of inputs needed to perform independent framing operations. Doing so also reduces the risk that one or more transient media capture opportunities are missed due to improper framing (e.g., that could exclude one or more subjects for media capture) via either the first set of one or more cameras or the second set of one or more cameras.

In some embodiments, the media captured concurrently with the first set of one or more cameras and the second set of one or more cameras is video media that is stored as a media stream (e.g., a single media stream) that includes data from the first set of one or more cameras and data from the second set of one or more cameras (e.g., as described with reference to FIG. 11B and input 1102b). In some embodiments, the computer system stores video data from both sets of cameras as a single video stream in which both sets of data are embedded in (e.g., baked in). For example, video from the second set of one or more cameras is overlaid (e.g., as a picture-in-picture overlay) over video from the first set of one or more cameras and the video is then stored as a single video stream/file. Storing the captured media as a media stream in which data from the first set of one or more cameras and data from the second set of one or more cameras are both embedded reduces the number of inputs needed to manage media captured via both sets of one or more cameras.

In some embodiments, the media captured concurrently with the first set of one or more cameras and the second set of one or more cameras is video media that includes: video from the first set of one or more cameras that is stored as a first media stream; and video from the second set of one or more cameras that is stored as a second media stream, separate from the first media stream (e.g., as described with reference to FIG. 11B and input 1102b). In some embodiments, the computer system stores video data from the first set of one or more cameras separately from video data from the second set of one or more cameras. In some embodiments, because the data is stored separately, each set of data (e.g., each media stream) can be manipulated separately such that the video from the first set of one or more cameras and the second set of one or more cameras can be presented in different ways (e.g., independently or in conjunction). For example, when presented together, the video streams can be repositioned relative to each other and/or resized relative to each other. Storing the captured media as two separate media streams provides greater flexibility in managing and/or modifying the media captured from the first set of one or more cameras and the second set of one or more cameras. Doing so enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the sequence of one or more inputs (e.g., 1102b) that correspond to the request to capture media with both the first set of one or more cameras and the second set of one or more cameras is detected while the computer system is in a first media capture mode (e.g., a mode for capturing media of a first type, such as video media) in which capturing media concurrently with the first set of one or more cameras and the second set of one or more cameras is enabled. While the computer system is configured to a second media capture mode (e.g., a photo capture mode or a panoramic capture mode), different from the first media capture mode, the computer system captures media concurrently with the first set of one or more cameras and the second set of one or more cameras is disabled (e.g., is not enabled) (e.g., as described with reference to FIG. 11J).

In some embodiments, the camera user interface includes a camera selection user interface object (e.g., 614e or 1100e) (e.g., an affordance for switching between capture using the first set of one or more cameras, the second set of one or more cameras, and/or both the first set of one or more cameras and the second set of one or more cameras, concurrently)/While the computer system is configured to capture media with the first set of one or more cameras (in some embodiments, the second set of one or more cameras) based on a user input requesting media capture (e.g., without capturing media with the second set of one or more cameras), the computer system detects, via the one or more input devices, an input (e.g., 1102a) (e.g., a tap, a swipe, and/or an air gesture) directed to the camera selection user interface object. In response to detecting the input corresponding to the camera selection user interface object, the computer system configures the computer system to capture media with both the first set of one or more cameras and the second set of one or more cameras. In some embodiments, and also updating a live preview of content to show previews of content from both the first set of one or more cameras and the second set of one or more cameras.

In some embodiments, the camera selection user interface object (e.g., 1100e), when selected via one or more successive inputs (e.g., as 1102c, 1102d, and 1102e), causes the computer system to switch (e.g., as described with reference to FIG. 11F) between two or more of: being configured to capture media with the first set of one more cameras (e.g., without being configured to capture media with the second set of one or more cameras): being configured to capture media with the second set of one or more cameras (e.g., without being configured to capture media with the first set of one or more cameras); or being configured to capture media with both (e.g., concurrently with both) the first set of one or more cameras and the second set of one or more cameras. In some embodiments, the system cycles through in a first order (e.g., the first set of one or more cameras, the second set of one or more cameras, then both the first and second sets) or cycles through in a second order (e.g., the second set of one or more cameras, the first set one or more cameras, and then with both the first and second sets). Providing a camera selection user interface object that allows a user to cycle between being configured to capture media with the first set of one more cameras, the second set of one or more cameras, or with both the first set of one or more cameras and the second set of one or more cameras reduces the number of inputs required to select a camera configuration and provides additional control options without cluttering the UI with additional displayed controls.

In some embodiments, after capturing media concurrently with the first set of one or more cameras and the second set of one or more cameras is initiated (in some embodiments, after capturing media concurrently with the first set of one or more cameras and the second set of one or more cameras is completed), the computer system displays, via the one or more display generation components (in some embodiments, in the camera user interface), a representation of the captured media that includes an indication that media was captured concurrently with the first set of one or more cameras and the second set of one or more cameras (e.g., as described with reference to FIGS. 11N1, 11N2, and 110). In some embodiments, the representation is a thumbnail that includes visual media from both the first set of one or more cameras and the second set of one or more cameras (e.g., a thumbnail with a picture-in-picture effect). In some embodiments, the indication is a textual indication or a graphical indication (e.g., a specific icon, glyph, border, and/or visual effect) that indicates that media was captured concurrently with the first set of one or more cameras and the second set of one or more cameras. Displaying a representation of the captured media that includes an indication that media was captured concurrently with the first set of one or more cameras and the second set of one or more cameras provides improved feedback as concurrent media capture.

The representation of the captured media that includes an indication that media was captured concurrently with the first set of one or more cameras and the second set of one or more cameras includes (e.g., concurrently includes): at least a first subportion (e.g., 1114b2) that is based on media captured via the first set of one or more cameras; and at least a second subportion (e.g., 1114b1) that is based on media captured via the second set of one or more cameras. In some embodiments, the first subportion is a cropped image based on media captured via the first set of one or more cameras and the second subportion is a cropped image based on media captured via the second set of one or more cameras. In some embodiments, the first subportion and the second subportion are concurrently displayed. Displaying an indication that media was captured concurrently with the first set of one or more cameras and the second set of one or more cameras that includes at least a first subportion that is based on media captured via the first set of one or more cameras and a second subportion that is based on media captured via the second set of one or more cameras provides improved feedback.

In some embodiments, while the representation of the captured media that includes an indication that media was captured concurrently with the first set of one or more cameras and the second set of one or more cameras includes a visual representation of media captured via the first set of one or more cameras (e.g., without including a visual representation of media captured via the second set of one or more cameras), the computer system detects, via the one or more input devices (in some embodiments, one or more sensors of the computer system), a change in orientation of the computer system (e.g., 1102i and/or 1102k) (e.g., detecting the system being tilted and/or rotated). In some embodiments, in response to detecting the change in orientation of the computer system, updating the representation of the captured media that includes an indication that media was captured concurrently with the first set of one or more cameras and the second set of one or more cameras to include a visual representation of media captured via the second set of one or more cameras (in some embodiments, and ceasing to include in the representation of the captured media the visual representation of media captured via the first set of one or more cameras). Updating the representation of the captured media that includes an indication that media was captured concurrently with the first set of one or more cameras and the second set of one or more cameras to include a visual representation of media captured via the second set of one or more cameras in response to a change in orientation of the computer system provides additional control options without cluttering the UI with additional displayed controls.

In some embodiments, while the representation of the captured media that includes an indication that media was captured concurrently with the first set of one or more cameras and the second set of one or more cameras does not include a visual representation of media captured via the first set of one or more cameras (e.g., as described with reference to FIG. 11M) (in some embodiments, does not include a visual representation of media captured via the second set of one or more cameras), the computer system detects, via the one or more input devices, an input (e.g., a tap gesture on 1114a) (e.g., a tap, a swipe, and/or an air gesture) directed to the representation of the captured media that includes an indication that media was captured concurrently with the first set of one or more cameras and the second set of one or more cameras. In response to detecting the input directed to the representation of the captured media that includes an indication that media was captured concurrently with the first set of one or more cameras and the second set of one or more cameras, the computer system updates the representation of the captured media that includes an indication that media was captured concurrently with the first set of one or more cameras and the second set of one or more cameras to include a visual representation of media captured via the first set of one or more cameras. In some embodiments, the updated representation of media includes a representation of media captured via the first set of one or more cameras and a representation of the media captured via the second set of one or more cameras. In some embodiments, the updated representation of media includes a representation of media captured via the first set of one or more cameras and does not include a representation of the media captured via the second set of one or more cameras. In some embodiments, successive inputs cause the representation of the captured media to toggle between including a representation of media captured via the first set of one or more cameras and media captured via the second set of one or more cameras.

In some embodiments, the camera user interface, prior to (e.g., immediately prior to) detecting the sequence of one or more inputs (e.g., prior to 1102b) that correspond to the request to capture media with both the first set of one or more cameras and the second set of one or more cameras, includes a live preview of content (e.g., 614a) from the first set of one or more cameras (in some embodiments, and does not include a live preview of content from the second set of one or more cameras) set of one or more cameras. In response to detecting the sequence of one or more inputs that correspond to the request to capture media with both the first set of one or more cameras and the second set of one or more cameras, the computer system displays, via the one or more display generation components, (e.g., initially displaying) a live preview of content (e.g., 1100g) from the second set of one or more cameras, wherein the live preview of content from the second set of one or more cameras overlays a portion of the live preview of content from the first set of one or more cameras (e.g., as described with reference to FIG. 11B) (e.g., the live preview of content from the second set of one or more cameras is displayed as a picture-in-picture overlay). Displaying (e.g., initially displaying) a live preview of content from the second set of one or more cameras in response to detecting the sequence of one or more inputs that correspond to the request to capture media with both the first set of one or more cameras and the second set of one or more cameras reduces the number of inputs required to start concurrent capture and display the live preview. Doing so also provides improved feedback that concurrent capture was started while also assisting the user with proper composition of media capture, thereby reducing the risk that one or more transient media capture opportunities are missed due to improper composition (e.g., that could exclude one or more subjects for media capture), which enhances the operability of the system and makes the user-system interface more efficient (e.g., by helping the user to provide proper inputs and reducing user mistakes when operating/interacting with the system) which, additionally, reduces power usage and improves battery life of the system by enabling the user to use the system more quickly and efficiently.

In some embodiments, the camera user interface (e.g., 1100), prior to (e.g., immediately prior to) detecting the sequence of one or more inputs (e.g., prior to 1102b) that correspond to the request to capture media with both the first set of one or more cameras and the second set of one or more cameras, includes a live preview of content (e.g., 1100g) from the second set of one or more cameras (in some embodiments, and does not include a live preview of content from the first set of one or more cameras) set of one or more cameras. In response to detecting the sequence of one or more inputs that correspond to the request to capture media with both the first set of one or more cameras and the second set of one or more cameras: the computer system reduces the size of the live preview of content from the second set of one or more cameras; and the computer system displays, via the one or more display generation components, (e.g., initially displaying) a live preview of content from the first set of one or more cameras, wherein the live preview of content (e.g., 614a) from the first set of one or more cameras is larger than the reduced live preview of content (e.g., 1100g) from the second set of one or more cameras. In some embodiments, the reduced live preview of content from the second set of one or more cameras is overlaid on the live preview of content from the first set of one or more cameras (e.g., is a picture-in-picture overlay). Reducing the size of the live preview of content from the second set of one or more cameras and displaying a live preview of content from the first set of one or more cameras in response to detecting the sequence of one or more inputs that correspond to the request to capture media with both the first set of one or more cameras and the second set of one or more cameras reduces the number of inputs required to start concurrent capture and display the live preview of content from the first set of one or more cameras. Doing so also provides improved feedback that concurrent capture was started while also assisting the user with proper composition of media capture, thereby reducing the risk that one or more transient media capture opportunities are missed due to improper composition (e.g., that could exclude one or more subjects for media capture).

In some embodiments, the camera user interface includes, while capturing media (e.g., capturing with the first set of one or more cameras, the second set of one or more cameras, or concurrently with the first set of one or more cameras and the second set of one or more cameras), a respective live preview of content from the second set of one or more cameras (e.g., 1100g). While displaying the respective live preview of content from the second set of one or more cameras, the computer system detects, via the one or more input devices, a sequence of one or more inputs (e.g., as described with reference to FIG. 11L1) corresponding to a request to modify a size of the respective live preview of content from the second set of one or more cameras; and In some embodiments, the sequence of one or more inputs includes an directed to a camera selection user interface object and/or an input directed to an affordance for controlling whether both the first set of one or more cameras and the second set of one or more cameras are used to capture media. In response to detecting the request to modify the size of the respective live preview of content from the second set of one or more cameras, the computer system changes the size (e.g., expanding or collapsing) of the respective live preview of content from the second set of one or more cameras.

In some embodiments, during a recording session for recording media with the first set of one or more cameras (e.g., recording session started via input 1102b) and while a live preview of content from the second set of one or more cameras is not expanded: in accordance with a determination that a live preview of content from the second set of one or more cameras was previously expanded (e.g., recording was enabled) during a recording session for recording media with the first set of one or more cameras, the computer system displays, via the one or more display generation components, a selectable option (e.g., 1100e) (e.g., a user interface object that, when selected, based on a sequence of one or more inputs including an input directed to the user interface object causes the device to) to expand a live preview of content from the second set of one or more cameras; and (e.g., displaying the selectable option concurrently with displaying a live preview of content from the first set of one or more cameras) In some embodiments, expanding a live preview of content from the second set of one or more cameras optionally includes starting a recording session with the second set of one or more cameras that runs concurrently with the recording session for the first set of one or more cameras. In accordance with a determination that a live preview of content from the second set of one or more cameras was not previously expanded (e.g., recording was not enabled) during the recording session for recording media with the first set of one or more cameras, the computer system forgoes displaying the selectable option (e.g., a user interface object that, when selected, based on a sequence of one or more inputs including an input directed to the user interface object causes the device to) to expand a live preview of content from the second set of one or more cameras. In some embodiments, the computer system does not allow expansion of the live preview of for the second set of one or more cameras and/or does not enable concurrent recording with the second set of one or more cameras if the recording session for the first set of one or more cameras started without a corresponding recording session for the second set of one or more cameras.

In some embodiments, while displaying the camera user interface and while the camera user interface includes a respective live preview of content (e.g., 1100g) from the first set of one or more cameras and a respective live preview of content (e.g., 614a) from the second set of one or more cameras, the computer system detects, via the one or more input devices, a sequence of one or more inputs (e.g., 1102e1 or 1102e2) that correspond to a request (e.g., a input on a touch-sensitive surface, an air gesture, or a mouse input that is directed to the respective live preview of content from the first set of one or more cameras and that indicates a direction and/or location to move the respective live preview of content from the first set of one or more cameras) to move the respective live preview of content from the first set of one or more cameras relative to the respective live preview of content from the second set of one or more cameras. In some embodiments, the request is a request to move the respective live preview of content from the second set of one or more cameras relative to the respective live preview of content from the first set of one or more cameras. In some embodiments, the request is a request to reposition the respective live preview of content from the first set of one or more cameras within the camera user interface (e.g., without changing the position of the respective live preview of content from the second set of one or more cameras). In response to detecting the sequence of one or more inputs that correspond to the request to move the respective live preview of content from the first set of one or more cameras relative to the respective live preview of content from the second set of one or more cameras, the computer system displays, via the one or more display generation components, (e.g., a motion blur effect and/or a frame interpolation effect that is applied to the respective live preview of content from the first set of one or more cameras) the respective live preview of content from the first set of one or more cameras with a visual effect (e.g., 1100g with the visual effect as shown in FIGS. 11F1 and 11F2) that reduces a fidelity of the live preview of content while the respective live preview of content is moving. In some embodiments, without displaying the respective live preview of content from the second set of one or more cameras with the visual effect. In some embodiments, further in response to detecting the sequence of one or more inputs that correspond to the request to move the respective live preview of content from the first set of one or more cameras relative to the respective live preview of content from the second set of one or more cameras, moving the respective live preview of content from the first set of one or more cameras within the camera user interface and relative to the respective live preview of content from the second set of one or more cameras. In some embodiments, the animated transition is displayed while the respective live preview of content from the first set of one or more cameras is moving and ceases to be displayed when the respective live preview of content from the first set of one or more cameras ceases moving.

In some embodiments, in response to detecting the sequence of one or more inputs (e.g., 1102e1 or 1102e2) that correspond to the request to move the respective live preview of content from the first set of one or more cameras relative to the respective live preview of content from the second set of one or more cameras, the computer system moves the respective live preview of content (e.g., 1100g) from the first set of one or more cameras within the camera user interface and relative to the respective live preview of content from the second set of one or more cameras, wherein one or more properties of the visual effect (e.g., a direction and/or magnitude) is based on a property of movement (e.g., a direction, speed, and/or acceleration) of the respective live preview of content from the first set of one or more cameras. In some embodiments, an amount of motion blur is applied to the respective live preview of content from the first set of one or more cameras that is based on the speed, direction, and/or acceleration of the movement. For example, more motion blur is applied as the speed of movement increases. In some embodiments, a direction of motion blur is applied to the respective live preview of content from the first set of one or more cameras that is based on the direction of the movement (e.g., if the movement is in a first direction, the motion blur is applied in the first direction and if the movement is in a second direction different from the first direction, the motion blur is applied in the second direction).

Note that details of the processes described above with respect to method 1200 (e.g., FIG. 12) are also applicable in an analogous manner to the methods described below/above. For example, method 1200 optionally includes one or more of the characteristics of the various methods described above with reference to methods 700, 800, 1000, 1400, 1500, 1600 and/or 1800. For example, capturing media concurrently with the first set of one or more cameras and the second set of one or more cameras can occur while displaying a user interface of methods 700, 800, 1000, 1400, 1500, 1600 and/or 1800. For brevity, these details are not repeated below.

FIGS. 13A-13W illustrate exemplary user interfaces for a camera application that includes a mode switching control that expands, a camera control panel overlaid on camera user interface, and displaying a control for adjusting a camera zoom level that shifts positions, in accordance with some embodiments. The user interfaces in these figures are used to illustrate the processes described below, including the processes in FIGS. 14, 15, and 16.

FIG. 13A illustrates device 600 displaying home screen 604 on display 602, as describe with reference to FIG. 6A. At FIG. 13A, device 600 detects input 1302a (e.g., a press) on camera button 608 and detects input 1302b (e.g., a tap gesture) corresponding to camera application affordance 604a. In some embodiments, input 1302a, 1302b, and/or one or more of inputs described with reference to FIGS. 13A-13W, discussed below, is a touch gesture (e.g., a tap, a swipe, or touch-and-hold), an air gesture (e.g., an air tap or air pinch), or a selection input (e.g., via a hardware input mechanism such as a button) that is detected while a respective user interface element (e.g., camera application affordance 604a) is selected and/or is in focus.

At FIG. 13B, in response to detecting input 1302a on camera button 608 and/or input 1302b corresponding to camera application affordance 604a, device 600 displays camera user interface 1300. Camera user interface 1300 includes various selectable user interface objects and indicators for configuring media capture functions and features, capturing media, and reviewing and/or editing captured media. In some embodiments, camera user interface includes one or more features or elements of camera user interface 614, camera user interface 900, and/or camera user interface 1300. In FIGS. 13B-13V, a number of different camera user interfaces are displayed, these camera user interfaces include various user interface elements including controls (e.g., 614, 1300, 1305, 1308, 1310, 1312, 1314, 1316 and/or sub-elements thereof (e.g., “614” refers to 614a, 614b, 614c, and so forth)) and status information elements (e.g., 1100). In some embodiments, some or all of these controls and/or status information elements are opaque or substantially opaque. In some embodiments, some or all of these controls and/or status information elements are at least partially transparent or translucent. In some embodiments, some or all of these controls and/or status information elements are made of, or are, displayed in platters that are made of a user interface material that has an appearance based on other content behind the user interface material. This user interface material is optionally a simulated glass material that has simulated reflective and/or refractive properties that are based on content beneath, near, and/or within the corresponding platter. In some embodiments, different controls and/or status information elements include and/or are displayed within platters that have a simulated glass material with different simulated properties (e.g., a different simulated transparency, tint, blur, degree of reflection, and/or degree of refraction). FIG. 13B, for example, depicts certain shapes and/or details of subject 1302a being partially visible through user interface objects of camera user interface 1300. For example, note that details (e.g., buttons) of the sweater worn by subject 1302a are visible through translucent shutter affordance 614b, 5× indicator 1300b3, and camera selection affordance 614e in FIG. 13B. For many of these controls and/or status information elements, the background for the camera user interface will be a live preview of content in a field-of-view of one or more cameras of the device (e.g., device 600), using a translucent or transparent material such as a simulated glass material (with one or more of the properties described in greater detail above), improves the efficiency of using the device by enabling more of the camera user interface to include content that is representative of the content that is in the field-of-view of the one or more cameras while concurrently displaying controls and/or status information elements, this enables a user to use the one or more cameras to capture media more quickly and efficiently and with fewer errors, ensuring that fleeting moments are able to be captured and reducing a total time of usage of the camera application, which reduces energy usage and saves battery life for battery powered devices.

Camera user interface 1300 includes camera preview 614a, which includes a representation of a field-of-view of the environment captured by one or more back facing cameras of computer system 600 that is framed (e.g., cropped) as it would currently be framed in media captured via camera user interface 1300 (e.g., camera preview 614a is a live or near-live viewfinder). For example, in the embodiment of FIGS. 13A-13W, camera user interface 1300 includes camera preview 614a that is a representation of the environment (e.g., an outdoor environment with subject 1302a, subject 1302b, and subject 1302c in the foreground) as captured by one or more of the rear facing cameras of device 600 (e.g., rear facing cameras 606A, 606B, and/or 606C). As seen in FIG. 13A, camera preview 614a spans the surface of display 602, showing content at each of the four edges of the display. In some embodiments, while camera preview 900a includes a representation of the environment from the top edge of display 602 to the bottom edge of display 602, portions (e.g., at the top and bottom of the display) are presented with a different visual appearance (e.g., a gray mask) to indicate that those portions will not be included in captured media. In some embodiments, the size and/or dimensions of the portions that are presented with the different visual appearance are based on a currently selected aspect ratio (e.g., a 4:3 aspect ratio would have larger portions at the top and bottom excluded from captured media than if a 16:9 aspect ratio were selected). Camera user interface 1300 also includes shutter affordance 614b that is a software button that can be selected to initiate the capture of media in a currently selected capture mode using one or more current settings, captured media affordance 614d that is a selectable thumbnail icon that previews captured media and can be selected to view and/or edit captured media (e.g., in a media viewing or media library user interface), and camera selection affordance 614e that is a software button for switching between primarily capturing using one or more rear (e.g., environment-facing, such as rear facing cameras 606A, 606B, and/or 606C) cameras and using a front (e.g., user-facing) camera (e.g., camera 606).

At FIG. 13B, camera user interface 1300 also includes mode option affordance 1300a that can be used to quickly (e.g., via a single input) switch between a photo capture mode and a video capture mode or to transition to additional capture modes. In some embodiments, mode option affordance 1300a includes one or more features of mode option affordance 614i (e.g., FIG. 6B) or capture mode selector 1100b (e.g., in FIG. 11A). As seen in FIG. 13B, device 600 is currently configured to capture (e.g., in response to detecting an input directed to shutter affordance 614b) media in a photo media capture mode, as indicated by the position of mode indicator 1300a1 that is a part of mode option affordance 1300a. In some embodiments, mode indicator 1300a1 is referred to as a platter (e.g., a shape having a define border and interior). At FIG. 13B, mode option affordance 1300a, and/or other portions of mode option affordance 1300a, is displayed with the appearance of simulated glass that is at least partially translucent. In some embodiments, content from preview 614a (e.g., portions of subject 1302a) are visible through mode indicator 1300a1, with a distorted appearance. Because device 600 is currently configured to capture photo media, camera user interface 1300 includes one or more photo-related user interface objects (e.g., “live” effect indicator 614g2 that is discussed in more detail with reference to FIG. 6B). Camera user interface 1300 also includes zoom affordance 1300b that is a control for changing the capture magnification and/or switching between cameras/lenses with different magnification; at FIG. 13B, zoom affordance 1300b indicates that the current zoom level is 1× (e.g., 1× indicator 1300b1 is centered in camera user interface 1300 and is visually emphasized relative to the remaining indicators). In addition to 1× indicator 1300b1, zoom affordance 1300b includes 2× indicator 1300b2, 5× indicator 1300b3, and 0.5× indicator 1300b4 that correspond to different zoom levels. The currently selected zoom level corresponds to the center zoom indicator (e.g., 1X indicator 1300b1 at FIG. 13B), which is displayed with the greatest visual prominence. The visual prominence of a given zoom indicator decreases the further the given indicator is away from the center. In some embodiments, visual prominence is indicated by one or more of bolding, size, color, and/or visual density. For example, 5× indicator 1300b4 and 2× indicator 1300b2 have the same visual prominence, which is less than that of 1X indicator 1300b1, but greater than that of 5× indicator 1300b3, as the 5× indicator 1300b3 is the furthest from the center in FIG. 13B. Additional details of zoom affordance 1300b are discussed with reference to FIGS. 13R-13V, below. Camera user interface 1300 also includes options affordance 1300c, which is discussed in more detail with reference to FIG. 13I. In some embodiments, zoom affordance 1300b includes one or more features of zoom affordance 614c (e.g., FIG. 6B) and/or zoom affordance 1100a (e.g., in FIG. 11A).

At FIG. 13B, device 600 detects input 1302c (e.g., a tap gesture) directed to shutter affordance 614b, input 1302d (e.g., a tap gesture) directed to camera selection affordance 614e, input 1302e (e.g., a sustained touch gesture) directed to mode option affordance 1300a, and input 1302f (e.g., a leftward swipe gesture) directed to mode option affordance 1300a. In response to detecting input 1302c, device 600 captures photo media that include content based on what is shown in preview 614a of FIG. 13B. In response to detecting input 1302d, device 600 configured user interface 1300 to capture media using one or more front facing cameras, including updating preview 614a to show content from the one or more front facing cameras (e.g., in a manner similar to that described with reference to FIGS. 11B and 11K).

At FIG. 13C, in response to detecting input 1302e and/or input 1302f, device 600 updates mode option affordance 1300a to a first expanded state that includes indication of additional available capture modes, beyond the photo and video capture modes (e.g., an end portion of the word “PORTRAIT” is visible in the left of mode option affordance 1300a and a beginning portion of the word “CINEMATIC” is visible in the right of mode option affordance 1300a). Mode option affordance 1300a, when in the first expanded state, provides feedback to the user that additional modes are available for selection via further input directed to mode option affordance 1300a. Device 600, when displaying mode option affordance 1300a in the first expanded state, outputs haptic output 1304a. In some embodiments, detecting input 1302e (e.g., a sustained touch gesture directed to mode option affordance 1300a) causes device 600 to display the mode option affordance 1300a in the first expanded state of FIG. 13C while detecting input 1302f (e.g., a swipe gesture directed to mode option affordance 1300a) causes mode option affordance 1300a to be displayed in a second expanded state that is discussed in more detail with reference to FIG. 13F. At FIG. 13C, input 1302e continues to be detected and mode option affordance 1300a remains in the first expanded state, while input 1302e continues to be detected. At FIG. 13C, device 600 detects an end of input 1302e (e.g., contact on display 600 ceases to be detected).

At FIG. 13D, in response to detecting the end of input 1302e1, device 600 returns mode option affordance 1300a to an unexpanded state and configures camera user interface 1300 to capture video media, as indicated by the position of mode indicator 1300a1. In some embodiments, device 600 responds to a tap input (as opposed to a sustained contact input) directed to mode option affordance 1300a as shown in FIG. 13B by directly switching to the video mode, without first displaying mode option affordance 1300a in the first expanded state of FIG. 13C. Because device 600 is currently configured to capture photo media, camera user interface 1300 includes one or more video-related user interface objects, such as recording time indicator 1100c (currently showing zero recording time, as capture has yet to be initiated) and capture resolution and frame rate indicator 1100d (in FIG. 13C, currently indicating high definition resolution at 30 frames per second).

At FIG. 13E, while camera user interface 1300 is configured to capture video media, device 600 detects input 1302g (e.g., a rightwards swipe input) directed to mode option affordance 1300a. In some embodiments, input 1302g is a leftwards swipe.

At FIG. 13F, in response to detecting input 1302g, device 600 ceases to display one or more user interface objects (e.g., captured media affordance 614d and camera selection affordance 614e) and displays mode option affordance 1300a in a second expanded state that is larger than the first expanded state illustrated in FIG. 13C. As shown in FIG. 13F, mode option affordance 1300a in the second expanded state occupies portions of camera user interface 1300 that were previously occupied by one or more of the user interface objects that ceased to be displayed. Mode option affordance 1300a in the second expanded state includes additional indications of other available modes, such as a “SPATIAL” capture mode (e.g., a mode for capturing stereoscopic media that can be later viewed/played back with a stereoscopic effect).

At 13F, further in response to detecting input 1302g, device 600 has configured camera user interface 1300 to capture media in a portrait mode, which is a mode for capturing photo media that are designated for display with synthetic depth-of-field effects, lighting effects, and/or other post-processing effects, as indicated by the position of mode indicator 1300a1. Because device 600 is currently configured to capture in the portrait mode, camera user interface 1300 includes one or more portrait-related user interface objects, such as depth setting indicator 1306, which can be selected to control a depth effect setting that controls a depth effect (e.g., simulated bokeh or depth effect) that is applied to captured media. In some embodiments, mode indicator 1300a1 is a focus indicator that remains in a first position (e.g., centered under shutter affordance 614b while the various mode options move beneath mode indicator 1300a1). In such embodiments, device 600 updates camera user interface 1300 with one or more user interface objects corresponding to the mode that is currently selected via mode indicator 1300a1. Device 600, when displaying mode option affordance 1300a in the second expanded state, outputs haptic output 1304b.

At FIG. 13G, device 600 displays mode option affordance 1300a in an unexpanded state while the portrait capture mode is selected. In some embodiments, device 1300 returns mode option affordance 1300a to the unexpanded state when input 1302g ceases to be detected or when the mode options within mode option affordance 1300a cease to move in response to the movement of input 1302g. As seen in FIG. 13G, when mode option affordance 1300a is in the unexpanded state and a mode other than video moder or photo mode are selected, mode option affordance 1300a includes indications of other modes that are adjacent to the currently selected mode within the sequence of modes displayed in mode option affordance 1300a. Device 600 also re-displays one or more of the user interface objects (e.g., captured media affordance 614d and camera selection affordance 614e) that ceased to be displayed when mode option affordance 1300a was displayed in the second expanded state. At FIG. 13G, device 600 detects input 1302h (e.g., a leftwards swipe) directed to mode option affordance 1300a.

At FIG. 13H, in response to input 1302h, device 600 displays mode option affordance 1300a in the second expanded state and configures camera user interface 1300 to capture media in a cinematic mode, which is a mode for capturing video media that are designated for display with synthetic depth-of-field effects, lighting effects, and/or other post-processing effects and/or media that tracks subjects and presents the subjects with synthetic depth-of-field effects. As discussed with reference to FIG. 13F, when mode option affordance 1300a is displayed in the second expanded state, device 600 ceases to display one or more user interface objects (e.g., captured media affordance 614d and camera selection affordance 614e).

At FIG. 13I, device 600 displays mode option affordance 1300a in an unexpanded state while the cinematic capture mode is selected. In some embodiments, device 1300 returns mode option affordance 1300a to the unexpanded state when input 1302h ceases to be detected or when the mode options within mode option affordance 1300a cease to move in response to the movement of input 1302h. Device 600 also re-displays one or more of the user interface objects (e.g., captured media affordance 614d and camera selection affordance 614e) that ceased to be displayed when mode option affordance 1300a was displayed in the second expanded state. At FIG. 13I, device 600 detects input 1302i (e.g., a tap gesture) directed to options affordance 1300c and input 1302j (e.g., an upwards swipe) directed to mode option affordance 1300a.

At FIG. 13J, in response to input 1302i and/or input 1302j, device 600 displays an animation of mode indicator 1300a1 growing and transitioning into options platter 1300d, as shown in FIG. 13L, with 13J illustrating a first stage of the animation. At 13J, mode indicator 1300a1 has moved up from the position that it had at FIG. 13I and no longer surrounds the word “cinematic” in the remainder of mode option affordance 1300a. Also as illustrated at FIG. 13J, the animation includes one or more user interface elements (e.g., shutter affordance 614b, zoom control affordance 1300b, as well as other controls described with reference to FIG. 13B) fading in camera user interface 1300. Options affordance 1300c, like mode indicator 1300a1, does not fade.

FIG. 13K illustrates the animation initiated in response to device 600 detecting input 1302j progressing further from the state shown in FIG. 13J. At FIG. 13K, mode indicator 1300a1 has grown larger and shifted further up in camera user interface 1300. The one or more user interface objects that began to fade at FIG. 13J have now faded even more.

FIG. 13L illustrates camera user interface 1300 after the animation initiated in response to device 600 detecting input 1302j has been completed. Mode indicator 1300a1 has now fully expanded to become options platter 1300d that includes one or more options for modifying media capture. The one or more user interface objects that began to fade at FIG. 13J have now faded completely away and are no longer displayed in camera user interface 1300. At FIG. 13L, options platter 1300d includes flash option 1300d1, exposure option d2, and styles option 1300d3. At FIG. 13L, options platter 1300d is displayed with the appearance of simulated glass that is at least partially translucent. In some embodiments, content from preview 614a (e.g., portions of subject 1302a) are visible through options platter 1300d, with a distorted appearance. In some embodiments, the distorted appearance is greater at FIG. 13L than that discussed with reference to FIG. 13B.

At FIG. 13L, device 600 detects input 1302k (e.g., a tap gesture) directed to options affordance 1300c, input 13021 (e.g., a tap gesture) directed to flash option 1300d1, input 1302m (e.g., a tap gesture) directed at exposure option 1300d2, input 1302n (e.g., a tap input) directed to styles option 1300d3, input 13020 (e.g., a downwards swipe on options platter 1300d), and input 1302p (e.g., a tap gesture) on a portion of preview 614a. In response to input 1302k and/or input 1302p, device 600 displays the animation discussed with reference to FIGS. 13I-13L in reverse, restoring camera user interface to the visual state shown in FIG. 13I, including showing options platter 1300d transforming back into mode indicator 1300a1 and re-displaying the one or more user interface objects that faded out as part of the animation. The response of device 600 to inputs 1302l, 1302m, and 1302n are discussed in the following figures.

At FIG. 13M, in response to detecting input 13021, device 600 updates options platter 1300d to include flash settings controls 1308 that includes indicators and affordances relating to flash settings and options, including “off” affordance 1308a that corresponds to flash being forced to off, “on” affordance 1308b that corresponds to flash being forced on, and “auto” affordance 1308c corresponding a setting in which device 600 determines if a flash should be used during photo capture based on flash criteria (e.g., based on ambient light and/or one or more other photo settings, such as exposure) that is currently bolded to indicated that flash is set to auto mode. At FIG. 13M, device 600 detects input 1302q. Device 600, in response to detecting input 1302q, configures the flash to be in a forced off state for media capture. In some embodiments, device 600 displays one or more indicators and/or affordances based on changes made using options platter 1300d, once options platter 1300d is dismissed, as discussed in more detail with reference to FIG. 13R.

At FIG. 13N, in response to detecting input 13021, device 600 updates options platter 1300d to include exposure settings controls 1310 that can be used to select and set an exposure compensation value for media capture. In some embodiments, exposure settings controls 1310 includes one or more features of exposure control affordance 618l (e.g., FIG. 6H). As seen in FIG. 13N, exposure settings controls 1310 is a slider that overlays all of options platter 1300d and that indicates that the exposure compensation is set to “0.0”, indicating that no exposure compensation is currently being applied for media capture. Exposure settings controls 1310 also includes close affordance 1310a that can be selected to dismiss exposure settings controls 1310 and return options platter 1300d to the state shown in FIG. 13L. At FIG. 13N, device 600 detects input 1302r (e.g., a rightwards swipe) directed to exposure settings controls 1310.

At FIG. 13O, in response to input 1302r, device 600 adjusts the exposure compensation value to −0.3, as indicated in exposure settings controls 1310.

At FIG. 13P, in response to detecting input 1302n (e.g., in FIG. 13L), device 600 updates options platter 1300d to include styles settings controls 1312, which is a control for selecting and/or modifying one or more predetermined photographic styles (e.g., preset filters). Styles settings controls 1312 includes setting indicator 1312a that indicates that various values for the current style is set to a default value, since indicator 1312a is positioned at the center of styles settings controls 1312. Styles settings controls 1312 also includes close affordance 1312b that can be selected to dismiss styles settings controls 1312 and return options platter 1300d to the state shown in FIG. 13L. At FIG. 13P, device 600 detects input 1302s (e.g., a diagonal swipe gesture) originating on setting indicator 1312a.

At FIG. 13Q, in response to input 1302s, device 600 adjusts the values for the currently selected style to a tone adjustment value of 01 and color adjustment value of 02, as indicated by adjusted value indicator 1314 and the position of setting indicator 1312a in styles settings controls 1312. At FIG. 13Q, device 600 detects input 1302t (e.g., a tap gesture) directed to options affordance 1300c and input 1302u (e.g., a tap gesture) directed to a portion of preview 614a.

At FIG. 13R, in response to input 1302t and/or input 1302u, device 600 dismisses styles settings controls 1312, returning camera user interface 1300 to state similar to that of FIG. 13I. Camera user interface 1300 now includes one or more indicators corresponding to default settings that have been modified based on changes made using options platter 1300d. For example, camera user interface 1300 now includes modified exposure indicator 1316a that shows an exposure compensation value of −0.3 is currently being applied to captured media, modified style indicator 1316b that indicates that the default style value has been changed, and flash setting indicator 1316c that indicates that flash is set to off. In some embodiments, one or more of the indicators corresponding to default settings that have been modified based on changes made using options platter 1300d are selectable and one or more of those indicators are not. At FIG. 13R, modified style indicator 1316b is selectable while modified exposure indicator 1316a is not. In some embodiments, indicators displayed in a first portion of camera user interface 1300 (e.g., in the right upper corner region) are selectable while indicators displayed in a second portion of camera user interface 1300 (e.g., in the left upper corner region) are not selectable. At FIG. 13R, device 600 detects input 1302v (e.g., a tap) directed to modified style indicator 1316b. In response to detecting input 1302v, device 600 initiates a process to update the modified style setting (e.g., device 600 redisplays styles settings controls 1312). At FIG. 13R, device 600 detects input 1302w (e.g., a tap) directed to 0.5× indicator 1300b4.

At FIG. 13S, in response to detecting input 1302w, device 600 updates camera user interface 1300 to capture media at the 0.5× zoom value, including updating preview 614a and updating the position of the indicators of zoom affordance 1300b. At FIG. 13S, 0.5× indicator 1300b4 is now centered and has the greatest visual prominence. 5× indicator 1300b3 is now the furthest from the center and has the least visual prominence of the zoom indicators of zoom affordance 1300b. At FIG. 13S, device 600 detects input 1302x (e.g., a tap gesture) directed at the location of camera user interface 1300 at which 0.5× indicator 1300b4 was displayed in FIG. 13R and detects input 1302z (e.g., a tap gesture) that is directed at 5X indicator 1300b3. In response to input 1302x, device 600 performs a focus operation (e.g., based on object(s) in preview 614a that are detected at that location), without modifying a current zoom level, as the location no longer includes a zoom control indicator at FIG. 13S.

At FIG. 13T, in response to input 1302z, device 600 updates camera user interface 1300 to capture media at the 5× zoom value, including updating preview 614a and updating the position of the indicators of zoom affordance 1300b. At FIG. 13T, 5X indicator 1300b3 is now centered and has the greatest visual prominence. The indicator for the 0.5χ zoom level 1300b4 is now the furthest from the center and has the least visual prominence of the zoom indicators of zoom affordance 1300b. At FIG. 13T, device 600 detects input 1302aa (e.g., a tap gesture) directed to the location of camera user interface 1300 at which 5× indicator 1300b3 was displayed in FIG. 13S. In response to input 1302aa, device 600 performs a focus operation (e.g., based on object(s) in preview 614a that are detected at that location), without modifying a current zoom level, as the location no longer includes a zoom control indicator at FIG. 13T. Device 600 also detects input 1302bb (e.g., a rightward swipe) directed to zoom affordance 1300b.

At FIG. 13U, in response to detecting input 1302bb, device 600 updates camera user interface 1300 to capture media at a 4× zoom level, based on a magnitude (e.g., distance) of movement of input 1302bb, including modifying preview 614a and modifying the appearance of zoom affordance 1300b to indicate that gradual zoom changes can be made using a slider. At FIG. 13U, device 600 detects input 1302cc (e.g., a rightward swipe) directed to zoom affordance 1300b.

At FIG. 13V, in response to detecting input 1302cc, device 600 updates camera user interface 1300 to capture media at an 1× zoom level, based on a magnitude (e.g., distance) of movement of input 1302cc, including modifying preview 614a and modifying the appearance of zoom affordance 1300b. In some embodiments, device 600 returns zoom affordance 1300b to the visual state shown in FIG. 13R after zoom affordance 1300b has been displayed in the state shown in FIG. 13V for a predetermined period of time.

At FIG. 13W, in response to input 1302fl directed to captured media affordance 614d (e.g., in FIG. 13B), device 600 displays a media review user interface 1318 for viewing media captured using camera user interface 1300. Media review user interface 1318 includes back affordance 1320. Device 600 detects input 1302dd (e.g., a tap) directed to back affordance 1320. In response to input 1302dd, device 600 redisplays camera user interface 1300 in the state shown at FIG. 13V.

FIG. 14 is a flow diagram illustrating a method for displaying a camera user interface with a mode switching control that expands, in accordance with some embodiments. Method 1400 is performed at a computer system (e.g., 100, 300, 500, and/or 600) that is in communication with one or more input devices (e.g., 602) (e.g., touch-sensitive surfaces, hardware input devices (e.g., hardware buttons or rotatable input mechanisms), microphones, gesture input devices, air gesture input devices, and/or gaze input devices), one or more display generation components (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 1400 are, optionally, combined, the orders of some operations are, optionally, changed, and some operations are, optionally, omitted.

As described below, method 1400 provides an intuitive way for displaying a camera user interface with a mode switching control that expands. The method reduces the cognitive burden on a user for displaying a camera user interface with a mode switching control that expands. For battery-operated computing devices, enabling a user to displaying a camera user interface with a mode switching control that expands faster and more efficiently conserves power and increases the time between battery charges.

The devices, methods, and/or computer-readable storage media described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. For example, the devices, methods, and/or computer-readable storage media described below provide additional control options (such as by expanding the camera mode selection user interface object) without cluttering the UI with additional displayed controls at certain times enhances the operability of the device by reducing unnecessary inputs and/or steps to navigate through different user interfaces or sets of controls, reducing energy usage by the device. By way of additional example, displaying user interface elements (such as the camera mode selection user interface object) with different appearances at different times helps to avoid image persistence or burn in effects that can occur with some display technologies when the same object is displayed with the same appearance at the same location repeatedly or for a long period of time. By way of additional example, the devices, methods, and/or computer-readable storage media described below provide improved feedback (such as by expanding the camera mode selection user interface object to display indications of one or more additional controls) enhances the operability of the device by reducing accidental and mistaken inputs, reducing energy usage by the device.

The computer system (e.g., 600) displays (1402), via the one or more display generation components, a camera user interface (e.g., 1300) (e.g., an interface of a camera application) that includes a camera mode selection user interface object (e.g., 1300a) (e.g., an affordance for configuring/selecting the mode that the one or more cameras will capture media in response to a media capture request), wherein the camera mode selection user interface object includes an indication (e.g., 1300a1) (e.g., a graphical indication and/or a textual indication) of a currently selected capture mode for the one or more cameras. In some embodiments, the camera mode selection user interface object is a platter that overlays one or more portions of the camera user interface. In some embodiments, the platter has a visually-distinct border and encompasses a plurality of user interface objects. In some embodiments, the one or more cameras are capable of being configured to a plurality of capture modes such as photo capture mode, video capture mode, panoramic capture mode, slow motion capture mode, time lapse capture mode, and/or portrait capture mode with depth-based effects. In some embodiments, the camera user interface also includes a shutter interface object/button and the camera mode selection user interface object indicates a mode with which the one or more cameras will capture media upon selection of the shutter interface object.

The computer system detects (1404), via the one or more input devices, a set of one or more inputs (e.g., 1302f and/or 1302e) directed to the camera mode selection user interface object; and In some embodiments, the input is a touch input (e.g., a tap, a press-and-hold, or a swipe), a gaze input, an air gesture, and/or a button/key press

In response to detecting the set of one or more inputs directed to the camera mode selection user interface object, the computer system expands (1406) the camera mode selection user interface object from a first size to a second size, larger than the first size (e.g., 1300a at FIG. 13C). In some embodiments, displaying an animation of the camera mode selection user interface object expanding. In some embodiments, the input corresponding to the camera mode selection user interface object causes the camera capture mode to change. In some embodiments, the input corresponding to the camera mode selection user interface object does not cause the camera capture mode to change (e.g., the currently selected capture mode remains the same).

In some embodiments, expanding the camera mode selection user interface object from the first size to the second size includes: displaying, via the one or more display generation components, indications of one or more additional modes (e.g., as discussed with reference to 1300a at FIG. 13C) for the one or more cameras that were not displayed prior to detecting the set of one or more inputs directed to the camera mode selection user interface object (e.g., affordances/selectable user interface objects). In some embodiments, the indications are selectable user interface objects. In some embodiments, the indications indicate a mode setting, but are not separately selectable. In some embodiments, displaying at least a portion of the one or more control user interface objects. In some embodiments, the one or more control user interface objects include a mode option described above with reference to FIG. 7. In some embodiments, the one or more control objects includes one or more controls for modifying a current camera capture mode and/or for modifying a setting of a currently selected camera capture mode.

In some embodiments, expanding the camera mode selection user interface object from the first size to the second size includes: expanding the camera mode selection user interface object in a first direction of expansion (e.g., horizontally to the left); and expanding the camera mode selection user interface object in a second direction of expansion (e.g., horizontally to the right and/or vertically), different from the first direction of expansion (e.g., as discussed with reference to FIG. 13C).

In some embodiments, prior to expanding the camera mode selection user interface object from the first size to the second size, the camera mode selection user interface object includes a first set of one or more mode options for switching between photo capture mode and video capture mode (e.g., 1300a at FIG. 13B) (in some embodiments, the first set of one or more mode operations operates as a toggle, such that input causes the mode to switch between photo capture mode and video capture mode and vice versa); and In some embodiments, the camera mode selection user interface object, when expanded, includes at least one mode option that is not included in the unexpanded camera mode selection user interface object. The expanded camera mode selection user interface object includes a second set of one or more mode options (e.g., 1300a at FIG. 13C) that includes at least one mode option for switching to a capture mode that is different from the photo capture mode and video capture mode. In some embodiments, the second set of one or more mode options includes a portrait mode (e.g., a mode for capturing photo media that are designated for display with synthetic depth-of-field effects, lighting effects, and/or other post-processing effects), spatial capture mode (e.g., a mode for capturing stereoscopic media that can be later viewed/played back with a stereoscopic effect), cinematic capture mode (e.g., a mode for capturing video media that are designated for display with synthetic depth-of-field effects, lighting effects, and/or other post-processing effects and/or media that tracks subjects and presents the subjects with synthetic depth-of-field effects), panorama mode (e.g., a mode for capturing photos from different positions and/or angles that are stitched together to create a single, larger form-factor image), and/or a time lapse mode (e.g., a mode for capturing media over selected intervals that are designated for playback so as to create visual content that can quickly play back changes to a scene in a field of view of the one or more cameras that occurred over an extended period of time that is longer than the time that it takes to play back changes to the scene).

In some embodiments, displaying the camera mode selection user interface object includes: in accordance with a determination that the currently selected capture mode for the one or more cameras is first capture mode (e.g., a photo mode or a video mode), displaying the camera mode selection user interface object at a first displayed size (e.g., 1300a at FIG. 13B); and in accordance with a determination that the currently selected capture mode for the one or more cameras is second capture mode (e.g., a mode other than a photo mode or a video mode and/or a portrait mode, a spatial capture mode, a cinematic capture mode, a panorama mode, or a time lapse mode), different from the first capture mode, displaying the camera mode selection user interface object at a second displayed size (e.g., 1300a at FIG. 13G or 13I) that is greater than the first displayed size.

In some embodiments, the first capture mode is one of a photo capture mode or a video capture mode (e.g., 1300a at FIG. 13B). In some embodiments, the camera mode selection user interface object is initially displayed (e.g., upon launch of a camera application that corresponds to the camera user interface) with the photo capture mode and the video capture mode as the only two mode options.

In some embodiments, the second capture mode is one of a slow motion capture mode, a time elapse capture mode, portrait capture mode (e.g., 1300a at FIG. 13G or 13I) (e.g., a mode that captures photo media with depth information such that the media, when viewed, includes depth effects such as bokeh/blurring), a cinematic video capture mode (e.g., a mode that captures video media with depth information such that the media, when viewed, includes depth effects such as bokeh/blurring), a panorama capture mode (e.g., a mode for capturing media that combines multiple photos/images together to form a composite photo) or a spatial capture mode (e.g., a mode for capturing media for display with stereoscopic depth).

In some embodiments, the camera mode selection user interface object includes a respective capture mode option (e.g., 1300a at FIG. 13B with respect to the video mode) that corresponds to a respective capture mode (e.g., a photo capture mode or a video capture mode). While the respective capture mode is not the currently selected capture mode (e.g., while another capture mode is selected/enabled) (in some embodiments, while the camera mode selection user interface object is an unexpanded state or in the expanded state), the computer system detects, via the one or more input devices, an input directed to the respective capture mode option (e.g., 1302f and/or 1302e); and In some embodiments, the input is a touch input (e.g., a tap, a press-and-hold, or a swipe), a gaze input, an air gesture, and/or a button/key press. In response to detecting the input directed to the respective capture mode option, the computer system selects the respective capture mode as the currently selected capture mode (e.g., 1300a at FIG. 13D) (e.g., enabling the respective capture mode and/or configuring the computer system to capture media using the respective capture mode in response to a media capture input while the respective capture mode is a currently selected capture mode). In some embodiments, also updating the camera mode selection user interface object to indicate that the respective capture mode is now selected. In some embodiments, selecting the respective capture mode as the currently selected capture mode includes, in accordance with a determination that the input is directed to a representation of a second capture mode, selecting the second capture mode as the currently selected capture mode for the camera user interface and, in accordance with a determination that the input is directed to a representation of a third capture mode that is different from the second capture mode, selecting the third capture mode as the currently selected capture mode for the camera user interface.

In some embodiments, displaying the indication of the currently selected capture mode for the one or more cameras includes: in accordance with a determination that the currently selected capture mode is a first currently selected capture (e.g., a portrait mode, a spatial capture mode, a cinematic capture mode, a panorama mode, or a time lapse mode), displaying the indication of the currently selected capture mode (e.g., 1300a1) for the one or more cameras at a first position (e.g., 1300a at FIG. 13G or 13I) (e.g., a substantially center position) within the camera mode selection user interface object; and in accordance with a determination that the currently selected capture mode is a second currently selected capture mode (e.g., a photo capture mode or a video capture mode), different from the first currently selected capture mode, displaying the indication of the currently selected capture mode for the one or more cameras at a second position (e.g., 1300a at FIG. 13B or 13D) (e.g., an off-center position), different from the first position, within the camera mode selection user interface object.

In some embodiments, while displaying the camera mode selection user interface object at the second size (e.g., 1300a at FIG. 13G), the computer system detects, via the one or more input devices, a second set of one or more inputs (e.g., 1302h) directed to the camera mode selection user interface object, wherein the second set of one or more inputs includes movement (e.g., of at least one input within the second set of one or more inputs); In some embodiments, the second set of one or more inputs includes an input that is a continuation of an input of the first set of one or more inputs. For example, the first set of one or more inputs includes the initial portion of a touch input (e.g., an initial contact) and the second set of one or more inputs includes movement of that touch input. In some embodiments, the input is a touch input (e.g., a swipe), a gaze input, and/or an air gesture. In response to detecting the second set of one or more inputs, the computer system expands the camera mode selection user interface object from the second size to a third size, larger than the second size (e.g., 1300a at FIG. 13H).

In some embodiments, In response to detecting the second set of one or more inputs: in accordance with a determination that the movement has a first movement characteristic (e.g., movement in a certain direction, such as left, or movement having a respective magnitude or distance), the computer system switches the currently selected capture mode to a third capture mode (e.g., 1300a at FIG. 13G) determined based on the first movement characteristic (e.g., a photo capture mode), wherein the third capture mode is different from the first capture mode; and in accordance with a determination that the movement has a second movement characteristic, different from the first movement characteristic, the computer system switches the currently selected capture mode to a fourth capture mode (e.g., 1300a at FIG. 13I) (e.g., a cinematic capture mode) determined based on the second movement characteristic, wherein the fourth capture mode is different from the third capture mode and the first capture mode.

In some embodiments, switching the currently selected capture mode to the third capture mode includes outputting a first non-visual indication (e.g., 1304a) (e.g., haptic and/or audio feedback); and switching the currently selected capture mode to the fourth capture mode includes outputting a second non-visual indication (e.g., haptic and/or audio feedback). In some embodiments, the second non-visual indication is different from the first non-visual indication. In some embodiments, the second non-visual indication is the same as the first non-visual indication.

In some embodiments, the movement included in the second set of one or more inputs is in a first direction of movement (e.g., leftwards for 1302h). The computer system detects, via the one or more input devices, a third set of one or more inputs directed to the camera mode selection user interface object, wherein the third set of one or more inputs (e.g., upwards for 1302j) includes movement in a second direction of movement, different from the first direction of movement. In some embodiments, the input is a touch input (e.g., a tap, a press-and-hold, or a swipe), a gaze input, an air gesture, and/or a button/key press. In response to detecting the third set of one or more inputs, the computer system displays, via the one or more display generation components, one or more respective control user interface objects (e.g., 1300d1, 1300d2, and/or 1300d3) that are selectable to perform corresponding operations within the camera user interface (e.g., affordances/selectable user interface objects). In some embodiments, displaying at least a portion of the one or more control user interface objects. In some embodiments, the one or more respective control user interface objects include a mode option described above with reference to FIG. 7. In some embodiments, the one or more respective control objects includes one or more controls for modifying a current camera capture mode and/or for modifying a setting of a currently selected camera capture mode. In some embodiments, while displaying the one or more respective control user interface objects, the computer system detects a set of one or more inputs that includes an input directed to a first respective control user interface object (e.g., a flash control or an exposure control) of the one or more respective control user interface objects. In response to that set of one or more inputs, the computer system modifies (e.g., changes) a setting corresponding to the first respective control user interface object, such as changing a flash value (e.g., from “on” to “off” or to automatic or changing an exposure compensation value, using a displayed slider).

In some embodiments, camera mode selection user interface object (e.g., 1300a) includes a representation of a first camera mode, a representation of a second camera mode, and a respective user interface element (e.g., 1302f) that moves to indicate whether the first camera mode or the second camera mode is a currently selected camera mode. Displaying the one or more respective control user interface objects includes expanding the respective user interface element (e.g., as described with reference to FIGS. 13J to 13L) (in some embodiments, displaying an animation of the indication increasing in size). the one or more respective control user interface objects are displayed within the expanded respective user interface element. In some embodiments, the respective user interface element is made of a transparent or translucent user interface material that expands (e.g., stretches) to a larger size, and the one or more respective control user interface objects are displayed inside of the user interface material when it is expanded to the larger size.

In some embodiments, displaying the camera user interface includes displaying, concurrently with the camera mode selection user interface object prior to the camera mode selection user interface object being expanded, one or more camera controls (e.g., affordances/selectable user interface objects) that include a first camera control (e.g., 614d and/or 614e at FIG. 13B) at a first location in the camera user interface, the method further comprising: In some embodiments, the one or more camera controls are displayed next to (e.g., adjacent to) the camera mode selection user interface object. In response to detecting the set of one or more inputs directed to the camera mode selection user interface object, the computer system ceases to display the first camera control at the first location in the camera user interface (e.g., FIG. 13L). In some embodiments, the first location is a location that becomes occupied by at least a portion of the expanded camera mode selection user interface object. In some embodiments, ceasing to display a plurality of or all of the one or camera controls at the locations at which they were concurrently displayed with the unexpanded camera mode selection user interface object.

In some embodiments, ceasing to display the first camera control (e.g., 614b) at the first location includes moving the first camera control to a second location in the camera user interface (e.g., displaying an animation of the first camera control shifting from the first location to the second location or ceasing to display the first camera control at the first location and redisplaying the first camera control at the second location), different from the first location. In some embodiments, the second location is location that is not occupied by the expanded camera mode selection user interface object. In some embodiments, a plurality of or all of the one or camera controls are moved to new/different locations when the camera mode selection user interface object is expanded.

In some embodiments, ceasing to display the first camera control at the first location includes removing (e.g., ceasing to display via the one or more display generation components) the first camera control from the camera user interface (e.g., FIG. 13L). In some embodiments, a plurality of or all of the one or camera controls are no longer displayed when the camera mode selection user interface object is expanded.

In some embodiments, the first camera control (e.g., 614f) is a control that, when selected based on an input detected by the one or more input devices, causes the computer system to switch which camera is being used to capture media (e.g., switching between different cameras on a same side of a housing of the computer system and or switching between a first set of one or more cameras on a first sides of a housing of the computer system and a second set of one or more cameras on a second side of the housing of the computer system). In some embodiments, the first camera control is camera selection affordance 614e that operates as illustrated with reference to FIGS. 6B and 6R. In some embodiments, the first camera control is multi-camera affordance 1100e (e.g., FIG. 11A).

In some embodiments, the first camera control (e.g., 614d) is a control that, when selected based on an input detected by the one or more input devices, causes the computer system to display a user interface for displaying previously captured media (e.g., a camera roll affordance, such as captured media affordance 614d that is described with reference to FIG. 6B).

In some embodiments, the camera user interface includes one or more zoom controls (e.g., 1300b) (e.g., affordances/selectable user interface objects for selecting different camera zoom levels (e.g., fixed camera zoom levels such as 1×, 2×, or 5×)) that includes a first zoom control (e.g., 1300b1) at a third location within the camera user interface (and, optionally one or more additional zoom controls corresponding to different zoom levels displayed at or near the third location). The computer system detects, via the one or more input devices, a request to change a zoom level of the camera user interface. In some embodiments, the request is a selection of one or more zoom controls. In some embodiments, the request is a predetermined gesture (e.g., a tap gesture directed to one of the zoom controls, a swipe gesture directed to a region that contains the one or more zoom controls, or a pinch or de-pinch gesture directed to a respective region of the camera user interface (e.g., directed to a region of the camera user interface that includes a live preview of content of the one or more cameras that is included in the camera user interface)). In response to detecting the request to change the zoom level: the computer system changes a zoom level of the camera user interface; and (e.g., changing a zoom level that will be used to capture media using the one or more cameras if a request to capture media is received at the computer system) (in some embodiments, changing the zoom level such as described with reference to input 612i and/or as described with reference to FIGS. 13R-13V and/or method 1600) the computer system shifts the first zoom control to a fourth location within the camera user interface, different from the third location (e.g., as discussed with reference to FIGS. 13R-13T). In some embodiments, shifting a plurality of or all of the one or more zoom controls.

In some embodiments, the computer system detects, via the one or more input devices, an input (e.g., 1302bb) directed to the one or more zoom controls (e.g., 1300b) (e.g., directed to the first zoom control); and In some embodiments, the input is a swipe gesture or a press-and-hold gesture. In response to detecting the input directed to the one or more zoom controls, the computer system expands the one or more zoom controls (e.g., 1300b at FIG. 13U) to display additional zoom options that were not visible prior to detecting the input directed to the one or more zoom controls (e.g., displaying a visual representation of one or more additional zoom levels that were not displayed prior to detecting the input directed to the one or more zoom controls, for example the one or more zoom controls include indications of a first zoom level and/or a second zoom level and displaying the additional zoom controls includes displaying indications of one or more additional zoom levels between the first zoom level and/or second zoom level; indications of one or more additional zoom levels above the first zoom level and/or second zoom level; and/or indications of one or more additional zoom levels below the first zoom level and/or second zoom level).

Note that details of the processes described above with respect to method 1400 (e.g., FIG. 14) are also applicable in an analogous manner to the methods described below/above. For example, method 1400 optionally includes one or more of the characteristics of the various methods described above with reference to methods 700, 800, 1000, 1200, 1500, 1600 and/or 1800. For example, the first set of one or more mode options of method 1400 can be used to switch the type of media captured in response to a capture request, while maintaining a respective value of a camera setting, in accordance with method 1400. For brevity, these details are not repeated below.

FIG. 15 is a flow diagram illustrating a method for displaying a camera control panel overlaid on camera user interface, in accordance with some embodiments. Method 1500 is performed at a computer system (e.g., 100, 300, 500, and/or 600) that is in communication with one or more input devices (e.g., 602) (e.g., touch-sensitive surfaces, hardware input devices (e.g., hardware buttons or rotatable input mechanisms), microphones, gesture input devices, air gesture input devices, and/or gaze input devices), one or more display generation components (e.g., 602) (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 1500 are, optionally, combined, the orders of some operations are, optionally, changed, and some operations are, optionally, omitted.

As described below, method 1500 provides an intuitive way for displaying a camera control panel overlaid on camera user interface. The method reduces the cognitive burden on a user for capturing media concurrently with two sets of cameras, thereby creating a more efficient human-machine interface. For battery-operated computing devices, enabling a user to display a camera control panel overlaid on camera user interface faster and more efficiently conserves power and increases the time between battery charges.

The devices, methods, and/or computer-readable storage media described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. For example, the devices, methods, and/or computer-readable storage media described below provide additional control options (such as by expanding the respective platter and displaying the second plurality of camera controls) without cluttering the UI with additional displayed controls at certain times enhances the operability of the device by reducing unnecessary inputs and/or steps to navigate through different user interfaces or sets of controls, reducing energy usage by the device. By way of additional example, displaying user interface elements (such as the respective platter) with different appearances at different times helps to avoid image persistence or burn in effects that can occur with some display technologies when the same object is displayed with the same appearance at the same location repeatedly or for a long period of time. By way of additional example, the devices, methods, and/or computer-readable storage media described below provide improved feedback (such as by expanding the respective platter and displaying the second plurality of camera controls) enhances the operability of the device by reducing accidental and mistaken inputs, reducing energy usage by the device.

The computer system (e.g., 600) displays (1502), via the one or more display generation components (e.g., 602), a camera user interface (e.g., 1300) (e.g., an interface of a camera application) that includes a first plurality of camera controls (e.g., 614b, 614d, and/or 614e) (e.g., a shutter affordance, camera switching affordance, and/or a captured media display affordance), wherein the first plurality of camera controls includes a respective platter (e.g., 1300a1) that corresponds to one or more of the camera controls of the first plurality of camera controls; In some embodiments, the platter has a visually-distinct border and encompasses a plurality of user interface objects.

The computer system detects (1504), via the one or more user input devices, a set of one or more inputs (e.g., 1302j) corresponding to a request to display additional camera controls. In some embodiments, the input is a touch input (e.g., a tap, a press-and-hold, or a swipe), a gaze input, an air gesture, and/or a button/key press. In some embodiments, the input corresponds to the respective control and/or to the respective platter user interface object.

In response to detecting the set of one or more inputs corresponding to the request to display additional camera controls (1506): the computer system expands (1508) the respective platter from a first size to a second size (e.g., as discussed with reference to FIGS. 13J to 13L), larger than the first size (in some embodiments, displaying an animation of respective platter user interface object expanding); the computer system displays (1510), via the one or more generation components, a second plurality of camera controls (e.g., 1300d1, 1300d2, and/or 1300d3), different from the first plurality of camera controls (in some embodiments, the first plurality of camera controls does not include any user interface objects included in the second plurality of camera controls and/or vice versa), wherein, the respective platter, when displayed at the second size (e.g., when expanded), occupies a first portion of the camera user interface that was previously occupied by one or more of the first plurality of camera controls (e.g., 614b, 614d, and/or 614e); and the computer system ceases (1512) to display one or more of the first plurality of camera controls (e.g., displaying the second plurality of camera controls causes one or more of the first plurality of camera controls to cease to be displayed). In some embodiments, the one or more of the first plurality of camera controls that cease to be displayed include one or more of the first plurality of camera controls that were displayed at the location that is occupied by the respective platter user interface object when the respective platter is displayed at the second size.

In some embodiments, the respective platter (e.g., 1300a1) is part of (e.g., is a component of and/or is included in) a camera mode selection user interface object (e.g., 1300a) that, when selected based on an input (e.g., 1302e and/or 1302f) detected by the one or more input devices, causes the computer system to switch a camera capture mode (e.g., to switch from a photo capture mode and a video capture mode). In some embodiments, the camera mode selection user interface object includes a representation of a first camera mode, a representation of a second camera mode and a respective user interface element that moves to indicate whether the first camera mode or the second camera mode is a currently selected camera mode. In some embodiments, the respective user interface element is made of a transparent or translucent user interface material that expands (e.g., stretches) to a larger size, and the one or more respective control user interface objects are displayed inside of the user interface material when it is expanded to the larger size (e.g., as described in greater detail above with reference to method 1400).

The respective platter, when expanded (e.g., when at the second size), is partially translucent (e.g., as seen for 1300d at FIG. 13L). In some embodiments, the respective platter is completely translucent or partially transparent. In some embodiments, the camera user interface includes one or more visual elements that are overlaid by the expanded respective platter and these elements are partially perceivable at portions of the respective platter that are translucent.

In some embodiments, the camera user interface includes a live preview of content (e.g., 614a) from the one or more cameras (e.g., a preview based on a portion or all of a field-of-view(s) of one or more cameras); the respective platter, when expanded (e.g., when at the second size), overlays at a least a first portion of the live preview of content; and a distorted version (e.g., visually distorted when compared to portions of the live preview of content that are not overlaid by the respective platter) of the first portion of the live preview of content that is overlaid by the respective platter is visible through the respective platter, when the respective platter is expanded (e.g., as discussed with respect to FIG. 13L). In some embodiments, the distorted version is blurred, displayed with simulated refraction, and/or otherwise visually modified to simulate the translucency of the respective platter.

In some embodiments, the respective platter, when unexpanded (e.g., when at the first size), is partially translucent and overlays a second portion of the live preview of content that is different from the first portion of the live preview of the content; a distorted version of the second portion of the live preview of content that is overlaid by the respective platter is visible through the respective platter, when the respective platter is unexpanded (e.g., as discussed with respect to FIG. 13B); and the distorted version of the first portion of the live preview of content is more distorted than the distorted version of the second portion of the live preview of content (e.g. the respective platter is less translucent when expanded, includes a greater degree of simulated reflection, includes a greater degree of simulated refraction, and/or creates a greater distortion effect).

In some embodiments, ceasing to display one or more of the first plurality of camera controls includes ceasing to display a first camera control (e.g., 614d or 614e) that was displayed at a first location in the camera user interface; the first location is occupied by the respective platter, when the respective platter is expanded (e.g., when the respective platter is displayed at the second size); and the first location is not occupied by the respective platter, when the respective platter is unexpanded (e.g., when the respective platter is displayed at the first size). In some embodiments, one or more controls of the first plurality of camera controls that are displayed at location(s) that become occupied by the expanded platter cease to be displayed when the respective platter is expanded. In some embodiments, all controls of the first plurality of camera controls that are displayed at location(s) that become occupied by the expanded platter cease to be displayed when the respective platter is expanded.

In some embodiments, the first plurality of camera controls includes one or more of: a control (e.g., 614b) (e.g., an affordance) that, when selected based on an input detected by the one or more input devices, causes the computer system to capture media with the one or more cameras (e.g., a virtual camera shutter button); a control (e.g., 614e) that, when selected based on an input detected by the one or more input devices, causes the computer system to switch which camera is being used to capture media (e.g., switching between different cameras on a same side of a housing of the computer system and or switching between different cameras on different sides of a housing of the computer system); and a control (e.g., 614d) (e.g., such as captured media affordance 614d that is described with reference to FIG. 6B) that, when selected based on an input detected by the one or more input devices, causes the computer system to display a camera roll (e.g., a user interface for displaying previously captured media). In some embodiments, the control that, when selected based on an input detected by the one or more input devices, causes the computer system to switch which camera is being used to capture media is camera selection affordance 614e that operates as illustrated with reference to FIGS. 6B and 6R or multi-camera affordance 1100e (e.g., in FIG. 11A).

In some embodiments, the computer system detects, via the one or more input devices, a second set of one or more inputs (e.g., 13020) that includes detecting an input directed to a respective control (e.g., a camera setting control, such as a flash control) of the second plurality of camera controls (e.g., 1300d); and In some embodiments, the input is a touch input (e.g., a tap, a press-and-hold, or a swipe), a gaze input, an air gesture, and/or a button/key press. In response to detecting the second set of one or more inputs, the computer system displays (e.g., re-displaying) one or more of the first plurality of camera controls that ceased to be displayed in response to detecting the set of one or more inputs (e.g., as discussed with reference to FIG. 13L). In some embodiments, the one or more of the first plurality of camera controls are displayed at the same position(s) at which the one or more controls were previously displayed. In some embodiments, in response to detecting the second set of one or more inputs, performing an operation based on the respective control. In some embodiments, in response to detecting the second set of one or more inputs, re-displaying the respective platter at the first size (e.g., collapsing the respective platter).

In some embodiments, while the respective platter is displayed at the second size (e.g., as shown in FIG. 13L), the computer system detects, via the one or more input devices, a sequence of one or more inputs (e.g., 1302k, 1302o, and/or 1302p) that corresponds to a request to display the respective platter at the first size (e.g., a request to collapse the respective platter). In some embodiments, the input is a touch input (e.g., a tap, a press-and-hold, or a swipe), a gaze input, an air gesture, and/or a button/key press directed to one or more of the controls and/or an input directed to a region outside of the respective platter. In response to detecting the sequence of one or more inputs that corresponds to the request to display the respective platter at the first size: the computer system displays, via the one or more display generation components, the respective platter at the first size; and the computer system displays (e.g., re-displaying), via the one or more display generation components, one or more of the first plurality of camera controls that ceased to be displayed in response to detecting the set of one or more inputs. In some embodiments, the one or more of the first plurality of camera controls are displayed at the same position(s) at which the one or more controls were previously displayed.

In some embodiments, the camera user interface includes an additional control selectable user interface object (e.g., 1300c) (e.g., a control affordance); and the set of one or more inputs corresponding to a request to display additional camera controls includes an input directed to the additional control selectable user interface object. In some embodiments, the additional control selectable user interface object has a first appearance when the respective platter is at the first size and second appearance (e.g., bolded or highlighted), different from the first appearance, when the respective platter is at the second size. In some embodiments, the set of one or more inputs is the set of one or more inputs directed to the camera mode selection user interface object described with reference to FIG. 14.

In some embodiments, the set of one or more inputs corresponding to a request to display additional camera controls includes: a gesture (e.g., 1302j) of a first type (e.g., a tap gesture) directed to a first portion of the camera user interface (e.g., a portion of the user interface that is separate from the respective platter and includes an affordance); and/or a gesture (e.g., 1302i) of a second type (e.g., a swipe), different from the first type, directed to a second portion of the camera user interface (e.g., a portion that includes the respective platter and/or a different control of the first plurality of camera controls), different from the first portion. In some embodiments, a plurality of different gesture types (e.g., the first and second gesture types) can be used to cause display of the second plurality of camera controls (e.g., display within the expanded respective platter). In some embodiments, doing so allows a user to invoke and/or access the second plurality of camera controls while holding the computer system using a variety of different hand positions and/or by using different amounts of movement and/or by accessing different portions of the user interface. In some embodiments, doing so promotes the discovery of additional controls and/or improves access to these controls.

In some embodiments, the computer system detects, via the one or more input devices, a third set of one or more inputs that includes an input (e.g., 13021, 1302m, and/or 1302n) directed to a first control (e.g., a camera setting control, such as a flash control) of the second plurality of camera controls; and In some embodiments, the input is a touch input (e.g., a tap, a press-and-hold, or a swipe), a gaze input, an air gesture, and/or a button/key press. In response to detecting the third set of one or more inputs, the computer system initiates a process to change a camera setting (e.g., to change a flash setting) that corresponds to the first control (e.g., as discussed with reference to FIGS. 13M to 13Q).

In some embodiments, initiating the process to change the camera setting (e.g., to change a flash setting) that corresponds to the first control includes changing the camera setting that corresponds to the first control (e.g., 1300d1 at FIGS. 13L and 13M) (e.g., changing from a flash setting being on to being off). In some embodiments, in response to detecting the third set of one or more inputs, re-displaying the respective platter at the first size (e.g., collapsing the respective platter).

In some embodiments, initiating the process to change the camera setting (e.g., to change an exposure setting) that corresponds to the first control includes displaying (in some embodiments, within the respective platter), via the one or more display generation components, an adjustment control (e.g., 1310) (e.g., a slider) for adjusting a parameter of the camera setting that corresponds to the first control (e.g., a value of the camera setting). In some embodiments, the input directed to the first control is a long press input.

In some embodiments, initiating the process to change the camera setting (e.g., to change an exposure setting) that corresponds to the first control includes: in accordance with a determination that a respective parameter of the camera setting (e.g., an exposure value) that corresponds to the first control has been changed to a respective value that is different from a default value and a determination that the respective platter is being displayed at the first size (in some embodiments, a determination that the respective platter is not being displayed at the second size), displaying, via the one or more display generation components and in the camera user interface, an indication of the respective value (e.g., 1316a). In some embodiments, in accordance with a determination that the respective platter is being displayed at the first size and the respective parameter is at the default value, forgoing displaying an indication of the value of the respective parameter. In some embodiments, displaying the indication of the respective value includes, in accordance with a determination that the camera setting has a first value displaying a representation of the first value at a respective location in the camera user interface, and in accordance with a determination that the camera setting has a second value, different from the first value, displaying a representation of the second value at the respective location in the camera user interface.

In some embodiments, displaying the indication of the respective value includes: in accordance with a determination that camera setting that corresponds to the first control is first type of camera setting (e.g., an exposure setting), the indication of the respective value is displayed at a third location (e.g., at a top region of the user interface) in the camera user interface (e.g., location of 1316b); and in accordance with a determination that camera setting that corresponds to the first control is second type of camera setting (e.g., a flash setting), different from the first type of camera setting, the indication of the respective value is displayed at a fourth location (e.g., location of 1316a) (e.g., in the upper right regions of the camera user interface and/or in a platter with one or more other controls) in the camera user interface, different from the third location.

In some embodiments, the indication of the respective value, when displayed at the third location (e.g., 1316a), is not selectable to change the camera setting that corresponds to the first control (e.g., the indication is not a selectable user interface object when displayed at the third location). In some embodiments, when the indication is not selectable, the respective value of the first camera setting can be changed via the user interfaces and operations described with reference to FIGS. 13L to 13Q. In some embodiments, the indication of the respective value, when displayed at the fourth location (e.g., 1316b), is selectable (e.g., via the one or more input devices) to change the camera setting that corresponds to the first control (e.g., to change the setting to the default value or to a different value).

In some embodiments, the third location is closer to a respective edge (e.g., a top edge) of the one or more display generation components than the fourth location (e.g., as described for FIG. 13R). In some embodiments, the distance between the third location and an edge of the one or more display generation components that is closest to the third location is shorter than the distance between the fourth location and an edge of the one or more display generation components that is closest to the fourth location.

In some embodiments, while the respective platter is displayed at the second size, the computer system detects, via the one or more input devices, a fourth set of one or more inputs that includes an input (e.g., 1302p) (e.g., a tap gesture) outside of the respective platter (e.g., at a portion of the camera user interface that is not within the respective platter); and In some embodiments, the input is a touch input (e.g., a tap, a press-and-hold, or a swipe), a gaze input, an air gesture, and/or a button/key press. In response to detecting the fourth set of one or more inputs, the computer system ceases to display the respective platter at the second size (e.g., as described with reference to FIG. 13L). In some embodiments, collapsing the platter so that it is displayed (e.g., re-displayed) at the first size.

In some embodiments, while the respective platter is displayed at the second size, detecting, via the one or more input devices, a fifth set of one or more inputs that includes an input (e.g., 13020) (e.g., a tap gesture) directed to the respective platter (e.g., an input within the respective platter); and In some embodiments, the input is a touch input (e.g., a tap, a press-and-hold, or a swipe), a gaze input, an air gesture, and/or a button/key press. In response to detecting the fifth set of one or more inputs, the computer system ceases to display the respective platter at the second size (e.g., as described with reference to FIG. 13L). In some embodiments, collapsing the platter so that it is displayed (e.g., re-displayed) at the first size.

Note that details of the processes described above with respect to method 1500 (e.g., FIG. 15) are also applicable in an analogous manner to the methods described above/below. For example, method 1500 optionally includes one or more of the characteristics of the various methods described herein with reference to methods 700, 800, 1000, 1200, 1400, 1600 and/or 1800. For example, the first plurality of camera controls of method 1500 can be displayed while capturing media with two sets of cameras according to method 1200 or can be displayed in user interface that includes the expanding mode control of method 1400. For brevity, these details are not repeated below.

FIG. 16 is a flow diagram illustrating a method for displaying a control for adjusting a camera zoom level, in accordance with some embodiments. Method 1600 is performed at a computer system (e.g., including one or more mobile phones, personal computers, laptops, tablets, head-mounted displays, wearable devices, and/or other electronic devices) (e.g., 100, 300, 500, and/or 600) that is in communication with one or more input devices (e.g., 602) (e.g., touch-sensitive surfaces, hardware input devices (e.g., hardware buttons or rotatable input mechanisms), microphones, gesture input devices, air gesture input devices, and/or gaze input devices), one or more display generation components (e.g., 602) (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 1600 are, optionally, combined, the orders of some operations are, optionally, changed, and some operations are, optionally, omitted.

As described below, method 1600 provides an intuitive way for displaying a control for adjusting a camera zoom level. The method reduces the cognitive burden on a user for displaying a control for adjusting a camera zoom level, thereby creating a more efficient human-machine interface. For battery-operated computing devices, enabling a user to display a control for adjusting a camera zoom level faster and more efficiently conserves power and increases the time between battery charges.

The devices, methods, and/or computer-readable storage media described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. For example, the devices, methods, and/or computer-readable storage media described below perform an operation when a set of conditions has been met without requiring further user input (such as by displaying the zoom control user interface object at different locations) enhances the operability of the device by reducing unnecessary inputs and/or steps to navigate through different user interfaces or sets of controls, reducing energy usage by the device. By way of additional example, the devices, methods, and/or computer-readable storage media described below provide improved feedback (such as by displaying the zoom control user interface object at different locations based on the respective zoom level) enhances the operability of the device by reducing accidental and mistaken inputs, reducing energy usage by the device.

The computer system (e.g., 600) detects (1602), via the one or more user input devices (e.g., 602), a set of one or more inputs (e.g., 1302a, 1302b, 1302w, and/or 1302z) corresponding to a request to display a camera user interface for capturing media using the one or more cameras at a respective zoom level (e.g., 0.5×, 1×, or 2×); In some embodiments, 1× indicates a respective base and/or default zoom level, 0.5× indicates a zoom level that is ½ of the respective base and/or default zoom level, and 2× indicates a zoom level that is twice the respective base and/or default zoom level. In some embodiments, the input is a touch input (e.g., a tap, a press-and-hold, or a swipe), a gaze input, an air gesture, and/or a button/key press. In some embodiments, the input is directed to a camera application icon. In some embodiments, the camera user interface includes a live preview of a field-of-view of the one or more cameras that is also displayed at the respective zoom level.

In response to detecting the set of one or more inputs corresponding to the request to display the camera user interface for capturing media using the one or more cameras at the respective zoom level, the computer system displays (1604), via the one or more display generation components, the camera user interface (e.g., 1300), including: in accordance with a determination that the respective zoom level is a first zoom level (e.g., 1300b1, 1300b2, 1300b3, and/or 1300b4) (e.g., 0.5×, 1×, or 2×), the computer system displays (1606) a zoom control user interface object (e.g., an affordance that can be selected to change the zoom level, to initiate a process for changing the zoom level, and/or to invoke additional controls/affordances for adjusting the zoom level) for adjusting a zoom level of the one or more cameras at a first location (e.g., the position of 1300b4 in FIG. 13S) in the camera user interface (e.g., at first designated position in the camera user interface and/or in a displayable area of the one or more display generation components); and in accordance with a determination that the respective zoom level is a second zoom level, different from the first zoom level (e.g., 2× when the first zoom level is 1×), the computer system displays (1608) the zoom control user interface object for adjusting a zoom level of the one or more cameras at a second location in the camera user interface (e.g., the position of 1300b4 at FIG. 13R), different from the first location. In some embodiments, the zoom control user interface object includes a textual and/or graphical indication of the respective/current zoom level. In some embodiments, the first location and the second location are adjacent locations. In some embodiments, the first and second locations are separated by one or more user interface objects.

In some embodiments, the computer system detects, via the one or more input devices, a first input (e.g., 1302w or 1302z) directed to the zoom control user interface object; and In some embodiments, the input is a touch input (e.g., a tap, a press-and-hold, or a swipe), a gaze input, an air gesture, and/or a button/key press. In response to detecting the first input, the computer system adjusts the zoom level (e.g., increasing or decreasing the level) of the one or more cameras. In some embodiments, adjusting the zoom level includes adjusting the level based on a direction of movement of the first input and/or on a magnitude of the first input.

In some embodiments, the computer system detects, via the one or more input devices, a second input (e.g., 1302w, 1302z, 1302x, or 1302aa) (e.g., a tap input) directed to the zoom control user interface object (in some embodiments, different from the first zoom level and the second zoom level); and In some embodiments, directed to a portion of the zoom control user interface object that corresponds to the third zoom level. In some embodiments, the input is a touch input (e.g., a tap, a press-and-hold, or a swipe), a gaze input, an air gesture, and/or a button/key press. In response to the second input: in accordance with a determination that the second input is directed to the first location in the camera user interface while the respective zoom level is the first zoom level when the second input is detected, the computer system adjusts the zoom level to the third zoom level (e.g., response to 1302w described at FIG. 13S); in accordance with a determination that the second input is directed to the first location in the camera user interface while the respective zoom level is the second zoom level when the second input is detected, the computer system forgoes (e.g., response to 1302x described at FIG. 13S) adjusting the zoom level to the third zoom level (e.g., adjusting the zoom level to a different zoom level and/or performing a different operation such as setting a focus point based on a location of the second input and/or setting an exposure level based on a location of the second input); in accordance with a determination that the second input is directed to the second location in the camera user interface while the respective zoom level is the second zoom level when the second input is detected, the computer system adjusts the zoom level to the third zoom level (in some embodiments, the input target (e.g., tap target) for a given zoom level is at different locations, based on the zoom, level at the time the input is received); and in accordance with a determination that the second input is directed to the second location in the camera user interface while the respective zoom level is the first zoom level when the second input is detected, the computer system forgoes adjusting the zoom level to the third zoom level (e.g., adjusting the zoom level to a different zoom level and/or performing a different operation such as setting a focus point based on a location of the second input and/or setting an exposure level based on a location of the second input).

In some embodiments, the zoom control user interface object concurrently includes: a first portion (e.g., a 1× zoom portion) that corresponds to the first zoom level (e.g., 1300b1); a second portion (e.g., a 3× zoom portion) that corresponds to the second zoom level (e.g., 1300b2); and a third portion (e.g., a 5× zoom portion) that corresponds to the third zoom level (e.g., 1300b3). The first portion, the second portion, and the third portion of the zoom control user interface object are displayed at different locations in the camera user interface (e.g., as seen in FIG. 13B). In some embodiments, the locations of the first, second, and third portions change as the respective zoom level (e.g., the current zoom level) changes. In some embodiments, the one or more cameras includes three or more cameras (in some embodiments, prime cameras each having a different zoom level/focal length) that include a first camera, a second camera, and a third camera. In some embodiments, the first portion corresponds to the first camera, the second portion corresponds to a second camera, and the third portion corresponds to the third camera. In some embodiments, one or more of the first, second, and third portions correspond to a zoom level that is not a zoom level of a particular camera of the one or more cameras (e.g., one or more portions correspond to a digital zoom level).

In some embodiments, the computer system detects, via the one or more input devices, a first respective input (e.g., 1302w or 1302z) directed to a first respective location of the camera user interface (e.g., a particular location within the camera user interface); and In some embodiments, the input is a touch input (e.g., a tap, a press-and-hold, or a swipe), a gaze input, an air gesture, and/or a button/key press while attention is directed to the first respective location in the camera user interface. In response to detecting the first respective input: in accordance with a determination that the respective zoom level is the first zoom level, the computer system adjusts the zoom level based on the first respective input (e.g., response to 1302w described at FIG. 13S); and In some embodiments, the first respective location corresponds to a portion of the zoom control user interface object when the respective zoom level is the first zoom level. In accordance with a determination that the respective zoom level is the second zoom level, the computer system performs a first camera focus operation (e.g., response to 1302x described with reference to FIG. 13S) based on the first respective input (e.g., selecting content within the field-of-view of the one or more cameras that correspond to the first respective location as a focus point). In some embodiments, the first respective location does not correspond to any portion of the zoom control user interface object when the respective zoom level is the second zoom level and corresponds to, instead, to a portion of a live preview of content of the one or more cameras.

In some embodiments, the computer system detects, via the one or more input devices, a second respective input (e.g., 1302z or 1302aa) directed to a second respective location of the camera user interface, different from the first respective location (e.g., a different particular location within the camera user interface); In some embodiments, the input is a touch input (e.g., a tap, a press-and-hold, or a swipe), a gaze input, an air gesture, and/or a button/key press while attention is directed to the second respective location in the camera user interface. In response to detecting the second respective input: in accordance with a determination that the respective zoom level is the first zoom level, the computer system performs a second camera focus operation (e.g., response to 1302aa described with reference to FIG. 13T) based on the second respective input (e.g., selecting content within the field-of-view of the one or more cameras that correspond to the second respective location as a focus point); and (in some embodiments, the second respective location does not correspond to any portion of the zoom control user interface object when the respective zoom level is the second zoom level and corresponds to, instead, to a portion of a live preview of content of the one or more cameras) in accordance with a determination that the respective zoom level is the second zoom level, the computer system adjusts the zoom level (e.g., response to 1302z at FIG. 13T) based on the second respective input. In some embodiments, the second respective location corresponds to a portion of the zoom control user interface object when the respective zoom level is the second zoom level.

In some embodiments, the computer system displays, via the one or more display generation components, an indication of the respective zoom level (e.g., 1300b at the center of 1300) (e.g., the currently selected zoom level with which media will be captured) at a respective location (e.g., a fixed location, for example, directly above a shutter/capture affordance) within the camera user interface, including: In some embodiments, the indication of the respective zoom level is displayed at the respective location, regardless of the currently selected zoom level (e.g., it is displayed at a fixed location). In accordance with a determination that the respective zoom level is the first zoom level, the computer system displays an indication of the first zoom level (e.g., 1300b1 displayed at the center of 1300 at FIG. 13B) at the respective location within the camera user interface (e.g., without displaying an indication of another zoom level at the respective location within the camera user interface). In accordance with a determination that the respective zoom level is the second zoom level, the computer system displays an indication of the second zoom level (e.g., 1300b4 displayed at the center of 1300 at FIG. 13S) at the respective location within the camera user interface (e.g., without displaying an indication of another zoom level at the respective location within the camera user interface).

In some embodiments, displaying the zoom control user interface object (e.g., 1300b) includes concurrently displaying an indication of the respective zoom level and one or more indications of other zoom levels (e.g., a plurality of controls for adjusting the zoom level, such as a 1× zoom control, a 3× zoom control, and/or a 5× zoom control that correspond to currently unselected zoom levels) and an indication of the respective zoom level is visually emphasized relative to the one or more indications of other zoom levels (e.g., as described with reference to FIG. 13B), including: (e.g., the indication of the respective zoom level is larger, bolder, darker, a different color, more saturated, brighter, less transparent, and/or otherwise visually emphasized relative to the one or more indications of other zoom levels) in accordance with a determination that the respective zoom level is the first zoom level, visually emphasizing the indication of the first zoom level relative to indications of one or more other zoom levels; and in accordance with a determination that the respective zoom level is the second zoom level, visually emphasizing the indication of the second zoom level relative to indications of one or more other zoom levels.

In some embodiments, the plurality of controls for adjusting the zoom level includes: a first indication of a first different zoom level that is a first distance from the respective location (e.g., a first distance from the indication); a second indication of a second different zoom level that is a second distance from the respective location; and the second indication of the second different zoom level is visually deemphasized relative to the first indication of the first different zoom level (e.g., 1300b as described with reference to FIG. 13B). In some embodiments, the visual emphasis for a given control of the plurality of controls decreases the further away that the control is from the respective location.

In some embodiments, the computer system displays, via the one or more display generation components and concurrently with the zoom control user interface object (e.g., 1300b), one or more camera controls (e.g., 614b, 614d, and/or 614e) (e.g., affordances/selectable user interface objects). While displaying the one or more camera controls, the computer system detects, via the one or more input devices, an input directed to a respective camera control of the one or more other camera controls (e.g., a tap input, air tap input, click or button press that is directed to the respective camera control and/or is detected while attention is directed to the respective camera control). In response to detecting the input directed to the respective camera control, the computer system initiates a process to perform an operation associated with the camera. In some embodiments, the one or more camera controls include: a camera mode selection user interface object (e.g., as described with reference to FIG. 14); a first plurality of camera controls or a second plurality of camera controls (e.g., as described with reference to FIG. 15); a control (e.g., an affordance) that, when selected based on an input detected by the one or more input devices, causes the computer system to capture media with the one or more cameras (e.g., a shutter button); a control that, when selected based on an input detected by the one or more input devices, causes the computer system to switch which camera is being used to capture media (e.g., switching between different cameras on a same side of a housing of the computer system and or switching between different cameras on different sides of a housing of the computer system); and/or a control that, when selected based on an input detected by the one or more input devices, causes the computer system to display a camera roll (e.g., a user interface for displaying previously captured media).

Note that details of the processes described above with respect to method 1600 (e.g., FIG. 1600) are also applicable in an analogous manner to the methods described above/below. For example, method 1600 optionally includes one or more of the characteristics of the various methods described herein with reference to methods 700, 800, 1000, 1200, 1400, 1500 and/or 1800. For example, the control for adjusting a camera zoom level can be displayed with any of the user interfaces of methods 700, 800, 1000, 1200, 1400, 1500 and/or 1800. For brevity, these details are not repeated below.

FIGS. 17A-17K illustrate exemplary user interfaces for concurrently displaying one or more controls for changing a zoom level and one or more controls for changing a capture orientation, in accordance with some embodiments. The user interfaces in these figures are used to illustrate the processes described below, including the processes in FIG. 18.

FIG. 17A illustrates, at the bottom, device 600 displaying camera user interface 1700. Camera user interface 1700 includes various selectable user interface objects and indicators for configuring media capture functions and features, capturing media, and reviewing and/or editing captured media. In some embodiments, camera user interface 1700 includes one or more features of camera user interface 900, camera user interface 1100, and/or camera user interface 1300. For example, camera user interface 1700 includes camera preview 900a, which includes a representation of a field-of-view of the environment captured by one or more front facing cameras of computer system 600 that is framed (e.g., cropped) as it would currently be framed in media captured via camera user interface 1700 (e.g., camera preview 900a is a live or near-live viewfinder). At FIG. 17A, camera preview 900a is a representation of the environment (e.g., an indoor environment with subjects 1702a, 1702b, and 1702c standing in the foreground) as captured by one or more of the front facing cameras of device 600, such as front facing camera 606. Shutter affordance 900b is a software button that can be selected to initiate the capture of media in a currently selected capture mode using one or more current settings. Camera selection affordance 900c is a software button for switching between capture using one or more front facing cameras (e.g., front facing camera 606) and using one or more rear facing cameras (e.g., rear facing cameras 606A, 606B, and/or 606C). Captured media affordance 900d is a selectable thumbnail icon that previews captured media and can be selected to view and/or edit captured media (e.g., in a media viewing or media library user interface). Camera user interface 1700 also includes mode option affordance 1300a that can be used to quickly (e.g., via a single input) switch between a photo capture mode and a video capture mode or to transition to additional capture modes.

At FIG. 17A, camera user interface 1700 also includes zoom affordance 900f that can be selected to adjust (e.g., gradually change and/or toggle) the current level of zoom of the currently selected camera(s), which also modifies the zoom level of the content displayed in camera preview 900a. Camera user interface 1700 also includes, next to zoom affordance 900f, orientation affordance 1700a that can be selected to adjust (e.g., gradually change and/or toggle) a current orientation (e.g., from portrait to landscape or vice versa) of preview 900a and to change the orientation of media that is captured. In some embodiments, orientation affordance 1700a includes one or more features of capture orientation affordance 900g, described with reference to FIG. 9F. Camera user interface 1700 also includes options affordance 1700c that can be selected to display additional camera options, such as the options included in options platter 1300d (e.g., FIG. 13L). In some embodiments, options affordance 1700c includes one or more features of options affordance 1300c, described with reference to FIG. 13L. Camera user interface 1700 also includes automatic tracking affordance 1700b that can be selected to enable or disable an automatic tracking mode and/or to access additional controls for managing automatic tracking. In some embodiments, automatic tracking affordance 1700b includes one or more features of tracking mode affordance 900e1 (e.g., FIG. 9I) and/or tracking mode affordance 900e (e.g., FIG. 9A). At FIG. 17A, automatic tracking affordance 1700b is visually highlighted, indicating that an automatic tracking mode is currently enabled. In some embodiments, while in the automatic tracking mode, device 600 can automatically adjust the zoom and/or orientation of camera preview 900a and of media captured via camera user interface 1700. Camera user interface 1700 also includes depth affordance 1700d that can be selected to enable, disable, and/or modify a simulated (e.g., synthetic) depth-of-field effect that can be applied to captured media to create an appearance of depth (e.g., by blurring visual elements that are at different depths-of-field in the environment via a digital bokeh effect). In some embodiments, depth affordance 1700d includes one or more features of depth affordance 614f (e.g., FIGS. 6B and 6M). In some embodiments, one or more elements of camera user interface 1700 have a simulated glass appearance, as discussed with reference to FIG. 6B.

FIG. 17A illustrates, at the top, camera sensor schematic 1704. Camera sensor schematic 1704 is a schematic of a camera sensor of the one or more cameras of device 600 (e.g., a camera sensor of front facing camera 606). In some embodiments, the camera sensor corresponding to camera sensor schematic 1704 is a solid-state camera sensor, such as a CMOS sensor or a CCD sensor. In some embodiments, the camera sensor corresponding to camera sensor schematic 1704 has a pixel count of 8 megapixels (MP), 12 MP, 24 MP, 48 MP, or greater. In some embodiments, device 600 can use less than the total area of the camera sensor corresponding to camera sensor schematic 1704 when capturing media and/or when providing a live preview (e.g., preview 900a). For example, at FIG. 17A, preview 900a is generated using selected portion 1704a of the camera sensor corresponding to camera sensor schematic 1704 that has a 4:3 (height:width) aspect ratio and that is zoomed in, as indicated by the area of selected portion 1704a relative to the full, available area of camera sensor schematic 1704.

At FIG. 17A, device 600 detects a number of inputs directed to elements of camera user interface 1700. In some embodiments, when device 600 is depicted detecting a plurality of inputs, the inputs are detected at different times; in some embodiments, two or more of the inputs are detected at the same time. Device 600 detects input 1706a directed to zoom affordance 900f, the results of which are discussed in detail with reference to FIG. 17B. Device 600 detects input 1706b directed to orientation affordance 1700a, the results of which are discussed in detail with reference to FIG. 17C. Device 600 detects input 1706c directed to depth affordance 1700d. In response to input 1706c, device 600 applies a simulated depth effect to preview 900a (e.g., as described with reference to FIG. 6M). Device 600 detects input 1706d (e.g., a pinch gesture) directed to preview 900a. In some embodiments, input 1706a and/or one or more of inputs 1706b-17060, discussed below, is a touch gesture (e.g., a tap, a swipe, or touch-and-hold), an air gesture (e.g., an air tap or air pinch), or a selection input (e.g., via a hardware input mechanism such as a button) that is detected while a respective user interface element (e.g., shutter affordance 900b) is selected and/or is in focus.

At FIG. 17B, in response to input 1706a directed to zoom affordance 900f and/or input 1706d, device 600 zooms out to a predetermined zoom level, as reflected in preview 900a, the updated appearance of zoom affordance 900f, and camera sensor schematic 1704. Device 600 also, in response to input 1706a, disables the automatic tracking mode associated with automatic tracking affordance 1700b, as indicated by the updated appearance of automatic tracking affordance 1700b, and displays indication 1708a. Indication 1708a includes graphical element 1708a1 that matches the appearance of automatic tracking affordance 1700b and text 1708a2 (“AUTO TRACKING OFF”). In the embodiment of FIG. 17B, the matching appearance of graphical element 1708a1 and automatic tracking affordance 1700b assists users in associating the functionality of automatic tracking affordance 1700b with the change in status indicated by indication 1708a. In some embodiments, indication 1708a has a simulated glass appearance (e.g., as discussed with reference to FIG. 6B) and a distorted view of portions of preview 900a are visible through indication 1708a. In some embodiments, when device 600 disables the automatic tracking mode in response to selection of a control of preselected set of controls (e.g., a set that includes zoom affordance 900f and orientation affordance 1700a), the automatic tracking mode remains disabled until it is manually reenabled (e.g., FIGS. 17D and 17F) or until certain predetermined conditions are met (e.g., user interface 1700 is reinvoked after being closed). With the change in zoom level, camera sensor schematic 1704 now shows that selected portion 1704a includes the entire height of the camera sensor corresponding to camera sensor schematic 1704, while maintaining a 4:3 aspect ratio that does not include portions of the width of the camera sensor corresponding to camera sensor schematic 1704. At FIG. 17B, device 600 detects input 1706d (e.g., a de-pinch gesture). In response to input 1706d, device 600 zooms in to return preview 900a to the state shown in FIG. 17A. In some embodiments, reversing the zooming that occurred in response to input 1706a does not reverse the disabling of the automatic tracking mode.

At FIG. 17C, in response to input 1706b (FIG. 17A) directed to orientation affordance 1700a, device 600 changes the orientation of preview 900a from portrait to landscape (e.g., from 4:3 to 3:4) and prepares to capture media in landscape orientation, as reflected in preview 900a, the updated appearance of orientation affordance 1700a, and camera sensor schematic 1704. Device 600 also, in response to input 1706b, disables the automatic tracking mode associated with automatic tracking affordance 1700b, as indicated by the updated appearance of automatic tracking affordance 1700b, and displays indication 1708a. With the change in orientation, camera sensor schematic 1704 now shows that selected portion 1704a includes a greater amount of width of the camera sensor corresponding to camera sensor schematic 1704. Because preview 900a remains at the lower of the two predetermined zoom levels associated with zoom affordance 900f, selected portion 1704 does not include the entire width of the camera sensor corresponding to camera sensor schematic 1704. At FIG. 17C, device 600 detects input 1706f directed to automatic tracking affordance 1700b and input 1706g (e.g., an upwards swipe) directed to home affordance 1700e. In response to input 1706g, device 600 ceases to display camera user interface 1700 and displays home screen 604. In some embodiments, ceasing to display camera user interface 1700 (or ceasing to display camera user interface 1700 for at least a predetermined period of time), resets the automatic tracking mode to a default state (e.g., a default state of being enabled or a default state of being disabled).

At FIG. 17D, in response to input 1706f directed to automatic tracking affordance 1700b, device 600 displays automatic tracking mode platter 1700f. Automatic tracking mode platter 1700f includes options for controlling (e.g., enabling or disabling) aspects of the automatic tracking mode. In the embodiment of FIGS. 17A-17K, the automatic tracking mode includes two independently controllable elements: automatic zooming controls 1700f1 and automatic rotation controls 1700f2 (e.g., automatic orientation change). In some embodiments, changes to the automatic tracking mode that are made via automatic tracking mode platter 1700f persist across different camera capture sessions and are therefore permanent until changed, again, via automatic tracking mode platter 1700f, whereas disabling of the automatic tracking mode via manual capture parameter changes (e.g., input 1706a and/or input 1706b) persist only for the current camera capture session, as discussed above with reference to FIG. 17C. At FIG. 17D, automatic tracking mode platter 1700f shows that both functions are currently “OFF” (e.g., as a result of input 1706b of FIG. 17A). In some embodiments, manually changing the orientation only disables automatic rotation and/or manually changing the zoom level only disables automatic zooming. At FIG. 17D, device 600 detects input 1706h directed to automatic zooming controls 1700f1.

At FIG. 17E, in response to input 1706h, device 600 enables automatic zooming, while automatic rotation remains disabled. Further in response to input 1706h, device 600 displays indication 1708b. Indication 1708b includes graphical element 1708b1 that matches the appearance of automatic tracking affordance 1700b and text 1708b2 (“ZOOM ON”). Indication 1708b has a visual characteristic (e.g., highlighting) that matches a visual characteristic of automatic tracking affordance 1700b when it is in the enabled state (e.g., as seen in FIG. 17A). At FIG. 17E, device 600 detects input 1706i directed to automatic rotation controls 1700f2.

At FIG. 17F, in response to input 1706i, device 600 enables automatic rotation. Further in response to input 1706i, device 600 displays indication 1708c. Indication 1708c includes graphical element 1708cl that matches the appearance of automatic tracking affordance 1700b and text 1708c2 (“ROTATE ON”). At FIG. 17F, device 600 detects input 1706j (e.g., a tap) directed to preview 900a and also detects that subjects 1702b and 1702c have exited the field of view of the one or more cameras that corresponds to preview 900a.

At FIG. 17G, in response to input 1706j, device 600 ceases to display automatic tracking mode platter 1700f, which includes redisplaying automatic tracking affordance 1700b and options affordance 1700c. Because the automatic tracking mode is now enabled, automatic tracking affordance 1700b has the same appearance that it had at FIG. 17A. In response to detecting the change in subjects and/or the change in the field of view of the one or more cameras that corresponds to preview 900a, device 600 automatically changes the orientation (e.g., back to portrait) and zoom level of preview 900a to improve the framing of remaining subject 1702a. Device 600 also displays indication 1708d. Indication 1708d includes graphical element 1708d1 that matches the appearance of automatic tracking affordance 1700b and text 1708d2 (“ROTATE AND ZOOM”). With the automatic changes, camera sensor schematic 1704 now shows that selected portion 1704a includes portrait-oriented portion of the camera sensor that corresponds to camera sensor schematic 1704 that is smaller than that shown at FIG. 17A, because preview 900a is more zoomed in at FIG. 17F than at FIG. 17A. In some embodiments, device 600, while the automatic tracking mode is enabled, automatically changes a capture parameter (e.g., automatically changes a zoom level and/or an orientation) in response to detecting a change in the number of subjects in accordance with method 1000 and/or in accordance with a tracking mode (e.g., tracking mode rules) of method 1200. At FIG. 17G, device 600 detects an additional subject entering the field of view of the one or more cameras corresponding to preview 900a.

At FIG. 17H, in response to detecting the addition of subject 1702c and/or the change in the field of view of the one or more cameras that corresponds to preview 900a, device 600 automatically zooms out to improve the framing of subjects 1702a and 1702c, while remaining in portrait orientation. Device 600 also displays indication 1708e. Indication 1708e includes graphical element 1708e1 that matches the appearance of automatic tracking affordance 1700b and text 1708e2 (“ZOOM”). With the automatic zooming, camera sensor schematic 1704 now shows that selected portion 1704a includes a larger, portrait-oriented portion of the camera sensor that corresponds to camera sensor schematic 1704 compared to that shown in FIG. 17G. At FIG. 17H, device 600 detects input 1706k (e.g., a tap) directed to shutter affordance 900b, input 1706l (e.g., a tap) directed to mode option affordance 1300a, input 1706m (e.g., a rightward swipe) directed to mode option affordance 1300a, and input 1706n (e.g., a tap) directed to camera selection affordance 900c.

At FIG. 17I, in response to input 1706k directed to shutter affordance 900b, device 600 captures a photo corresponding to the content of preview 900a when input 1706k was detected. Device 600 also updates captured media affordance 900d to show a thumbnail of the captured photo.

At FIG. 17J, in response to input 1706l and/or input 1706m directed to mode option affordance 1300a, device 600 transitions to a video capture mode (e.g., prepares to capture video media). Device 600 updates the appearance of shutter affordance 900b and camera selection affordance 900c to reflect the change in capture mode and displays video-related indicators 1710 that show capture duration, resolution, and frame rate information. Device 600 also changes to a 16:9 aspect ratio for capture, as shown in preview 900a and camera sensor schematic 1704a.

At FIG. 17K, in response to input 1706n, device 600 transitions from displaying preview 900a using a set of one or more front facing cameras to displaying preview 900a (and preparing to capture media) using a set of one or more rear facing cameras (where rear facing cameras face away from a display that is being used to display the camera user interface), such as rear facing cameras 606A, 606B, and/or 606C. Device 600 updates camera user interface 1700 to include various controls for rear facing capture, including displaying zoom affordance 1300b that has multiple levels of zoom options. Notably, camera user interface 1700 at FIG. 17K, while configured for rear facing capture, does not include orientation affordance 1700a. In some embodiments, orientation affordance 1700a is displayed while device 600 is configured for rear facing capture. In some embodiments, camera user interface 1700, while configured for rear facing capture, includes one or more features of camera user interface 1300 as described with respect to FIG. 13B. At FIG. 17K, device 600 detects input 17060 directed to camera selection affordance 900c. In response to input 17060, device 600 returns to the state shown in FIG. 17J.

FIG. 18 is a flow diagram illustrating a method for displaying a camera user interface that concurrently includes one or more controls for changing a zoom level and one or more controls for changing a capture orientation, in accordance with some embodiments. Method 1800 is performed at a computer system (e.g., including one or more mobile phones, personal computers, laptops, tablets, head-mounted displays, wearable devices, and/or other electronic devices) (e.g., 100, 300, 500, and/or 600) that is in communication with one or more input devices (e.g., touch-sensitive surfaces, hardware input devices (e.g., hardware buttons or rotatable input mechanisms), microphones, gesture input devices, air gesture input devices, and/or gaze input devices), one or more display generation components (e.g., a display controller; a touch-sensitive display system; a display (e.g., integrated and/or connected), a 3D display, a transparent display, a projector, and/or a heads-up display), and one or more cameras (e.g., forward facing camera 606, rear facing cameras 606A, 606B, and/or 606C, and/or externally-connected cameras, and/or a plurality of cameras with different lenses (e.g., different fixed focal lengths), such as a standard camera, a telephoto camera, a wide-angle camera, and/or a macro camera). Some operations in method 1800 are, optionally, combined, the orders of some operations are, optionally, changed, and some operations are, optionally, omitted.

As described below, method 1800 provides an intuitive way for displaying a camera user interface by concurrently including one or more controls for changing a zoom level and one or more controls for changing a capture orientation. The method reduces the cognitive burden on a user for displaying a camera user interface by concurrently including one or more controls for changing a zoom level and one or more controls for changing a capture orientation, thereby creating a more efficient human-machine interface. For battery-operated computing devices, enabling a user to adjust a zoom level and/or capture orientation faster and more efficiently, thereby conserving power and increasing the time between battery charges.

The devices, methods, and/or computer-readable storage media described below enhance the operability of the device and makes the user-device interface more efficient (e.g., by helping the user to provide proper inputs and reducing user mistakes when operating/interacting with the device) which, additionally, reduces power usage and/or improves battery life of the device by enabling the user to use the device more quickly and efficiently. For example, the devices, methods, and/or computer-readable storage media described below provide improved control options that allow a user to more quickly and precisely control the zoom and/or orientation of media capture (e.g., without requiring multiple inputs or complex control menus). Moreover, doing so for a camera user interface reduces the risk that transient capture events/moments are missed while the user engages with complex and time-consuming control options.

The computer system detects (1802) (in some embodiments, via the one or more user input devices) an event (e.g., selection of a camera affordance in home user interface 602) associated with displaying a camera user interface (e.g., 1700). In some embodiments, the event is an input such as a touch input (e.g., a tap, a press-and-hold, or a swipe), a gaze input, an air gesture, and/or a button/key press. In some embodiments, the input is directed to a camera application icon. In some embodiments, the camera user interface includes a live preview of a field-of-view of the one or more cameras that is displayed at an initial zoom level. In some embodiments, the event is detecting, while the camera user interface is not displayed, content within the field-of-view of the one or more cameras that is indicative of a user wishing to capture media (e.g., one or more individuals posing in front of the one or more cameras).

In response to detecting the event associated with displaying the camera user interface, the computer system displays (1804), via the one or more display generation components, the camera user interface (e.g., 1700), including displaying concurrently within the camera user interface: a live preview of content (1806) (e.g., 900a) from the one or more cameras (e.g., a preview based on a portion or all of a field-of-view(s) of one or more cameras); and a plurality of selectable options (1808) (e.g., user-selectable graphical elements) including a first selectable option (e.g., 900f) and a second selectable option (e.g., 1700a) that is different from the first selectable option.

The computer system detects (1810), via the one or more input devices, a selection input (e.g., a touch input, an air gesture, and/or a button press) (e.g., 1706a or 1706b).

In response to detecting the selection input (1812) and in accordance with a determination that the selection input is directed to the first selectable option (e.g., 900f) (e.g., a zoom control, such as a 1× or 3× control, a zoom wheel, or a zoom slider) of the plurality of selectable options, the computer system changes (1814) a zoom level (e.g., increasing or decreasing the zoom level) (in some embodiments, changing the zoom level includes changing from displaying content from a first camera of the one or more cameras to displaying content from a second camera of the one or more cameras) of the live preview of content from the one or more cameras (e.g., as discussed with reference to FIG. 17B). In some embodiments, changing a zoom level of media captured by the one or more cameras via the camera user interface.

In response to detecting the selection input (1812) and in accordance with a determination that the selection input is directed to the second selectable option (e.g., 1700a) (e.g., a capture orientation control, a capture orientation wheel, or a capture orientation slider) of the plurality of selectable options, different from the first selectable option, the computer system changes (1816) a capture orientation (e.g., from horizontal (e.g., landscape) to vertical (e.g., portrait) or vice versa) of media (e.g., photo or video media) captured by the one or more cameras via the camera user interface (e.g., as discussed with reference to FIG. 17C). In some embodiments, media is captured when a software or hardware shutter button is activated. In some embodiments, changing the capture orientation of media includes changing the live preview of content from the one or more cameras from being oriented horizontally (e.g., landscape) to being oriented vertically (e.g., portrait) or vice versa. In some embodiments, changing the capture orientation includes changing the aspect ratio (e.g., the ratio of width to height) in addition to changing the orientation (e.g., from 16:9 to 3:4 or from 4:3 to 9:16). In some embodiments, changing the capture orientation includes remaining in a currently selected capture mode (e.g., a photo capture mode or a video capture mode). In some embodiments, the capture orientation is changed without changing an orientation of the camera and/or camera sensor (e.g., different subsets of the sensor are used to capture different orientations of media items such as capturing landscape orientation media items or portrait orientation media items).

In some embodiments, while displaying the camera user interface, the computer system detects, via the one or more input devices, a capture input (e.g., 1706k). In some embodiments, the plurality of selectable options includes a capture selectable option, such as a software shutter button, and the input is directed to the capture selectable option. In some embodiments, the one or more input devices includes a hardware button and the capture input is directed to the hardware button. In response to detecting the capture input, the computer system captures, via the one or more cameras, media (e.g., a photo or video) that corresponds to the live preview of content (e.g., as discussed with reference to FIG. 17I) (e.g., media that includes at least a portion of the content currently presented in the live preview of content and that includes one or more properties of the live preview of content, such as the zoom level and/or or orientation of the live preview of content). In some embodiments, different content is captured depending on a state of one or more camera capture settings for the one or more cameras (e.g., zoom level and/or orientation settings).

In some embodiments, the one or more cameras include a first camera (e.g., 606) that includes a camera sensor (e.g., a camera sensor corresponding to 1704); and changing a capture orientation of media captured by the one or more cameras includes changing a portion of the camera sensor that is designated for capturing media (e.g., designated for capturing media in response to detecting a capture input) from a first portion of the camera sensor to a second portion of the camera sensor, different from the first portion (e.g., as discussed with reference to 1704 and FIG. 17C). In some embodiments, the first portion of the camera sensor and the second portion of the camera sensor overlap at least in part. In some embodiments, the first portion and/or the second portion are a subset of the camera sensor. In some embodiments, the first portion and/or the second portion of the camera sensor has an aspect ratio and/or orientation that matches the aspect ratio and/or orientation of the live preview of content. In some embodiments, designating a portion of the camera sensor that is used for capturing media includes selecting image data detected by the respective portion of the camera sensor for processing and/or storage. In some embodiments, designating a portion of the camera sensor that used for capturing media includes selecting image data detected by the respective portion of the camera sensor for display when the media is presented. In some embodiments, sensor data from portions of the camera sensor that are not designated for capturing media is still stored for editing and/or image processing.

In some embodiments, the second portion of the camera sensor includes at least a portion of the camera sensor that was not designated for capturing media prior to detecting the selection input (e.g., as discussed with reference to 1704, 1704a, and FIG. 17C) (e.g., the second portion of the camera sensor includes a respective portion of the camera sensor that is not included in the first portion of the camera sensor). In some embodiments, changing a portion of the camera sensor that is designated for capturing media includes designating a portion of the camera sensor for media capture that was not previously designated for media capture.

In some embodiments, the first portion of the camera sensor includes at least a portion of the camera sensor that is not designated for capturing media in response to detecting the selection input (e.g., as discussed with reference to 1704, 1704a, and FIG. 17C) (e.g., the first portion of the camera sensor includes a respective portion of the camera sensor that is not included in the second portion of the camera sensor). In some embodiments, changing a portion of the camera sensor that is designated for capturing media includes ceasing to designate a portion of the camera sensor for media capture that was previously designated for media capture.

In some embodiments, the plurality of selectable options includes a mode selectable option (e.g., 1300a) that corresponds to a first capture mode (e.g., a portrait mode, a video mode, a macro mode, a time lapse mode, or a panorama mode). In response to detecting the selection input and in accordance with a determination that the selection input is directed to the mode selectable option, the computer system changes a capture mode of the one or more cameras from a current capture mode to the first capture mode (e.g., as discussed with reference to FIG. 17J). In some embodiments, changing the capture mode includes changing a zoom level, a capture orientation, and/or an aspect ratio of the live preview of content. In some embodiments, changing the capture mode includes maintaining one or more of a current zoom level, capture orientation, and/or aspect ratio of the live preview of content (e.g., from the previous capture mode).

In some embodiments, while the live preview of content is a live preview of content from a first set of one or more cameras of the one or more cameras, the computer system detects, via the one or more input devices, a request (e.g., 1706n) to change from the first set of one or more cameras to a second set of one or more cameras of the one or more cameras; and In some embodiments, the first set of one or more cameras are directed in a first direction (e.g., are a set of rear-facing cameras) and the second set of one or more cameras are directed in a second direction, different from the first direction (e.g., are a set of front-facing cameras). In some embodiments, the request is an input directed to a camera selection selectable option of the plurality of selectable options. In response to detecting the request to change from the first set of one more cameras to the second set of one or more cameras, the computer system changes from the first set of one more cameras to the second set of one or more cameras (e.g., as discussed with reference to FIG. 17K). In some embodiments, including updating the live preview of content. In response to detecting the request to change from the first set of one more cameras to the second set of one or more cameras, the computer system ceases to display one or more selectable options of the plurality of selectable options (e.g., ceases to display 1700a). In some embodiments, ceasing to display the first selectable option and/or the second selectable option. In some embodiments, changing from the first set of one or more cameras to the second set of one or more cameras includes changing a zoom level, a capture orientation, and/or an aspect ratio of the live preview of content. In some embodiments, changing from the first set of one or more cameras to the second set of one or more cameras includes maintaining one or more of a current zoom level, capture orientation, and/or aspect ratio of the live preview of content.

In some embodiments, changing the zoom level of the live preview of content from the one or more cameras includes displaying, via the one or more display generation components, an indication (e.g., a graphical or textual indication) that the zoom level has been changed (e.g., 900f at FIG. 17B). In some embodiments, the indication that the zoom level has changed is a transient/temporary indication that is displayed for a predetermined period of time. Changing the capture orientation of media captured by the one or more cameras includes displaying, via the one or more display generation components, an indication (e.g., a graphical or textual indication) that the capture orientation has been changed (e.g., 1700a at FIG. 17C). In some embodiments, the indication that the capture orientation has changed is a transient/temporary indication that is displayed for a predetermined period of time. In some embodiments, the indication that the zoom level has been changed is displayed at a first location in the camera user interface and the indication that the capture orientation has changed is also displayed at the first location.

In some embodiments, the indication that the zoom level has changed has a visual appearance that is different from a visual appearance of the indication that the capture orientation has changed (e.g., compare 900f at FIGS. 17B and 1700a at FIG. 17C) (e.g., the indication that the zoom level has changed and the indication that the capture orientation has changed are visually different and/or are displayed at different locations in the camera user interface). In some embodiments, the indication that the zoom level has changed and the indication that the capture orientation has changed are the same.

In some embodiments, the computer system detects that a set of one or more criteria for changing a capture parameter have been met (e.g., detecting a change in subjects as discussed with reference to FIGS. 17G and 17H). In some embodiments, detecting that the one or more criteria for changing a capture parameter have been met occurs without detecting a user input. In some embodiments, the set of one or more criteria for changing a capture parameter have been met include one or more criteria such as a detected content criteria (e.g., a criteria based on content detected within the field-of-view of the one or more cameras such as a person(s) detected in the field-of-view, a change in the number of subjects within the field-of-view, or movement detected within the field-of-view and environmental condition criteria (e.g., a change in lighting or color/white balance)). in response to detecting that the set of one or more criteria for changing a capture parameter have been met, automatically changing a value of the capture parameter, including: in accordance with a determination that a set of one or more zoom level change criteria are met, automatically changing (e.g., without explicit user input requesting a change) the zoom level of the live preview of content from the one or more cameras (e.g., as discussed with reference to FIG. 17G and FIG. 17H); and in accordance with a determination that a set of one or more capture orientation change criteria are met, automatically changing (e.g., without explicit user input requesting a change) the capture orientation of media captured by the one or more cameras via the camera user interface (e.g., as discussed with reference to FIG. 17G). In some embodiments, the computer system changes the zoom level and/or capture orientation when certain conditions are met, without requiring explicit user input to do so. In some embodiments, the computer system changes the zoom level and/or capture orientation when certain conditions are met in accordance with method 1000 and/or 1200.

In some embodiments, the computer system detects, via the one or more input devices, a set of one or more inputs (e.g., 1706a or 1706b) corresponding to a request to manually change the value of the capture parameter. In response to detecting the set of one or more inputs corresponding to the request to manually change the value of the capture parameter, the computer system changes the value of the capture parameter in accordance with the set of one or more inputs corresponding to the request to manually change the value of the capture parameter. In response to detecting the set of one or more inputs corresponding to the request to manually change the value of the capture parameter and in accordance with a determination that automatic changes to the value of the capture parameter were enabled when the set of one or more inputs corresponding to the request to manually change the value of the capture parameter was detected, the computer system displays a visual indication (e.g., 1708a) that automatic changes to the value of the capture parameter are disabled (e.g., temporarily or permanently as discussed with reference to FIG. 17C). In response to detecting the set of one or more inputs corresponding to the request to manually change the value of the capture parameter and in accordance with a determination that automatic changes to the value of the capture parameter were disable when the set of one or more inputs corresponding to the request to manually change the value of the capture parameter was detected, the computer system forgoes display of the visual indication that automatic changes to the value of the capture parameter are disabled (e.g., because the automatic changes to the value of the capture parameter were already disabled). In some embodiments, the visual indication that automatic changes to the value of the capture parameter are disabled is only displayed with the automatic tracking mode transitions from being enabled to disabled and is not redisplayed on subsequent manual changes to capture parameter (e.g., until the mode is reenabled and then subsequently disabled again).

In some embodiments, in conjunction with (e.g., concurrently with or shortly before or shortly after) automatically changing the value of the capture parameter, the computer system displays, via the one or more display generation components, an indication (e.g., 1708b or 1708c) that the value of the capture parameter has changed. For example, in conjunction with automatically changing the zoom level of the live preview of content from the one or more cameras, the computer system displays via the one or more display generation components, an indication (e.g., a graphical or textual indication) that the zoom level has been automatically changed; and In some embodiments, the indication that the zoom level has automatically changed is a transient/temporary indication that is displayed for a predetermined period of time. For example, in conjunction with automatically changing the capture orientation of media captured by the one or more cameras, the computer system displays, via the one or more display generation components, an indication (e.g., a graphical or textual indication) that the capture orientation has been automatically changed. In some embodiments, the indication that the capture orientation has automatically changed is a transient/temporary indication that is displayed for a predetermined period of time. In some embodiments, the indication that the zoom level has been automatically changed is displayed at a first location in the camera user interface and the indication that the capture orientation has automatically changed is also displayed at the first location.

In some embodiments, the indication (e.g., 1708b or 1708c) that the value of the capture parameter (e.g., zoom level or capture orientation) has been automatically changed has a first appearance. The computer system detects, via the one or more input devices, a set of one or more inputs corresponding to a request to manually change the value of the capture parameter. In response to detecting the set of one or more inputs corresponding to the request to manually change the value of the capture parameter, the computer system changes the value of the capture parameter in accordance with the set of one or more inputs corresponding to the request to manually change the value of the capture parameter; and displays an indication (e.g., appearance of 900f and/or 1700a) that the value of the capture parameter has been manually changed (e.g., displaying an indication if the change in value and/or displaying an indication that automatic changes in the value of the capture parameter have been disabled), wherein the indication that the value of the capture parameter has been manually changed as a second appearance that is different (e.g., differs in content, size, or color) from the first appearance of the indication that the value of the capture parameter has been automatically changed. In some embodiments, a notice is generated for automatic changes in the value of the capture parameter and a notice is not generated for manual changes in the capture parameter.

In some embodiments, the computer system detects, via the one or more input devices, a set of one or more inputs (e.g., 1706a or 1706b) corresponding to a request to disable automatic changes to the value of the capture parameter. In response to detecting the set of one or more inputs corresponding to the request to disable automatic changes to the value of the capture parameter, the computer system disables automatic changing of the value of the capture parameter, and displays, via the one or more display generation components, a visual indication (e.g., 1708a) that automatic changes to the value of the capture parameter have been disabled that has a third visual appearance. The appearance of the indication (e.g., 1708d or 1708e) that the value of the capture parameter (e.g., zoom level or capture orientation) has been automatically changed (and optionally the second appearance of the indication that the value of the capture parameter has been manually changed) has a first value for a respective visual characteristic. The appearance of the indication that automatic changes to the value of the capture parameter have been disabled has a second value, different from the first value, for the respective visual characteristic (e.g., alerts, badges and/or notices that the value of the capture parameter has changed based on manual input or automatically have a first color, while alerts, badges and/or notices that automatic switching of the value of the capture parameter has been disabled have a second color that is different from the first color).

In some embodiments, automatic changing of a value of the capture parameter (e.g., automatic changing of the zoom level and/or automatic changing of the capture orientation) is enabled when the selection input (e.g., 1706a or 1706b) is detected; and manually changing the value of the capture parameter causes automatic changing of the value of the capture parameter to be disabled (e.g., as discussed with reference to FIG. 17B). For example, changing the zoom level of the live preview of content from the one or more cameras causing (e.g., for a predetermined period of time or until a setting is manually changed) automatic changing of the zoom level to be disabled. For example, changing the capture orientation of media captured by the one or more cameras via the camera user interface causes (e.g., for a predetermined period of time or until a setting is manually changed) automatic changing of the capture orientation to be disabled.

In some embodiments, automatic changing of a value of the capture parameter (e.g., automatic changing of the zoom level and/or automatic changing of the capture orientation) is enabled when the selection input (e.g., 1706a or 1706b) is detected; and manually changing the value of the capture parameter causes automatic changing of the value of the capture parameter to be disabled until a first set of respective criteria are met (e.g., as discussed with reference to FIG. 17C). In some embodiments, the first set of respective criteria are met when a current camera capture session has ended (e.g., the camera user interface and/or a camera application that manages the camera user interface has been closed for a predetermined period of time). For example, changing the zoom level of the live preview of content from the one or more cameras causes automatic changing of the zoom level to be disabled until the first set of respective criteria are met; and In some embodiments, the first set of respective criteria are met when a current camera capture session has ended (e.g., the camera user interface and/or a camera application that manages the camera user interface has been closed for a predetermined period of time). For example, changing the capture orientation of media captured by the one or more cameras via the camera user interface causes automatic changing of the capture orientation to be disabled until a second set of respective criteria are met. In some embodiments, the second set of respective criteria are met when a current camera capture session has ended (e.g., the camera user interface and/or a camera application that manages the camera user interface has been closed for a predetermined period of time).

In some embodiments, the camera user interface (e.g., the plurality of selectable options or a separate settings panel for adjusting one or more capture parameters that optionally includes options for changing settings for multiple capture parameters such as zoom level and capture orientation) includes a third selectable option (e.g., “OFF” option in 1700f1), different from the first selectable option and the second selectable option. In response to detecting the selection input and in accordance with a determination that the selection input is directed to the third selectable option, the computer system disables (e.g., for a predetermined period of time or until a set of conditions are met) automatic changing of a first capture parameter (e.g., automatic changing of the zoom level or capture orientation).

In some embodiments, the camera user interface (e.g., the plurality of selectable options or a separate settings panel for adjusting one or more capture parameters that optionally includes options for changing settings for multiple capture parameters such as zoom level and capture orientation) includes a fourth selectable option (e.g., “OFF” option in 1700f2), different from the first selectable option, the second selectable option, and the third selectable option. In response to detecting the selection input and in accordance with a determination that the selection input is directed to the fourth selectable option, the computer system disables (e.g., for a predetermined period of time or until a set of conditions are met) automatic changing of a second capture parameter (e.g., automatic changing of the zoom level or capture orientation), different from the first capture parameter.

Note that details of the processes described above with respect to method 1800 (e.g., FIG. 18) are also applicable in an analogous manner to the methods described above. For example, method 1800 optionally includes one or more of the characteristics of the various methods described above with reference to methods 700, 800, 1000, 1200, 1400, 1500, and/or 1600. For example, the first set of one or more mode options of method 700 can be used to switch the type of media captured in response to a capture request, while concurrently displaying a zoom control and a capture orientation control, in accordance with method 1800.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the capture of media. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve the capture of media. Accordingly, use of such personal information data enables users to have calculated control of the captured media and/or of options for capturing media. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media capture settings and/or options, the present technology can be configured to allow users to select to “opt in” or “opt out” of participation in the collection of personal information data during registration for services or anytime thereafter. In another example, users can select not to provide mood-associated data for improving media capture. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, media capture settings can be selected by inferring preferences based on non-personal information data or a bare minimum amount of personal information, such as the content being requested by the device associated with a user, other non-personal information available to the media capture application, or publicly available information.

1-233. (canceled)

234. A computer system configured to communicate with one or more input devices, one or more display generation components, and one or more cameras, comprising:
one or more processors; and
memory storing one or more programs configured to be executed by the one or more processors, the one or more programs including instructions for:
displaying, via the one or more display generation components, a camera user interface that includes a camera mode selection user interface object, wherein the camera mode selection user interface object includes an indication of a currently selected capture mode for the one or more cameras;
detecting, via the one or more input devices, a set of one or more inputs directed to the camera mode selection user interface object; and
in response to detecting the set of one or more inputs directed to the camera mode selection user interface object, expanding the camera mode selection user interface object from a first size to a second size, larger than the first size.

235. The computer system of claim 234, wherein expanding the camera mode selection user interface object from the first size to the second size includes:
displaying, via the one or more display generation components, indications of one or more additional modes for the one or more cameras that were not displayed prior to detecting the set of one or more inputs directed to the camera mode selection user interface object.

236. The computer system of claim 234, wherein expanding the camera mode selection user interface object from the first size to the second size includes:
expanding the camera mode selection user interface object in a first direction of expansion; and
expanding the camera mode selection user interface object in a second direction of expansion, different from the first direction of expansion.

237. The computer system of claim 234, wherein:
prior to expanding the camera mode selection user interface object from the first size to the second size, the camera mode selection user interface object includes a first set of one or more mode options for switching between photo capture mode and video capture mode; and
the expanded camera mode selection user interface object includes a second set of one or more mode options that includes at least one mode option for switching to a capture mode that is different from the photo capture mode and video capture mode.

238. The computer system of claim 234, wherein displaying the camera mode selection user interface object includes:
in accordance with a determination that the currently selected capture mode for the one or more cameras is first capture mode, displaying the camera mode selection user interface object at a first displayed size; and
in accordance with a determination that the currently selected capture mode for the one or more cameras is second capture mode, different from the first capture mode, displaying the camera mode selection user interface object at a second displayed size that is greater than the first displayed size.

239. The computer system of claim 238, wherein the first capture mode is one of a photo capture mode or a video capture mode.

240. The computer system of claim 238, wherein the second capture mode is one of a slow motion capture mode, a time elapse capture mode, portrait capture mode, a cinematic video capture mode, a panorama capture mode or a spatial capture mode.

241. The computer system of claim 234, wherein the camera mode selection user interface object includes a respective capture mode option that corresponds to a respective capture mode, the one or more programs further including instructions for:
while the respective capture mode is not the currently selected capture mode, detecting, via the one or more input devices, an input directed to the respective capture mode option; and
in response to detecting the input directed to the respective capture mode option, selecting the respective capture mode as the currently selected capture mode.

242. The computer system of claim 234, wherein displaying the indication of the currently selected capture mode for the one or more cameras includes:
in accordance with a determination that the currently selected capture mode is a first currently selected capture mode, displaying the indication of the currently selected capture mode for the one or more cameras at a first position within the camera mode selection user interface object; and
in accordance with a determination that the currently selected capture mode is a second currently selected capture mode, different from the first currently selected capture mode, displaying the indication of the currently selected capture mode for the one or more cameras at a second position, different from the first position, within the camera mode selection user interface object.

243. The computer system of claim 234, the one or more programs further including instructions for:
while displaying the camera mode selection user interface object at the second size, detecting, via the one or more input devices, a second set of one or more inputs directed to the camera mode selection user interface object, wherein the second set of one or more inputs includes movement; and
in response to detecting the second set of one or more inputs, expanding the camera mode selection user interface object from the second size to a third size, larger than the second size.

244. The computer system of claim 243, the one or more programs further including instructions for:
in response to detecting the second set of one or more inputs:
in accordance with a determination that the movement has a first movement characteristic, switching the currently selected capture mode to a third capture mode determined based on the first movement characteristic, wherein the third capture mode is different from the first capture mode; and
in accordance with a determination that the movement has a second movement characteristic, different from the first movement characteristic, switching the currently selected capture mode to a fourth capture mode determined based on the second movement characteristic, wherein the fourth capture mode is different from the third capture mode and the first capture mode.

245. The computer system of claim 244, wherein:
switching the currently selected capture mode to the third capture mode includes outputting a first non-visual indication; and
switching the currently selected capture mode to the fourth capture mode includes outputting a second non-visual indication.

246. The computer system of claim 243, wherein the movement included in the second set of one or more inputs is in a first direction of movement, the one or more programs further including instructions for:
detecting, via the one or more input devices, a third set of one or more inputs directed to the camera mode selection user interface object, wherein the third set of one or more inputs includes movement in a second direction of movement, different from the first direction of movement; and
in response to detecting the third set of one or more inputs, displaying, via the one or more display generation components, one or more respective control user interface objects that are selectable to perform corresponding operations within the camera user interface.

247. The computer system of claim 246, wherein:
camera mode selection user interface object includes a representation of a first camera mode, a representation of a second camera mode, and a respective user interface element that moves to indicate whether the first camera mode or the second camera mode is a currently selected camera mode;
displaying the one or more respective control user interface objects includes expanding the respective user interface element; and
the one or more respective control user interface objects are displayed within the expanded respective user interface element.

248. The computer system of claim 234, wherein displaying the camera user interface includes displaying, concurrently with the camera mode selection user interface object prior to the camera mode selection user interface object being expanded, one or more camera controls that include a first camera control at a first location in the camera user interface, the one or more programs further including instructions for:
in response to detecting the set of one or more inputs directed to the camera mode selection user interface object, ceasing to display the first camera control at the first location in the camera user interface.

249. The computer system of claim 248, wherein ceasing to display the first camera control at the first location includes moving the first camera control to a second location in the camera user interface, different from the first location.

250. The computer system of claim 248, wherein ceasing to display the first camera control at the first location includes removing the first camera control from the camera user interface.

251. The computer system of claim 248, wherein the first camera control is a control that, when selected based on an input detected by the one or more input devices, causes the computer system to switch which camera is being used to capture media.

252. The computer system of claim 248, wherein the first camera control is a control that, when selected based on an input detected by the one or more input devices, causes the computer system to display a user interface for displaying previously captured media.

253. The computer system of claim 234, wherein the camera user interface includes one or more zoom controls that includes a first zoom control at a third location within the camera user interface, the one or more programs further including instructions for:
detecting, via the one or more input devices, a request to change a zoom level of the camera user interface; and
in response to detecting the request to change the zoom level:
changing a zoom level of the camera user interface; and
shifting the first zoom control to a fourth location within the camera user interface, different from the third location.

254. The computer system of claim 253, the one or more programs further including instructions for:
detecting, via the one or more input devices, an input directed to the one or more zoom controls; and
in response to detecting the input directed to the one or more zoom controls, expanding the one or more zoom controls to display additional zoom options that were not visible prior to detecting the input directed to the one or more zoom controls.

255. A non-transitory computer-readable storage medium storing one or more programs configured to be executed by one or more processors of a computer system that is in communication with one or more input devices, one or more display generation components, and one or more cameras, the one or more programs including instructions for:
displaying, via the one or more display generation components, a camera user interface that includes a camera mode selection user interface object, wherein the camera mode selection user interface object includes an indication of a currently selected capture mode for the one or more cameras;
detecting, via the one or more input devices, a set of one or more inputs directed to the camera mode selection user interface object; and
in response to detecting the set of one or more inputs directed to the camera mode selection user interface object, expanding the camera mode selection user interface object from a first size to a second size, larger than the first size.

256. A method, comprising:
at a computer system that is in communication with one or more input devices, one or more display generation components, and one or more cameras:
displaying, via the one or more display generation components, a camera user interface that includes a camera mode selection user interface object, wherein the camera mode selection user interface object includes an indication of a currently selected capture mode for the one or more cameras;
detecting, via the one or more input devices, a set of one or more inputs directed to the camera mode selection user interface object; and
in response to detecting the set of one or more inputs directed to the camera mode selection user interface object, expanding the camera mode selection user interface object from a first size to a second size, larger than the first size.
